(19) United States
(12) Patent Application Publication
(10) Pub. No.: US 2025/0013820 A1
(43) Pub. Date: Jan. 9, 2025

(54) METHODS AND SYSTEMS FOR SPECIFYING AND USING IN SPREADSHEET CELL FORMULAS JOINS BETWEEN DATA SETS

(71) Applicant: Adaptam Inc., Palo Alto, CA (US)

(72) Inventors: Robert E. Dvorak, Portola Valley, CA (US); Yuriy Garin, San Carlos, CA (US); Alexey Verkhovskiy, Calgary (CA)

(73) Assignee: Adaptam Inc., Palo Alto, CA (US)

(21) Appl. No.: 18/765,168

(22) Filed: Jul. 5, 2024

Related U.S. Application Data
(60) Provisional application No. 63/525,138, filed on Jul. 5, 2023.

(51) Int. Cl. G06F 40/18; G06F 3/0482; G06F 16/2455

(52) U.S. Cl. CPC G06F 40/18; G06F 16/2456; G06F 3/0482

(57) ABSTRACT

The disclosed technology creates a range of manual to automated ways of setting up and verifying the correct joining of data sets within spreadsheet cell formulas. Handling pairing of data sets and then chaining/sequencing of joins resulting in joins of three or more data sets. Limiting joins, as desired, to data value matching criteria and data modelling cardinality requirements. Allowing the qualification of the data sets for joining to be done within or before the cell formula. Making the qualified joinable data sets available in situationally intelligent data field/column selection lists for use populating those cell formulas. Availing those joined data fields/columns to be used in regular cell formula calculations.

### CROSS-REFERENCE

This application claims priority to and the benefit of U.S. Provisional Application No. 63/525,138 titled “Methods and Systems for Specifying and Using In Spreadsheet Cell Formulas Joins Between Data Sets,” filed 5 Jul. 2023 (Atty. Docket No. 1016-1). The priority application is incorporated by reference herein for all purposes.

### RELATED APPLICATIONS

This application is related to and incorporates by reference the following applications: U.S. application Ser. No. 16/031,339 titled “Methods and Systems for Providing Selective Multi-Way Replication and Atomization of Cell Blocks and Other Elements in Spreadsheets and Presentations,” filed 10 Jul. 2018, now U.S. Pat. No. 11,182,548, issued 23 Nov. 2021 (Atty. Docket No. ADAP 1000-2), which claims the benefit of U.S. Provisional Application No. 62/530,835, filed 10 Jul. 2017 (Atty. Docket No. ADAP 1000-1).

U.S. application Ser. No. 16/031,379 titled “Methods and Systems for Connecting a Spreadsheet to External Data Sources with Formulaic Specification of Data Retrieval,” filed 10 Jul. 2018, now U.S. Pat. No. 11,354,494, issued 7 Jun. 2022 (Atty. Docket No. ADAP 1001-2), which claims the benefit of U.S. Provisional Application No. 62/530,786, filed 10 Jul. 2017 (Atty. Docket No. ADAP 1001-1).

U.S. application Ser. No. 16/031,759 titled, “Methods and Systems for Connecting a Spreadsheet to External Data Sources with Temporal Replication of Cell Blocks,” filed 10 Jul. 2018, now U.S. Pat. No. 11,017,165, issued 25 May 2021 (Atty. Docket No. ADAP 1002-2), which claims the benefit of U.S. Provisional Patent Application No. 62/530,794, filed 10 Jul. 2017 (Atty. Docket No. ADAP 1002-1).

U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 11,036,929, issued 15 Jun. 2021 (Atty. Docket No. ADAP 1003-2), which claims the benefit of U.S. Provisional Patent Application No. 62/586,719, filed on Nov. 15, 2017 (Atty Docket ADAP 1003-1).

U.S. application Ser. No. 17/359,430 titled, “Methods and Systems for Constructing a Complex Formula in a Spreadsheet Cell,” filed 25 Jun. 2021 (Atty Docket ADAP 1004-2), which claims the benefit of U.S. Provisional Patent Application No. 63/044,990, filed 26 Jun. 2020 (Atty Docket No. ADAP 1004-1).

U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 (Atty Docket No. ADAP 1005-2), which claims the benefit of U.S. Provisional Patent Application No. 63/044,989, filed 26 Jun. 2020 (Atty Docket No. ADAP 1005-1).

U.S. application Ser. No. 17/384,404 titled “Method and System for Improved Spreadsheet Charts,” filed 23 Jul. 2021 (Atty Docket No. ADAP 1006-2), which claims the benefit of U.S. Provisional Patent Application No. 63/055,581, filed 23 Jul. 2020 (Atty Docket No. ADAP 1006-1).

U.S. application Ser. No. 17/374,898 titled “Method and System for Improved Spreadsheet Analytical Functioning,” filed 13 Jul. 2021, now U.S. Pat. No. 11,694,023, issued 4 Jul. 2023 (Atty Docket No. ADAP 1007-2), which claims the benefit of U.S. Provisional Patent Application No. 63/051,280, filed 13 Jul. 2020 (Atty Docket No. ADAP 1007-1).

U.S. application Ser. No. 17/374,901 titled “Method and System for Improved Ordering of Output from Spreadsheet Analytical Functions,” filed 13 Jul. 2021 (Atty Docket No. ADAP 1008-2), which claims the benefit of U.S. Provisional Patent Application No. 63/051,283, filed 13 Jul. 2020 (Atty Docket No. ADAP 1008-1).

U.S. application Ser. No. 17/752,814 titled “Method and System for Spreadsheet Error Identification and Avoidance,” filed 24 May 2022 (Atty Docket No. ADAP 1009-2) which claims the benefit of U.S. Provisional Patent Application No. 63/192,475, filed 24 May 2021 (Atty Docket No. ADAP 1009-1).

U.S. application Ser. No. 17/903,934 titled “Method and System for Improved 2d Ordering of Output from Spreadsheet Analytical Functions,” filed 6 Sep. 2022 (Atty Docket No. ADAP 1010-2) which claims the benefit of U.S. Provisional Patent Application No. 63/240,828, filed 3 Sep. 2021 (Atty Docket No. ADAP 1010-1).

U.S. application Ser. No. 17/988,641 titled “Methods and Systems for Sorting Spreadsheet Cells with Formulas,” filed 16 Nov. 2022 (Atty Docket No. ADAP 1011-2) which claims the benefit of U.S. Provisional Patent Application No. 63/280,590, filed 17 Nov. 2021 (Atty Docket No. ADAP 1011-1).

U.S. application Ser. No. 18/074,301 titled “Method and System for Improved Visualization of Charts in Spreadsheets,” filed 2 Dec. 2022 (Atty Docket No. ADAP 1012-2) which claims the benefit of U.S. Provisional Patent Application No. 63/25,945, filed 3 Dec. 2021 (Atty Docket No. ADAP 1012-1).

U.S. application Ser. No. 18/142,560 titled “Methods and Systems for Spreadsheet Function and Flex Copy-Paste Control of Formatting and Use of Selection List Panels,” filed 2 May 2022 (Atty Docket No. ADAP 1013-2) which claims the benefit of U.S. Provisional Application No. 63/337,576, filed 2 May 2022 (Atty Docket No. ADAP 1013-1).

U.S. application Ser. No. 18/142,557 titled “Methods and Systems for Bucketing Values in Spreadsheet Functions,” filed 2 May 2023 (Atty Docket No. ADAP 1014-2) which claims the benefit of U.S. Provisional Application No. 63/337,572, filed 2 May 2022 (Atty Docket No. ADAP 1014-1).

U.S. application Ser. No. 18/542,510 titled “Methods and Systems for Flexibly Linking Spreadsheet Cell Movements and Formulas,” filed 15 Dec. 2024 which claims the benefit of U.S. Provisional Application No. 63/433,408, filed 16 Dec. 2022 (Atty Docket No. ADAP 1015-1).

### BACKGROUND

Today's spreadsheets have very limited capabilities to help users join data from different sets of data (e.g., tables of data). In regular spreadsheet cells there are data matching capabilities (e.g., VLOOKUP) but not true SQL data table joining capabilities. SQL like data joining capabilities are found in a limited way in the Spreadsheet data importing tools (e.g., Microsoft Excel Power Query) or the advanced version of PivotTables (e.g., Microsoft Excel PowerPivot). They are not available in regular spreadsheet cell formulas. Users are not able to write regular algebraic and math and trigonometry, statistical and engineering functional formulas that join tables of data stored within the cells of the spreadsheet or stored externally to the spreadsheet. Instead, regular spreadsheet cells are limited to matching data cell by cell (i.e., not table to table) using the lookup and reference functions such as VLOOKUP or XLOOKUP. These capabilities do not join data tables in a SQL sense but simply do a one cell match to a set of data (e.g., range or table) stored in the spreadsheet. They do limit nor warn the user if that match is not a unique one and therefore may not be correct for what the user is doing. They do not warn or stop the user from making matches that make no sense (e.g., where the matched range does not have the same data type as what it is matching). They do not give the users of regular spreadsheet formulas (therefore excluding the embedded programming languages within spreadsheets such as Microsoft Excel VBA) the ability to join data external to the spreadsheet.

Accordingly, an opportunity arises to give spreadsheet users a way to use SQL like joined data tables data in regular spreadsheet cell formulas. Where the joined data can be used in algebraic formulas, prebuilt function formulas (e.g., SUM, COUNT, AVERAGE, and WRITE_2D), formulaic data formulas, and mix and match combinations of algebraic, prebuilt function and formulaic data formulas. There also arises an opportunity to ensure users do not execute data joins that will not work (e.g., with keys of different data types) and joins which do not join (e.g., with keys that have no overlapping/shared values) through verified (qualified) joinable selection lists (e.g., Hints) for formula building only showing fields in data sets hitting certain join parameters (e.g., join keys with of the same data type and shared values). There is an opportunity to make it extremely easy for the spreadsheet users to join data via lists of joinable data which also screens out certain data modelling cardinalities of the data sets (e.g., limited Cartesian Product joins from many to many join key situations or Full Cartesian joins from a cross join) that result in data row duplication the unsophisticated user may not understand. There are opportunities to automate the determination of joinable data set pairings and to then automatically determine combinations of joinable data set pairings (via chaining or sequencing of joins) resulting in three or more data set joins for use in the spreadsheet cell formulas.

### SUMMARY

The disclosed technology creates a range of manual to automated ways of setting up and verifying the correct joining (e.g., same data type keys with shared values) of data sets. Handling pairing of data sets and then chaining/sequencing of joins resulting in joins of three or more data sets. These qualified (validated) joinable data set fields/columns are then usable in regular cell formulas which are then error protected against unverified joins through warnings or error messages. The situationally qualified (e.g., validated or verified) data set joins of the in-cell and/or external joined data sets can then be presented by our technology in selection lists (e.g., hints) for easy population into the cell formulas. Those joinable data selection lists (e.g., hints) can be further limited to exclude limited and/or full Cartesian Product joins to protect unsophisticated users from joins that duplicate data rows in ways they may not understand.

Embodiments of the disclosed technology range from human qualified joinability to fully automated qualification with different combinations of human and automated qualification/validation processes and steps. That qualification can include eliminating joins between keys that are not the same data type and join keys that share no overlapping/shared values which would of course generate no inner join values. It can also be extended to a very narrow range of acceptable joins such as referential integrity to less limiting variants of “unique to unique” or “unique to many (non-unique)” join key relationships to any join that results in a non-null inner join outcome to any join key combination that generates a SQL join outcome. Embodiments can make it easy for users to set up the desired joins via selection lists presenting information on the potential join key combinations through removing options not meeting qualification criteria. Embodiments can go as far as automating the determination of the joining keys and therefore the data set joins. Embodiments can make using the joined data sets easier via joinable data selection lists (e.g., hints) to automatically avail users of the joinable data sets. Embodiments of those selection lists can make it easy to use certain joins that require little sophistication to understand the outcomes and more difficult to do data set joins typically requiring more sophistication to understand the outcomes (e.g., Cartesian Product joins or composite key joins).

Embodiments can ensure that once the joining moves beyond a pair of data sets that the selection list supported joinable data does not violate any of these join limitations (e.g., limited Cartesian Product joins) for the chained/sequenced joins. Embodiments can give users access to chained/sequenced joinable data sets from joins qualified before their cell formula and that execute in their cell formulas with no visible join argument or arguments. With further embodiments that allow more sophisticated users the ability to specify any of the SQL type joins (e.g., inner, left outer, right outer, full outer, cross, and self) and specify joins not prequalified.

Embodiments of the disclosed technology allow usage in spreadsheet cell formulaic data algebraic formulas, prebuilt function formulas, and/or formulaic data formulas. Where that usage results in adding a joined data field/column to the formula and/or substituting a joined data field for a field/column from another joined data set. Embodiments support the data join being done as a normal part of the formula or through a dedicated function (e.g., a new ADD, JOIN, or SUB function). Embodiments support default join types and join keys which can then be changed via a capability or function setting. Those joined data sets can reside within the spreadsheet cells and/or in non-spreadsheet cells (NSCs) external to the spreadsheet cells.

Embodiments support multiple joins between the same two data sets automatically creating a field/column naming approach to identify the multiple joined fields. Further embodiments support the automatic or user decision supported modification of spreadsheet formula arguments as a user invokes a join requiring alteration of a previous argument in the formula.

Embodiments of the disclosed technology can situationally specific present a qualified joinable list (e.g., Hint) of selectable formulaic data fields/columns for user population into the spreadsheet cell formula. Where that list changes with selections and is not present when there are no joinable options or no pre-verified options. Embodiments support informing users should they type a non-joinable set of formulaic data fields into a formula with ERROR messages after they enter the formula and/or as they type the formula. Embodiments help users who want to specify a join within a cell formula or before the cell formula with information to inform the join specification, e.g., key pair data type compatibility, value matches and data modelling cardinality, through to automated screening of key pairs passing qualification (join validation) tests.

Particular aspects of the technology disclosed are described in the claims, specification, and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

The color drawings also may be available in PAIR via the Supplemental Content tab.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 examples prior art of Microsoft Excel XLOOKUP limitation of one value.

FIG. 2 examples prior art of Microsoft Excel XLOOKUP limitation of no overlapping value matching problem identification during the matching or after execution of the formula.

FIG. 3 examples prior art of Microsoft Excel XLOOKUP limitation of no data type matching problem identification during the matching or after execution of the formula.

FIG. 4 examples a spectrum of join qualification success paths supported by our technology.

FIG. 5 examples a data join done in SQL with no Cartesian Product.

FIG. 6 examples a data join done in SQL with a limited Cartesian Product.

FIG. 7 examples one scenario of steps taken by a user (and our spreadsheet) creating an in-cell spreadsheet formula employing qualified joinable data sets in selection lists.

FIG. 8 examples different ways for specifying and validating (qualifying) the joinable data sets.

FIG. 9A examples a user specifying the two data sets which are joinable (employing qualification path ‘a/b/g’ or ‘a/c/d/h’ in FIG. 8) and their join keys in three small data sets.

FIG. 9B examples an automated approach by our technology specifying the join key pairs between two data sets which are joinable employing qualification via path ‘a/e/f/g’ or ‘a/g/h’ in FIG. 8 and qualification tests exampled in FIG. 4.

FIG. 10A illustratively examples the data sets for our spreadsheet application being non-spreadsheet cell (NSC) external data sets residing in a database on the device (e.g., laptop) running the spreadsheet application.

FIG. 10B illustratively examples the data sets for our spreadsheet application being non-spreadsheet cell (NSC) external data sets residing in a database somewhere in the cloud.

FIG. 11A illustratively examples the data sets for our spreadsheet application being in-cell data ranges residing within a worksheet within the spreadsheet.

FIG. 11B illustratively examples the data sets for our spreadsheet application being in-cell data tables residing within a worksheet within the spreadsheet.

FIG. 12 examples a UI residing in an external tool or within our spreadsheet that can be used to specify data set join keys.

FIG. 13 examples a semi-automatic data set joining UI residing in an external data intake tool or within our spreadsheet.

FIG. 14 visually examples the result of four types of (SQL) data joins.

FIG. 15 illustratively examples our technology joining data sets for calculational use within a cell formula for the four different join types in FIG. 14.

FIGS. 16A, 16B and 16C example a formulaic data spreadsheet cell formula joining data across two data sets employing two-step selection lists (hints).

FIGS. 17A, 17B and 17C example a formulaic data spreadsheet cell formula joining data across two data sets employing a one-step selection list (hint).

FIG. 18A illustratively examples the calculation steps done within the spreadsheet cell formula in FIGS. 16C, 17B, and 17C using a full outer join.

FIG. 18B illustratively examples the calculation steps done within the spreadsheet cell formula in FIGS. 16C, 17B, and 17C using an inner join.

FIG. 19A examples a cell formula selection list for a field/column with no joinable data sets (therefore no ADD row or fields from another data set shown).

FIG. 19B examples a cell formula ERROR outcome from a user typing into a formula a field from another data set which is not qualified for joining.

FIGS. 20A, 20B, 20C, and 20D examples another way, field substitution, our technology can use the selection lists and formula argument setup that it supports for the joinable data fields.

FIGS. 21A, 21B, 21C, 21D, and 22 examples the use of our joinable data technology in a summation formula (prebuilt function SUM).

FIGS. 23A, 23B, 23C, 23D, and 24 examples adding a second joinable data field/column as a constraint in a summation formula (prebuilt function SUM).

FIGS. 25A, 25B, 25C, 26A, and 26B examples the use of our joinable data technology in a “DROPDOWN_MANY’ prebuilt function spreadsheet cell formula.

FIGS. 27A, 27B, 27C, 28A, 28B, and 28C examples the use of our joinable data technology in a “COUNT_TEXT_UNIQUE” prebuilt function spreadsheet cell formula.

FIGS. 29A, 29B, 30A, 30B, 31A, 31B, 31C, 32A, 32B, and 32C examples adding a joinable data field in a ‘WRITE’ function formula.

FIGS. 33A, 33B, 34A, 34B, 34C, 35A, 35B, and 35C examples substituting (replacing) a joinable data field for a field from another data set in a ‘WRITE’ function formula.

FIGS. 36A, 36B, 36C, 37A, and 37B examples adding a joinable data field in a SUM function within a ‘WRITE’ function formula employing a one-step joinable data selection list.

FIGS. 38A, 38B, 38C, 39A, 39B, and 39C examples adding and substituting joinable data fields with a two functions within a third function.

FIG. 40A examples a user specifying the two data sets which are joinable (employing qualification path ‘a/b/g’ or ‘a/c/d/h’ in FIG. 8) with a data modelling cardinality of non-unique to unique and their join keys in three small data sets.

FIG. 40B examples an automated approach by our technology specifying the join key pairs with a data modelling cardinality of non-unique to unique between two data sets which are joinable employing qualification via path ‘a/e/f/g’ or ‘a/g/h’ in FIG. 8 and qualification tests exampled in FIG. 4.

FIGS. 41 and 42 illustratively example our spreadsheet cell formula data joining technology joining two data sets with data modelling cardinality of unique to non-unique using inner, left outer, right outer and full outer joins.

FIGS. 43A, 43B, 43C, 43D, 44A, and 44B examples unique to non-unique join data modelling cardinality substitution joinable selection lists (hints) and spreadsheet formula data joins and calculations.

FIGS. 45A, 45B, 45C, 45D, and 46 examples unique to non-unique join data modelling cardinality addition selection lists (hints) and data joins/calculations in a prebuilt function spreadsheet formula (SUM).

FIGS. 47A, 47B, 47C, 47D, and 48 examples multiple use of our unique to non-unique join data modelling cardinality joinable data technology in a prebuilt function spreadsheet formula (SUM).

FIGS. 49A, 49B, 49C, 50A, 50B, 51A, 51B, 51C, 52A, and 52B examples multiple use (ADD and SUB) of our joinable data fields in a multi-cell output prebuilt function (‘WRITE_CALC_V’) that employs other functions.

FIG. 53A examples a semi-automatic rejection of a many to many join between two data sets in the automated part of a human then automated join set up and qualification validation in our technology.

FIG. 53B examples an automatic rejection of a many to many join between two data sets in the join qualification validation in our technology.

FIGS. 54 and 55 example a UI used for the automatic join qualification validation rejection of a many to many join specified and submitted by a user.

FIG. 56 example UI where the automated join qualification rejects all the potential joins between the three data sets in FIG. 53B.

FIG. 57 illustratively examples the FIG. 4 ‘E’ pathway validation of every possible join key combination for the three data sets in FIG. 53B.

FIG. 58A examples the no joinable data from the data sets in FIG. 53A and FIG. 53B in the selection lists.

FIG. 58B examples the no joinable data from the data sets in FIG. 53A through FIG. 53B when used in a cell formula (resulting in an error), respectively.

FIGS. 58C and 58D example a different embodiment than FIG. 58B where ‘non-unique to non-unique (“many to many”) joins are blocked in the selection list, as shown in FIG. 58A, but work if inputted into the cell formula.

FIG. 59A examples three data sets used for alternative joins in our technology.

FIG. 59B examples a user specifying the two sets of alternative join key pairs for two data sets which are joinable (employing qualification path ‘a/b/g’ or ‘a/c/d/h’ in FIG. 8).

FIGS. 60A and 60B examples an automated approach by our technology specifying two alternative join key pairs between two data sets which are joinable employing qualification via path ‘a/e/f/g’ or ‘a/g/h’ in FIG. 8 and qualification tests exampled in FIG. 4.

FIG. 61 illustratively examples our spreadsheet cell formula data joining technology doing a full outer join of the two alternative joins exampled in FIGS. 59B, 60A, and 60B.

FIGS. 62A, 62B, 62C, 63A, 63B, 64A, 64B, 64C, 65A, and 65B examples a partially manual alternative joins embodiment with a preselected join type and qualified alternative join key pairs but no default selection.

FIGS. 66A, 66B, 67A, and 67B examples in-cell selection list and formula use of the default alternative join in our technology.

FIGS. 68A, 68B, 68C, 69A, 69B, 69C, 69D, 70, and 71 examples an alternative joins embodiment with no join type default and no alternative join key default.

FIGS. 72A, 72B, 73A, 73B, 73C, 73D, and 74 examples the manual override of default specified data set join keys and join types in our technology.

FIGS. 75A, 75B, 76A, 76B, 77, 78A, 78B, 79A, 79B, 80A, 80B, 81A, 81B, 82A, 82B, 82C, 83A, and 83B example spreadsheet formulas using our technology in a spreadsheet cell to double join two data sets as part of the formula.

FIG. 84 examples the many to many full outer and left outer joins of the two data sets in FIG. 53A and FIG. 53B.

FIG. 85 examples the use of the joined data in the calculations done for the cell formula in ‘A1’ in FIG. 58C.

FIGS. 86A and 86B example the use of the joined data in the calculations done for the cell formula in ‘A1’ in FIG. 58D.

FIGS. 87A, 87B, 88A, 88B, 89A, 89B, 90A, 90B, 90C, 91, 92, 93A, 93B, 93C, 94, 95A, and 95B examples our technology chain/sequence joining three data sets within a cell formula for use in the formula calculations.

FIGS. 96A, 96B, 97A, 97B, 98A, 98B, 99A, 99B, 99C, 100, 101, 102A, 102B, 103A, 103B, 103C, 104A, and 104B examples our technology chain/sequence joining three data sets within a cell formula for use in the formula calculations employing data modelling cardinality unique to non-unique joins.

FIGS. 105A, 105B, 106A, 106B, 107A, 107B, and 108 examples multiple function use of our three or more data set chain/sequence join technology employing a combination of a ‘WRITE_CALC_V’ and ‘SUM’ function.

FIGS. 109A, 109B, 110A, 110B, 111A, 111B, 112A, 112B, 113A, 113B, 114, 115, 116A, and 116B examples a situation that does not occur in two data set joins but does occur in three or more data set chained/sequenced joins, where the combination turns unique to non-unique join key pair joins into effectively non-unique to non-unique join key pair joins.

FIGS. 117A, 117B, 118A, 118B, 119A, 119B, 119C, 120A, 120B, 120C, 120D, 121A, 121B, and 121C example our spreadsheet cell formula data joining technology working for two different sets of data joining selections lists from the beginning of the formula, one set for setting up joins and one set for using the joinable fields/columns.

FIGS. 122A, 122B, and 122C example a popup selector for selecting different alternative joined fields to replace a field within a formula that has multiple alternatives once a join is invoked, exampling a different UI than that in FIG. 82B.

FIGS. 123A, 123B, 123C, 123D, 123E, and 123F examples our technology supporting manual joins with only function selection lists.

FIGS. 124A, 124B, 124C, 124D and 124E examples our technology supporting manual joins with more informative join key selection lists.

FIGS. 125A, 125B, 125C, 125D, 125E, 126A, 126B, 126C, 126D, 127A, and 127B examples our technology supporting manual creation of the join formula in a function (SUM) within a function (WRITE_CALC_V) formula.

FIG. 128 examples some of the endpoints of the spectrums of join setup and resetting supported by our in-cell formula data joining technology as well as some midpoints.

FIGS. 129A, 129B, 129C, 130A, 130B, 130C, 130D, 131A, 131B, 131C, 132A, and 132B example our spreadsheet cell formula data joining technology working first for data joining selections lists that then instantiate selection lists for using the joinable data.

FIGS. 133A, 133B, 133C and 133D example two of many different modes of accessing join setup and setting up joins for a spreadsheet, a worksheet, and a spreadsheet cell.

FIG. 134 examples a potential UI that a user can employ to see which data sets have alternative joins, their join keys and the default pair as well as change the default join key pair.

FIGS. 135A and 135B example auto-populated join functions which specify the type of join and the join keys for single joins and a pair of joins that sequence/chain.

FIGS. 136A, 136B, 152A, 152B, 153, 154A, 154B, 155A, and 155B examples a more complicated formula with multiple functions and algebraic operators employing joins of four different data sets in our technology.

FIGS. 137A, 137B, 137C, 138A, 138B, 138C, 138D, 139A, 139B, and 139C example our spreadsheet cell formula data joining technology working first for data joining selections lists that then instantiate selection lists for using the joinable data employing a general join function with an argument specifying the join type.

FIGS. 140A, 140B, and 140C examples three different argument constructs for multiple joins in our general ‘JOIN’ function.

FIG. 141 examples a one-step (all joined fields displayed at once) selection list that would replace the two step selection lists in FIGS. 131A and 131B.

FIGS. 142A, 142B, 142C, 143A, 143B, 143C, 144A, 144B, 145A, 145B, 145C, 146A, 146B, 146C, 146D, 147A, 147B, and 147C example our spreadsheet cell formula data joining technology working first for data joining selections lists that then instantiate selection lists for using the joinable data for chained/sequenced joins.

FIGS. 148A, 148B, 148C, and 149 examples vignettes of in-formula joins and chained/sequenced joins automatically enabling the joinable field selection lists employing a general “JOIN’ function.

FIGS. 150A, 150B, 150C, 150D, 150F, and 150G examples the setup of a functioning formula with multiple chained/sequenced joins supported only by a function selection list and the function guiding syntax help.

FIG. 151 examples one join qualification UI done as part of a data intake tool.

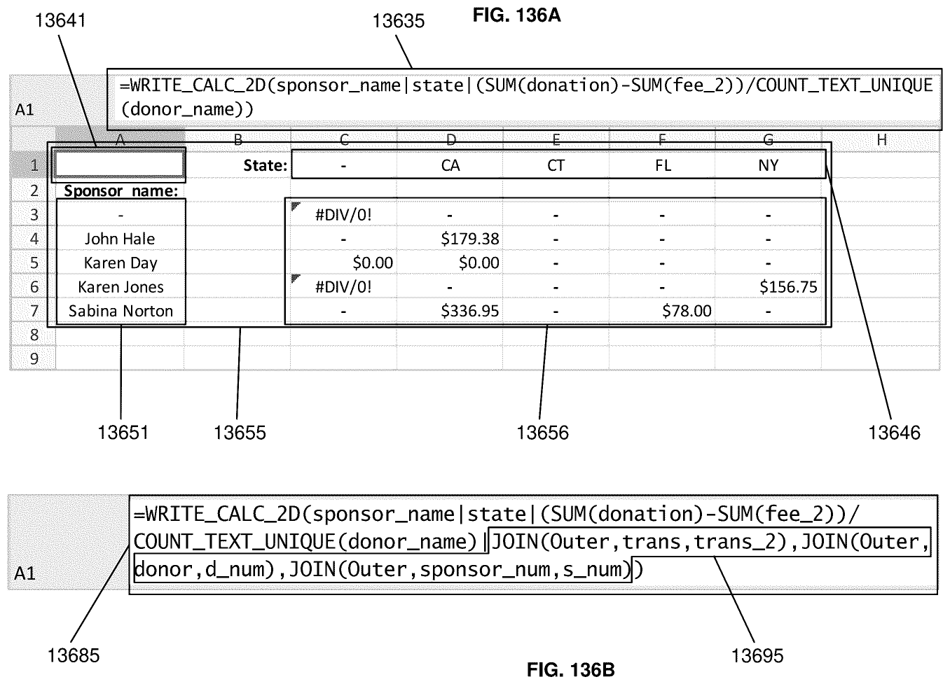

FIGS. 136A, 136B, 152A, 152B, 153, 154A, 154B, 155A, 155B, 136A, and 136B examples a more complicated formula with multiple functions and algebraic operators employing joins of four different data sets in our technology.

FIGS. 156A, 156B, and 156C examples the user specifying sets of join arguments which include data modelling cardinality and both direction value match arguments.

FIG. 157 depicts an example computer system that can be used to implement aspects of the technology disclosed.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

When spreadsheet applications were first created, they electronically emulated tabular paper spreadsheets. More recently, Microsoft Excel, Google Sheets, Apple Numbers, and others have dramatically increased the breadth of capabilities and usefulness of spreadsheets. However, current spreadsheets do not allow users to join different data sets of in-cell and/or external data in their regular spreadsheet cell formulas. The best they can do is employ a lookup and reference prebuilt function (e.g., XLOOKUP or VLOOKUP) to do a cell by cell matching of data from a range (or table) of data within the spreadsheet. These operations require creating a new data set which is not joined in a SQL like table joining sense. They also do not stop the users from trying to match incorrect data sets (e.g., numbers matched to text) and does not inform the user if their match is one of many possible outcomes (and therefore possibly wrong) versus a unique value. Our disclosed technology solves the deficiencies mentioned and can go much farther in warning or protecting some or all users from attempting to join data that is joinable in a SQL operation but generates limited or full Cartesian Product outcomes (e.g., duplication of “many data set” data rows which can miss-inform the user not realizing that is what happened when used in calculations). Our technology goes well beyond the data joining capabilities in the Spreadsheet data importing tools (e.g., Microsoft Excel Power Query) or the advanced version of PivotTables (e.g., Microsoft Excel PowerPivot) in proactively informing the user of qualified (validated) joins (e.g., Hints), providing situationally changing selectable lists of validated joins, supporting a much broader set of join types (e.g., inner and full outer), supporting a broader set of join situations (e.g., greater than two data sets with different join keys, double joins between two data sets, and constraint allowed joins), and doing all of this in regular cell formulas using a large set of the spreadsheet existing prebuilt functions and a large combination of algebraic operations.

### Existing Spreadsheet Cell Formula Capabilities

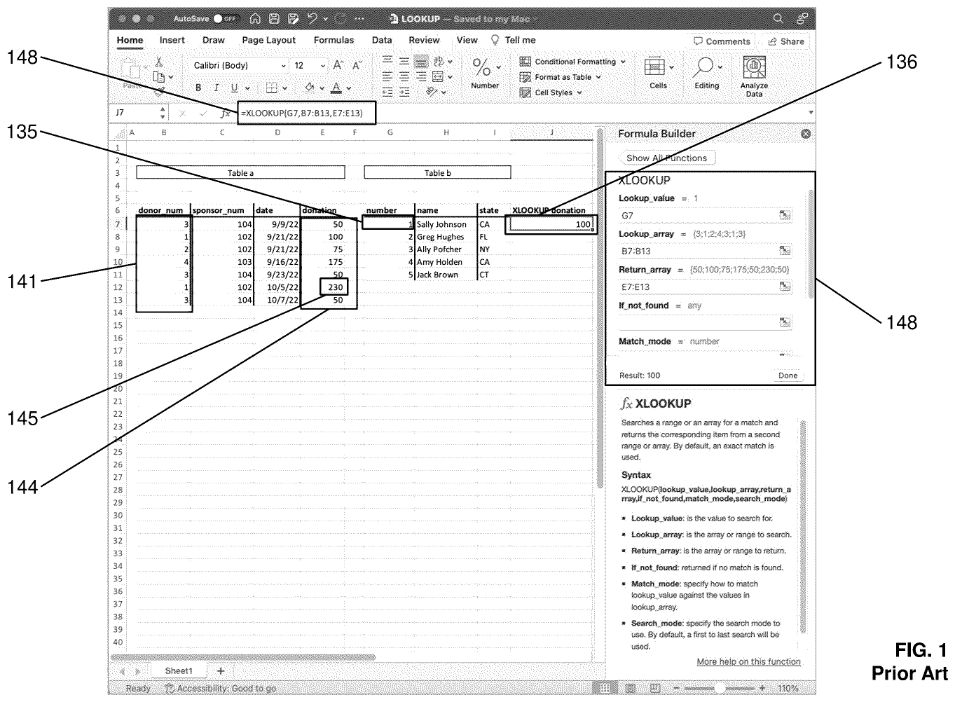

Regular spreadsheet cell formulas (versus spreadsheet capabilities like Power Query, Power Pivot and VBA) do not have SQL like data table joining capabilities but instead cell by cell data matching functions including XLOOKUP, VLOOKUP, and HLOOKUP. These spreadsheet cell functions can be used to match data across in-cell tables of data one cell at a time as exampled in FIG. 1. However, we use the term matching data because it is done at the cell-by-cell level and does not join entire data sets. It also does not discern an ambiguous (i.e., non-unique or “many”) matching situation, meaning when there are many rows for the value to be matched and therefore potentially many different values of the returned value. This could lead to potential problems using the returned value as it may not be the correct value for the situation and the fact that the user does not know there are multiple values is a potential problem in itself. In this example a charity user wants to lookup the donations for each state, however they have not formulated the matching of the data correctly to get all the donations for each state. The problem with this is there is more than one donation per state and the XLOOKUP function does not do a table join but will only provide one value. It does not warn the user there is more than one matching value. This is exampled by returning only the value of ‘100’ in cell ‘J7’ 136 despite the fact that the lookup value of ‘1’ in cell ‘G7’ 135 also has the potential return value of ‘230’ 145. Unless the user were to look at the return array 144 and the lookup array 141, which would be hard to do for a table with many rows, they would not realize they have that problem. That the ‘100’ is not a unique value but one of many possible values (in this example two values). The cell-by-cell matching of the data does not result in the desired table-to-table joins between, in this example, ‘Table a’ and ‘Table b’. The cell-by-cell approach makes using the values directly in formulas (versus populating them in individual cells) complicated because you need a formula for each matched value, not a single formula that matches all the values between tables. These functions (XLOOKUP, VLOOKUP, and HLOOKUP) also only work for in-cell data, not external data (non-spreadsheet cell data) or a combination of the two.

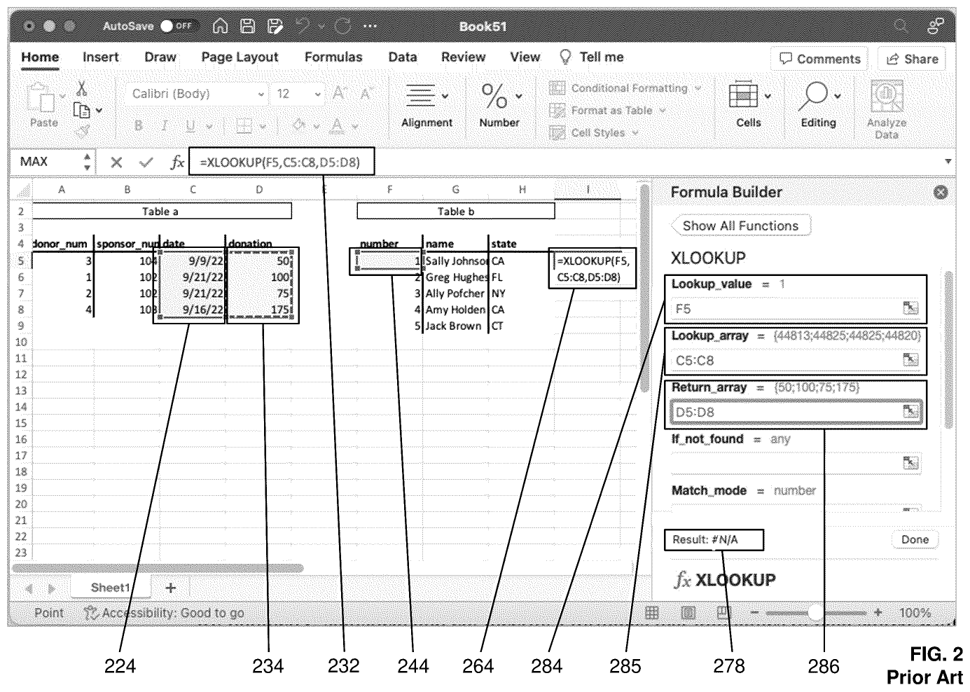

As previously mentioned, the current spreadsheet in cell formula data matching functions (e.g., XLOOKUP, VLOOKUP, and HLOOKUP) do not warn the user of the ambiguous (e.g., “many”) match to a single value situation or stop the user from doing that. These functions also do not stop the user mismatching the lookup value and the lookup array as exampled in FIG. 2. Here the user intended to match the lookup value in ‘F5’ 244/284 with the range in cells ‘A5’ to ‘A8’ but mistakenly set the range ‘C5:C8’ 224/285. They then correctly set the desired return array ‘D5:D8’ 234/286. However, because there was no warning of a data mismatch (e.g., data type and/or data values) they got a ‘Result: #N/A’ 278 shown in the Formula Builder (which would be shown for the formula in cell ‘15’ 264/232 once they enter the formula). There is no capability to help stop the user from making a mistake and no error message that explains to them their error. In this example because Microsoft Excel represents dates also as numbers the error is the non-overlapping values between ‘1’ 244 and the range of dates 224 which have numeric values ranging from 44813 to 44820. It is easy to see the problem in these very small data set examples but imagine a more typical data set with thirty to fifty columns of data, at that point it is easy to enter the wrong column into the formula. In this example, in some but not all spreadsheets, the number and date were the same data type because current spreadsheets turn dates into numbers, in a more traditional SQL setting and in some spreadsheets those would be two different data types which would then fail a data type verification test. However, the large divergence of the values, which are all in the forty-thousands for the dates, and the lookup value which is one fails a matching value verification. And because this function matches at the individual cell level there is no comparison of two columns of values to see if there is any overlap (matching) of the values.

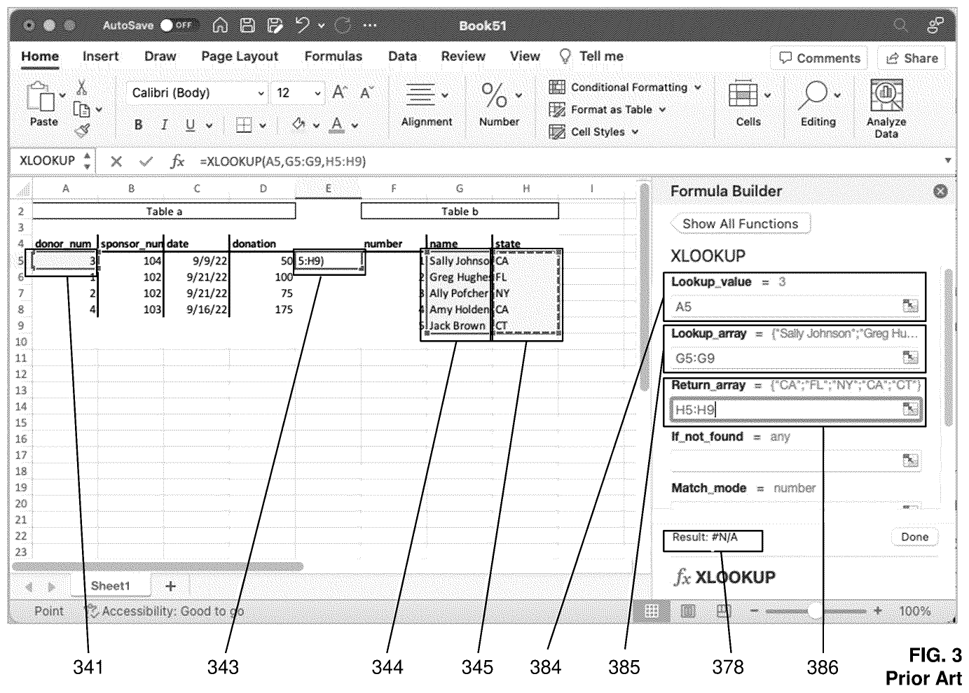

FIG. 3 clearly examples the lack of even a data type verification with the cell formula data matching functions (e.g., XLOOKUP, VLOOKUP, and HLOOKUP). The charity user in this example wants to match the state to the donation values in ‘Table a’ via cell ‘E5’ 344, doing that one cell at a time using the XLOOKUP function. While they meant do this matching the value in ‘A5’ 341/384 to the range in cells ‘F5’ to F9’ they mistakenly set the lookup array in cells ‘G5:G9’ 344/385 although using the correct return array of ‘H5:H9’ 345/386. However, because there was no warning of a data mismatch (e.g., data type and/or data values) they got a ‘Result: #N/A’ 378 shown in the Formula Builder (which would be shown for the formula in cell ‘E5’ 343 once they enter the formula). Even in current spreadsheets this clearly is a data type mismatch as the lookup value in ‘A5’ 341 is numeric and the lookup range ‘G5: G9’ 344 is text. As mentioned before, there is no capability to help stop the user from making this mistake and no error message that explains to them their error. These functions match data at a cell-by-cell level not joining entire tables of data in a SQL like mode. They only work for in-cell data with no ability to join data from non-spreadsheet cell external data sources (e.g., the cloud).

Our technology gives spreadsheet users the ability to do in cell formula data set joins of any particular type (e.g., inner or full outer) with an analytically validated (e.g., same data type, overlapping values) or not validated (user specified with no automated validation) join, for two or more data sets, using in-spreadsheet cell or external (e.g., NSC) data. Embodiments can further limit the type of joins to key data modelling cardinality combinations that are unique to unique, unique to non-unique (“many”) or more limiting variants like referential integrity joins. Embodiments of our technology can then present those joinable field options in a selector list (e.g., hint) for easy selection by the spreadsheet user in building the in-spreadsheet cell formula. At the other end of spectrum our technology supports users writing in-cell formulas for any type of SQL like table join used as part of the data in the formula, with or without any join key validation and with or without any selection list. We will start exampling embodiments with extensive joining validation/limitation and selector lists, move to examples with less of each, and then move to examples with no validation/limitations and no selector lists. In doing so we will also example joins of two data sets, multiple joins between two data sets and then joins of three or more data sets. All of our examples could be done using in-cell, external (NSC) or combinations of both. In the interest of conciseness, the combinations of features disclosed in this application are not individually enumerated and are not repeated for each type of formula, function, join type, et cetera. The reader will understand how features identified in each section can readily be combined with features in the other sections.

### Join Qualification

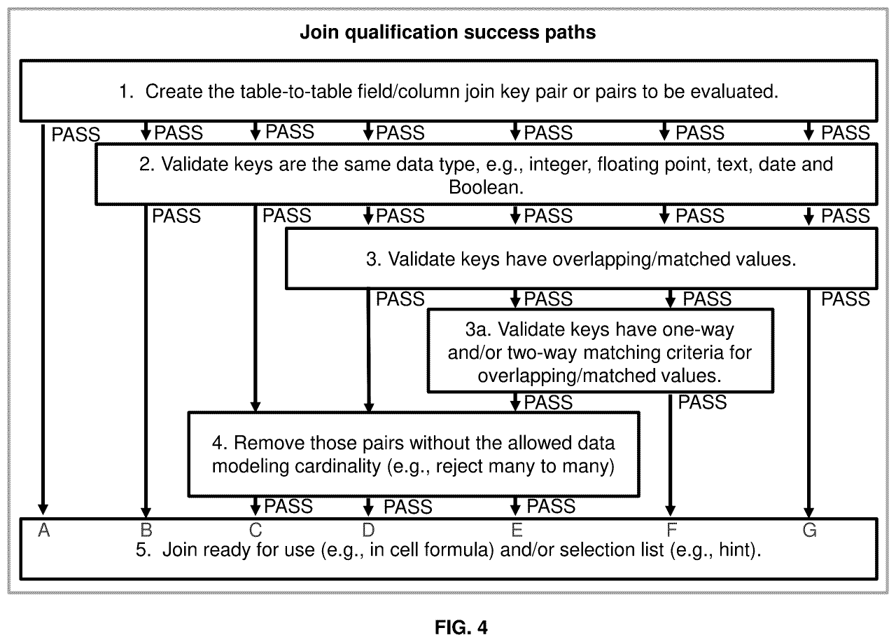

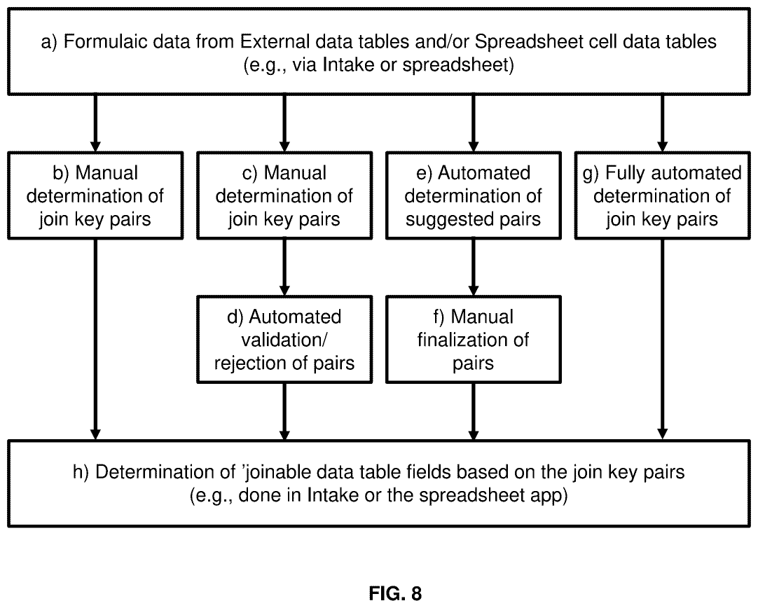

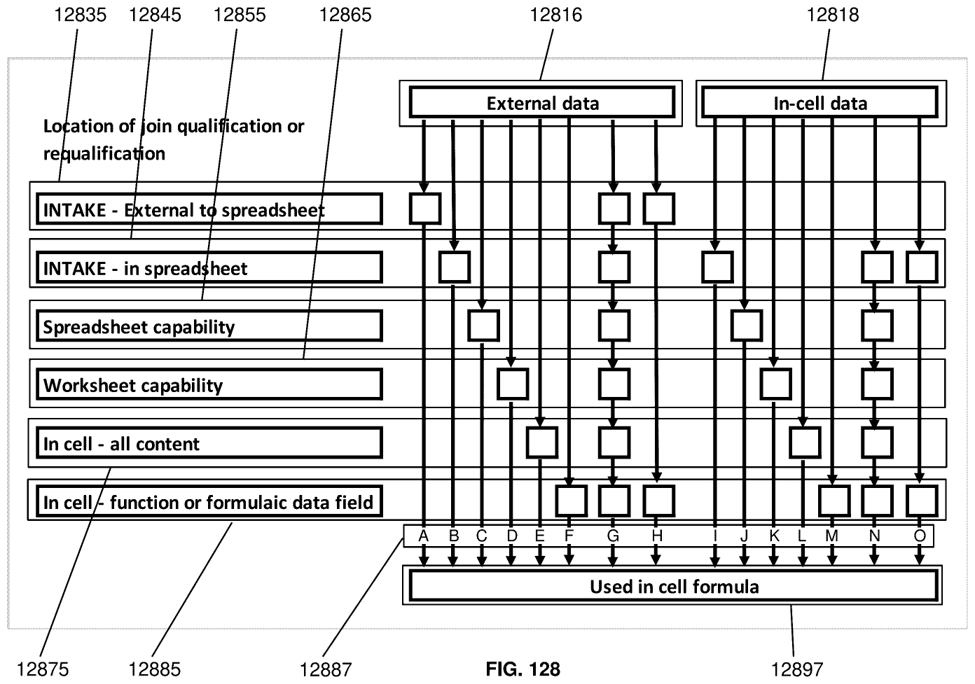

Our in-cell formula data joining technology supports a broad range of data set joining qualification (validation), from no validation (exampled in FIG. 4 path ‘A’) to extensive join key pair validation (exampled in FIG. 4 path ‘E’). These qualifications can be done at many different locations in our technology as exampled in FIG. 128. These qualifications can be done in many different manual and/or automated ways as exampled in FIG. 8. Embodiments of our disclosed technology support the same or different qualification (e.g., path in FIG. 4) used for error free use in a cell formula and availability in a selection list (e.g., hint) used to populate that cell formula, as well as differences in the qualification path used by where the join was set up (e.g., joins set up in the in-cell formula allow all data modelling cardinalities while joins set up before the in-cell formula only accept unique to unique and unique to non-unique but not non-unique to non-unique).

Our technology supports these different combinations to potentially protect less sophisticated users from creating complicated joins that they are unlikely to understand, e.g., non-unique (“many”) to non-unique (“many”) joins and compound key joins, while still giving the sophisticated user the full set of join capabilities. It also supports different levels of validation, including tests that can be helpful to everyone eliminating joins that will generate a null set (e.g., not passing ‘2’ and ‘3’ in FIG. 4) and tests that are more situationally valuable (e.g., ‘3a’ or ‘4’ in FIG. 4) but not always definitively correct. We will start exampling embodiments employing extensive join key qualification validation tests for both the selection list availability and the formula use before exampling different combinations.

### Extensive Join Qualification Validation Tests

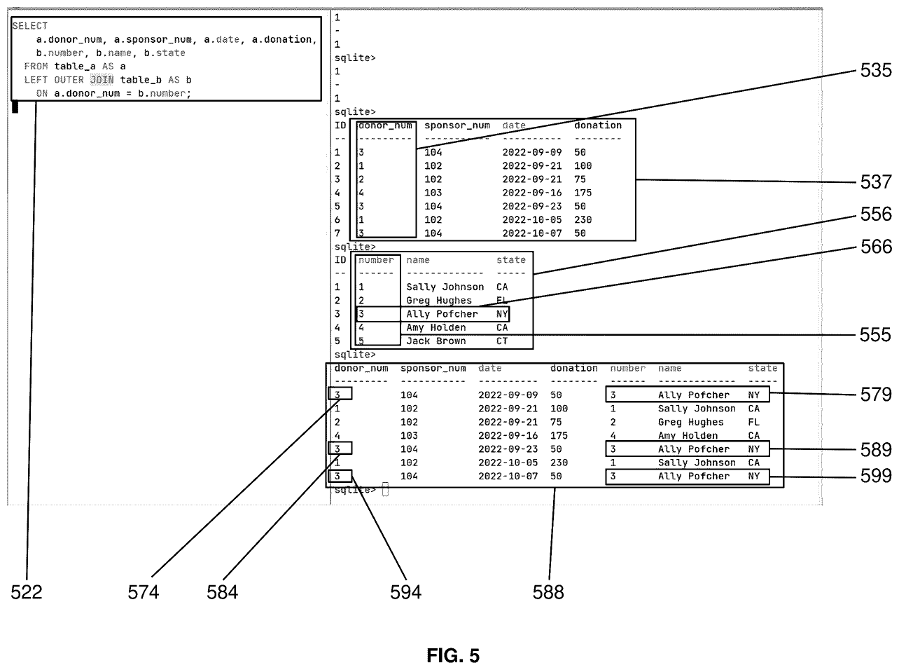

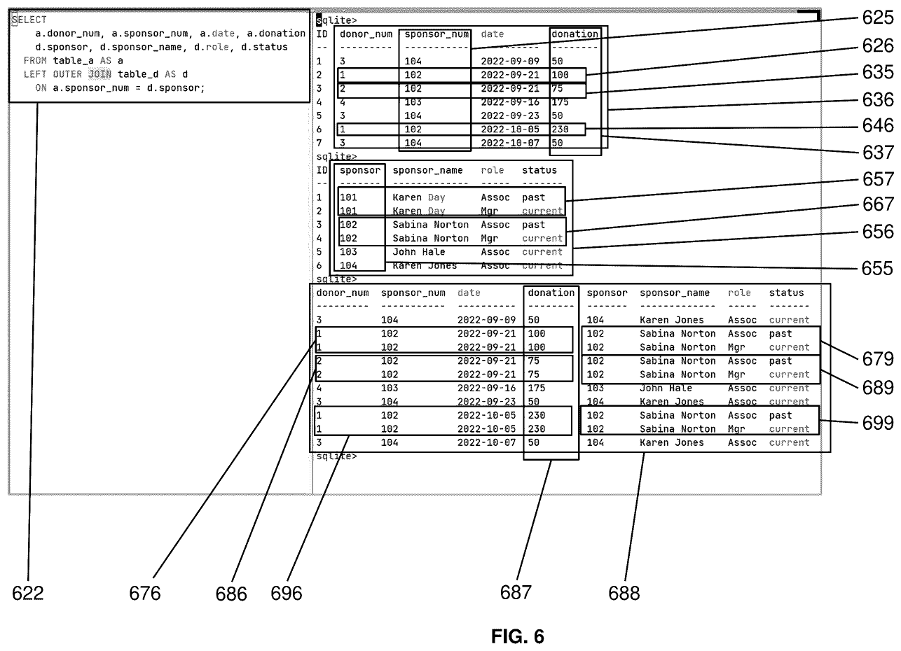

We will start exampling path ‘E’ in FIG. 4 for a charity user who has two data sets similar to those in the prior art examples. One data set holds the donor donations (e.g., a donor identification number, donation amount, and donation date) and the second data set holds information on each donor (e.g., their donor identification number, name and state of residence). The charity user wants to do some analyses using data from both data sets and therefore wants to effectively join the data in doing the analysis. However, depending upon their sophistication it may be desirable to protect them from some more complicated joins which result in changes to the data they may not realize and understand. FIG. 5 and FIG. 6 example two data joins done in SQL, one with an easily understandable outcome in FIG. 5 and one with a more complicated outcome (limited Cartesian Product) in FIG. 6 that a user not experienced in SQL data joins is likely to not anticipate or understand. This is particularly true when the join is done in a formula where they don't see the joining of the data but instead see only a calculated outcome from the cell formula using that data. Therefore, in this extensive validation test embodiment example our technology will only use those joins that pass all the qualification validation tests in FIG. 4 path ‘E’. In that process it will eliminate joins that SQL supports (e.g., joins failing the one-way or two-way matches of step ‘3a’ or the many to many joins that fail step ‘4’).

FIG. 5 examples a data join that many people would call a lookup. Where the join is looking up the ‘name’ and ‘state’ (of residence) from the ‘table_b’ 556 for each row in the ‘table_a’ 537 using the join key ‘donor_num’ 535 in the ‘table_a’ 537 and the join key ‘number’ 555 in the ‘table_b’ 556. The SQL code 522 does that using a ‘LEFT OUTER JOIN’ delivering the joined table 588. That outcome appends the ‘number’, ‘name’ and ‘state’ from ‘table_b’ 556 to each row of ‘table_a’ 537. It has successfully created a table from which a user can specify donations (joined field ‘donation’) by donor name (field ‘name’) from the joined table 588 as exampled by the appending of the ‘Ally Pofcher’ information 566 to the three rows containing 579/589/599. This joined data 588 would allow users to do calculations to sum the donations by each person's name, find the name of the person with largest donation, sum donations by state of donor residence and more, as we will example later. However, in our spreadsheet cell technology the joining of the data is not visible like in this SQL example but happens within the formula to deliver the formula outcome. It therefore lacks the transparency on what the joined data looks like which becomes important in FIG. 6 when what the join delivers is not a unique to unique or unique to non-unique join but instead is non-unique to non-unique (‘many to many”) limited Cartesian Product join outcome. This outcome requires the user to be much more knowledgeable in how they write their spreadsheet formulas to avoid outcomes that are misleading (some would say incorrect). A level of SQL sophistication that many spreadsheet users lack because they do not know SQL and therefore do not how the different SQL joins work (e.g., left outer, right outer, inner, full outer, cross and self), let alone more complicated Cartesian Product situations.

FIG. 6 examples a limited Cartesian Product data join that for the non-knowledgeable SQL users would have a totally unexpected outcome. That is because they would not realize that the data they want appended, the ‘sponsor_name’ is not unique and therefore rather than being appended is added via a limited Cartesian Product. That limited Cartesian Product then results in the duplication of some of the ‘table_a’ 636 rows, e.g., 626/635/646 which are duplicated 676/686/696 in the join table 688. This is caused by the non-unique join keys ‘sponsor_num’ 625 and ‘sponsor’ 655 where, because both are non-unique, rather than appending values they are combined in a limited Cartesian Product. This gives a situation where if a user is not careful using the joined data they can arrive at some wrong answers. For example, if the user sums ‘donation’ 687 in the joined data 688 they get ‘1135’ instead of the actual total of ‘donation’ 637 in the original data 636 of ‘750’. This is driven by the duplication of the ‘sponsor_num’ ‘102’ 667 rows in the joined data 679/689/699 duplicating 676/686/696. Thus, making use of the non-unique to non-unique joined data (“many to many”) can potentially give erroneous results. However, for someone sophisticated who really understands the join they can get the correct result by filtering out the duplicated rows, in this example by limiting (filtering) the donations to only those for ‘status’ ‘current’. Something a user without in-depth knowledge of the data and the joins is unlikely to realize.

So, our technology allows many paths of qualification validation tests (as exampled in FIG. 4) and degrees of validation which can be used for the joinable data selection list selectors (e.g., hints) and error free formula usage. It supports using the same or different qualification validation for the joinable data selector lists and the error free formula as we will example. Embodiments of our technology also support many different ways for that qualification validation process to take place as will also be exampled.

### Data Join Qualification Steps/Tests

Our disclosed technology supports many different combinations of qualification tests (see FIG. 4) for validating which data joins are doable without an error message and which are presentable in selectable list for use in a spreadsheet cell formula. Those outcomes can be situational in our technology, working in some situations and not working in others. For example, a combination of joins (chained/sequenced) may make two individual one to many joins an invalid non-unique to non-unique (“many to many”) join when they are chained/sequenced together and face a data modelling cardinality test rejecting non-unique to non-unique joins.

FIG. 8 examples different ways of qualifying the potential for joinability in our in-cell formulas. A spectrum of those ways are exampled in FIG. 8 ranging from a completely manual set up to a fully automated set up and verification. FIG. 8 examples a range of the ways the qualification is done with FIG. 4 exampling the types of qualification tests and FIG. 128, to be discussed later, exampling the different locations of the qualification (e.g., from data intake to in-cell formula).

FIG. 8 starts with step ‘a’ accessing the data which can reside in spreadsheet cells (in-cell) or can reside in non-spreadsheet cells (NSC) external data sources (e.g., databases on the same computer as the application or elsewhere in servers or other accessible storage devices as exampled in FIG. 10A and FIG. 10B respectively). This can be done by an Intake capability (as described in U.S. application Ser. No. 17/752,814 titled “Method And System for Spreadsheet Error Identification and Avoidance,”) within the spreadsheet application or separate from it. Path ‘a/b/h’ is the most manual method relying entirely on a user (e.g., Intake) user to set up and make correct joins applying. At the other end of the spectrum is path ‘a/g/h’ which is a fully automated determination by our application (i.e., Intake or the spreadsheet) of valid joins applying many or all of the qualification validation tests in FIG. 4.

FIG. 8 path ‘a/c/d/h’ is a combination of human join key pair specification and our application verification of the validity of those selections. The user selects one or more data set to data set join key pairs in step ‘c’ and then in step ‘d’ our technology automatically tests the validity of each of those pairs using any of the validation paths in FIG. 4 passing the validated joins to step ‘h’ which then returns the joinable date fields passing all the tests.

FIG. 8 path ‘a/e/f/h’ is a different combination of the user (human) and our technology specification/validation. In step ‘e’ our technology creates all the across data set field/column join key combinations and then automatically tests the validity of each of those pairs using any of the validation paths in FIG. 4 passing the validated joins to step ‘f’ where the user decides which should be used to create the joinable list in step ‘h’. The user therefore has the final decision on whether a join is or is not added to joinable list. That joinable list sets a join qualification flag in our technology that then is used to enable visibility of the joinable fields in our selection lists (e.g., hints) and/or enable the formula to join the data sets and use the joined data in executing the cell formula.

As mentioned previously, our technology has the ability to have different join qualification flags for the selection lists and the formula error creation. As well as our technology can support different join qualification flags for the selection lists based on changes in the qualification done in different locations within our technology. This will be example in detail later, for a situation where at Intake qualification selection list qualification flags supported data modelling cardinalities of unique to unique and unique to non-unique while the error free joinability for the formula accepts all data modelling cardinalities. So, the user will see in selection lists the joinable data sets that are qualified with unique to unique and unique to non-unique joins but can manually populate joins and fields that are non-unique to non-unique in the formula and have them execute successfully. Our technology even has a capability that after the manual creation of that non-unique to non-unique join can change the selection list flag so those joinable fields will become visible in the selection lists. Thus, our technology gives a breadth of flexibility in setting the qualification of joinable fields within the application.

FIG. 8 path ‘a/g/h’ is the most automated path where our Intake or spreadsheet application automatically creates all the across data set field/column join key combinations and then automatically tests the validity of each of those pairs using any of the validation paths in FIG. 4 passing the validated joins to step ‘h’ where all the validated join key joins are turned into joinable fields for use in cell formulas or cell formulas and joinable data selection lists (e.g., hints). Any trade-offs between competing join key pairs are resolved to fulfil any limitations to the types and number of joins. This fully automated join qualification flag setting can be done within our spreadsheet application or prior to it in a data intake application.

### Example Qualification UIs

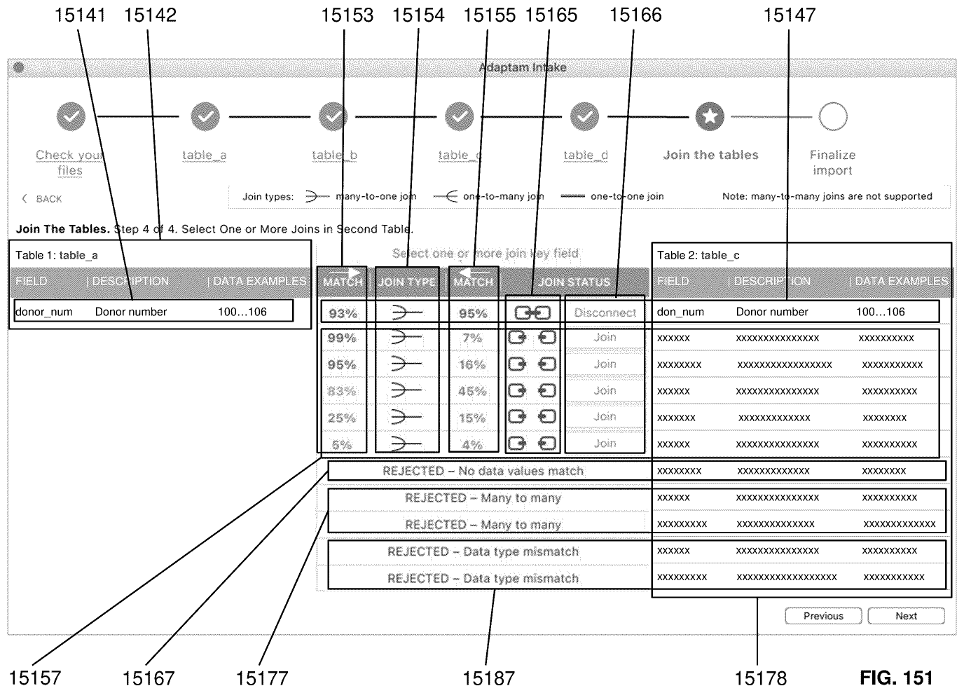

FIG. 151 examples one join qualification UI which is shown here as an external or within the spreadsheet Intake tool. However, its elements can be utilized in other join set up situations (e.g., spreadsheet or worksheet join set up) and with different qualification validation tests. In this example the user has specified a data set ‘table_a’ 15142 and join key field/column ‘donor_num’ 15141 and the second join key data set ‘table_c’ 15178 and our application populates all the additional information. This examples in a UI the FIG. 4 path ‘D’ validating every field (FIG. 4 step ‘1.’) in data set ‘table_c’ relative to the field ‘donor_num’ in ‘table_a’, Fields/columns in ‘table_c’ are rejected based on data type mismatches 15187 (FIG. 4 step ‘2.’). Fields/columns in ‘table_c’ are rejected based on no overlapping/match values 15167 (FIG. 4 step ‘3.’). Fields/columns in ‘table_c’ are rejected based on a data modelling cardinality rule 15177 (FIG. 4 step ‘4.’) which in this example is rejecting ‘Many to many’. Finally, users are given color coded one-way 15153 and two-way 15155 match values but in this embodiment there is no FIG. 4 step ‘3a.’ rejection values (e.g., minimum value below which joins are rejected). Users are also automatically given helpful information such as the field/column data descriptions and data examples 15141 and 15147 and the data modelling cardinality of the potential join 15154. The UI also makes it easy for users to make a selection with join/disconnect buttons 15166 and easy to see status icons 15165. It also allows multiple joins between two data sets as will be exampled later. We provide to users the information they need to make a join decision and/or to understand an automated decision or suggestion.

### Example Usage Scenario

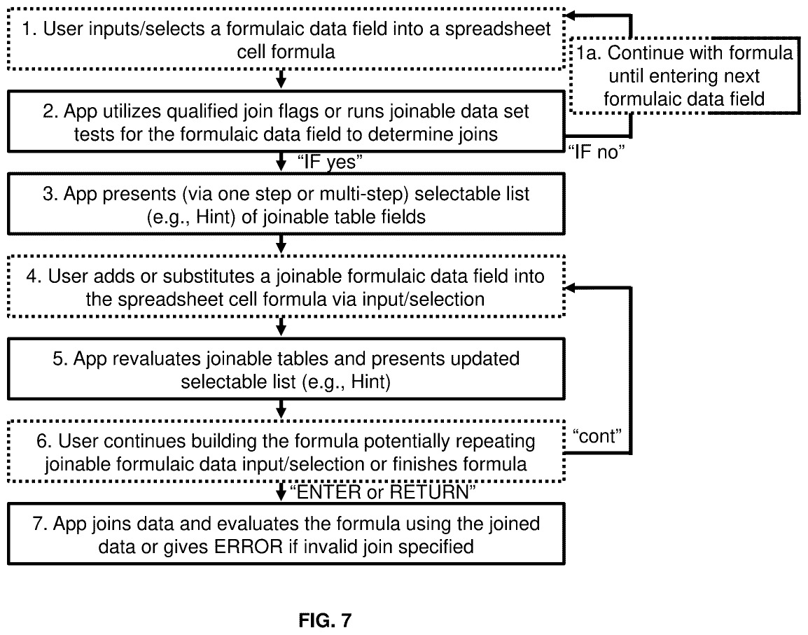

FIG. 7 examples one scenario of steps taken by a user (and our spreadsheet) creating an in-cell spreadsheet formula employing qualified joinable data sets in selection lists. In FIG. 7 the dotted outlined steps ‘1’, ‘4’, and ‘6’ are performed by the user while steps ‘2’, ‘3’, ‘5’, and ‘7’ are automatically done by our spreadsheet application.

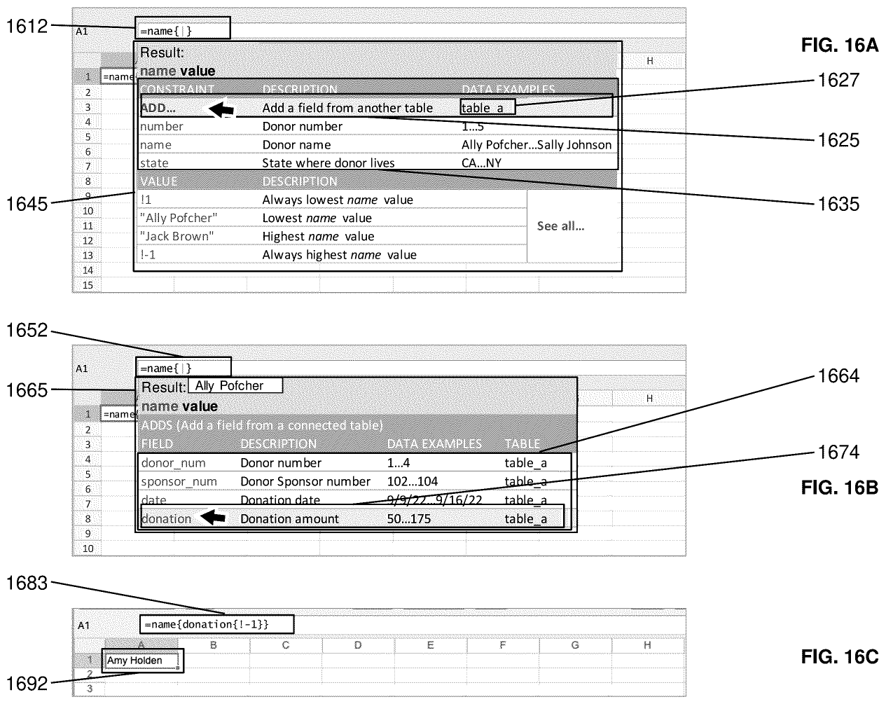

In FIG. 7 step ‘1’ the user types a formulaic data field into a spreadsheet cell like the user has done in FIG. 16A for the formulaic data field ‘name { }’ 1612 which triggers our technology to automatically execute FIG. 7 step ‘2’. FIG. 7 step ‘2’ triggers a determination of whether any joinable fields from another data set are flagged for this field. That could be from the qualification flag (e.g., addition to a list in data set accessed by our spreadsheet) produced by a location prior to the spreadsheet cell (e.g., FIGS. 128 12835, 12845, 12855, and 12865) or even another cell formula within the spreadsheet changing the flag (e.g., FIG. 128 12875). It could also be from a fully automated qualification test automatically run by our spreadsheet application as exampled in FIG. 8 step ‘g’. If the flag answer is yes, then it proceeds to FIG. 7 step ‘3’ otherwise it loops through step ‘1a’ until it gets a yes.

### Selectable List of Joinable Fields Presentation

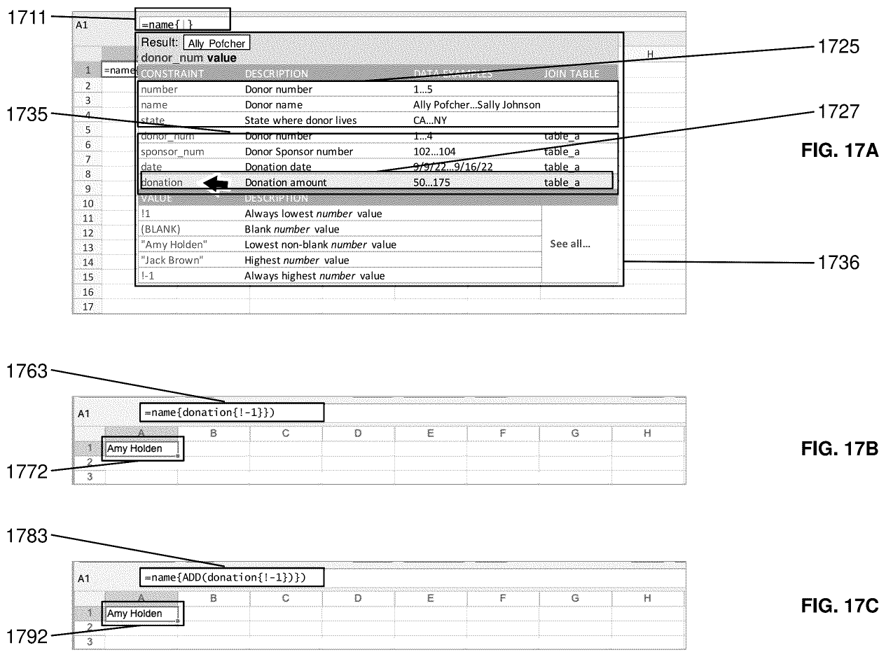

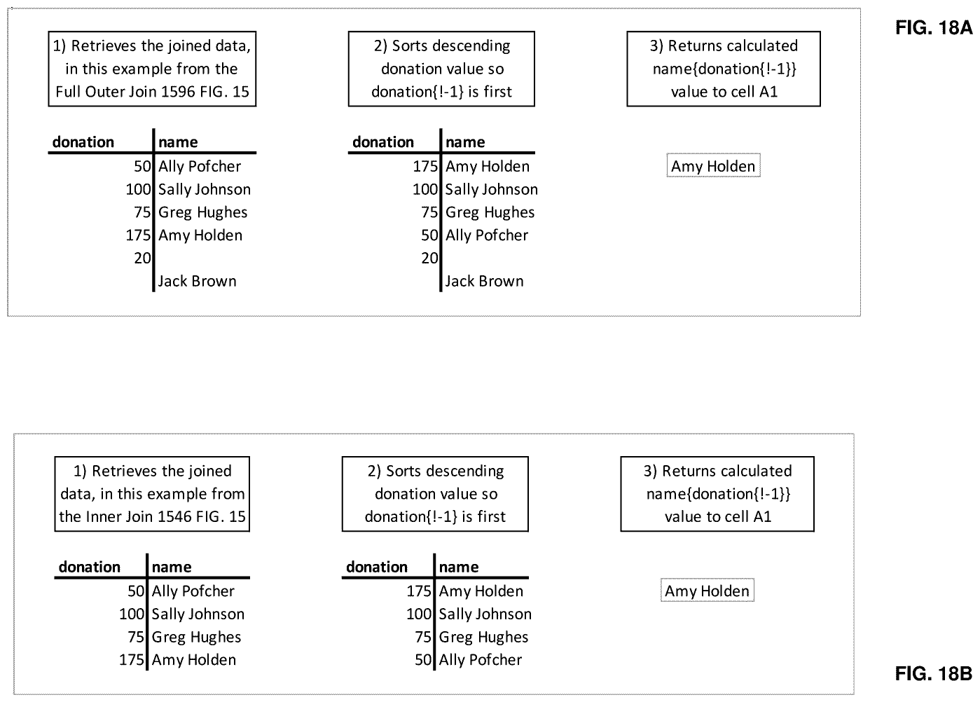

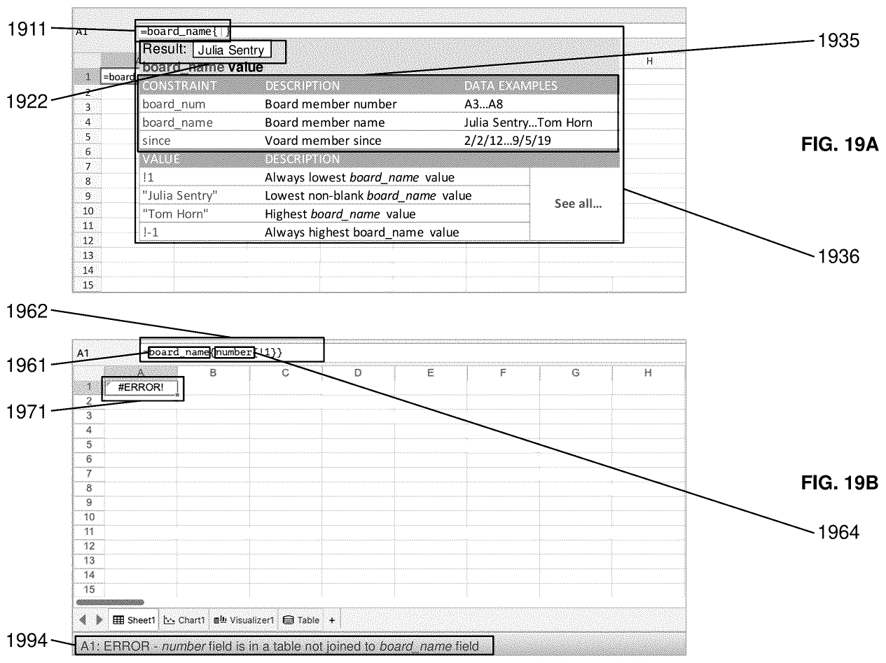

After joinable field(s) verification in FIG. 7 step ‘2’, step ‘3’ then presents that joinable list of other data set fields for selection or typing into the formula. It can be done in any one of the types of UIs exampled or mentioned in our U.S. application Ser. No. 17/752,814 titled “Method And System for Spreadsheet Error Identification and Avoidance,” as well as further examples herein. For example, FIG. 16A and FIG. 16B examples a two UI (two step) embodiment where the user is first presented with an ‘ADD . . . ’ line 1625 in the selection list that only shows up if the field or fields in the formula has joinable fields/columns from another data set. If the user selects that line 1625 as done in FIG. 16A they then get the qualified selectable list of joinable (‘ADDS’) fields 1664 as shown in FIG. 16B. FIG. 17A examples a one UI (one step) embodiment where the current data set fields 1725 and the qualified joinable fields 1735 are presented in a single UI 1736 for selection into the formula. If there are no qualified joinable fields the regular selectable hint is presented with no joinable fields, as exampled in FIG. 19A 1936 and the user is not in FIG. 7 step ‘3’ but looping in step ‘1a “, until a joinable ‘yes’ is answered for step ‘2’.

### Joinable List Selection

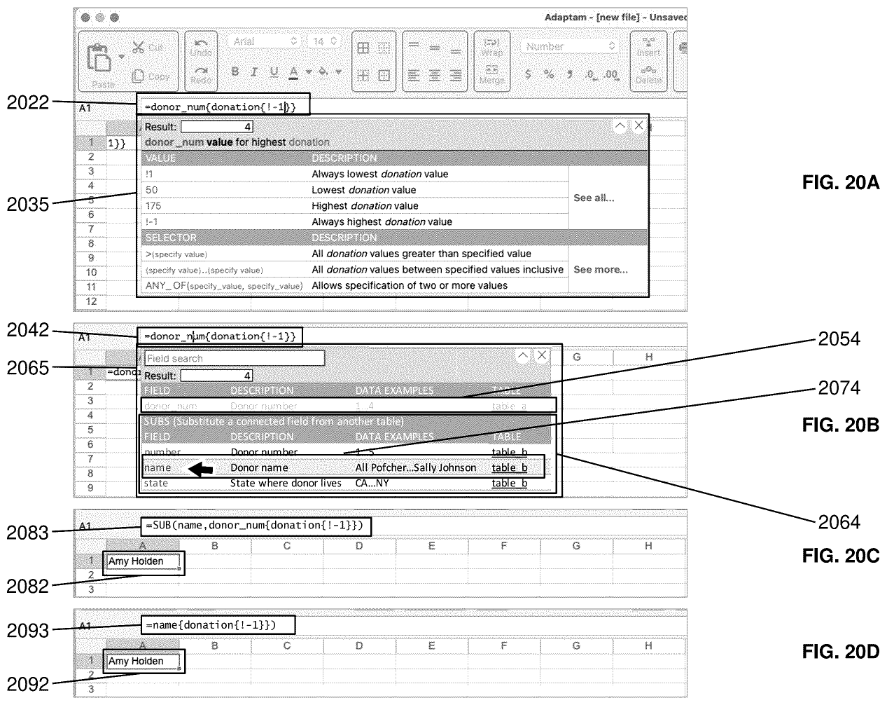

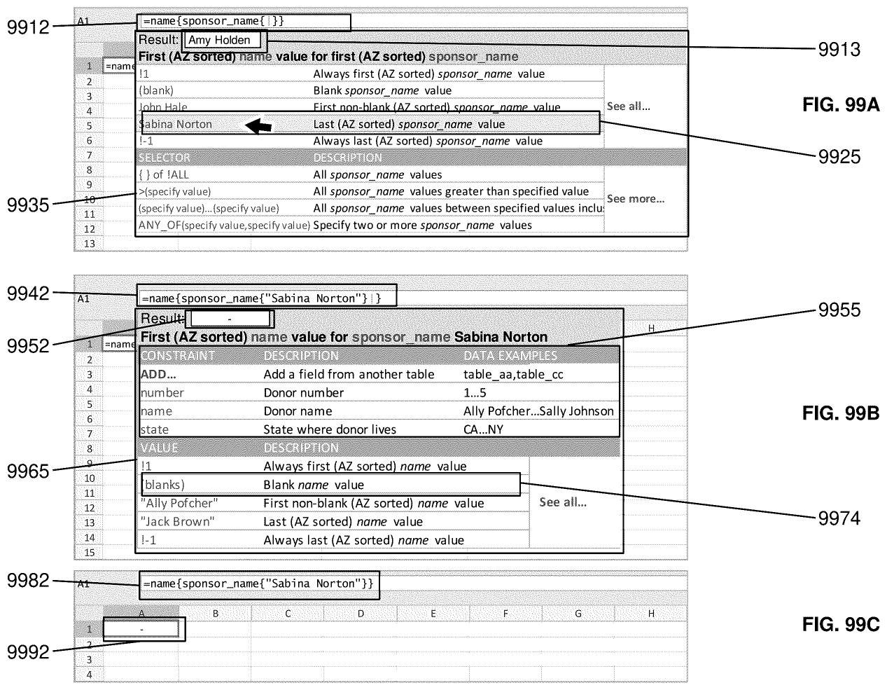

FIG. 7 step ‘4’ then examples the user selecting or typing into the formula one of the qualified joinable fields/columns as exampled in FIG. 16B/FIG. 16C, FIG. 17A/FIG. 17B, FIG. 17A/FIG. 17C, FIG. 20A/FIG. 20B/FIG. 20C, and FIG. 20A/FIG. 20B/FIG. 20D. In FIG. 16B/FIG. 16C, FIG. 17A/FIG. 17B, and FIG. 17A/FIG. 17C the selection adds a joinable field to the formula and executes the joining of the data when the user hits ENTER or RETURN. In some embodiments where the spreadsheet application shows the user as current evaluation of the formula, as exampled in FIG. 99A 9913, our spreadsheet evaluates the join and uses the joined data for the as current formula (before the user hits ENTER or RETURN). FIG. 20A/FIG. 20B/FIG. 20C and FIG. 20A/FIG. 20B/FIG. 20D examples where the selection of the validated joinable field results in the replacement of a field in spreadsheet cell formula from the original data set with a field from the joined data set. Thus, in both field/column addition and the field/column substitution executing the joining of the data while evaluating the formula in some embodiments as the formula is built and in others only when the user hits ENTER or RETURN.

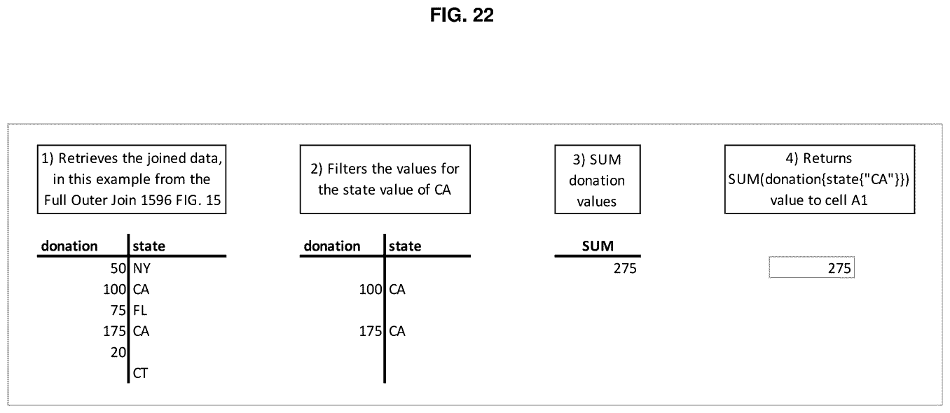

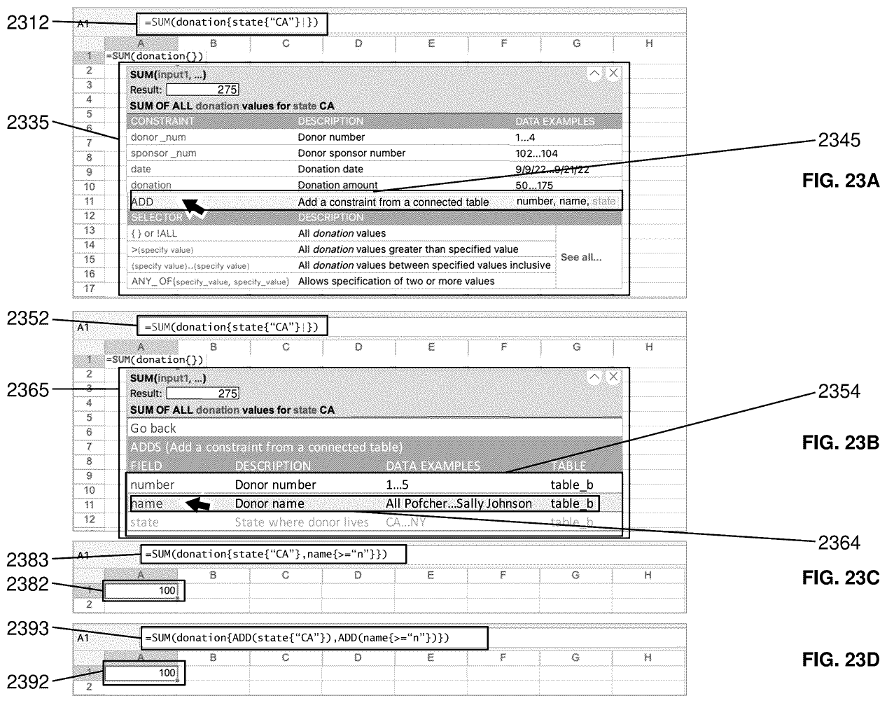

If the user builds a longer formula with multiple joined fields/columns, as exampled in FIG. 23A through FIG. 24D, then the qualified joinable selection list continues to be revised and shown to the user as described in FIG. 7 step ‘5’ and any repetitions circling between step ‘4’ step ‘5’ and step ‘6’ until the user has completed the formula and evaluated it (hitting ENTER with a PC or RETURN with a Mac). At that point, if not before in the running evaluation mode, our technology joins the data and evaluates the cell formula providing the outcomes as shown in FIG. 16C, FIG. 17B, FIG. 17C, FIG. 20C, FIG. 20D, FIG. 23C, and FIG. 23D. However, if the user in this embodiment has tried to join non-qualified joinable fields (e.g., by typing into the formula a field not shown in the qualified field selectable list) they will get an outcome like that in FIG. 19B with an ERROR message. In other embodiments where the validations for selection list and generating errors have been separated into two different qualification flags, formulas using joinable fields not shown in the selection list may work and not generate an error. One reason for doing this as previously mentioned is to protect less sophisticated users from possible errors from misuse of more complicated joins while allowing sophisticated users the ability to do those joins and use the joined fields in cell formulas.

The join qualification ways, tests and locations exampled in FIG. 8, FIG. 4, and FIG. 128 and the spreadsheet user in-cell formula actions exampled in FIG. 7, are applicable to many different data situations, join types, and cell formula usage. As well as our technology supports many different versions of FIG. 7 including situations where the user sets up and qualifies the joins in the cell formula to mixing and matching the user use of joins qualified before the cell formula and joins set up and qualified within the cell formula. We will start exampling simple data situations and then move to more complicated data examples. We will start with situations where the selectable list and the error free joinable data is the same and then example situations where they are not the same. We will example where joinable field selection lists are not available at all or only become available after the user creates/qualifies the join within the cell formula.

### Joining Data Sets Via Two Unique Join Keys

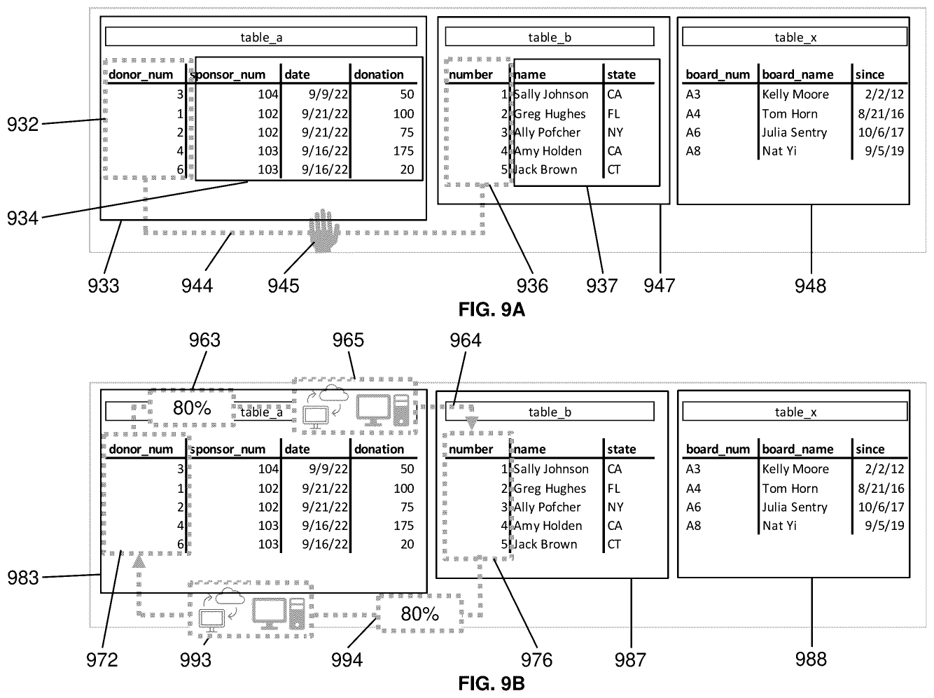

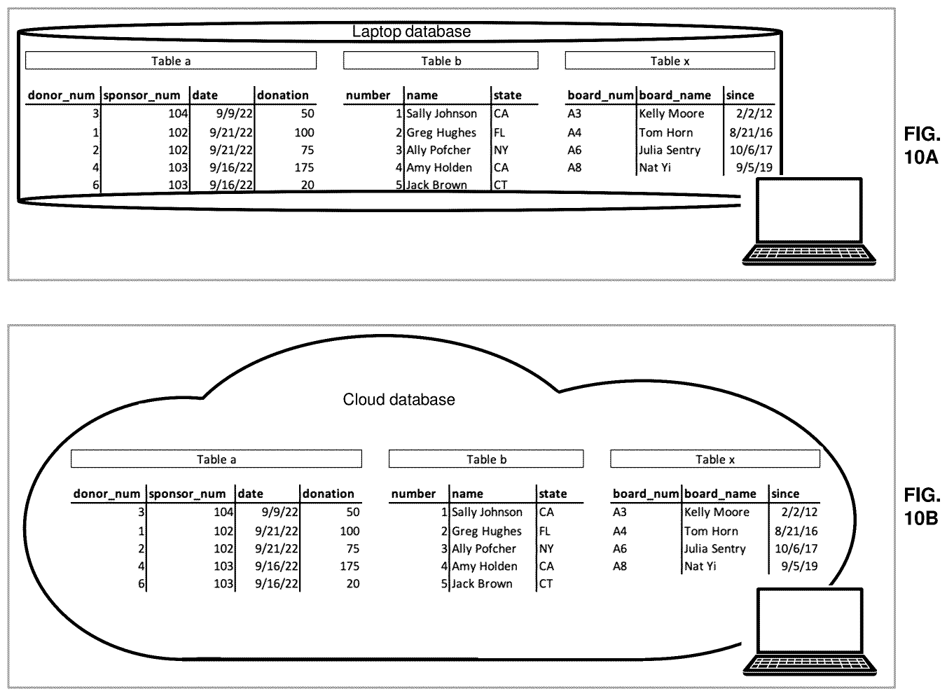

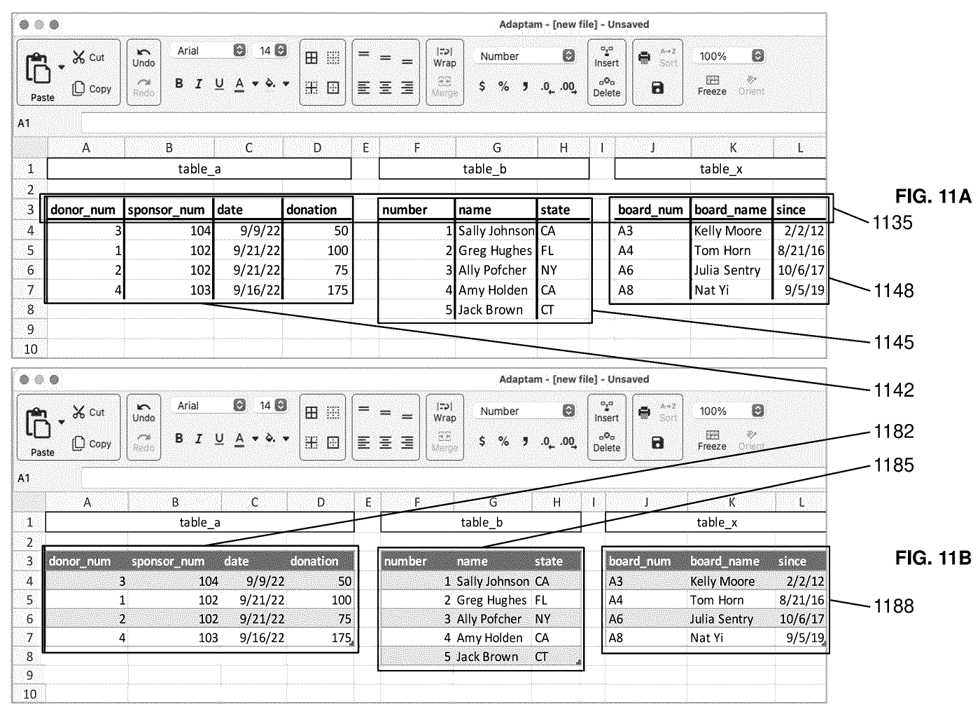

We will start exampling one of the simplest data set joining situations, two data sets joined via unique join keys. FIG. 9A examples a spreadsheet with availability to three small data sets. Those data sets could be non-spreadsheet cell (NSC) external data sets residing in a database on the device (e.g., laptop) running the spreadsheet application as exampled in FIG. 10A. Or they could in a database somewhere in the cloud which the device running the spreadsheet application can access, as exampled in FIG. 10B. Alternatively, those data sets could be in the spreadsheet cells as cell data, as exampled in FIG. 11A 1142/1145/1148 (note while in this example the data has headings 1135 used as the field/column names the data could be without those headings instead using the cell ranges as the field/column names) or as data sets within the spreadsheet cells, as exampled in FIG. 11B 1182/1185/1188. They could also be combinations of in-cell data sets and/or data sets sourced from NSC external data sources. Any of our following examples could have data from the different data sources.

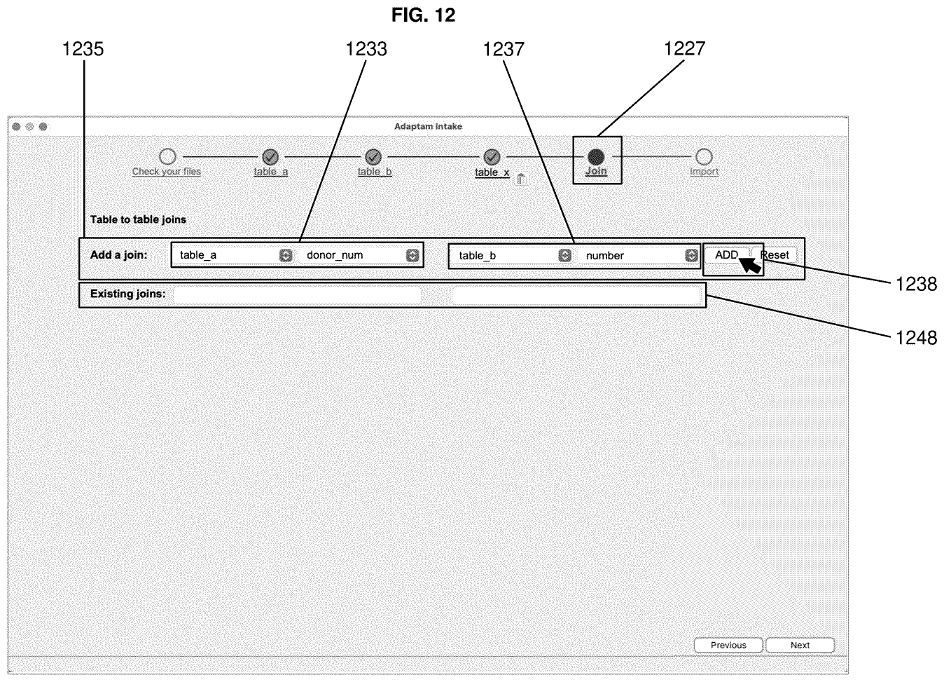

FIG. 9A illustratively examples a user specifying the data sets which are joinable and their join keys. In this example the two data sets ‘table_a’ 933 and ‘table_b’ 947 are joinable. Each of those data sets has column headings which will become the field/column names (e.g., donor_num) with the values below (e.g., ‘3’, ‘1’, ‘2’, ‘4’, ‘6’ for donor_num 932). In this example the user has manually specified that ‘donor_num’ 932 and ‘number’ 936 are the join keys used for joining the data sets. This manual determination of the joinable data set pairs examples FIG. 8 path ‘a/b/h’. It could also FIG. 8 path ‘a/c/d/h’ where the user makes one or more manual determination of join keys and then our technology does an automated qualification validation (any of the paths ‘B’ through ‘G’ in FIG. 4) of the paired data sets and their join keys. Either of these join setups could be executed in a UI such as FIG. 12 where the user specifies the pair of data sets and join keys 1233/1237 in the ‘Add a join’ line 1235 which in this embodiment has ‘ADD’ 1238 or ‘Reset’ (reject) buttons for the user to confirm their selection. In the FIG. 8 path ‘a/c/d/h’ the difference is our technology then validates the join before accepting it and if it fails gives the user an error message and/or failure explanation and does not move it to ‘Existing joins’ 1248. In path ‘a/b/h’ when the user hits ‘ADD’ 1238 the join is simply added to the ‘Existing joins’ 1248 with no other qualification validation tests. These ‘Existing joins’ 1248 then have a qualification flag (which can be done in many different ways) telling the spreadsheet that these data sets are joinable to each other for selection list availability and/or error free formula evaluation. The qualification flag is a method for communicating joinability to the spreadsheet formulas and can be done many ways such as an internal table used by our technology to determine which data sets are joinable.

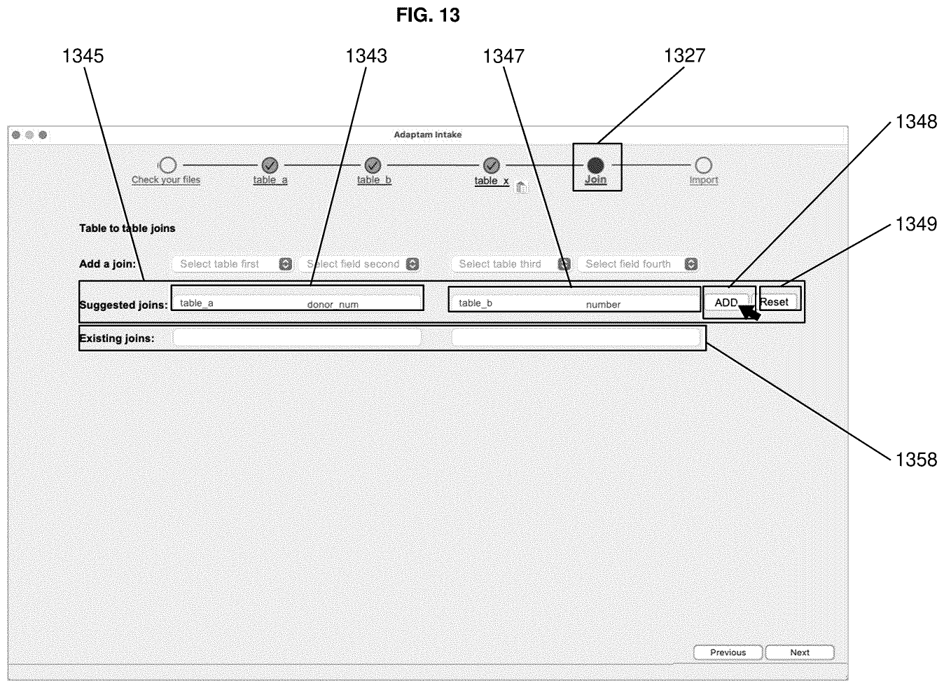

FIG. 9B illustratively examples our technology algorithmically determining the join keys and therefore the joinable data sets. In one such embodiment the first step is to determine all the fields/columns across three data sets 983/987/988 which are the same data types. Next is testing the overlap of the values with could start with a simple test of is there any overlap of values between the two keys 972/976. Having passed that test the next test could be achieving a minimum percentage of value overlap, such as the calculation that ‘80%’ 963 of the values in ‘donor_num’ 972 are contained in ‘number’ 976. And the reciprocal calculation that that ‘80%’ 994 of the values in ‘number’ 976 are contained in ‘donor_num’ 972. High percentages one-way is a pretty good sign and high percentages both ways is an even better sign. These value determinations could be done at the row level within the data set or at the distinct values contained within those rows. The fields/columns that pass those criteria are then tested for data modelling cardinality, such as passing “one” to “one” or “one” to “many” and in this embodiment eliminating any “many” to “many” pairs. Additional tests may be added in embodiments weighing in fields that have the same or similar field/column names/headings. Deciding in situation where there are multiple keys that could be used to join two data sets, deciding which pair of keys to use (e.g., the pair that results in the most rows appended). After doing these tests for the three data sets 983/987/988 no join was found between ‘table x’ 988 and either of the other data sets. The join was between ‘table_a’ 983 and ‘table_b’ 987 was accomplished through the keys ‘donor_num’ 972 and ‘number’ 976. Therefore, in the fully automated pathway in FIG. 8 steps ‘a/g/h’ all the fields in ‘table_a’ 983 and ‘table_b’ 987 would be added to the joinable list for the other data set. Likewise, in a semi-automated path, that potential join would be qualified by FIG. 8 step ‘e’ (employing tests in FIG. 4) and presented to the user for step ‘f’ in a UI, such as the one exampled in FIG. 13. Where the pair of data sets and join keys 1343/1347 are presented as ‘Suggested joins’ 1345 giving the user the final say as to whether to ‘ADD’ 1348 or ‘Reset’ (reject) 1349 that suggested join. Thus, after all the different join validation tests giving the user the final say as to whether the join gets a qualified join flag supporting its usage in selectable lists (e.g., Hints) and/or spreadsheet cell formulas. Where then it would show up in the ‘Existing joins: 1358 after the user clicks ‘ADD’ 1348.

The user is now ready to use our technology to create a spreadsheet cell formula and, in this embodiment, do it with curated selectable lists which present the joinable field options when they are applicable.

### Types of Joins

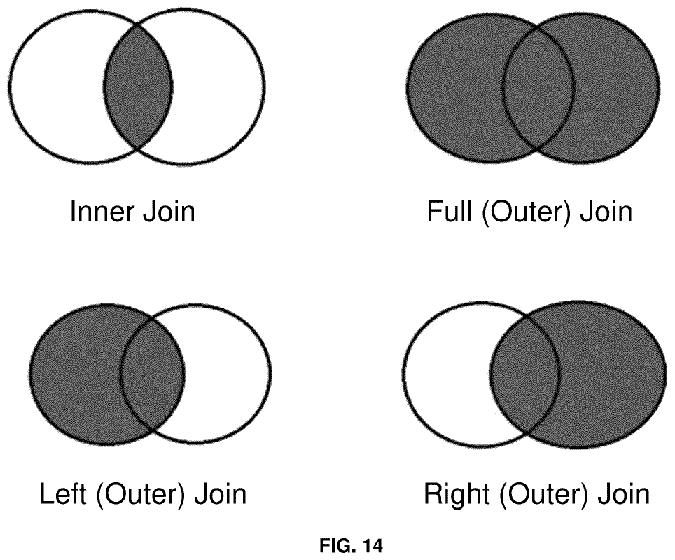

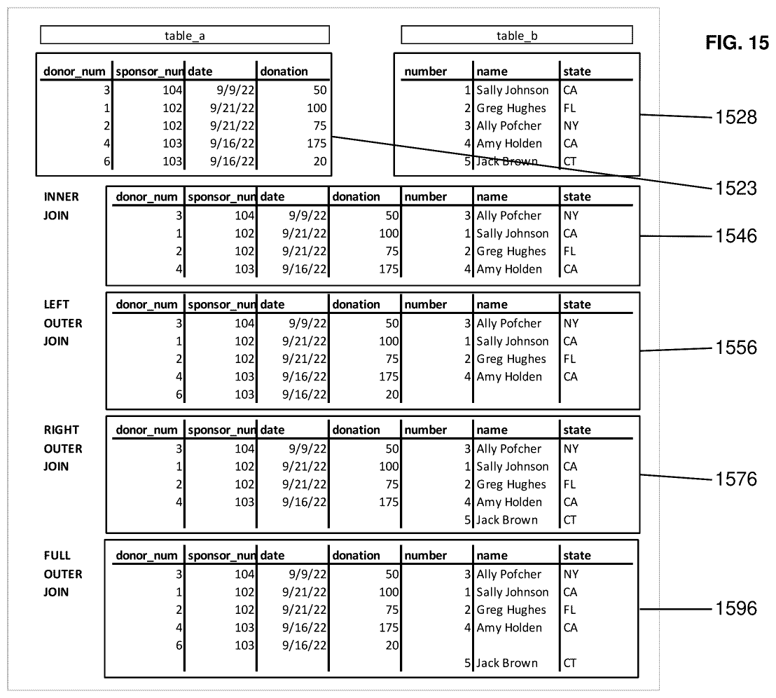

Our technology supports the full range of data set joins (e.g., inner, full outer, left outer, right outer, self, and cross) with our exampling more focused on the more commonly used joins in FIG. 14. Those example joins use any of the data locations or combinations of data locations in FIG. 10A through FIG. 11B. FIG. 14 visually examples pictorially in the red-colored space the join results for the inner, left outer join, right outer, and full outer joins. FIG. 15 examples those four different joins for the joining of ‘table_a’ 1523 and ‘table_b’ 1528 with unique join keys (as exampled in FIG. 9A and FIG. 9B) in each data set. The ‘inner join’ 1546 joins only rows with the intersecting key values in ‘table_a’ 1523 and in ‘table_b’ 1528 and therefore has the least rows. The ‘left outer join’ 1556 joins all the rows in ‘table_a’ 1523 with any of the intersecting rows (rows having the same key value) in ‘table_b’ 1528. The ‘right outer join’ 1576 joins all the rows in ‘table_b’ 1528 with any of the intersecting rows (rows having the same key value) in ‘table_a’ 1523. The ‘full outer join’ 1596 joins all the rows in ‘table_a’ 1523 and in ‘table_b’ 1528. These joined table data sets are exampled here to give a visual illustration of the type of data joins being executed as part of the in-cell formulas exampled in FIG. 16A through FIG. 38C. Our technology automatically joins the data required as part of executing the cell formula. There are many variants of the types of formulas supported by our joinable data technology as we will now begin to example.

Formulaic Data Formula with Two-Step Joinable Hints

FIG. 16A through FIG. 16C example a formulaic data spreadsheet cell formula joining data across two data sets employing two step selectable lists (hints). The charity user would like to know the name of the donor of the largest donation. However, the donations are in ‘table_a’ 1523 in FIG. 15 and donor names are in ‘table_b’ 1528. Since what they want is the ‘name’ they type or select that field as shown into the formula 1612 FIG. 16A at which point they get a selectable list (hint) 1645 which not only lists the constraints 1635 they can add from the data set containing the field ‘name’ (‘table_b’ 1528 in FIG. 15) but also get an ‘ADD’ row 1625 which informs the user they can ‘Add a field from another data set’ and in this embodiment tells them what data set that is ‘table_a’ 1627. That selectable list 1645 contains the ‘ADD’ row 1625 because our application in this embodiment has verified that the field ‘name’ 1612 has joinable fields in another data set (via the qualification flag) and in this embodiment informs the user that is ‘table_a’ 1627. Had ‘name’ had no joinable fields from another data set the ‘ADD’ row would not have been there. Because the user wants donations and does not see it in the list for the current data set, they click the ‘ADD’ 1625 selection and then are automatically presented in FIG. 16B with a new hint 1665 listing the ADD selections 1664 in ‘table_a’. The user then sees the field they want ‘donation’ and clicks on it 1674 thus using the data joined across ‘table_a’ 1523 and ‘table_b’ 1528 in FIG. 15. They then select or type the ‘!-1’ to get the largest ‘donation’ value and hit ENTER to get the result of ‘Amy Holden’ 1692 from the formula ‘=name {donation {!-1}}’ 1683 in FIG. 16C.

In this embodiment the user was presented two-step selectable lists starting with the ‘ADD’ potential selection line 1625 in the selectable list 1645 in FIG. 16A as the first step (which gives access to the joinable fields) and then the selection list 1665 in FIG. 16B as the second step selectable list (that displays the joinable fields). The rationale for a two-step list is in many real-world situations (versus small filing examples) the data sets can be very large with thirty-five to fifty plus fields/columns, at which point a single list with seventy to one hundred fields can be overpowering to users. So, in this embodiment the two lists are presented in different selection lists. In situations where there are a number of joined data sets a further embodiment or variant of this embodiment may add a third step. Where the second step is a selectable list of the joinable data sets (from which the user selects the data set they want a joinable field from), and the third step is the list of joinable fields/columns for the selected joinable data set. In all of these embodiments if the field originally specified, in this example ‘name’ 1612, has no joinable data then the ‘ADD’ row 1625 of the selectable list is omitted as exampled in FIG. 19A where the selectable list 1936 for the field ‘board_name’ 1911, which is in ‘table_x’ 948 in FIG. 9A, has no ‘ADD’ row or listing of fields from another data set because it has no potential joins.

Formulaic Data Formula with a One-Step Joinable Hint

FIG. 17A through FIG. 17C examples a formulaic data spreadsheet cell formula joining data across two data sets employing a one-step selectable list (hint). There are many different ways to present the one-step selectable join list, in this embodiment the two different data set lists (one for the data set of the field and the other for the joinable data set) sit one above the other. The charity user is solving the same problem as in FIG. 16A through FIG. 16C of finding the name of the donor with the largest donation. However, in this embodiment the user sees in the selectable list (hint) 1736 the potential constraints 1725 for the data set that ‘name’ 1711 resides in, as well as the qualified joinable fields 1735 that reside in ‘table_a’. When the user selects ‘donation’ 1727, selects or types ‘!-1’ within ‘donation {!-1}’ to get the largest ‘donation’ value and hits ENTER/RETURN, they get the result in FIG. 17B of ‘Amy Holden’ 1772 from the formula ‘=name {donation {!-1}}’ 1763. Or in a different embodiment where the joined field is added to the formula via a new prebuilt function, in this embodiment a function called ‘ADD’, the user gets the result in FIG. 17C of ‘Amy Holden’ 1792 from the formula ‘=name {ADD (donation {!-1})}’ 1783.

While the selection lists presentations may vary based on UI configuration and one-step. two-step or three-step, and the formula may have different arguments based on whether a prebuilt function is used or not, the answer does not change. For simplicity of understanding our functionality (free from distractions of very different UI types) most of the examples herein use popup selection lists, however our technology supports those selections lists presented in a broad spectrum of UI, such as sidebars, special inserts, wizards, menus, and any of the applicable UIs in our U.S. application Ser. No. 17/752,814 titled “Method And System for Spreadsheet Error Identification and Avoidance,”. Our technology also supports voice output of the joinable fields/columns to the user and voice selection from those outputted options.

FIG. 18A and FIG. 18B illustratively example those steps done by our application to provide that answer recognizing that these examples are to illustrate what is done, as the steps taken by our application to achieve the same outcome may well be different. What can change the answer is the type of join employed either by a default setting in the application or by user selection. FIG. 18A examples using the ‘Full Outer Join’ 1596 from FIG. 15 to calculate the value ‘Amy Holden’ 1692 FIG. 16C/1772 FIG. 17B/1792 FIG. 17C from the formula ‘=name {donation {!-1}}’ 1683 FIG. 16C/1763 FIG. 17B or from the formula ‘=name {ADD (donation {!-1})}’ 1783 FIG. 17C. FIG. 18A Step ‘1)’ retrieves the joined data from 1596 in FIG. 15 while step ‘2)’ sorts the data from largest to smallest ‘donation’ before step ‘3)’ returns the ‘name’ of ‘Amy Holden’ for the largest donation. FIG. 18B examples the same steps but instead using the using the ‘Inner Join’ 1546 from FIG. 15 to do the remaining steps. In this example that does not give a different answer, but it could have, and it would have if the user asked for the donor giving the smallest donation.

### Protections Provided to Stop Unwanted Joins

FIG. 19A and FIG. 19B example two different protections provided by our technology against users doing unwanted data joins. The first protection is the lack of any joinable fields in our selectable list. FIG. 19A examples the charity user building a formula starting with a field ‘board_name’ 1911 that is in ‘table_x’ 948 FIG. 9A/988 FIG. 9B. This is the third table in the data set and the one with no (non-null) joins to the other two tables. So, the selectable list 1936 does not contain any join data set line, like the ‘ADD’ line 1625 in FIG. 16A, or joinable data fields from another data set, like 1735 in FIG. 17A. The lack of a joinable field selection is one way of protecting the user from making an unwanted join.

FIG. 19B examples a second way our technology protects the user from an invalid data table join. If the user goes ahead and types in a field from another table as the user has done adding ‘number’ 1964 as a constraint for ‘board_name’ 1961 in the formula in 1962, our technology will show it as an error. FIG. 19B examples that once the user has entered the formula and it has been evaluated showing ‘#ERROR!’ 1971 in the cell and in this embodiment showing an error message ‘A1:ERROR—number field is in a table not joined to the board_name field’ 1994 in the status bar at the bottom of the spreadsheet. Our technology can further support showing the ‘#ERROR!’ in the hint ‘Result:’ (e.g., replacing the ‘Julia Sentry’ shown in 1922) prior to the evaluation. Thus, giving users multiple indications that they are trying to do an invalid data join and then effectively stopping it if they go ahead and do one.

As we mentioned before there are situations where in our technology what is protected from usage by the selection list and what is protected from join usage by the formula execution is different. An example would be a data join like the one in FIG. 6 where it is desirable to not present the option for non-unique to non-unique (“many to many”) joins to unsophisticated users (who will only do what is in the hints, or easily accessible within hints) while letting more sophisticated users (who fully understand how to deal with its Partial/limited Cartesian Products) the ability to do them. In these situations, in an embodiment of our technology the join would not appear in the selection list but would not generate an ERROR if the user were to correctly populate the join in the formula, as we will example later. Thus, protecting unsophisticated users from unknowably making mistakes while giving more sophisticated users the ability to do the broad range of potential data joins in their spreadsheet cell formulas.

### Substitution

FIG. 20A through FIG. 20D examples another way, field substitution, our technology can use the selection lists and formula argument setup that it supports for the joinable data fields. FIG. 20A examples a single data set formulaic data field formula 2022 with its accompanying selection list (e.g., hint) 2035. However, that data is from ‘table_a’ 933 in FIG. 9 which is joinable to ‘table_b’ 947 in FIG. 9. So, when the user puts the cursor back into the formula 2042 field ‘donor_num’ in FIG. 20B the selectable list 2065 gives the user their field replacement (substitution) options. Our new technology offers two types of replacements. The original way without our new joinable technology which provides all the fields that are spelled through the cursor, which in this case is all the fields that are spelled ‘donor_n’ (which is only the current field ‘donor_num’ 2054). The new addition with our joinable technology is that it provides all the fields that are joinable to the current field ‘donor_num’, which are the three fields in the “SUBS’ 2064 part of the hint. As the hint says, ‘SUBS (Substitute a connected field from another data set)’ presents selections that will replace (substitute) a field from a joinable (connected) data set. In this situation the charity user who wrote the formula in FIG. 20A then realized they wanted the donor name not the donor number, so they now select the row in the ‘SUBS’ 2064 part of the hint (selection list) with ‘name’ 2074 and depending on embodiments get the outcomes in FIG. 20C or FIG. 20D. FIG. 20C examples an embodiment where the substituted field is done via a function, in this example ‘SUB’, where ‘name’ is substituted for the field ‘donor_num’ in the formula 2083 to give the value ‘Amy Holden’ in the cell ‘A1’ 2082. FIG. 20D examples another embodiment where the substituted field simply replaces ‘donor_num’ with ‘number’ in the formula 2093 to give the value ‘Amy Holden’ in the cell ‘A1’ 2092. In both FIG. 20C and FIG. 20D the formula executes in our application steps along the lines illustrated in FIG. 18A or FIG. 18B, depending on the type of join used full outer or inner. Those figures give an illustration of what is done realizing our technology can execute the steps very differently to arrive at the same outcomes.

### Other Types of Formulas Employing Our Join Technology

So far, our examples have been pure formulaic data examples, however our data joining technology is applicable to a broad range of spreadsheet cell formulas, from single prebuilt function formulas to complex multi algebraic operator, multi formulaic data, and multi prebuilt function formulas. To example these we will continue using our three-table data set from FIG. 9A through FIG. 11B and start with simple prebuilt function examples.

### Prebuilt Function Use

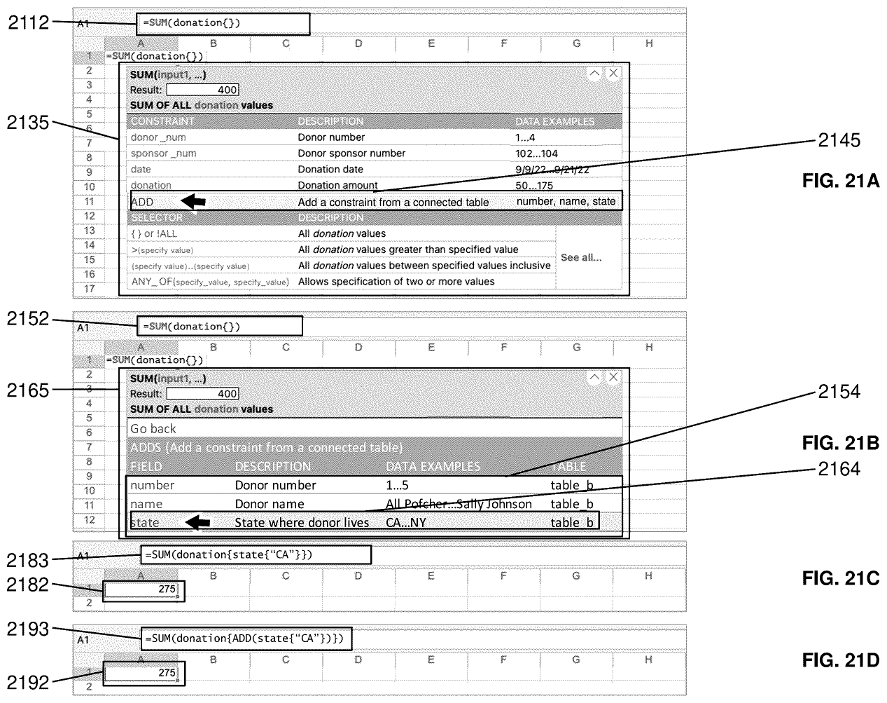

FIG. 21A through FIG. 22 examples the use of our joinable data technology in a summation formula (prebuilt SUM). The charity user wants to total the donations from the state of California but to do so will need to use data from both ‘table_a’ 933/1523 and ‘table_b’ 947/1528 in FIG. 9/15. The user starts the formula as they normally would in FIG. 21A, but the difference is our joining technology presents the ‘ADD’ 2145 constraint to the selectable list (hint) 2135 for the formula 2112. Our technology knows that ‘donation’ has joinable fields from another data set and therefore adds the ‘ADD’ 2145 line. Not seeing the state as an option the user clicks the ‘ADD’ 2145 line to automatically get the new selectable list 2165 in FIG. 21B. The formula 2152 is yet unchanged but the user has been given a set of three joinable fields 2154 within which the user sees the one they want, ‘state’. They select (click) ‘state’ 2164 and then select (or type) ‘“CA”’ and hit ENTER/RETURN to complete the formula as shown in FIG. 21C or FIG. 21D. FIG. 21C examples an embodiment where the added joined field ‘state {“CA”}’ goes into the formula 2183 to give the value ‘275’ in the cell ‘A1’ 2182. FIG. 21D examples another embodiment where the added join field ‘state {“CA”}’ is done via a function, in this example the ‘ADD’ function, in the formula 2193 to give the value ‘275’ in the cell ‘A1’ 2192. In both FIG. 21C and FIG. 21D the formula executes in our application steps along the lines illustrated in FIG. 22. Those illustrative steps start with the full outer join being done as exampled in 1596 in FIG. 15 and the joined data retrieval in step ‘1)’. In step ‘2)’ the joined data is filtered to only include the rows for ‘state’ ‘CA’. Step ‘3)’ then sums those values and that summation and the formula are returned to cell ‘A1’ in step ‘4)’. As previously stated, and assumed for all the following examples those steps are shown to illustrate what is done not to exactly duplicate how our application arrives at the same value.

### Multiple Use in One Formula

FIG. 23A through FIG. 24 examples the continued use of our joinable data technology in a summation formula (prebuilt SUM) picking up where the previous example in FIG. 21A through FIG. 22 left off adding a second joined data field constraint. In FIG. 23A the user is in the donation field within the formula 2312 and therefore gets a selectable list (hint) 2335 showing their in-table constraint options and the ‘ADD’ line 2345 (of joinable table fields) which they select. Then in FIG. 21B the user is then automatically given a new selectable list 2365, despite the spreadsheet cell formula 2352 having not changed, with the joinable data fields they can add 2354 (with ‘state’ disabled/grayed out in this embodiment because it was already used). Given the user wants to further constrain the donations to people in the back half of the alphabet (i.e., ‘name’ ‘>=“n”‘they click the ‘name’ line 2364 and then add the constraint of ‘>=“n”’ to ‘name’ before hitting ENTER/RETURN to get the outcome in FIG. 23C or FIG. 23D. FIG. 23C examples an embodiment where the added joined field ‘name {>=“n”}’ goes into the formula 2383 to give the value ‘100’ in the cell ‘A1’ 2382. FIG. 23D examples another embodiment where the added join field ‘state’ is done via a function, in this example the function ‘ADD’, in the formula 2393 to give the value ‘100’ in the cell ‘A1’ 2392. In both FIG. 23C and FIG. 23D the formula executes in our application steps along the lines illustrated in FIG. 24. Those illustrative steps start with the full outer join being done as exampled in 1596 in FIG. 15 and the joined data retrieval in step ‘1)’. In step ‘2)’ the joined data is filtered to only include the rows for ‘state’ ‘CA’. In step ‘3)’ the joined data is further filtered to include only include the rows for ‘name’ “>=“n”’ (including the last half of the alphabet). Step ‘4)’ then sums that value and that summation value and the formula are returned to cell ‘A1’ in step ‘5)’.

Our spreadsheet formula joinable data technology supports use in the full spectrum of prebuilt functions in existing spreadsheets which employ data for calculations. It also supports new prebuilt functions supported by our technology, such as the new functions which were the subject of our U.S. application Ser. No. 17/359,418, titled “Methods and Systems for Presenting Drop-Down, Pop-Up or Other Presentation of a Multi-Value Data Set in a Spreadsheet Cell,” as exampled next.

### Use in Functions Presenting Multiple Values

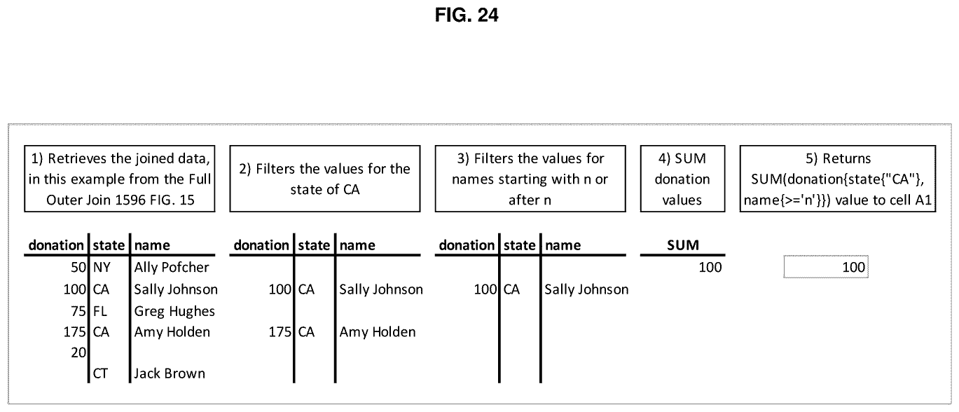

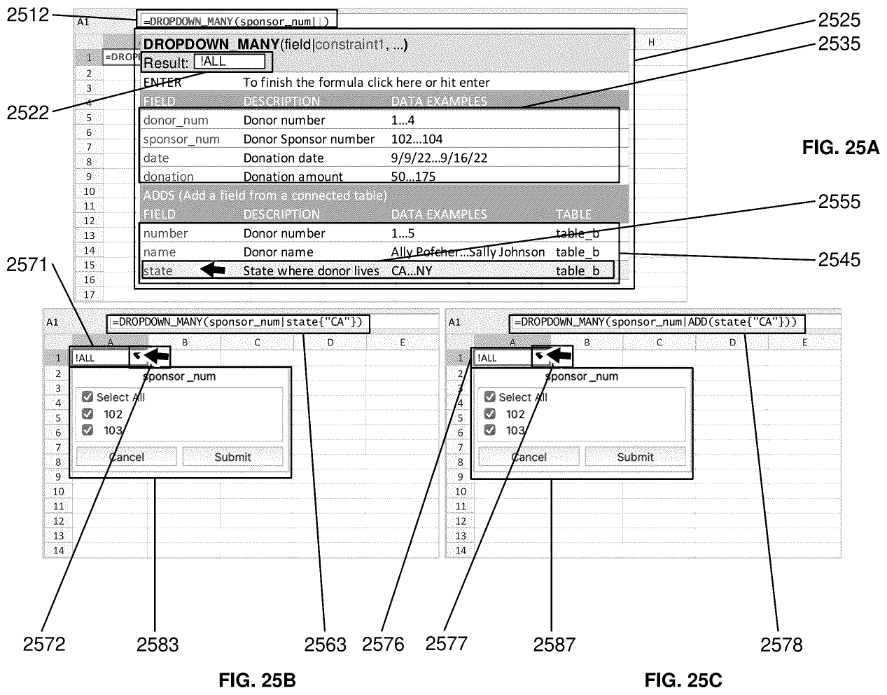

FIG. 25A through FIG. 26B examples the use of our joinable data technology in a “DROPDOWN_MANY’ prebuilt function. The charity user wants to create a multi-value selector cell popup for the all the sponsors (i.e., ‘sponsor_num) who sponsored donations from the state of California. Because ‘sponsor_num’ and ‘state’ are in different data sets that will involve using our data joining technology in the ‘DROPDOWN_MANY’ functional formula. In FIG. 25A the user has started building the formula 2512 to the point that they are ready to enter a constraint field. In this embodiment they are presented a one-step joinable data selection list 2525 (hint) displaying the fields 2535 in the table with ‘sponsor_num’ and the fields 2545 that can be added from the joinable table, ‘table_b’. The user sees ‘state’ there and selects that field 2555 after which they select/type the ‘state’ value ‘“CA”’ and hit ENTER/RETURN to get the outcome in either FIG. 25B or FIG. 25C, depending on embodiments.

In FIG. 25B the user clicks on the dropdown button (arrow) 2572 in cell ‘A1’ 2571 showing the ‘DROPDOWN_MANY’ popup 2583 with the joined ‘“CA”’ ‘state’ value data constrained ‘sponsor_num’ values for the formula 2563 where the joined data field is populated in the formula (versus FIG. 25C where the joined data field is populated in the formula via a prebuilt function). FIG. 26A illustratively examples what our technology does to populate that popup 2583. Those illustrative steps start with the full outer join being done as exampled in 1596 in FIG. 15 and the joined data retrieval in step ‘1)’. In step ‘2)’ the joined data is filtered to only include the rows for ‘state’ ‘CA’. In step ‘3)’ the values are deduped (if necessary), sorted and returned to the cell ‘A1’ for use in the popup with a starting selection of all values (Select all). As mentioned previously our technology supports many different data joining types and FIG. 26B illustratively examples using an ‘Inner Join’ for the same steps.

FIG. 25C examples the same user actions as in FIG. 25B except for an embodiment of our technology where the joined data field is added via a prebuilt function, ADD in this case, in the spreadsheet cell formula 2578. Clicking the dropdown button (arrow) 2577 in cell ‘A1’ 2576 showing the ‘DROPDOWN_MANY’ popup 2587 with the joined ‘“CA”’ ‘state’ value data constrained ‘sponsor_num’ values. The illustrative steps to deliver those values are the same ones in FIG. 26A and FIG. 26B as the only difference is the joined data argument (with the ‘ADD’ function). Our technology would support other joined data argument types and different naming of the prebuilt function ‘ADD’ as well as different ways to give the user the selectable lists with the joinable data.

### Use in New Functions

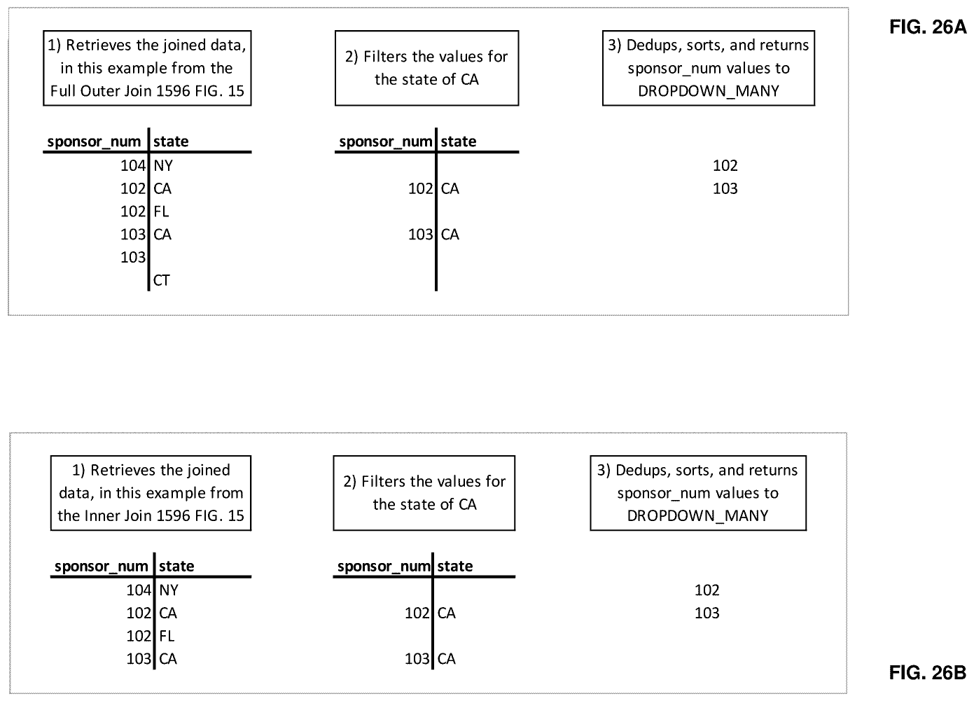

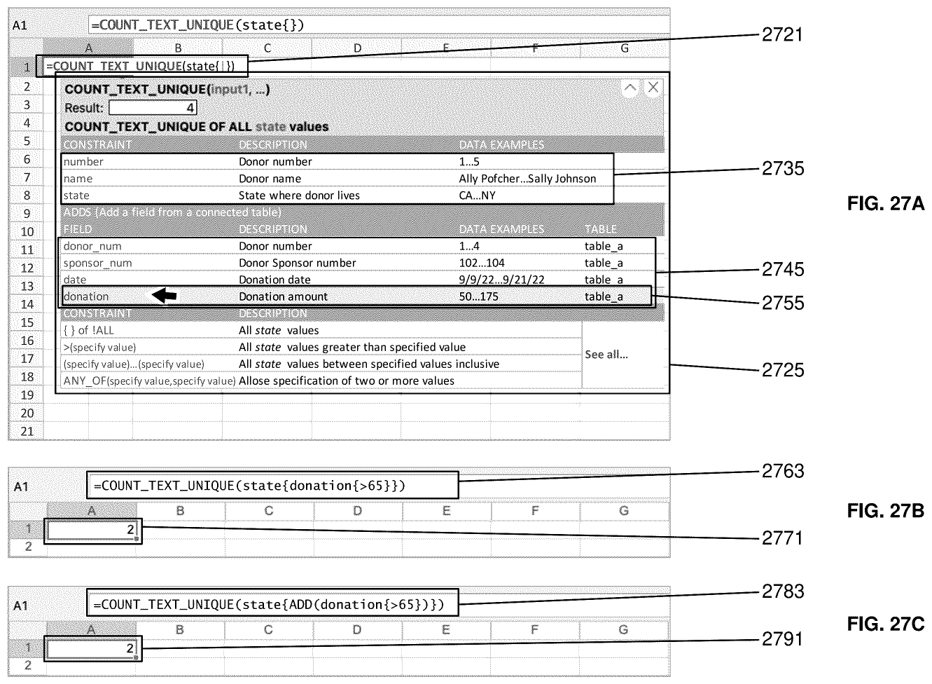

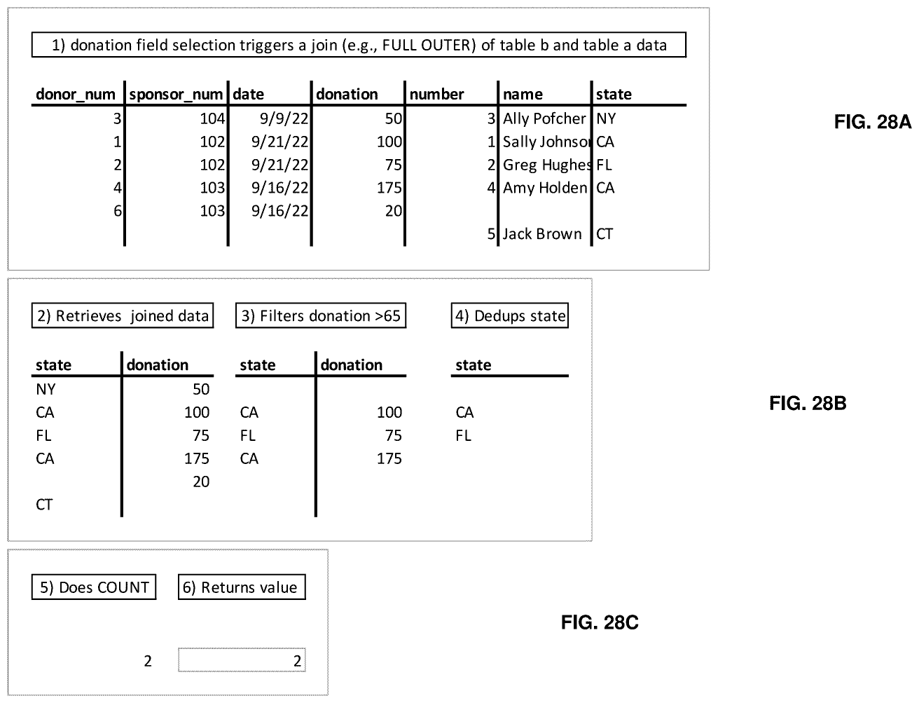

Our joinable data technology also supports other new functions our spreadsheet has added which are not found in the traditional spreadsheets (e.g., Microsoft Excel, Google Sheets and Apple Numbers). FIG. 27A through FIG. 28C examples the use of our joinable data technology in a “COUNT_TEXT_UNIQUE” prebuilt function. The charity user wants to count how many different states had individual donations greater than $65. In FIG. 27A they start populating the formula ‘=COUNT_TEXT_UNIQUE (state { })’ into cell ‘A1’ 2721 where they are presented with what we have labelled a one-step joinable data selector list (hint) 2725 with constraints 2735 they can select from the same table as ‘state’ and our technology curated list of joinable fields 2745 (with a qualified joinable flag) where they see the ‘donation’ field that they want. They select that field ‘donation’ 2755 and then select/type ‘>65’ and hit ENTER/RETURN to get the outcome in either FIG. 27B or FIG. 27C, depending on embodiment. FIG. 27B examples an embodiment where the added joined field ‘donation’ goes into the formula 2763 to give the value ‘2’ in the cell ‘A1’ 2771. FIG. 27C examples another embodiment where the added join field ‘donation’ is done via a function, in this example ‘ADD’, in the formula 2783 to give the value ‘2’ in the cell ‘A1’ 2791. In both FIG. 27B and FIG. 27C the formula executes in our application steps along the lines illustrated in FIG. 28A through FIG. 28C. Those illustrative steps start with the full outer join (but could have used other join types) being done as exampled in step ‘1)’ FIG. 28A. Step ‘2)’ in FIG. 28B retrieves the joined data for the needed fields. In step ‘3)’ in FIG. 28B the joined data is filtered to only include the rows where the ‘donation’ values are greater than ‘65 (‘>65’). Step ‘4)’ in FIG. 28B dedups the ‘state’ abbreviation values to make them UNIQUE. Step ‘5)’ in FIG. 28C then does the count of the UNIQUE ‘state’ values and step ‘6)’ in FIG. 28C returns the value of ‘2’ to cell ‘A1’ with the cell formula (which varies by embodiment). Our technology supports joinable data use in a very broad set of spreadsheet cell existing and new prebuilt functions.

### Joinable Data Used in Multi-Cell Output Functions

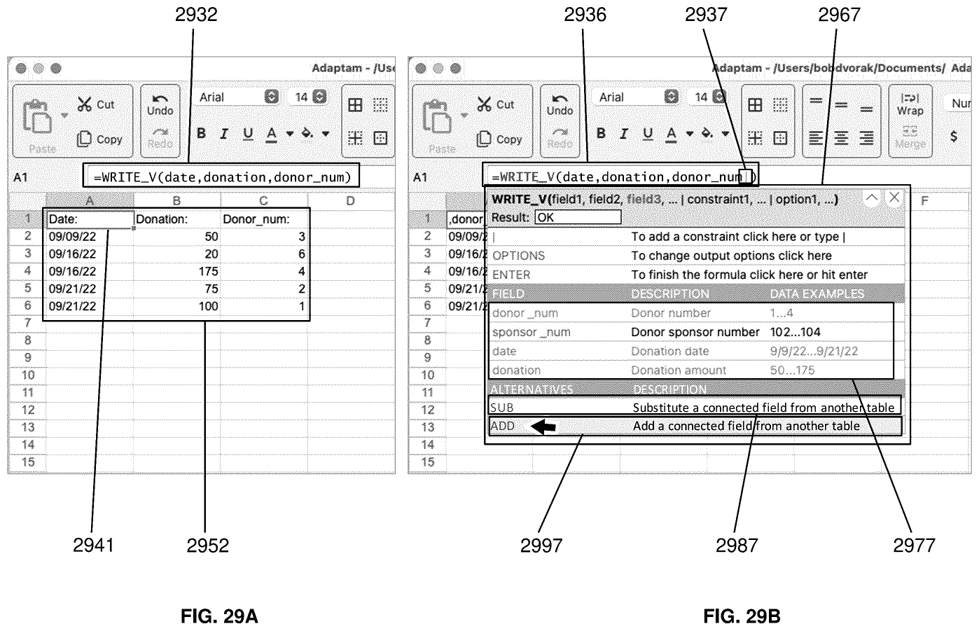

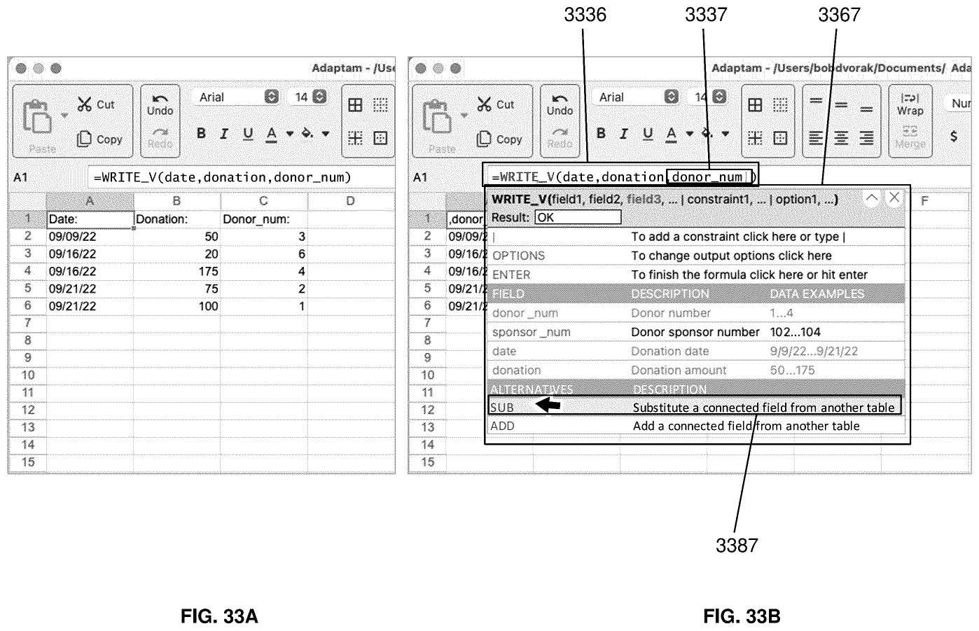

Our joinable data technology is also applicable to prebuilt functions that populate more than one cell, such as those in U.S. application Ser. No. 16/191,402, titled, “Methods and Systems for Connecting A Spreadsheet to External Data Sources with Ordered Formulaic Specification of Data Retrieved,”, now U.S. Pat. No. 11,036,929, issued 15 Jun. 2021, U.S. application Ser. No. 17/374,901, titled “Method and System for Improved Ordering of Output from Spreadsheet Analytical Functions,”, and U.S. application Ser. No. 17/903,934 titled “Method and System for Improved 2d Ordering of Output from Spreadsheet Analytical Functions,”. FIG. 29A through FIG. 32C examples adding a joinable data field in a ‘WRITE’ function while FIG. 33A through FIG. 35C examples substituting a joinable data field in a ‘WRITE’ function.

### ADD in Multi-Cell Output Functions

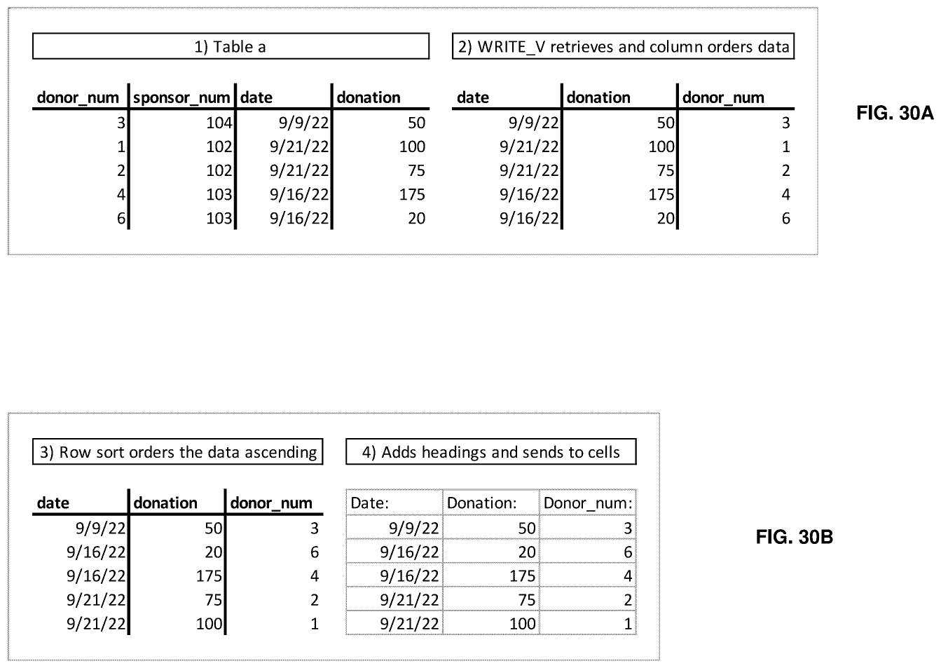

FIG. 29A examples one of our ‘WRITE’ function formulas 2932 in cell ‘A1’ 2941 that populates the values in cells ‘A1’ through “C6’ 2952 from the formula 2932. The illustrative steps on what that ‘WRITE’ formula 2932 does are exampled in FIG. 30A and FIG. 30B to give an illustrative starting point for comparison as to what is different when the same ‘WRITE’ function employs our joinable data technology. Step ‘1)’ in FIG. 30A is the data that can reside in spreadsheet cells or in non-spreadsheet cells in an of the previously mentioned modes. Step ‘2)’ then retrieves and column sorts that data. Step ‘3)’ in FIG. 30B then row sorts the data in this embodiment to the default settings of ascending values starting with the first column and then ordering any ties by ascending then on the second column and if necessary, the third column. Step ‘4)’ in this embodiment adds the column headings (initial capitalization of the input field name ending with a colon) and sends the values with the formula to the cells.

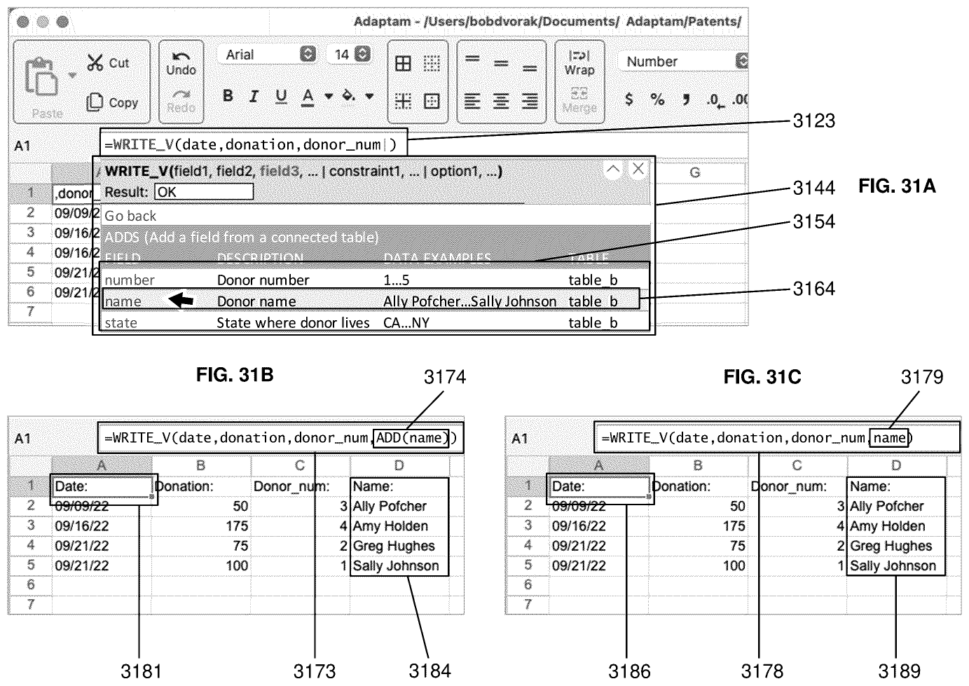

In FIG. 29B when the charity user reopens the formula putting the cursor 2937 inside the formula 2936 closing parenthesis they get the selection list (hint) 2967 which gives the user the selection list 2977 of additional fields in the table of the formula populated fields (note with only one active field ‘sponsor_num’ which has not already been used) and via our new technology two additional ‘ALTERNATIVES’ to ‘SUB’ ‘Substitute a connected field from another table’ 2987 or to ‘ADD’ ‘Add a connected field from another table’ 2997. In this example the charity user decides they would like to ‘ADD’ 2997 and clicks on that alternative which opens the selectable list 3144 in FIG. 31A. The formula 3123 has not changed but this new hint 3144 gives the user the option to add one of three different fields 3154 from the joinable ‘table_b’ to the formula. The user sees the ‘Donor name’ ‘DESCRIPTION’ field ‘name’ that they want and selects (e.g., clicks) it 3164 and then hits ENTER/RETURN to get either of the outcomes in FIG. 31B or FIG. 31C, depending on embodiment.

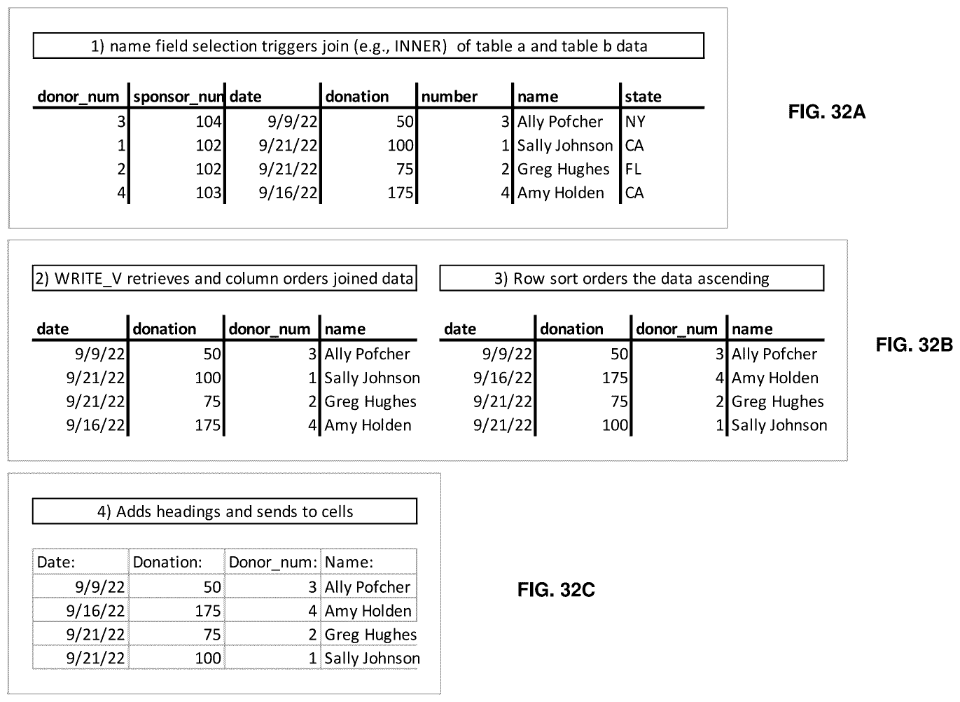

FIG. 31B examples an embodiment where the added join field ‘name’ 3174 is done via a function, in this example the ‘ADD’ function, in the formula 3173 for cell ‘A1’ 3181 and that ‘ADD (name)’ argument populates the values in cells ‘D1’ through ‘D5’ 3184. FIG. 31C examples another embodiment where the added joined field ‘name’ 3179 goes into the formula 3178 for cell ‘A1’ 3186 and that ‘name’ argument populates the values in cells ‘D1’ through ‘D5’ 3189. In both FIG. 31B and FIG. 31C the formula executes in our application illustrative steps along the lines shown in FIG. 32A through FIG. 32C. Those illustrative steps start in step ‘1)’ with the retrieval of the two data tables and then their inner join as illustrated in FIG. 32A. Step ‘2)’ in FIG. 32B retrieves the joined data fields used in the formula and column sorts the data to match the argument order in the ‘WRITE’ formula. Step ‘3’ in FIG. 32B row sorts the data as previously described in column ordered ascending order (starting with the ‘date’ column). Step ‘4)’ in FIG. 32C adds the headings, as previously described, and sends the values and the formula to cells ‘A1’ through ‘D5’ in either FIG. 31B or FIG. 31C. Note, the ‘ADD’ function embodiment in this example eliminates the ADD from the heading in FIG. 31B believing that is what the user would want. Although our technology could have also left it in the heading.

### SUB in Multi-Cell Output Functions

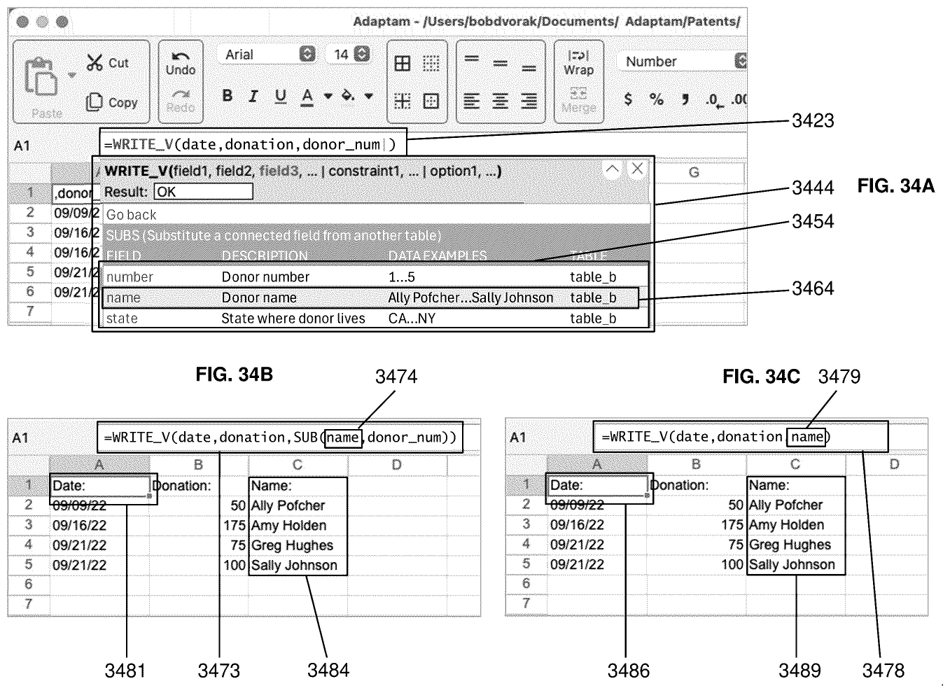

FIG. 33A through FIG. 35C parallels what was exampled in FIG. 29A through FIG. 32C but for when the user decides they want to substitute a joinable field for an existing field in the formula rather than add it. FIG. 33A gives the exact same starting point as FIG. 29A having been created the same way. FIG. 33B is also exactly like FIG. 29B except this time the user decides they would like to replace the field ‘donor_num’, which is just before the cursor 3337 in the formula 3336. So, this time they select (click) the ‘SUB’ ‘Substitute a connected field from another table’ line 3387 in the selection list 3367 which automatically opens the selectable list 3444 in FIG. 34A. The formula 3423 has not changed (from the formula 3336 in FIG. 33B) but this new hint 3444 gives the user the option to substitute one of three different fields 3454 for ‘donor_num’ in the formula. The user sees the ‘name’ field that they want with the ‘DESCRIPTION’ ‘Donor name’ and selects (e.g., clicks) it 3464 and then hits ENTER/RETURN to get either of the outcomes in FIG. 34B or FIG. 34C, depending on embodiment.

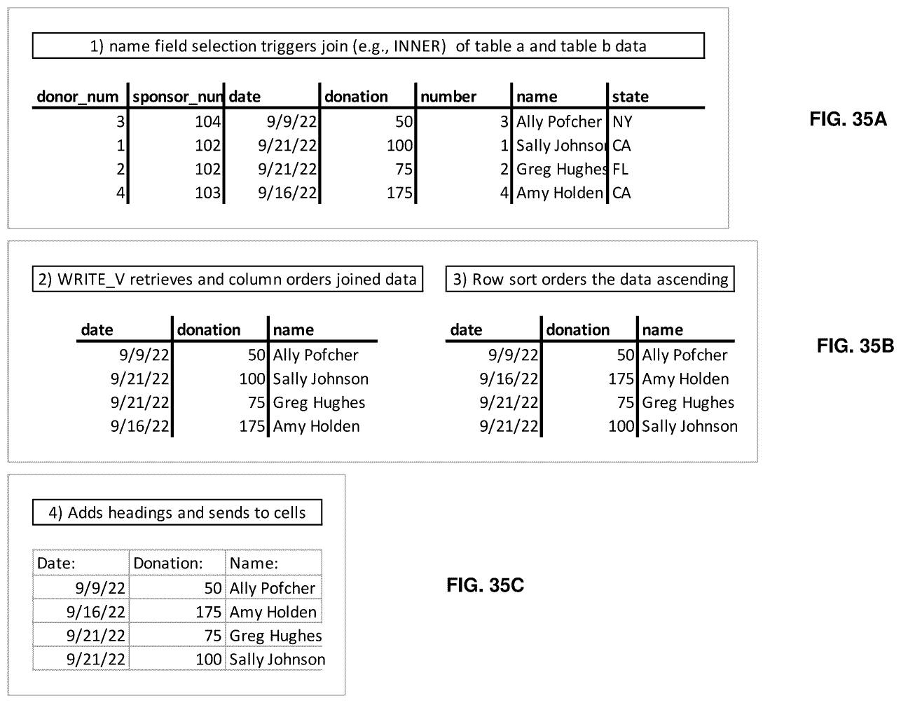

FIG. 34B examples an embodiment where the substituted join field ‘name’ 3474 is done via a function, in this example ‘SUB’, in the formula 3473 in cell ‘A1’ 3481 to replace the values in cells ‘C1’ through ‘C5’ 3484. FIG. 34C examples another embodiment where the substituted joined field ‘name’ 3479 goes into the formula 3478 in cell ‘A1’ 3486 to replace the values in cells ‘C1’ through ‘C5’ 3489. In both FIG. 34B and FIG. 34C the formula executes in our application illustrative steps along the lines shown in FIG. 35A through FIG. 35C. Those illustrative steps start in step ‘1)’ with the retrieval of the two data tables and their inner join as illustrated in FIG. 35A. Step ‘2)’ in FIG. 35B retrieves the joined data fields used in the formula and column sorts the data to match the argument order in the ‘WRITE’ formula. Step ‘3’ in FIG. 35B row sorts the data as previously described in ascending order column-wise. Step ‘4)’ in FIG. 35C adds the headings, as previously described, and sends the values and the formula to cells ‘A1’ through ‘C5’ in either FIG. 35B or FIG. 35C. Note, the ‘SUB’ function embodiment in this example eliminates the SUB formula from the heading in FIG. 35B believing that is what the user would want. Although our technology could have also left it in the heading.

### Joinable Data Use in More Complex Multi-Cell Output Functions

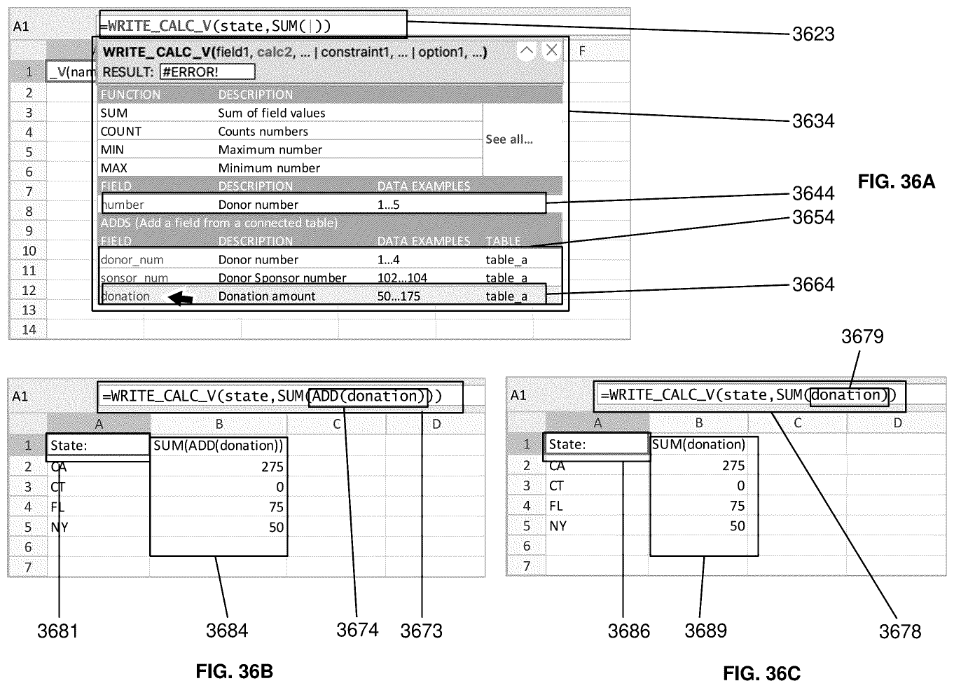

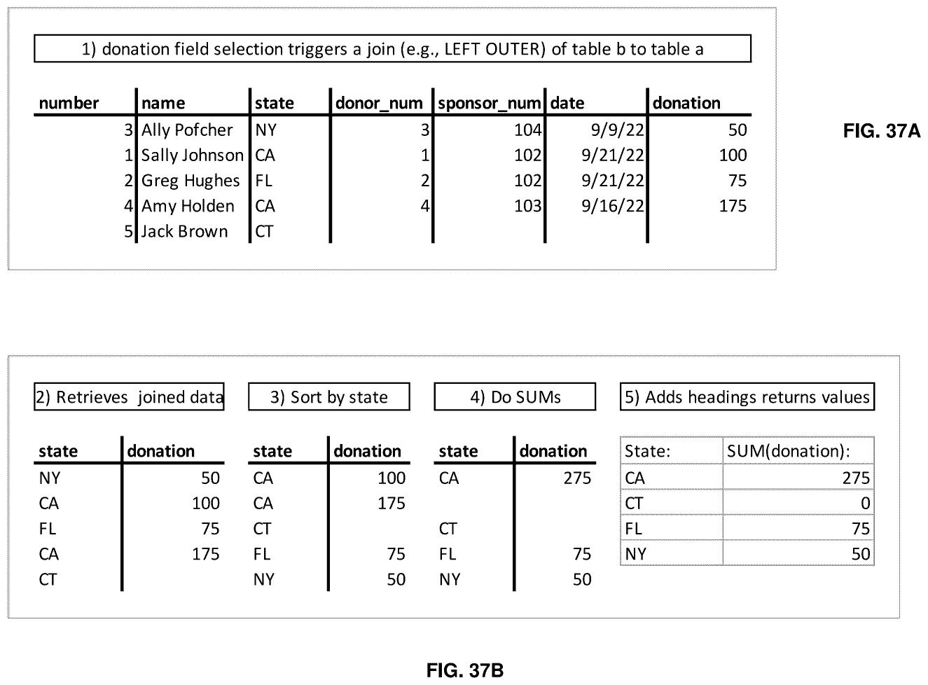

Our joinable data technology works in our more complicated multi-cell output functions (e.g., WRITE_CALC_V and WRITE_CALC_2D) and a prebuilt function within a prebuilt function as exampled in FIG. 36A through FIG. 37B. In FIG. 36A the charity user has decided they would like to total the donations for each donor by their name realizing this will require joining data across two data tables. They begin the ‘WRITE_CALC’ formula 3623 with field ‘name’ and then type or click populate the ‘SUM function at which point they get the selection list 3634, which is what we have called a one-step hint showing the applicable fields 3644 in the table that contains the field ‘name’ and any applicable fields 3654 in tables joinable to the field ‘name’. In this example those are limited to numeric fields because of the SUM function limit to numeric fields. So, the user sees one field from the same data set that has the field/column ‘state’ (‘table_b’) 3644 and three fields from the joinable data set ‘table_a’ 3654. The user then sees the field that they want, ‘donation’ 3664, clicks it and hits ENTER/RETURN to get either of the outcomes in FIG. 36B or FIG. 36C, depending on embodiment.

FIG. 36B examples an embodiment where the added join field ‘donation’ 3674 is done via a function, in this example ‘ADD’, in the formula 3673 in cell ‘A1’ 3681 with that ‘SUM (ADD (donation))’ argument populating the values in cells ‘B1’ through ‘B6’ 3684. FIG. 36C examples another embodiment where the added joined field ‘donation’ 3679 goes into the formula 3678 in cell ‘A1’ 3689 by itself to populate so that the argument ‘SUM (donation)’ populates the values in cells ‘B1’ through ‘B6’ 3689. It is worth noting that one of the simplifying factors of these embodiments is that the cell formula has the equivalent of an invisible joining argument that specifies the data sets and keys used for the joining of the data sets. The user is not incumbered with all the formula complexity that would be added to show the parameters of the join. In both FIG. 36B and FIG. 36C the formula executes in our application illustrative steps along the lines shown in FIG. 37A and FIG. 37B. Those illustrative steps start in step ‘1)’ with the retrieval of the two data sets (from wherever they reside) and their ‘LEFT OUTER’ join being illustrated in FIG. 37A. Step ‘2)’ in FIG. 37B retrieves the ‘LEFT OUTER’ joined data fields used in the formula and column sorts the data to match the argument order in the ‘WRITE_CALC’ formula. Step ‘3’ in FIG. 37B row sorts the ‘state’ values in ascending order. Step ‘4)’ in FIG. 37B does the sums to which Step ‘5)’ adds the headings and sends the values to cells ‘A1’ through ‘B6’ in FIG. 36C and the formula to cell ‘A1’. The one difference in this example for FIG. 36B is heading in FIG. 36B contains the ‘ADD’ function but other than the heading change the rest of the steps for FIG. 36B are the same as in FIG. 37A and FIG. 37B.

### Joinable Data Used Multiple Times in a Formula

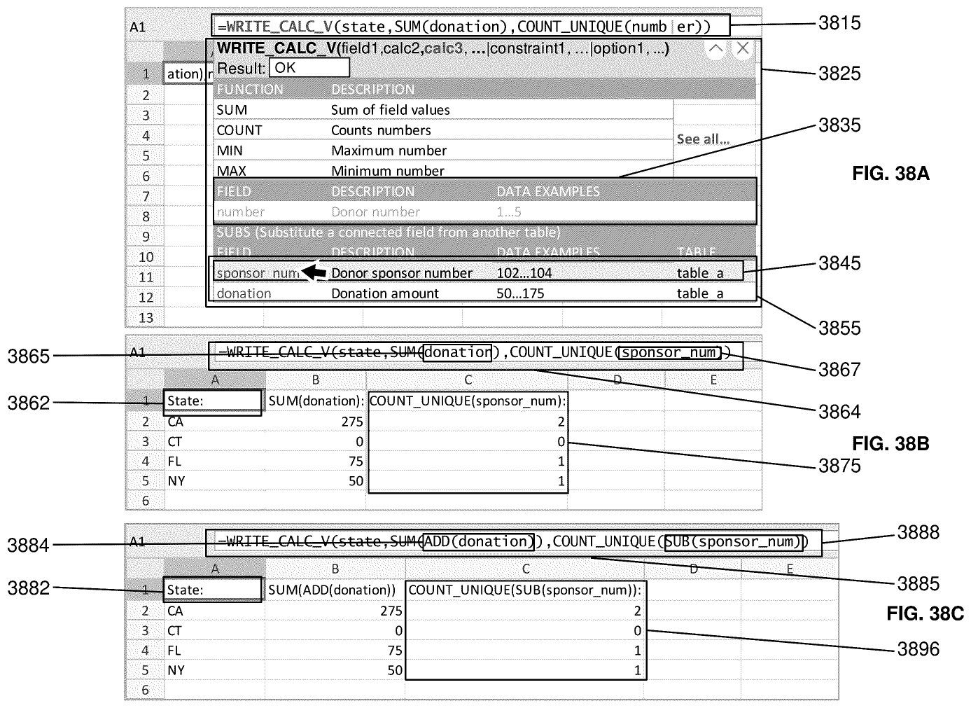

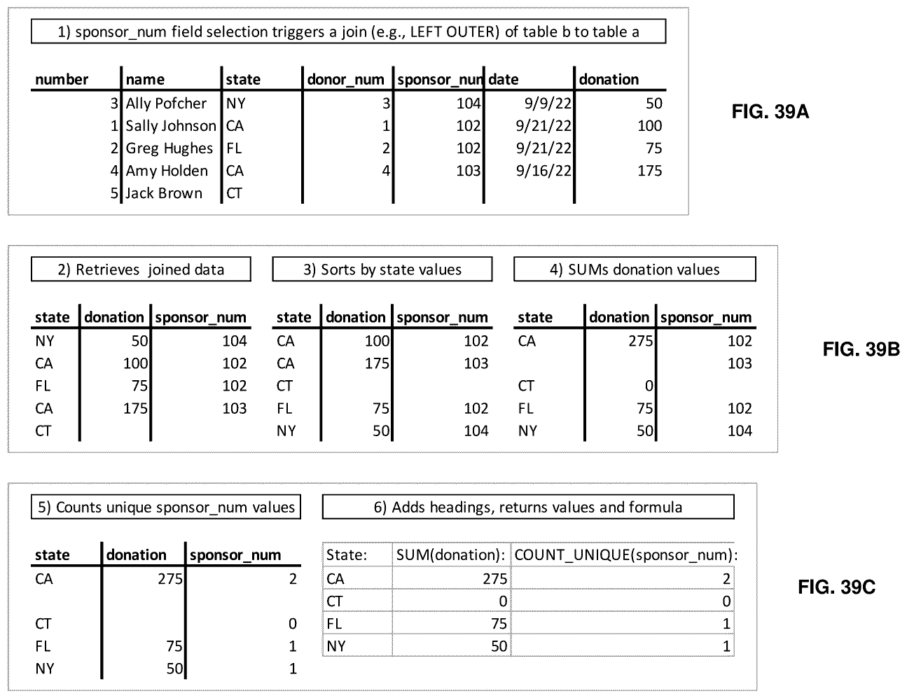

Our joinable data technology can be used multiple times and in multiple different ways in any applicable formula as exampled in FIG. 38A through FIG. 39C. For example, a user could do multiple additions of joined data fields within a single formula, could do multiple substitutions within a single formula, and could do singles or multiples of joined data additions (e.g., ADD) and substitutions (e.g., ‘SUB’) within a single formula. FIG. 38A through FIG. 39C examples the charity user doing one add and one substitution within a single formula, actually continuing on with the formula exampled in FIG. 36A through FIG. 37B.

In FIG. 38A the charity user continued working with the formula 3678 in FIG. 36C adding the function “COUNT_UNIQUE’ and the field ‘number’ at which point they realized that they did not want the ‘Donor number’ but instead wanted that donor's ‘Donor sponsor number’. So, they moved the cursor back into the field ‘number’ in the formula 3815 to get the selection list (hint) 3825, which in this embodiment displays the replacement fields 3835 they can select in same table as ‘number’ and the replacement (substitution) fields 3855 they can select in joinable tables. Note: all limited to numerical fields by the function ‘COUNT_UNIQUE’ which counts only numeric values. From that hint (selection list) 3825 they see and select the ‘sponsor_num’ field 3845 and click it then hitting ENTER/RETURN to get either of the outcomes in FIG. 38B or FIG. 38C, depending on embodiment.

FIG. 38B examples an embodiment where the substituted joined field ‘sponsor_num’ 3867 goes into the formula 3864 in cell ‘A1’ 3862 to replace the field ‘number’ and that argument populates the values in cells ‘C1’ through ‘C5’ 3875. At this point the user has two joined data fields 3865 and 3867 in the formula 3864 with one inputted by addition of the field and the other inputted by substituting it for a field. FIG. 38C examples another embodiment where the substituted join field ‘sponsor_num’ 3888 is done via a function, in this example ‘SUB’, in the formula 3885 in cell ‘A1’ 3882 which replaces the field ‘number’, and that argument populates the values in cells ‘C1’ through ‘C5’ 3896. Note, the formula 3885 in FIG. 38C is also written as if the user started with FIG. 36B and therefore has the argument ‘ADD (donation)’ 3884 which is the equivalent of ‘donation’ 3865 in FIG. 38B. At this point in FIG. 38C the user has two joined data fields 3884 and 3888 (with accompanying functions ADD and SUB, respectively) in the formula 3885 with one inputted by addition of the field and the other inputted by substituting it for a field. In both FIG. 38B and FIG. 38C the respective formula executes in our application illustrative steps along the lines shown in FIG. 39A through FIG. 39C. Those illustrative steps start in step ‘1)’ in FIG. 39A with the retrieval of the two data tables and then their ‘LEFT OUTER’ join. Step ‘2)’ in FIG. 39B retrieves the ‘LEFT OUTER’ joined data fields used in the formula and column sorts the data to match the argument order usage in the ‘WRITE_CALC’ formula. Step ‘3’ in FIG. 39B row sorts the data as previously described in ascending order. Step ‘4)’ in FIG. 39B sums the donation values for each of the ‘state’ values. Step ‘5)’ in FIG. 39C counts the unique values of ‘donor_num’ for each state. Step ‘6)’ in FIG. 39C adds the headings, as previously described, and sends the values and the formula to cells ‘A1’ through ‘C5’ in either FIG. 39B or FIG. 39C. Note, FIG. 39C step ‘6)’ examples the headings for FIG. 39B while in the embodiment for FIG. 39C the headings include the ‘ADD’ and ‘SUB’ functions as exampled in FIG. 38C cells ‘B1’ and ‘C1’. In a different embodiment mentioned previously the formulas in FIG. 38C could have the ‘ADD’ and ‘SUB’ functions in the formula arguments but eliminate those functions in the output headings.

While we could continue with further examples of different spreadsheet cell usages of our joinable data technology with different functions and more complicate algebraic operations for unique-to-unique join key joined data sets, we instead will move to exampling our technology working with unique to non-unique join key joined data sets.

### Unique to Non-Unique Joinable Data Set Examples

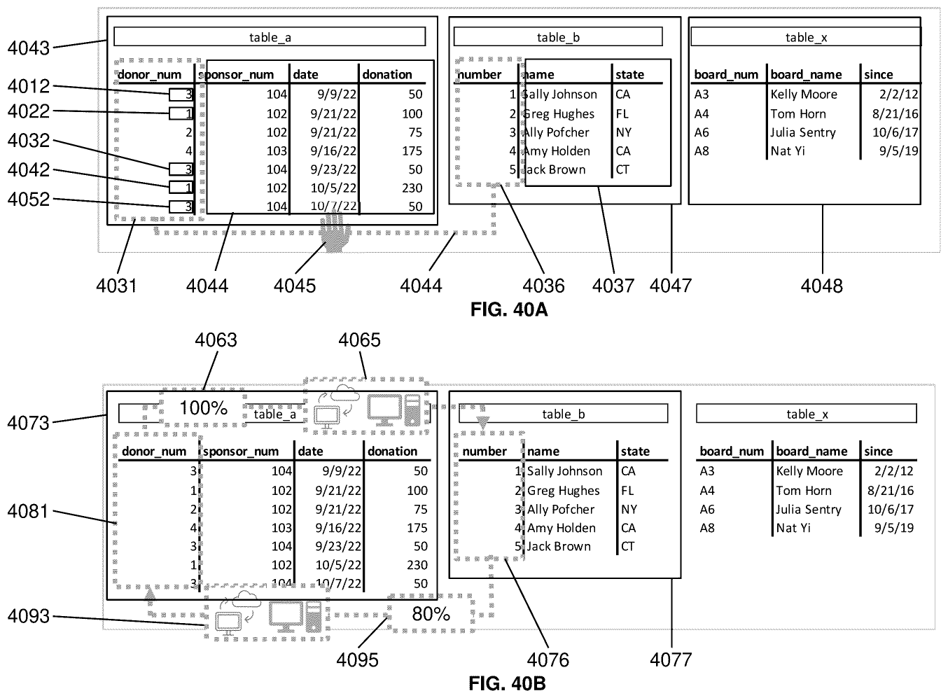

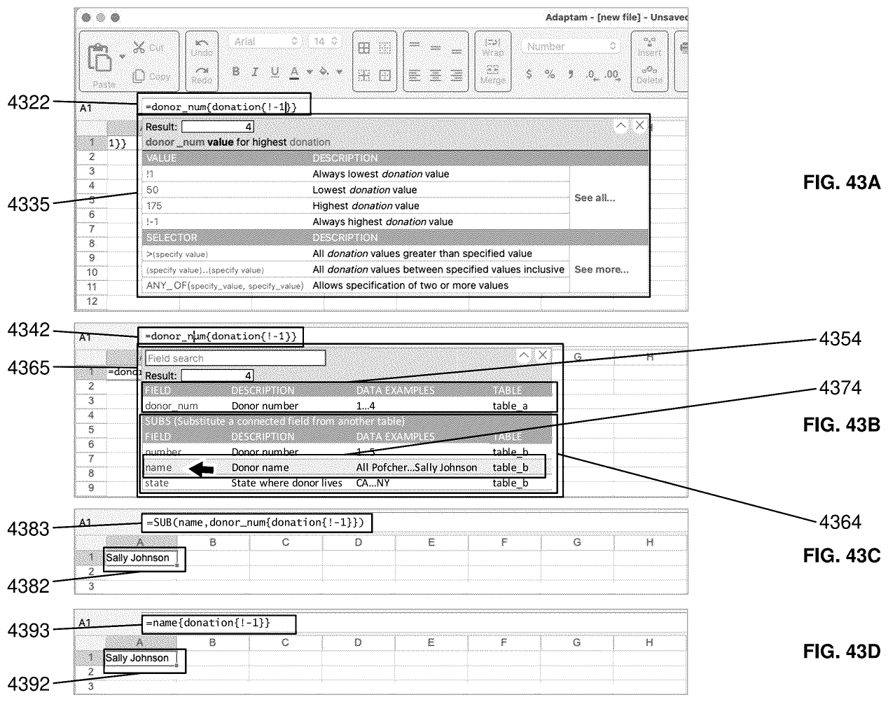

Our unique to non-unique join key joinable technology works very similarly to our previously exampled unique-to-unique technology with the only difference being in the table joins themselves, where the unique table rows can be appended to more than one of the non-unique table rows. FIG. 40A through FIG. 42 examples a ‘table_a’ which is different than the previously exampled ‘table_a’ use in FIG. 9A through FIG. 39C because this new ‘table_a’ is non-unique while the previous ‘table_a’ was unique for the join key. The ‘table_b’ is unchanged and therefore like the previous ‘table_b’ is unique for the join key. Therefore, the new ‘table_a’ join to ‘table_b’ has a data modelling cardinality of non-unique to unique. FIG. 43A through FIG. 52B examples the use of those non-unique to unique joins in our joinable selectable list and joined data spreadsheet cell formula technologies. Note, the ‘table_x’ 4048 is unchanged and therefore still has no joins to either ‘table_a 4043 or table_b 4037.

We are continuing our examples with the charity user who this time has a different ‘table_a’ 4043 which is a non-unique for the join key ‘donor_num’ 4031. It is a non-unique because the join key ‘donor_num’ 4031 has duplicate values. In this example three rows with the value ‘3’ 4012/4032/4052 and two rows 4022/4042 with value ‘1’. The set up/creation of those potential joins can be done in many different ways in our technology as previously described in FIG. 8 and previously exampled in FIG. 9A through FIG. 13. FIG. 40A and FIG. 40B example the spectrum of those join set ups ranging from the fully manual set up 4045 (path ‘a/b/h’ in FIG. 8) to the fully automated 4063/4065/4093/4095 (path ‘a/g/h’ in FIG. 8), with the previously cited UIs in FIG. 12 and FIG. 13 exampling some of the combinations in-between (examples of the pathways ‘a/c/d/h’ and ‘a/e/f/h’ in FIG. 8).

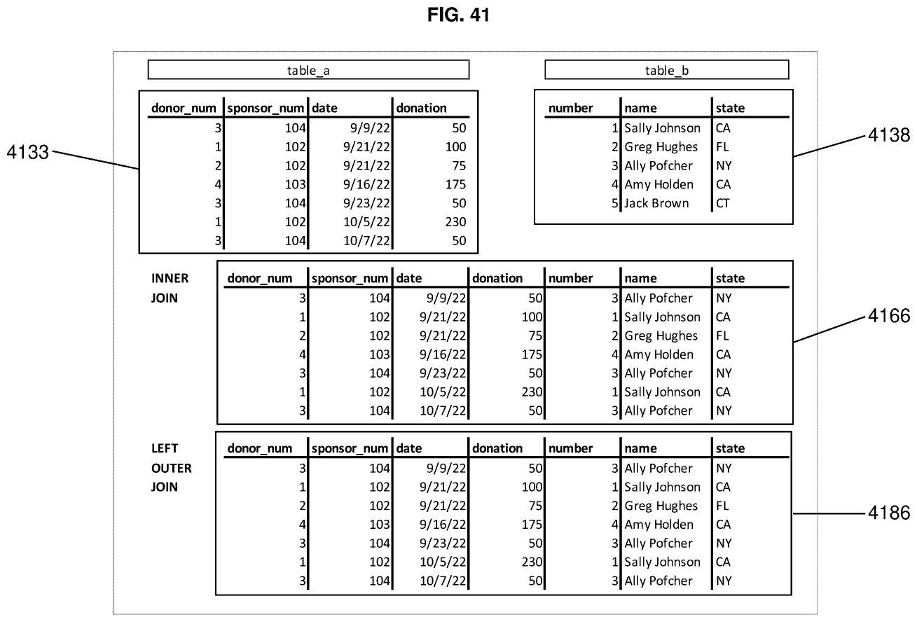

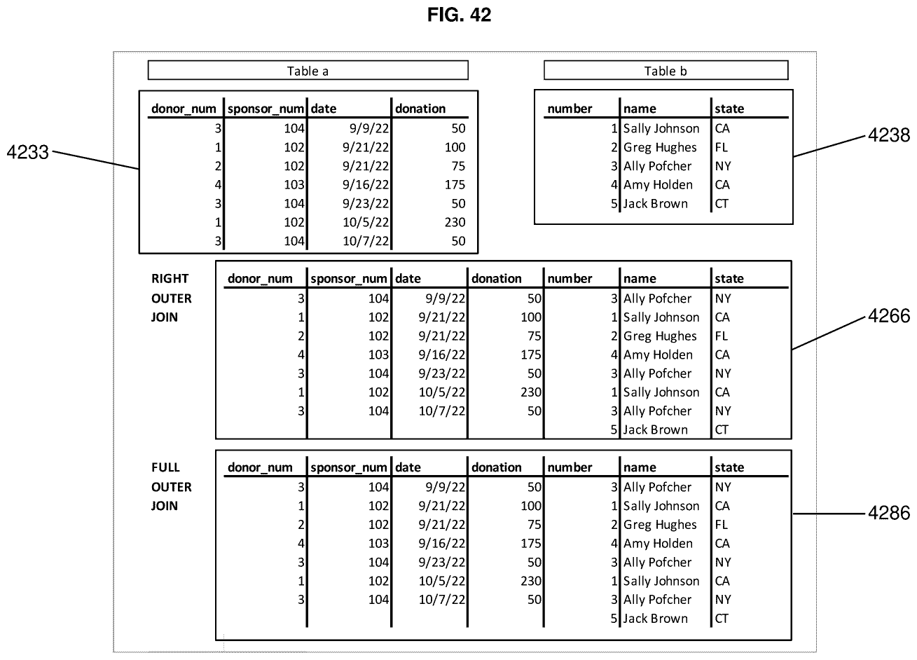

The unique to non-unique joins types supported in our technology include the four join types visually exampled in FIG. 14 as illustratively exampled for the new ‘table_a’ 4133/4233 and ‘table_b’ 4138/4238 in FIG. 41 and FIG. 42. The ‘LEFT OUTER’ join 4186 in FIG. 41 is exampled in FIG. 5 as done in SQL showing the desired appending of the unique rows to the non-unique rows without the unwanted duplication (partial Cartesian Product) of non-unique rows that occurs in non-unique to non-unique joins (exampled in FIG. 6). They therefore give an easily usable outcome for the joined data set without any distortion of the non-unique data. FIG. 43A through FIG. 52B examples some of those usages for both addition or substitution use of joinable fields, one-step and multi-step selection lists (hints), different types of formulas, and combinations of the afore mentioned.

### Unique to Non-Unique Joinable Field Substitution

FIG. 43A through FIG. 44B examples unique to non-unique join data modelling cardinality substitution joinable selection lists (hints) and spreadsheet formula data joins and calculations. FIG. 43A examples a single data set formulaic data field formula 4322 with its accompanying selection list (e.g., hint) 4335. However, that data is from ‘table_a’ 4133 in FIG. 41 (also in 4043 in FIG. 40A, 4073 in FIG. 40B, and 4233 in FIG. 42) which is joinable to ‘table_b’ 4138 in FIG. 41 (also in 4047 in FIG. 40A, 4077 in FIG. 40B, and 4238 in FIG. 42). So, when the user puts the cursor back into the formula 4342 field ‘donor_num’ the selectable list 4365 gives the user their field replacement (substitution) options. With our new technology it does it two different ways. The original way without our new joinable technology which provides all the fields that are spelled through the cursor, which in this case is all the fields that are spelled ‘donor_n’ (which is only the current field ‘donor_num’ 4354). The new addition is that our data set joining technology also provides all the fields that are joinable to the current field ‘donor_num’, which are the three fields in the “SUBS’ 4364 part of the hint. As the hint says, ‘SUBS (Substitute a connected field from another table)’ presents selections that will replace (substitute) a field from a joinable (connected) table. In this situation the charity user who wrote the formula in FIG. 43A then realized they wanted the donor name not the donor number, so they now select (click) the row in the ‘SUBS’ part of the hint (selection list) with ‘name’ 4374 and depending on embodiments get the outcomes in FIG. 43C or FIG. 43D. FIG. 43C examples an embodiment where the substituted field is done via a function, in this example ‘SUB’, where ‘name’ is substituted for the field ‘donor_num’ in the formula 4383 to give the value ‘Amy Holden’ in the cell ‘A1’ 4382. FIG. 43D examples another embodiment where the substituted field simply replaces ‘donor_num’ with ‘number’ in the formula 4393 to give the value ‘Amy Holden’ in the cell ‘A1’ 4392. In both FIG. 43C and FIG. 43D the formula executes in our application steps along the lines illustrated in FIG. 44A or FIG. 44B.

While the selectable lists presentations may vary based on UI configuration and one-step or two-step, and the formula may have different arguments based on whether a prebuilt function is used or not, the joined data calculated answer in the spreadsheet cell formula does not change, and the illustrative steps done by our application to provide that answer do not materially change (other than arguments here) as exampled by FIG. 44A and FIG. 44B. However, the answer can change by the type of join employed by the embodiment. FIG. 44A examples using the ‘Full Outer Join’ data 4286 from FIG. 42 to calculate the ‘=name {donation {!-1}}’ 4393 FIG. 43D or ‘=SUB (name, donor_num {donation {!-1}})’ 4383 FIG. 43C value ‘Sally Johnson’ 4382 FIG. 43C/4392 FIG. 43D. Step ‘1)’ in FIG. 44A retrieves the joined data while step ‘2)’ sorts the data from largest to smallest ‘donation’ before step ‘3)’ returns the ‘name’ of ‘Sally Johnson” for the largest donation to cell ‘A1’. FIG. 44B examples the same steps but instead using the using the ‘Inner Join’ data 4166 from FIG. 41 to do the same three steps. In this example that does not give a different answer, but it could have, and it would have if the user asked for the donor giving the smallest donation.

### Unique to Non-Unique Joinable Addition

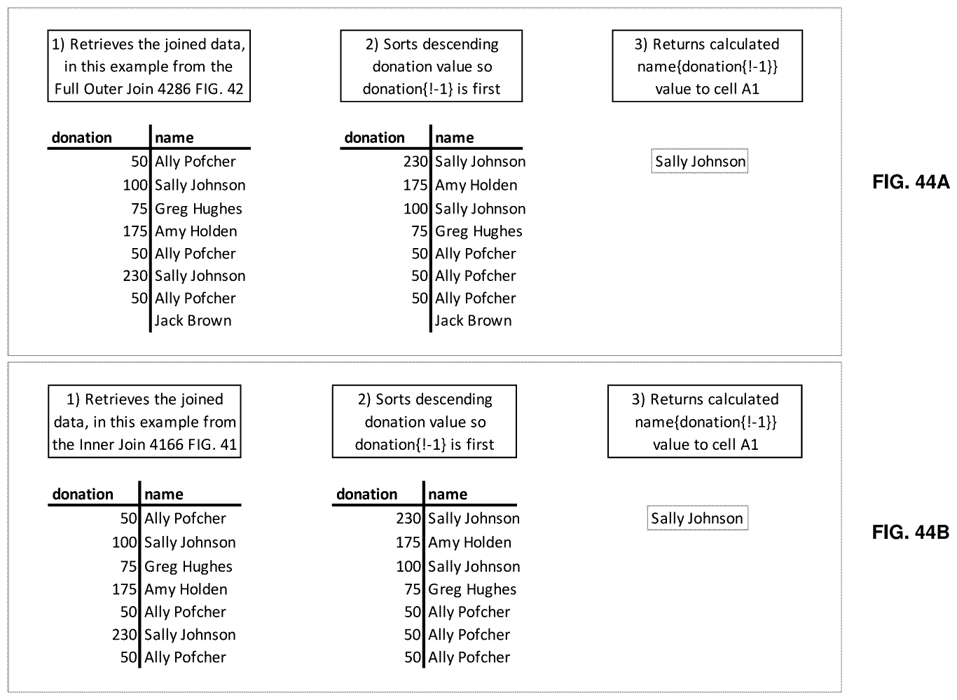

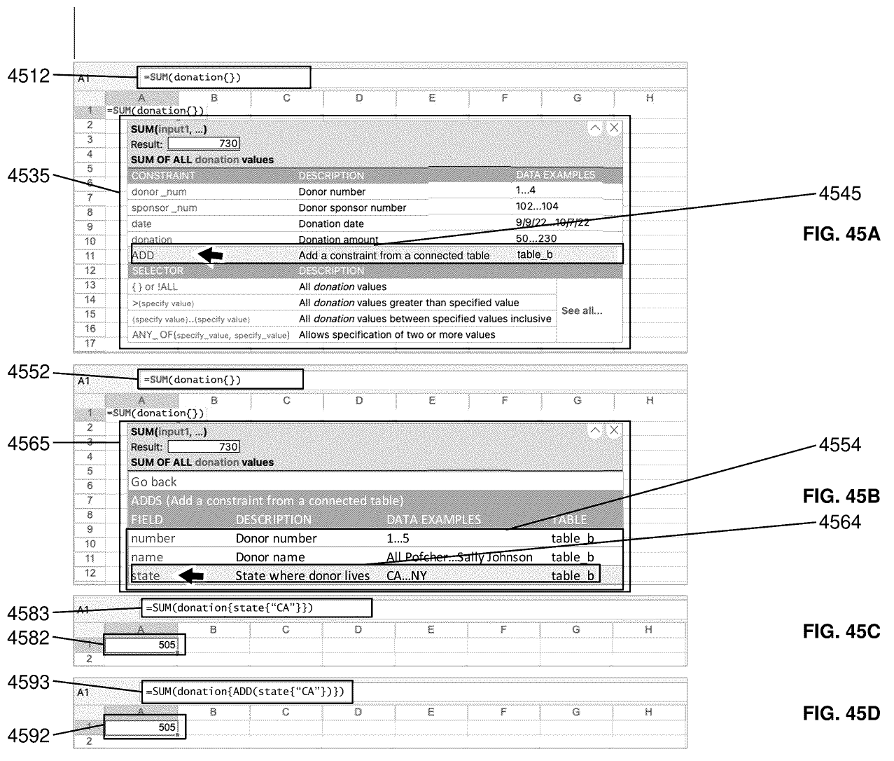

FIG. 45A through FIG. 46 examples unique to non-unique join data modelling cardinality addition selection lists (hints) and data joins/calculations in a prebuilt function spreadsheet formula (SUM). The charity user wants to total the donations from the state of California but to do so will need to use data from both ‘table_a’ 4133/4233 and ‘table_b’ 4138/4238 in FIG. 41 and FIG. 42, respectively. The user starts the formula as they normally would but the difference, as before with unique-to-unique qualified joinable data sets, is our joining technology presents the ‘ADD’ 4545 constraint to the selectable list (hint) 4535 for the formula 4512 in FIG. 45A. Our technology knows, via a qualified join flag, that ‘donation’ has joinable fields from another table and therefore adds the ‘ADD’ 4545 line. Not seeing the state constraint as an option in the hint 4535, the user clicks the ‘ADD’ line 4545 to automatically get the new ‘ADD’ selectable list 4565 in FIG. 45B. The formula 4552 is yet unchanged but the user has been given a set of three joinable fields 4554 within which the user sees the one they want, ‘state’. They select (click) ‘state’ 4564 and then select (or type) ‘“CA”’ and hit ENTER/RETURN to complete the formula as shown in FIG. 45C or FIG. 45D. FIG. 45C examples an embodiment where the added joined field ‘state’ goes into the formula 4583 to give the value ‘505’ in the cell ‘A1’ 4582. FIG. 45D examples another embodiment where the added join field ‘state’ is done via a function, in this example the ‘ADD’ function, in the formula 4593 to give the value ‘505’ in the cell ‘A1’ 4592. In both FIG. 45C and FIG. 45D the formula executes in our application along the lines illustrated in FIG. 46. Those illustrative steps start with the full outer join being done as exampled in 4286 in FIG. 42 and then joined data retrieval in step ‘1)’ in FIG. 46. In step ‘2)’ the joined data is filtered to only include the rows for ‘state’ ‘CA’. Step ‘3)’ then sums those values and that summation and the formula are returned to cell ‘A1’ in step ‘4)’. As previously stated, and assumed for all the following examples those steps are shown to illustrate what is done not to exactly duplicate how our application arrives at the same value.

### Unique to Non-Unique Multiple Joined Field Usage

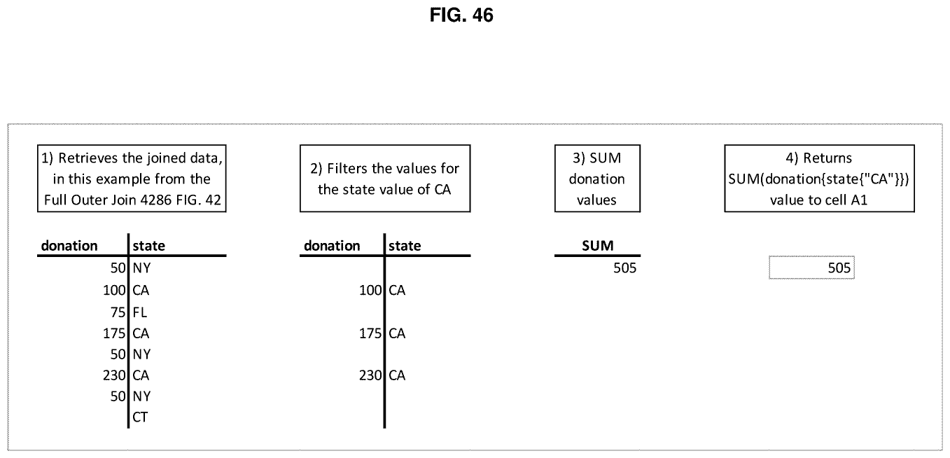

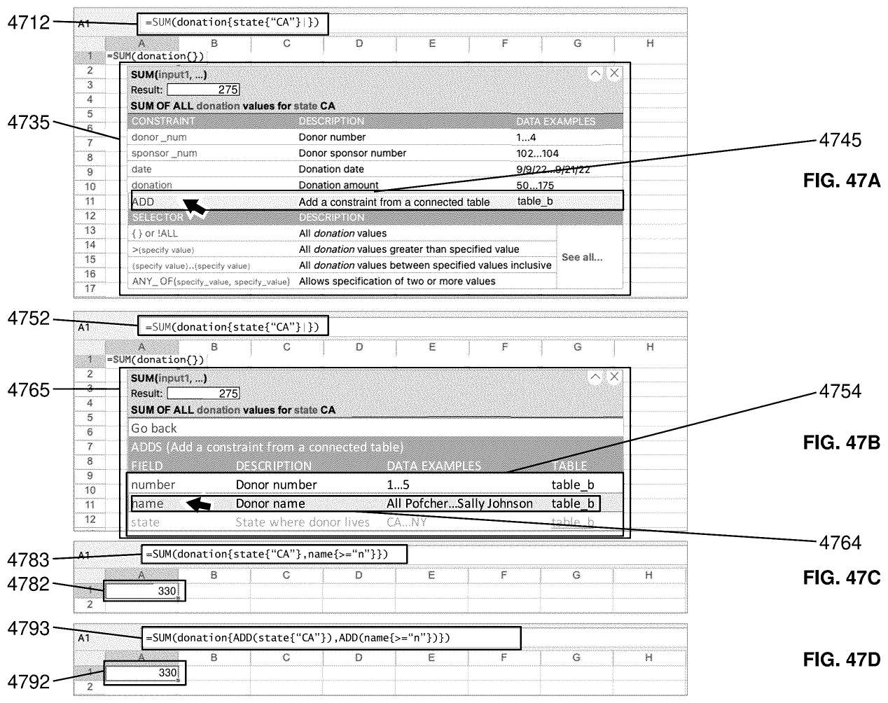

FIG. 47A through FIG. 48 examples multiple use of our joinable data technology in a summation formula (prebuilt SUM) picking up where the previous example in FIG. 45A through FIG. 46 left off adding a second joined data field constraint. In FIG. 47A the user is in the donation field just before the closing curly bracket within the formula 4712 and therefore gets a selectable list (hint) 4735 showing their in-table constraint options and the ‘ADD’ line 4745 (of joinable table fields) which they select. The user is then given in FIG. 47B a new selectable list 4765 with the joinable data fields they can add 4754 (with ‘state’ grayed out/disabled in this embodiment because it was already used) despite the spreadsheet cell formula 4752 having not changed. Given the user wants to further constrain the donations to people in the back half of the alphabet (i.e., ‘name’ ‘>=“n”’) they click the ‘name’ line 4764 and then add the constraint of ‘>=“n”’ to it before hitting ENTER/RETURN to get the outcome in FIG. 47C or FIG. 47D. FIG. 47C examples an embodiment where the added joined field ‘name {>=“n”}’ goes into the formula 4783 to be used in the cell formula calculation to give the value ‘330’ in the cell ‘A1’ 4782. FIG. 47D examples another embodiment where the added join field ‘name {>=“n”}’ is done via a function, in this example ‘ADD’, in the formula 4793 to be used in the cell formula calculation to give the value ‘330’ in the cell ‘A1’ 4792. In both FIG. 47C and FIG. 47D the formula executes in our application steps along the lines illustrated in FIG. 48. Those illustrative steps start with the full outer join being done as exampled in 4286 in FIG. 42 and then data retrieval in step ‘1)’ in FIG. 48. In step ‘2)’ the joined data is filtered to only include the rows for ‘state’ ‘CA’. In step ‘3)’ the joined data is further filtered to include only include the rows for ‘name’ “>=” n″ ‘(starting in the last half of the alphabet). Step ‘4)’ then sums that value and that summation calculated value and the formula are returned to cell ‘A1’ in step ‘5)’.

As previously mentioned, our spreadsheet formula joinable data technology supports use in the full spectrum of prebuilt functions in existing spreadsheets which employ data for calculations, whether the joins are unique-to-unique, unique to non-unique (“many”), or non-unique to unique. It also supports new prebuilt functions supported by our technology, such as the new functions which were the subject of our U.S. application Ser. No. 17/359,418, titled “Methods and Systems for Presenting Drop-Down, Pop-Up or Other Presentation of a Multi-Value Data Set in a Spreadsheet Cell,” as was previously exampled. Rather than exampling a broader set of the prebuilt functions, whether existing or new, that populate a single cell we will example using our join technology in a multiple cell populating function that also employs other functions within it.

### Unique to Non-Unique Joinable Data Use in Multi-Cell Output Functions

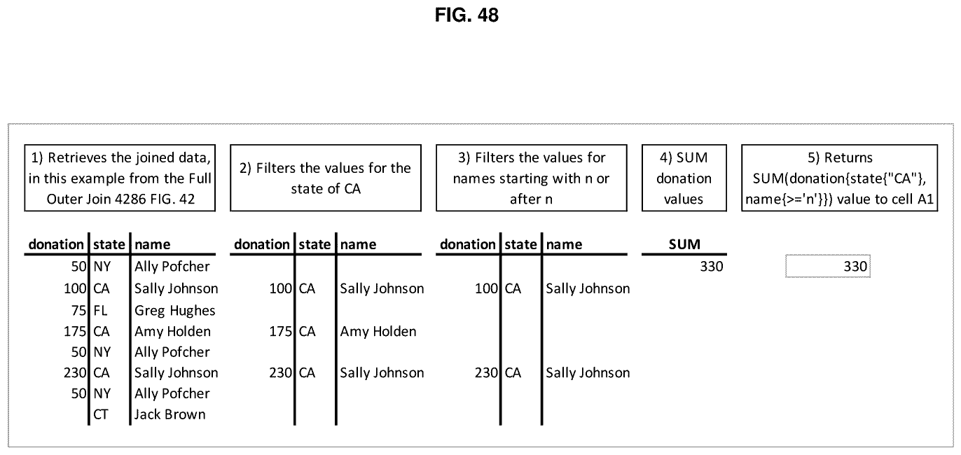

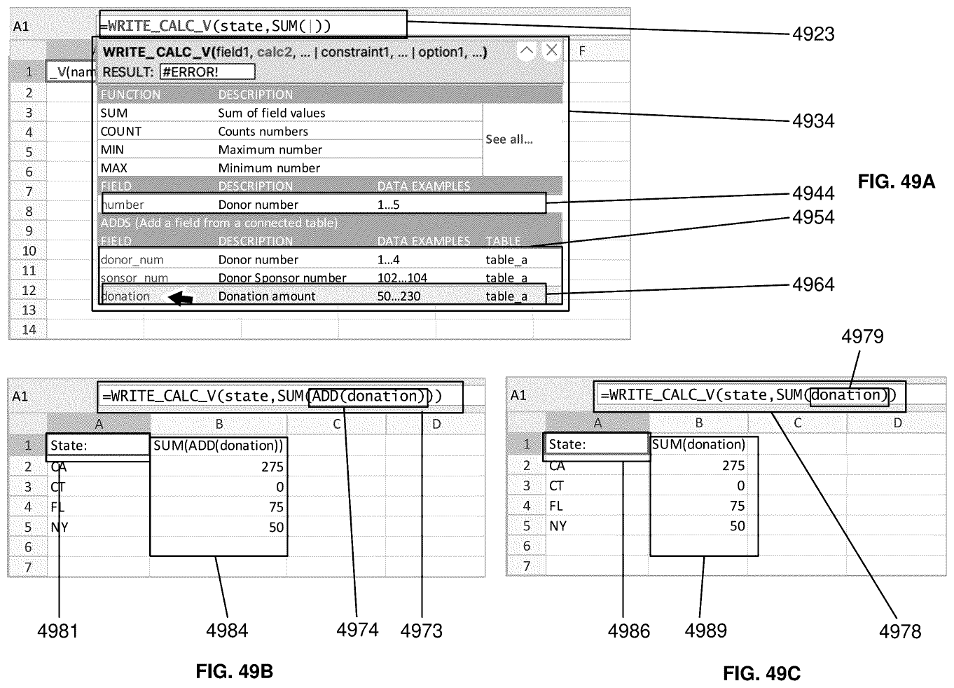

As previously mentioned, our joinable data technology is also applicable to prebuilt functions that populate more than one cell, such as those in U.S. application Ser. No. 16/191,402, titled, “Methods and Systems for Connecting A Spreadsheet to External Data Sources with Ordered Formulaic Specification of Data Retrieved,”, now U.S. Pat. No. 11,036,929, issued 15 Jun. 2021, U.S. application Ser. No. 17/374,901, titled “Method and System for Improved Ordering of Output from Spreadsheet Analytical Functions,”, and U.S. application Ser. No. 17/903,934 titled “Method and System for Improved 2d Ordering of Output from Spreadsheet Analytical Functions,”. FIG. 49A through FIG. 52B examples multiple use (e.g., of ADD and SUB) of our joinable data fields in a multi-cell output prebuilt function (‘WRITE_CALC_V’) that employs other functions.

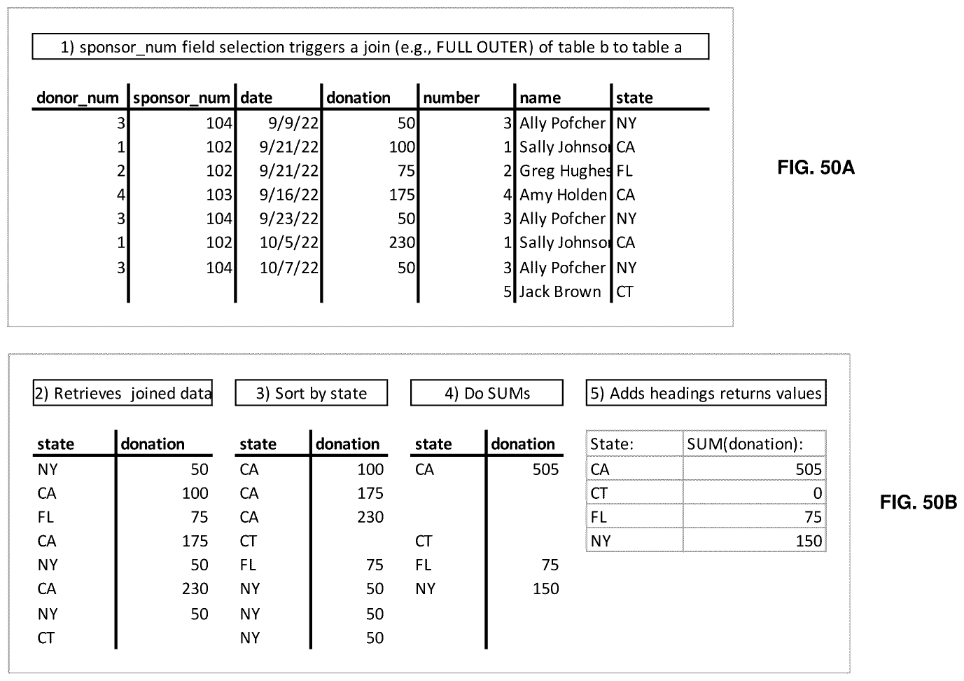

In FIG. 49A the charity user has again used on of our spreadsheets with the unique to non-unique (or vice a versa as implied in our usage of the term as our technology supports joins both directions) joined data sets ‘table_a’ 4043 and ‘table_b’ 4037, and the non-joined ‘table_x’ 4048 in FIG. 40A. This time they decided they would like to total the donations for each donor by their name realizing this will require joining data across two data tables. They begin the ‘WRITE_CALC’ formula 4923 with field ‘name’ and then type or click the ‘SUM function at which point they get the selection list 4934 which is what we have called a one-step hint showing the applicable fields 4944 in the table that contains the field ‘name’ and any applicable fields 4954 in tables joinable to the field ‘name’. In this example those are limited to numeric fields because of the SUM function limitation to work only for numeric fields. The user then sees the field that they want, ‘donation’ 4964, clicks it and hits ENTER/RETURN to get either of the outcomes in FIG. 49B or FIG. 49C, depending on embodiment. FIG. 49B examples an embodiment where the added join field ‘donation’ 4974 is done via a function, in this example ‘ADD’, in the formula 4973 in cell ‘A1’ 4981 where the “WRITE_CALC_V’ function argument ‘SUM (ADD (donation))’ populates the values in cells ‘B1’ through ‘B6’ 4984. FIG. 49C examples another embodiment where the added joined field ‘donation’ 4979 goes into the formula 4978 in cell ‘A1’ 4986 by itself where the “WRITE_CALC_V’ function argument ‘SUM (donation)’ populates the values in cells ‘B1’ through ‘B6’ 4989. In both FIG. 49B and FIG. 49C the formula executes in our application illustrative steps along the lines shown in FIG. 50A and FIG. 50B. Those illustrative steps start in step ‘1)’ in FIG. 50A with the ‘FULL OUTER’ join of the two data tables (‘table_a’ 4043 and ‘table_b’ 4037 in FIG. 40A). Step ‘2)’ in FIG. 50B retrieves the ‘FULL OUTER’ joined data fields used in the formula and column sorts the data to match the argument order in the ‘WRITE_CALC_V’ formula. Step ‘3)’ in FIG. 50B row sorts by ‘state’ values in ascending order. Step ‘4)’ in FIG. 50B does the sums to which Step ‘5)’ in FIG. 50B adds the headings sends the values and the formula to cells ‘A1’ through ‘B6’ in FIG. 49C. The two differences in this example in FIG. 49B is the cell heading in ‘B1’ contains the ‘ADD’ function and the formula contains the ‘ADD’ function but otherwise the illustrative steps for creating the output in FIG. 49B are the same as in FIG. 50A and FIG. 50B.

### Joinable Data Used Multiple Times in a Formula

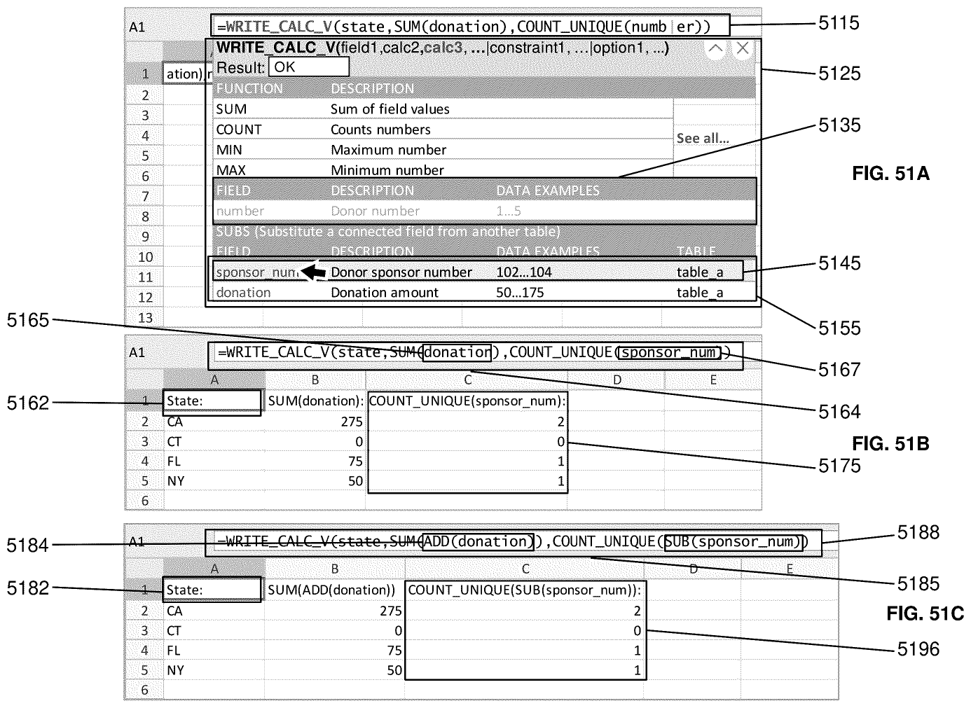

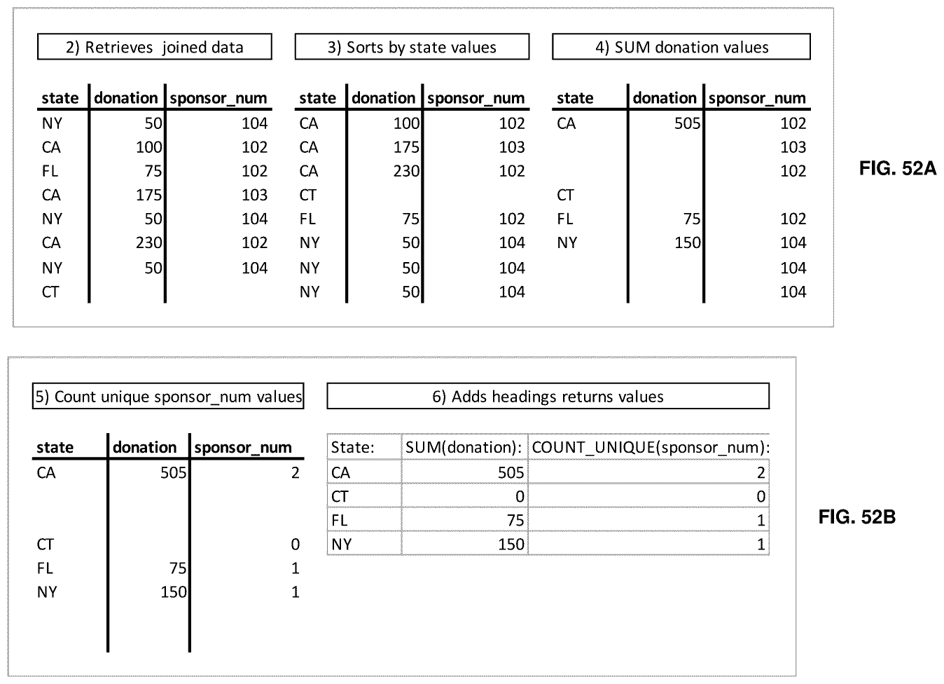

Our joinable data technology can be used multiple times and in multiple different ways in any applicable formula as exampled in FIG. 51A through FIG. 52C. For example, a user could do multiple additions of joined data fields within a single formula, could do multiple substitutions within a single formula, and could do singles or multiples of joined data additions (e.g., ‘ADD’) and substitutions (e.g., ‘SUB’) within a single formula. FIG. 51A through FIG. 52 examples the charity user doing one add and one substitution within a single formula, actually continuing on with the formula exampled in FIG. 49A through FIG. 50B.

In FIG. 51A the charity user continued on to the formula 4978 in FIG. 49C adding the field ‘number’ at which point they realized that they did not want the ‘Donor number’ but instead wanted that donor's ‘Donor sponsor number’. So, they moved the cursor back into the field ‘number’ in the formula 5115 to get the selection list (hint) 5125 which in this embodiment displays the replacement fields 5135 they can select in same table as ‘number’ and the replacement substitution fields 5155 they can select in joinable tables. Note: limited to numerical fields by the function ‘COUNT_UNIQUE’ which counts only numeric values. At that point they see and select the ‘sponsor_num’ field 5145 that they want and click it then hitting ENTER/RETURN to get either of the outcomes in FIG. 51B or FIG. 51C, depending on embodiment. FIG. 51B examples an embodiment where the substituted joined field ‘sponsor_num’ 5167 goes into the formula 5164 in cell ‘A1’ 5162 to replace field ‘number’ and is used in the formula calculations to populate the values in cells ‘C1’ through ‘C5’ 5175. At this point the user has two joined data fields 5165 and 5167 in the formula with one inputted by addition of the field and the other inputted by substituting it for a field. FIG. 51C examples another embodiment where the substituted join field ‘sponsor_num’ 5188 is done via a function, in this example ‘SUB’, in the formula 5185 in cell ‘A1’ 5182 which replaces the field ‘number’ and is used in the formula calculations to populate the values in cells ‘C1’ through ‘C5’ 5196. At this point the user has two joined data fields 5184 and 5188 (with accompanying functions ADD and SUB, respectively) in the formula with one inputted by addition of the field and the other inputted by substituting it for a field. In both FIG. 51B and FIG. 51C the respective formula executes in our application illustrative steps along the lines shown in FIG. 52A through FIG. 52C. Those illustrative steps start in step ‘1)’ in FIG. 50A with the ‘FULL OUTER’ join of the two data tables (‘table_a’ 4043 and ‘table_b’ 4037 in FIG. 40A). Step ‘2)’ in FIG. 52A retrieves the ‘FULL OUTER’ joined data fields used in the formula and column sorts the data the to match the argument order usage in the ‘WRITE_CALC’ formula. Step ‘3)’ in FIG. 52A row sorts the data as previously described in ascending order. Step ‘4)’ in FIG. 52A sums the donation values for each of the ‘state’ values. Step ‘5)’ in FIG. 52B counts the unique values of ‘sponsor_num’ for each state. Step ‘6)’ in FIG. 52B adds the headings, as previously described, and sends the values and the formula to cells ‘A1’ through ‘C5’ in either FIG. 51B or FIG. 51C. Note, FIG. 52C step ‘6)’ examples the headings for FIG. 52B while in the embodiment for FIG. 52C the headings would include the “ADD’ and “SUB’ functions as well, as exampled in FIG. 51C cells ‘B1’ and ‘C2’. As exampled previously a different embodiment of the formulas in FIG. 51C could eliminate those ‘ADD’ and ‘SUB’ functions in the ‘WRITE’ headings.

While we could continue to example multiple different joined data usage in different types of formulas (e.g., straight formulaic data formulas, function formulas, and functions within functions formulas) done with and without joining functions (e.g., ‘ADD’ and ‘SUB’), we instead will next example why in some situations, our technology blocks the usage of certain data modelling cardinality joins (e.g., non-unique to non-unique data table). Either blocking selection list inclusion and blocking formula usage by generating formula usage errors or just blocking selection list inclusion.

### Non-Unique to Non-Unique Joins Handling

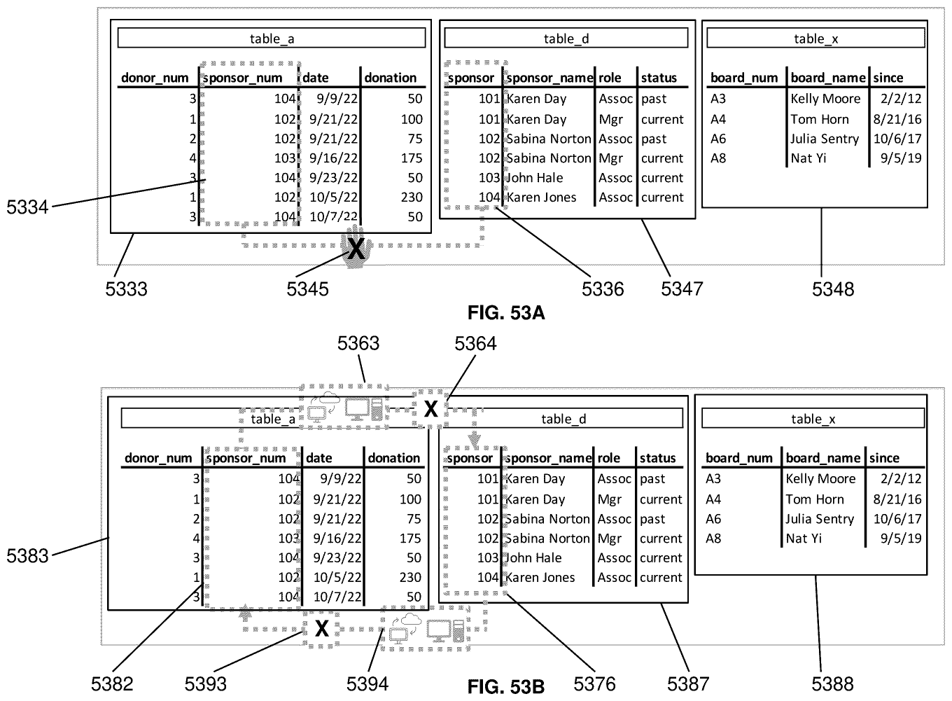

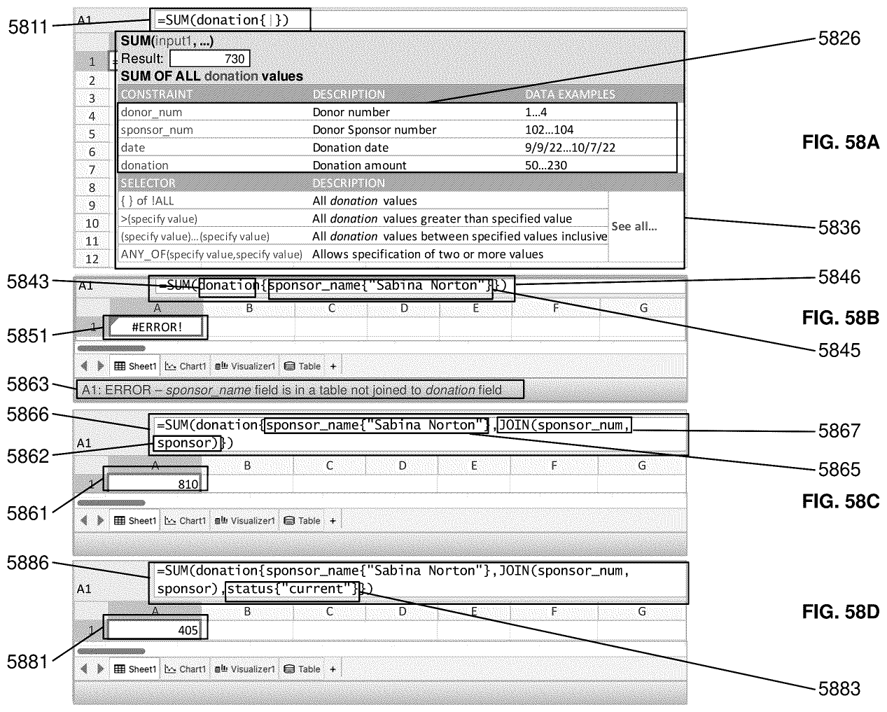

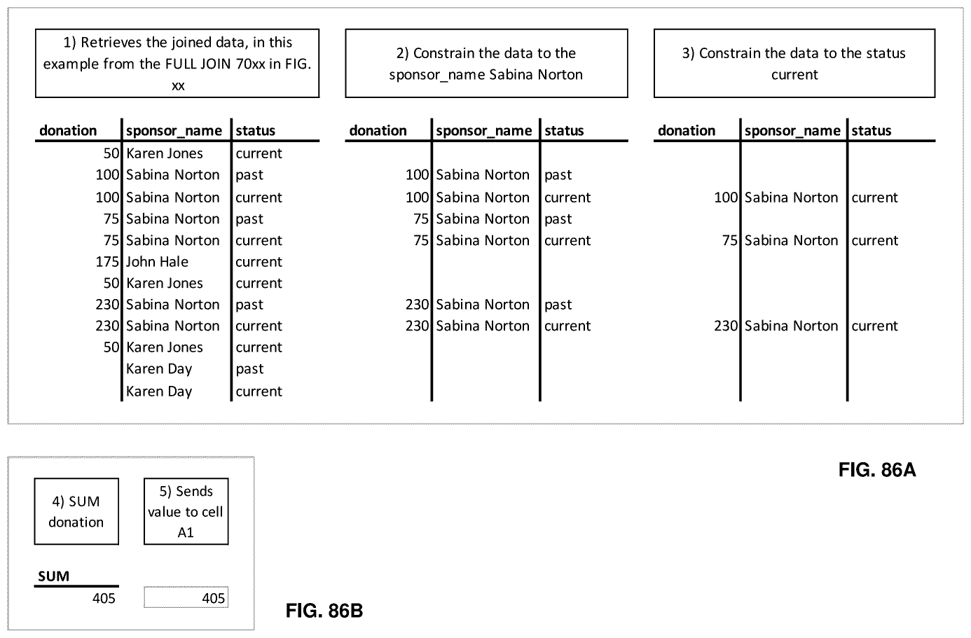

While “many” (non-unique) to “many” (non-unique) data table joins are supported in SQL they frequently generate results that require some expertise to deal with to not generate erroneous calculational answers. And therefore, many embodiments of our data joining technology do not present those options in our selectable lists (e.g., hints) and some generate an error should a user attempt usage in a formula. FIG. 53A and FIG. 53B example three data tables for potential joining. ‘table_a’ 5333 and ‘table_d’ 5347 example two data tables with potentially joinable data based on the key columns/fields of ‘sponsor_num’ 5334 and ‘sponsor’ 5336. However, neither of those data columns has unique (distinct) values and therefore when joined, as exampled using SQL in FIG. 6, do not append values from a “unique” table to rows in the “many” table. Instead, because there is no “unique” data table key, i.e., both are “many” data table keys, the result is a limited (partial) Cartesian Product of the table rows. That partial Cartesian Product in this example duplicates the rows 626/635/646 in ‘table_a’ 636 to deliver the duplicated rows 676/686/696 for the joined data 688 in FIG. 6. Thus, having doubled some of the ‘donor_num’, ‘sponsor_num’, ‘date’ and ‘donation’ rows (as shown in 676/686/696 versus 626/635/646 in FIG. 6). This results in any count (e.g., COUNT, COUNT_TEXT, and COUNT_DATE) of those fields in the joined data not arriving at the correct original table 636 totals. It also means a sum of the field ‘donation’ 687 using the joined data 688 will not arrive at the correct total for donations (because of the duplicated values). For those reasons many embodiments of our technology do not present those options, as exampled in FIG. 53A through FIG. 57, in our joinable data selectable lists (e.g., hints) and some options generate an error should a user attempt usage in a formula, as exampled in FIG. 58A and FIG. 58B. That said, a sophisticated user can navigate the data challenges presented by these joins and therefore embodiments of our technology support using these joins as exampled in FIG. 58D and FIG. 86A/FIG. 86B.

FIG. 53B examples the same set of validation rules as FIG. 53A executed by an automated join validation external to the spreadsheet or internal to the spreadsheet data intake tool. That tool starts with the same three data sets in FIG. 53A/FIG. 53B ‘table_a’ 5333/5383, ‘table_d’ 5347/5387 and ‘table_x’ 5348/5388 and attempts to find join keys that fulfil the data type, data values and cardinality constraints (no non-unique to non-unique joins). The closest it comes is the ‘sponsor_num’ 5382 to ‘sponsor’ 5376 keys which pass the data type and data values requirements but fail 5364/5394 because they are non-unique to non-unique. Thus, this automated validation 5363/5393 does not generate any joins between the three tables, recognizing that other embodiments could eliminate the cardinality constraint therefore finding at least one join.

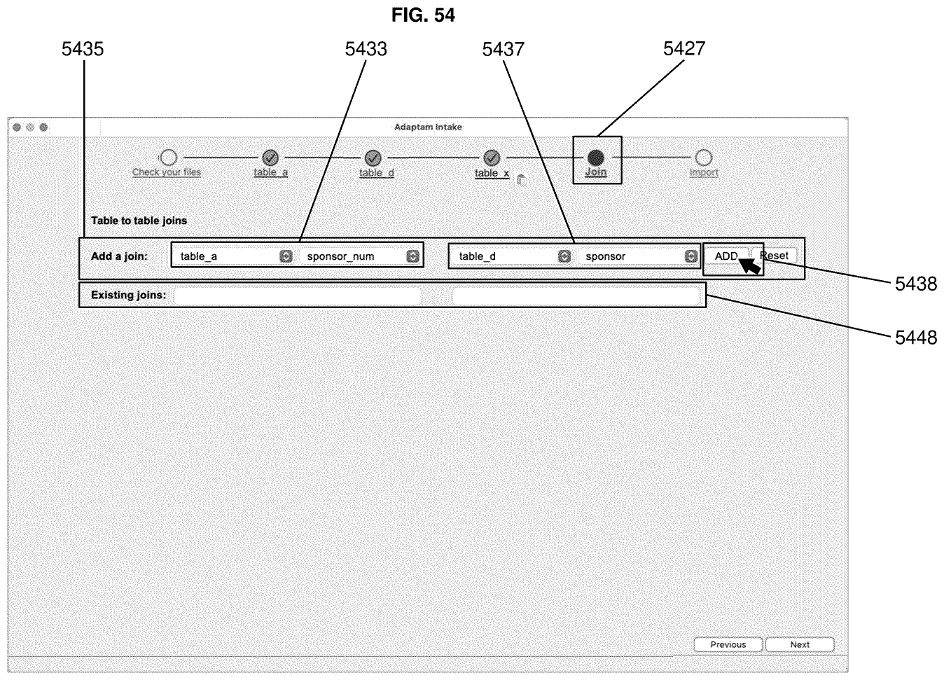

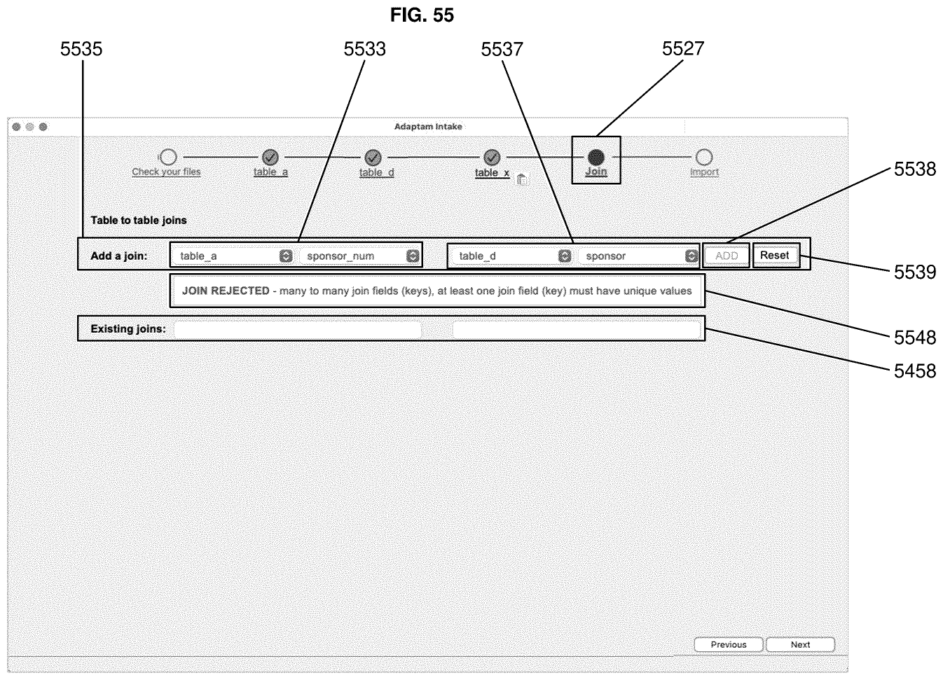

FIG. 54 and FIG. 55 example one of the ways our technology pre-emptively blocks the presentation and/or usage of joins as pictorially exampled in the ‘X” 5345 in FIG. 53A. FIG. 54 examples the charity user manually attempting to set up a ‘table_a’ (5333 in FIG. 53A) to ‘table_d’ (5347 in FIG. 53A) join via the table/join keys ‘sponsor_num’ 5433 and ‘sponsor’ 5437 in FIG. 54. In this embodiment the user does it by specifying an ‘Add a join;’ 5435 and then clicking the ‘ADD’ button 5438. They then expect the join to be added to the ‘Existing joins:’ 5448. All this is being done in the data setup tool UI 5427 within our spreadsheet or one that separately works to specify the data used by our spreadsheet. However, our technology then qualification validates the acceptability of that user specified join (e.g., data type compatibility, data value matching, and data modelling cardinality acceptability as exampled in FIG. 4). FIG. 55 then examples our technology rejecting this join because the key relationship is unacceptable in this embodiment-because it is not a “unique” to “unique” key join or a “unique” to “non-unique” (many) key join. Instead, being a “non-unique” to “non-unique” key join it is rejected in this embodiment to protect the unsophisticated users inadvertently using it without understanding how it changes the joined data (e.g., partial Cartesian Product). This embodiment shows the user a ‘JOIN REJECTED’ message 5548 and gives the user the option to alter one or both of the tables and join keys 5533/5537 or ‘Reset’ 5539 the ‘Add Join:’ 5535. The ‘ADD’ 5538 join button is disabled and the join was not added to the ‘Existing joins:’ 5458. It has exampled a UI for the FIG. 8 pathway ‘a/c/d/h’. The validation checks used for the rejection could be any of FIG. 4 paths ‘C’, ‘D’, or ‘D’, as this example fails on the many to many data modelling cardinality test in step ‘4)’. As we will later example this rejection of the join may be for the selection list but not a manually specified in-cell formula or it could be for both the selection list and the in-cell formula.

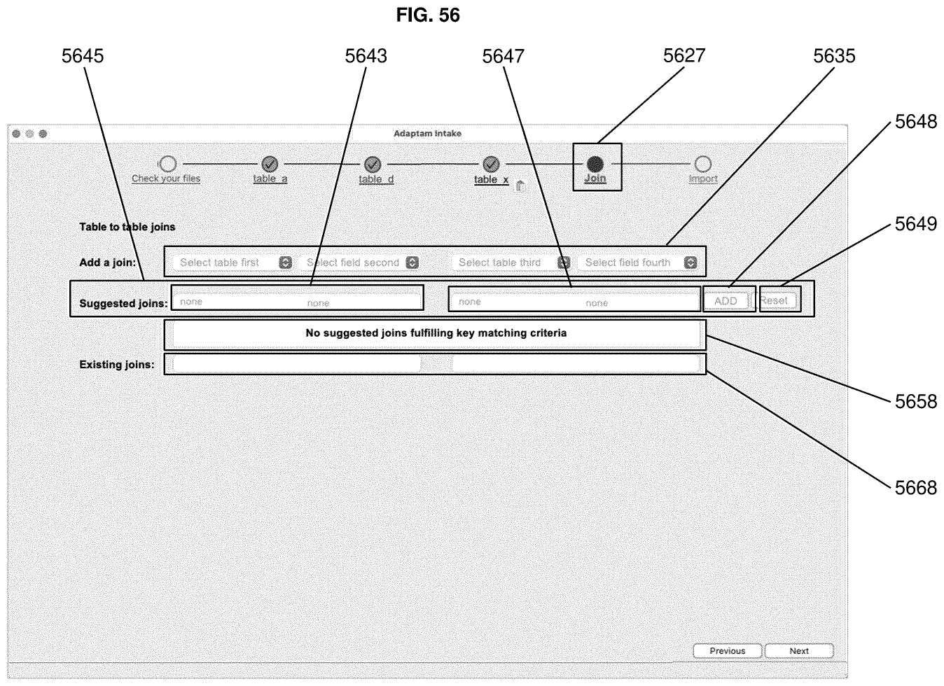

FIG. 56 illustratively examples in a UI the automated rejection of the joinability of three tables 5333/5347/5348 in FIG. 53A as was pictorially exampled in FIG. 53B with the ‘X’ 5393. The UI examples a combination of the paths in FIG. 8 with the ‘Suggested joins:’ 5645 exampling path ‘a/c/f/h’ where our application suggests joins the user can then accept or reject. The input above it ‘Add a join:’ 5635 allows a user to input a join of their own which if not validated is the FIG. 8 ‘a/b/h’ pathway and if validated is the ‘a/c/d/h’ pathway.

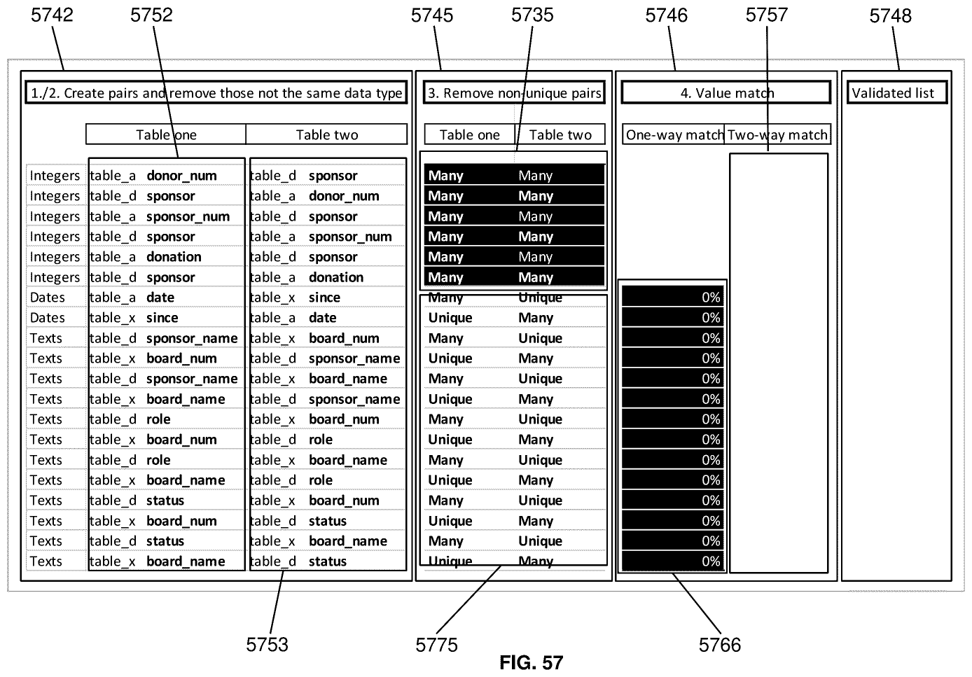

FIG. 57 examples the FIG. 4 ‘E’ pathway validation of every possible join key combination for data sets ‘table_a’ (5333 in FIG. 53A), ‘table_d’ (5347 in FIG. 53A) and ‘table_x’ (5348 in FIG. 53A). For brevity purposes the FIG. 4 step ‘1.’ and step ‘2.’ actions have been combined 5742 in FIG. 57 illustrating the reduction of all the cross table potential key pairs (fields/columns) 5752/5753 to only those that share the same data type. Step three 5745 in FIG. 57 then does step ‘4.’ of in FIG. 4. In this situation changing the order because that is the more efficient way of doing the elimination and acknowledging that the order of the validations can be changed for efficiency/speed of doing them. This eliminates the “many” (non-unique) to “many” (non-unique) combinations 5735 leaving only those that are “unique” to “unique” or “many” to “unique” 5775. Step four 5746 in FIG. 57 examples a combination of steps ‘3’ and ‘3a’ in FIG. 4 value matching validation which ensures that the keys share values across keys. In this example all the potential pairs fail on the simplest one-way match that determines whether they share the same values. The failure is exampled by the black fill and results from the ‘0%’ match percentage for all the remaining pairs 5766. In some embodiments a match percentage of specified value (e.g., 60%) on either of the one-way matches would be sufficient to pass to the validated list 5748. In other embodiments, as will be exampled later, the step four ‘Value match’ requires not only passing the one-way match but the two-way match which has a criteria looking at both of the one-way values (e.g., a one-way match pair of 95% and 1% resulting in a rejection of the join). Note, the steps outlined and exampled are illustrative of what our technology is doing as how the code achieves the same result may vary for speed of computing reasons. So, in this example there are no automated join 5748 suggestions (‘Validated list’ values) as exampled in message in FIG. 56 5658 and the empty ‘Suggested joins:’ 5645 5643/5647 with the ‘ADD’ 5648 and ‘Reset’ 5649 buttons inactive. In the partially automated or totally automated join versions of our technology the user would see no joins in the lack of any join field options (direct listings or via an ‘ADD’ or similar) selection list option (e.g., in a hint as exampled in FIG. 58A 5836 which has no ADD line or joined fields) and/or in the inability to write a formula without an error when using a join field (as exampled in FIG. 58B).

FIG. 58A and FIG. 58B example the no joinable data from the tables in FIG. 53A through FIG. 53B in the selection lists and the no joinable use in a cell formula (resulting in an error), respectively. When the charity user gets the selection list for the formula ‘=SUM (donation { })’ 5811 in FIG. 58A, that selection list (e.g., hint) 5836 displays no join field/column options (e.g., an ‘ADD’ selection or other table fields/columns) but just the fields/columns 5826 in the same data set as the field ‘donation’. And should the user then type another table field/column like ‘sponsor_name {“Sabina Norton”}’ 5845 into the formula 5846 as shown in FIG. 58B and hit ENTER/RETURN in this embodiment the result is an error message 5851 evaluated in the cell ‘A1’ with more detail on the error 5863 in what we call the status bar at the bottom of the spreadsheet. This is because the field ‘donation’ 5843 is in a data set that for this embodiment is not joinable to the data set containing the field/column ‘sponsor_name’ 5845. That lack of joinability owing to the inability in this embodiment to join many to many (non-unique to non-unique) join key cardinality relationships.

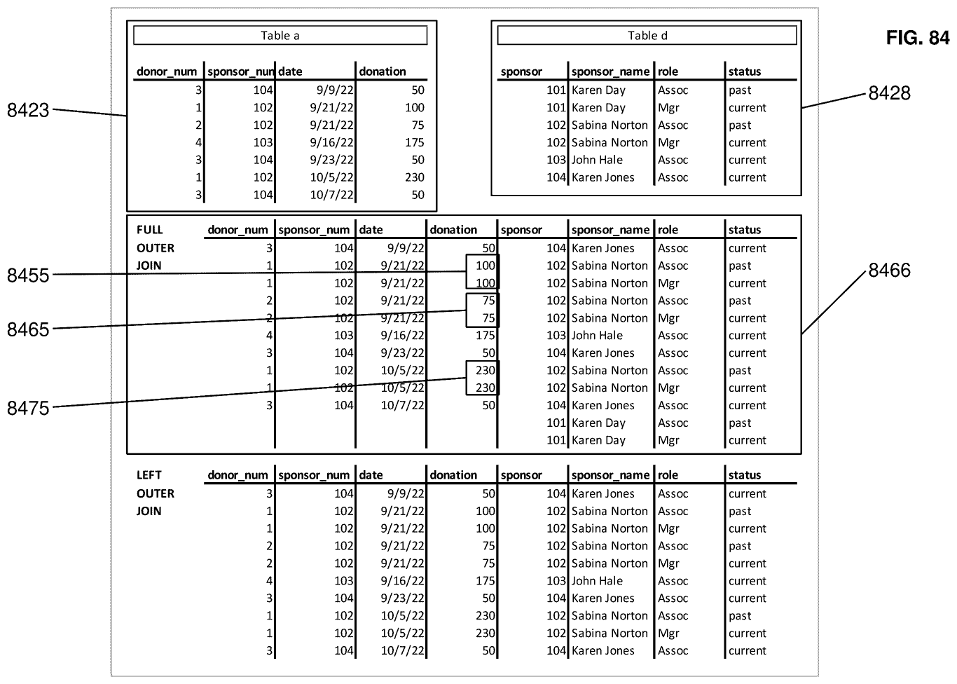

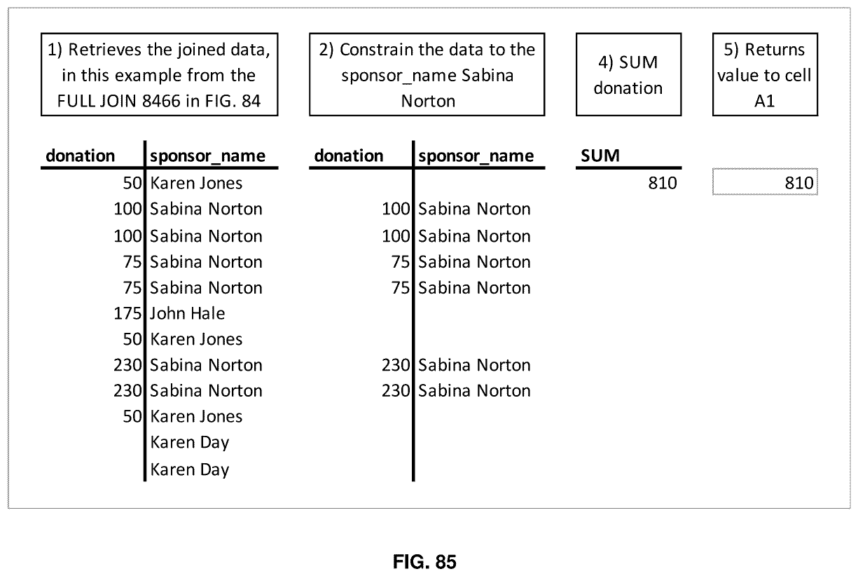

FIG. 58C and FIG. 58D example a different embodiment where ‘non-unique to non-unique (“many to many”) joins are blocked in the selection list, as shown in FIG. 58A, but work if inputted into the cell formula. In this embodiment this is done by adding the ‘JOIN (sponsor_num,sponsor)’ argument 5867/5862 in the formula 5866 which tells our application to use a full outer join by the use of ‘JOIN’ and then within the parentheses specify the two join keys in this example ‘sponsor_num’ 5867 and ‘sponsor’ 5862. This allows our application to know what tables (data sets) to join as the fields are specific to tables. In this embodiment ‘JOIN’ is a full outer join, ‘JOIN_LEFT’ is a left outer join, ‘JOIN_RIGHT’ is a right outer join, ‘JOIN_INNER’ is an inner join, ‘JOIN_CROSS’ is a cross join, and ‘JOIN_SELF’ is a self-join. However, FIG. 58C examples the risk of letting unsophisticated users use these capabilities as the sum of the donation values for the ‘sponsor_name {“Sabina Norton”} 5865 of ‘810’ delivered in cell ‘A1’ 5861 by the formula 5866 is greater than the total amount of donations in the data. The problem is the partial Cartesian Product produced by the full outer joins, exampled in FIG. 84 8466 (joining data from ‘Table a’ 8423 and ‘Table b’ 8428), results in the duplication of the donations for ‘Sabina Norton’ 8455/8465/8475. This when carried through the calculations done by our system in FIG. 85 results in doubling the donations by ‘Sabrina Norton’. A more sophisticated user with a better understanding of the data and the join keys could realize this problem and eliminate it as done in formula 5886 in FIG. 58D. By specifying ‘status {“current”}’ 5883 as a constraint or filter the more sophisticated user has removed the source of the partial Cartesian Product from the formula and therefore removes the duplication of the donations by ‘Sabina Norton’ in the calculation, as exampled in FIG. 86A step three to arrive at the correct ‘donation’ of ‘405’ in step five that then is sent to cell ‘A1’ 5881 in FIG. 58D. Other than the constraint/filter argument ‘status {“current”}’ 5883 the formula 5886 in FIG. 58D is identical to the formula 5866 in FIG. 58C. Exampling the potential value of blocking ‘many to many’ joins from the typical user but providing the capability to the more sophisticated user so that they can exploit its power. We have given the more sophisticated user an in-cell formula ability to do any type of join while protecting the user that does not understand data joining from making mistakes due to more complicated joins that they do not understand.

While we could do further examples of join key determinations (e.g., different paths in FIG. 8) and different levels of qualification key validation (e.g., different paths in FIG. 4) we will instead move to a different join situation between two tables, namely multiple joins between the same two tables.

### Multiple Same Two Tables Join Key Pairs

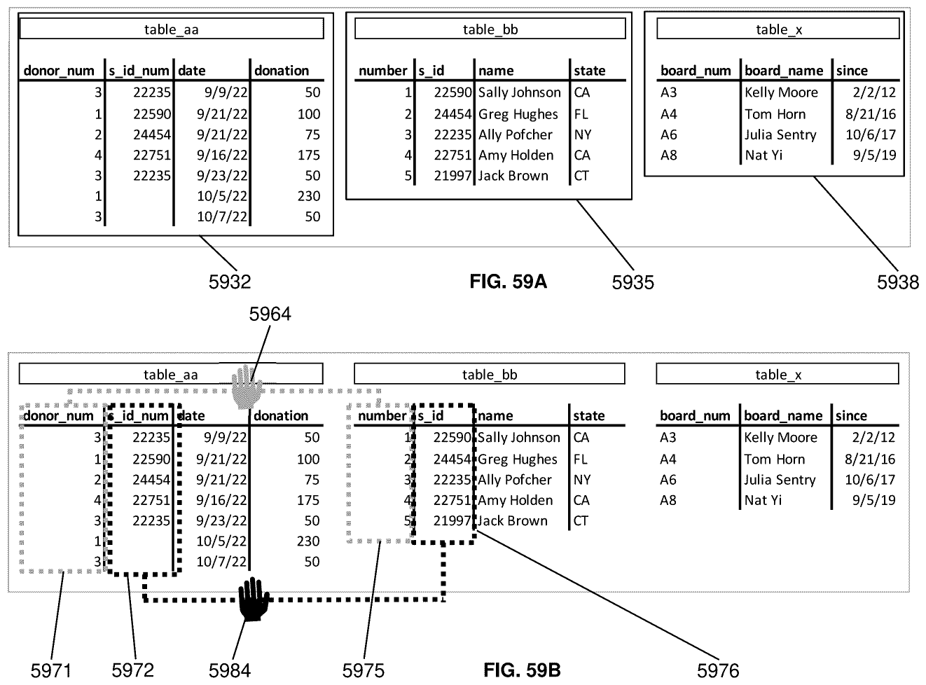

Our technology works for multiple potential join key pairs between the same two tables in more than way. We will first example how it works for different alternative join key pairs between the two tables, where typically the user will select one or the other as exampled in FIG. 59A through FIG. 69D. Then we will example another way that works in our technology where the multiple joins work simultaneously, typically to do multiple lookup joins across the two tables.

### Alternative Join Key Pairs

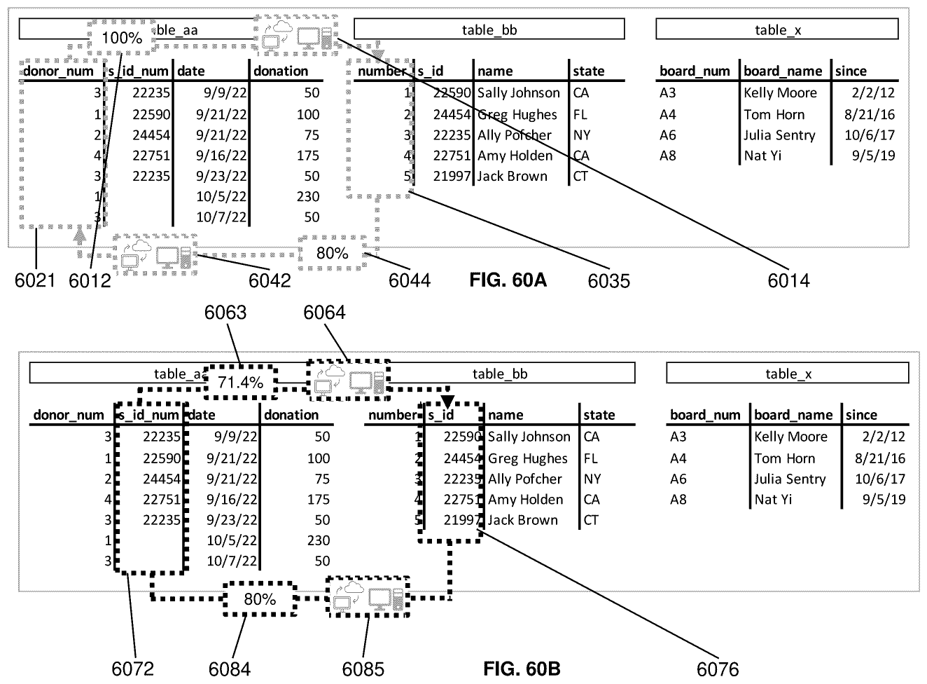

FIG. 59A examples three data sets ‘table_aa’ 5932, ‘table_bb’ 5935, and ‘table_x’ 5938. Data sets ‘table_aa’ 5932 and ‘table_bb’ 5935 have two potential pairs of join keys 5971/5975 and 5972/5976 which are manually specified by the user 5964/5984 as exampled in FIG. 59B. That manual specification could then be verified by our technology in some embodiments along the lines previously discussed. FIG. 60A and FIG. 60B illustratively examples those two joins being automatically generated and validated (6042/6014 and 6064/6085) on the user's computer, in the cloud or some combination of the two. The data types are the same for each join key pair (6021/6035 and 6072/6076), one of each join key pair is unique, and the values matches are all ‘71.4%’ or higher (as shown in 6012/6044/6063/6084), thus passing the one-way and two-way match requirements set for this embodiment (e.g., 65%). Those setup and validation actions could be done using any of the previously exampled appropriate UIs. However, when there are multiple join key pairs passing validation which do not share any fields/columns in their join keys, we label those as alternative joins or alternative join key pairs because this embodiment requires alternative one join key pair is set as the default used pair and the other is an alternative which can be alternatively selected. Thus, there is an additional automated or manual step to select the default join key pair used by the spreadsheet cell formula provided no override of it is specified. Numerous automated rule sets can be used to determine the default join key pair, e.g., the highest two-way match, the highest one-way match, the more joined rows, or a combination rules. Of course, the default join key pair could be set by the user in a manual mode or overriding an automated suggestion or setting.

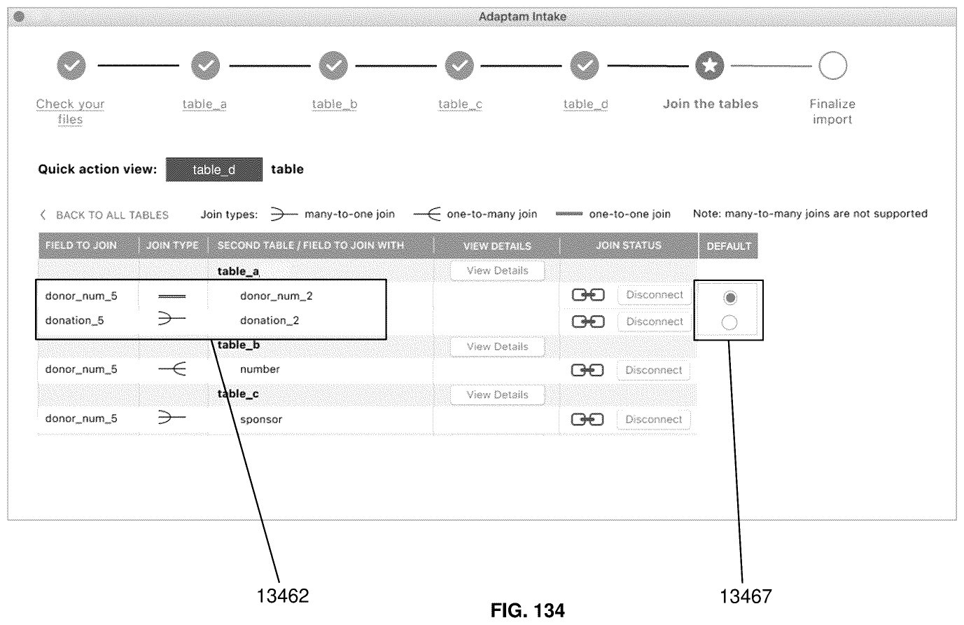

FIG. 134 examples a potential UI users can employ to see which tables have alternative joins, their join keys and the default pair as well as change the default join key pair. Both joins share no fields/columns 13462 fulfilling the requirement for being an alternative join. They are both qualified as joinable, and one has been set as the ‘DEFAULT’ with a radio button 134467 allowing the user to change that selection. This examples two alternative joins however our technology supports any number of alternative joins.

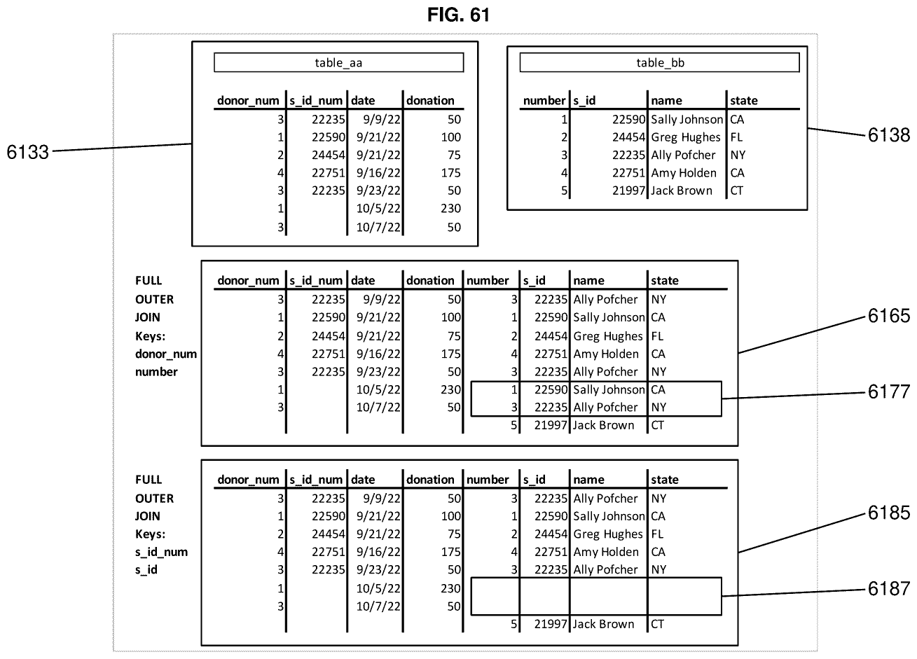

FIG. 61 examples the potential importance of the join key pair default selection given its potential differences in completeness, e.g., the join in 6165 filling two more rows (6177 versus 6187) than the join in 6185 when each was joined with full outer joins of the two tables 6133 and 6138. Although in other situations it may not be clear cut on which join to use and if the joins were on different types of ids, then it makes total sense that each would make sense for different analyses. With that in mind, we will example different embodiments with and without default join key pairing. We will take the same situation and example it with different embodiments ranging from an embodiment where both the type of join and the alternative join key pair selection has a default, to a situation at the other end of the spectrum with no defaults, where the user manually selects/types the join type and alternative join key pair.

### Alternative Joins—Default Join Type and Default Join Key Pair

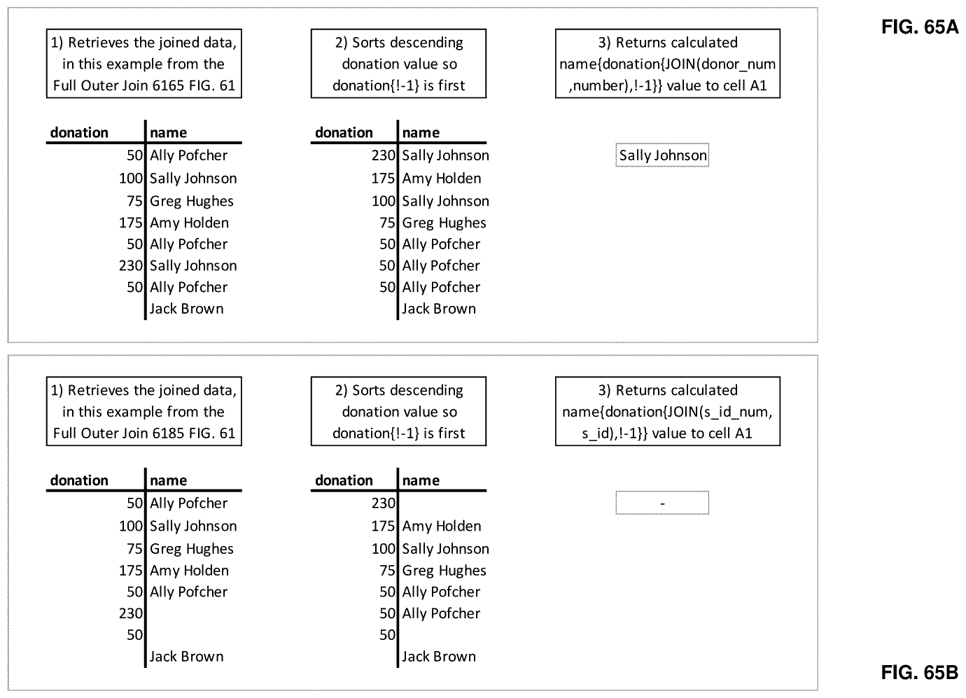

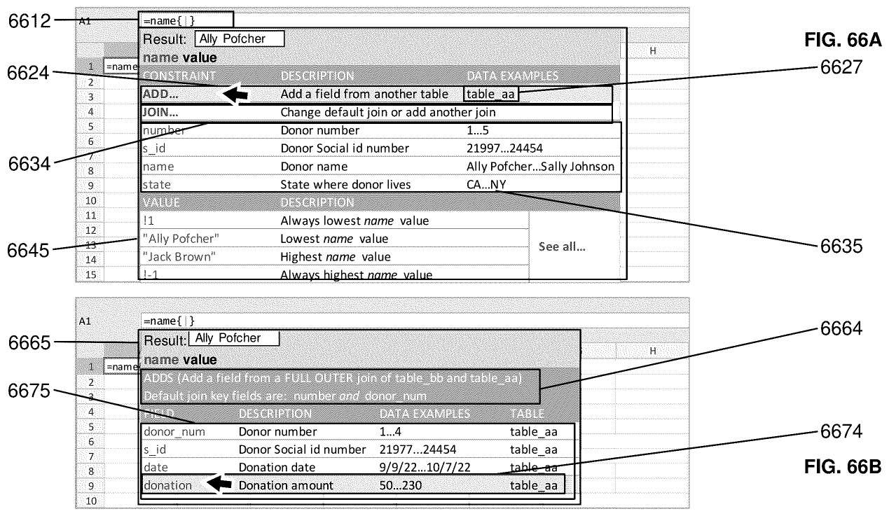

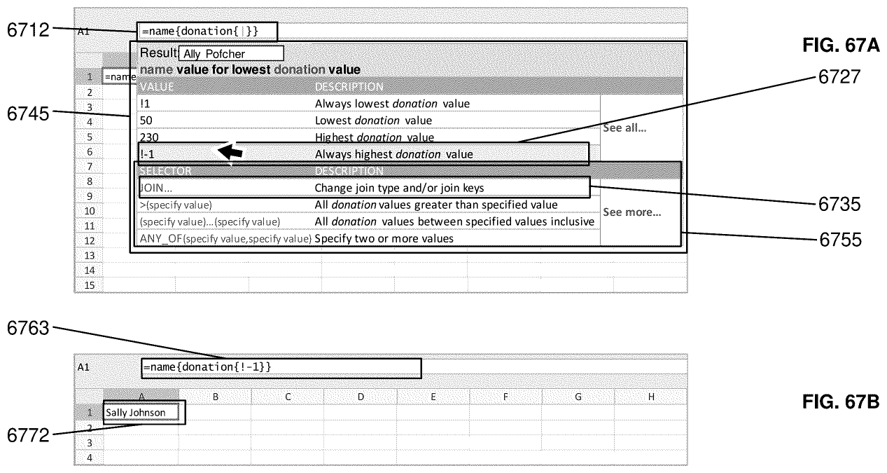

FIG. 66A, through FIG. 67B examples in-cell selection list and formula use of the default alternative join in our technology. FIG. 66A examples the charity user wanting to determine the ‘name’ of the donor who made the largest ‘donation’. This embodiment has a default join type and alternative join key pair where both are not shown in the formula until a point in time when some change is made to the default join type (e.g., inner, outer, or left outer) or the join key pair selection. In other related embodiments the default join and alternative join key pair could be automatically populated in the cell formula and therefore be visible as the formula is created.

The user starts creating the formula by typing or specifying from a hint ‘=name { }’ 6612 at which point they get the selection list (e.g., hint) 6645 and when they don't see a field with the donation values, they click the ‘ADD’ row 6624 where they see they will be able to add fields from ‘table_aa’ 6627. This opens a new popup selection list 6665 in FIG. 66B with the four ‘ADDS’ fields 6675 where they see the field they want ‘donation’ and clicks its row 6674. Note: the selection list 6665 also told the user that the join was a ‘FULL OUTER join of table_bb and table_aa’ and that the ‘Default join key fields are” number and donor_num’ 6664. Therefore, if the user wanted to alter that they could go back to the previous selection list, 6645 in FIG. 66A and click the ‘JOIN. . . . Change default join or add another join’ line 6634 to access selection lists which would allow them to switch to an alternative pair of join keys for data sets ‘table_aa’ and ‘table_bb’, as we will example later.

Returning to the clicking of ‘donation’ in row 6674, in this embodiment that populates the field ‘donation { }’ into the formula 6712 in FIG. 67A and opens an additional selection list 6745 which presents the user with options on what to populate in ‘donation { }’. The user sees the ‘Always largest donation value’ row 6727 and clicks it and hits ENTER/RETURN to get the value ‘Sally Johnson’ in cell ‘A1’ 6772 in FIG. 67B for the formula 6763. This calculation is illustratively exampled in in three steps in FIG. 65A. The full outer data join (6165 FIG. 61) referenced in step ‘1)’ appends a ‘name’ to each of the donation values. Step ‘2)’ then sorts those values from highest to lowest ‘donation’ value. Since the user asked for the largest ‘donation’ value the ‘name’ value ‘Sally Johnson’ corresponding to it is returned in step ‘3)’ to the cell ‘A1’ 6772 in FIG. 67B.

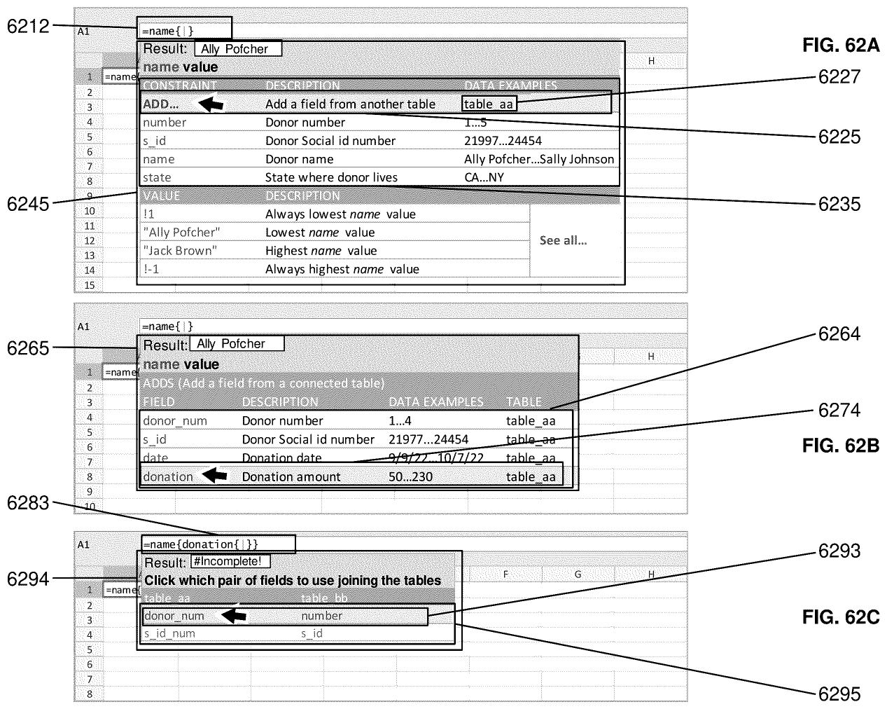

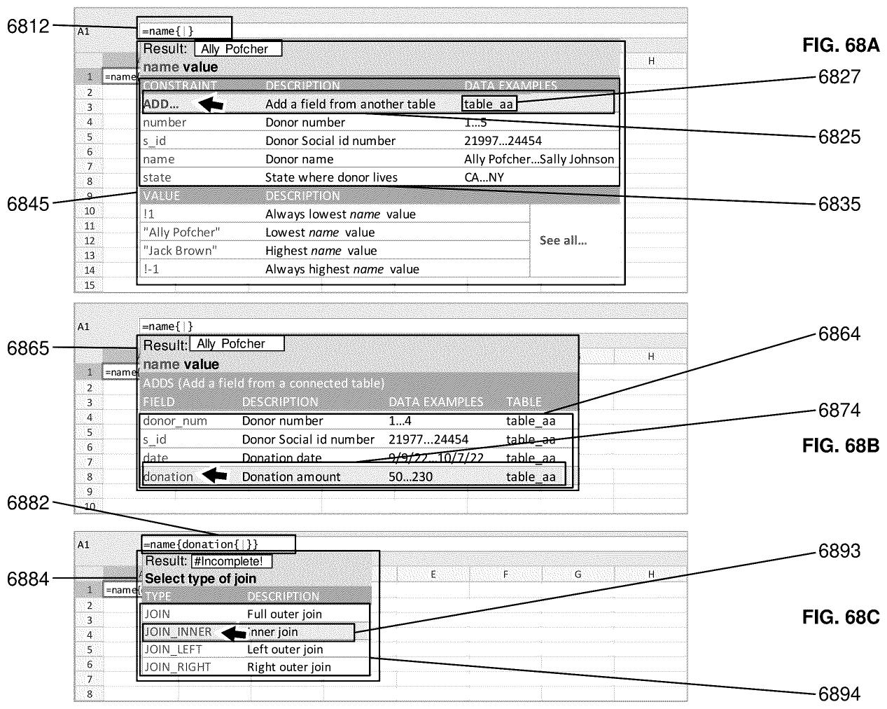

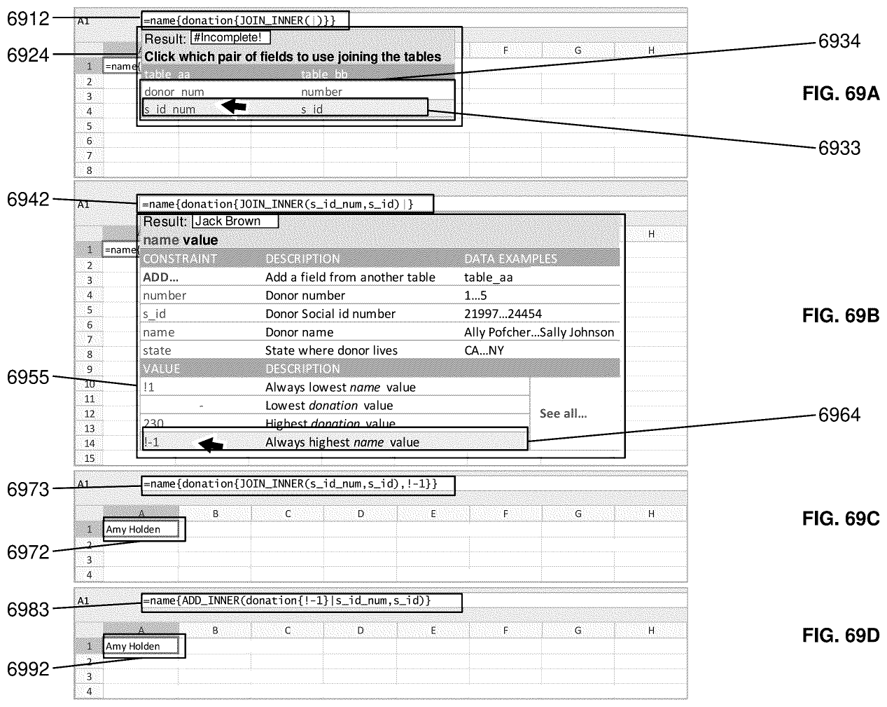

As previously described the formula 6763 for cell ‘A1’ 6772 in FIG. 67B shows no ‘JOIN’ function/constraint or join arguments but in different embodiments could have automatically populated it. In this embodiment the user was given the opportunity to change the join and/or the join key pair with the ‘JOIN . . . ’ option 6735 in the ‘SELECTOR’ list 6755 within the selection list 6745 in FIG. 67A. Selecting that option would then open selection lists like that in those in FIG. 68C and FIG. 69A allowing the user to change the type of join (FIG. 68C) and the join key pair (FIG. 69A). Or in a more limited embodiment with only one join type where there the ‘JOIN’ 6735 ‘DESCRIPTION’ wording instead says ‘Change join keys’ it would open a selection list like that in FIG. 62C 6294 allowing the user to change the join key pair.

Alternative Joins—Default Join Type with Manual Selection of Join Key Pair

FIG. 62A through FIG. 65B examples a more manual alternative joins embodiment with a preselected join type and qualified alternative join key pairs but no default selection. FIG. 62A again examples the charity user wanting to determine the ‘name’ of the donor who made the largest ‘donation’. This embodiment has a default join type (e.g., full outer join) but no default alternative join key pair. Instead, when there are alternative join key pairs the user manually specifies which pair they want used. This embodiment could have a related embodiment where in all situations, not just alternative join key pair situations, the user specifies the join key pair.

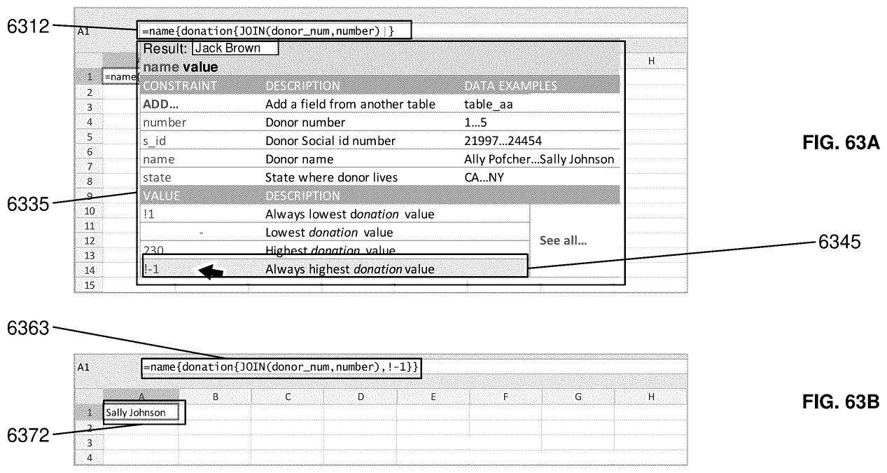

The user starts creating the formula by typing or specifying from a hint ‘=name { }’ 6212 at which point they get the selection list (e.g., hint) 6245. When they don't see a field with the donation values in the “CONSTRAINT’ options 6235 they click the ‘ADD’ row 6225 where they see they will be able to add fields from ‘table_aa’ 6227. This opens a new popup selection list 6265 in FIG. 62B with the four ‘ADDS’ fields 6264 where they see the field they want ‘donation’ and selects it 6274. In this embodiment that populates the field ‘donation { }’ into the formula 6283 in FIG. 62C and opens an additional selection list 6294 which presents the user with the two different qualified join key pairs 6295 for joining the data. In different embodiments those join key pairs could have been setup by any of the paths in FIG. 8. The user then selects the first join key pair 6293 which then populates the join key pair ‘donor_num, number’ as arguments in the new ‘JOIN’ prebuilt function in the cell formula 6312 in FIG. 63A. In this embodiment the join type is a default automatically populated with the selection of the join key pair. As we will example later in this embodiment our new ‘JOIN’ prebuilt function is the outer join variant of a family of functions or constraints that do all the different SQL join types (e.g., JOIN_INNER, JOIN_CROSS, JOIN_LEFT_OUTER, and JOIN_RIGHT_OUTER). Clearly those functions could have had different names/starting names (e.g., CONNECT) but JOIN is simple and descriptive. The user then finishes the formula 6312 by clicking the ‘!-1 Always highest donation value’ 6345 in the selection list 6335 in FIG. 63A then hitting ENTER/RETURN to get the donor name ‘Sally Johnson’ 6372 in cell ‘A1’ for the donor giving the largest donation from the formula 6363 in FIG. 63B. This calculation is illustratively exampled in in three steps in FIG. 65A. The full outer data join (6165 FIG. 61) referenced in step ‘1)’ appends a ‘name’ to each of the donation values. Step ‘2)’ then sorts those values from highest to lowest ‘donation’ value. Since the user asked for the largest ‘donation’ value the ‘name’ value ‘Sally Johnson’ corresponding to it is returned in step ‘3)’ to the cell ‘A1’ 6372 in FIG. 63B.

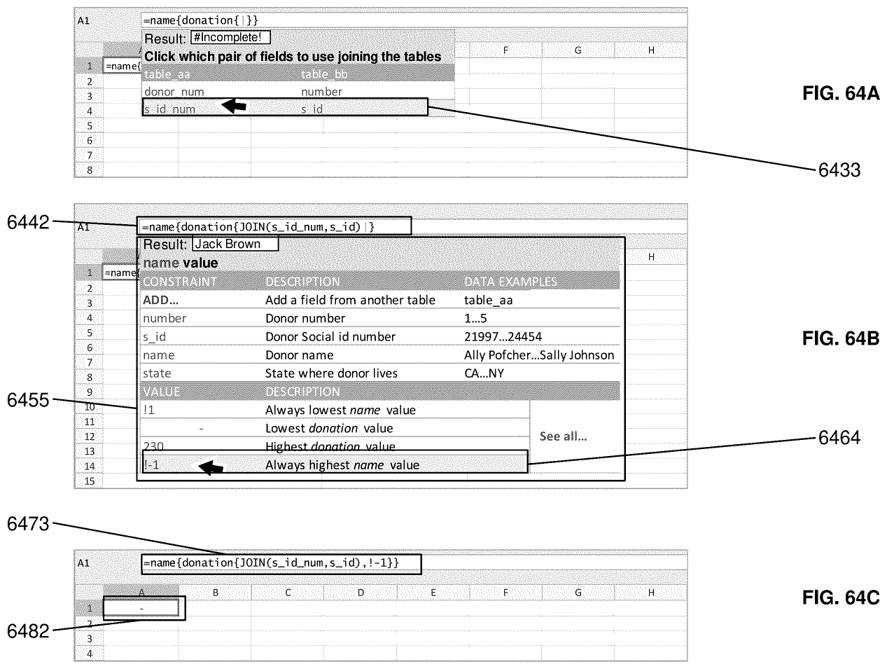

FIG. 64A through FIG. 64C examples the difference in the outcome had the user selected the other join key pair in FIG. 62C as they now do with the selection 6433 in FIG. 64A. Like before the user then finishes the formula 6442 by clicking the”!-1 Always highest donation value’ 6464 in the selection list 6455 in FIG. 64B and hitting ENTER/RETURN to get the donor's name ‘-’ (blank) in cell ‘A1’ 6482 for the donor giving the largest donation from the cell formula 6473 in FIG. 64C. However, because the data join is different in this example the value returned is different, as illustratively exampled in three steps in FIG. 65B. The different join (6185 FIG. 61) referenced in step ‘1)’ results in a blank value being returned in step ‘3) to the cell ‘A1’ 6482 in FIG. 64C. Where in this embodiment a blank value is represented by ‘-’.

### Alternative Joins—Manual Join Type and Manual Join Key Pair Selection

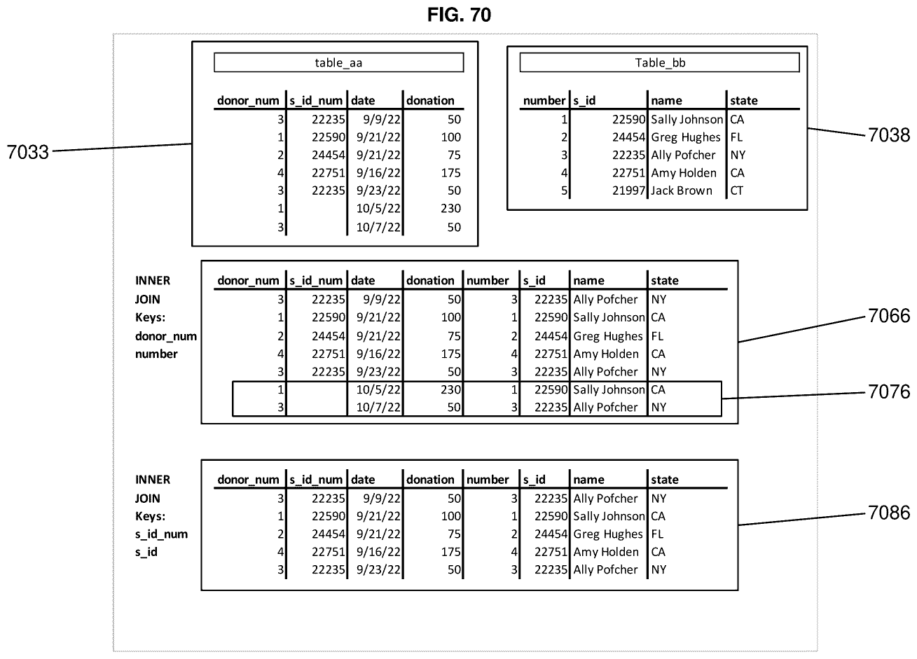

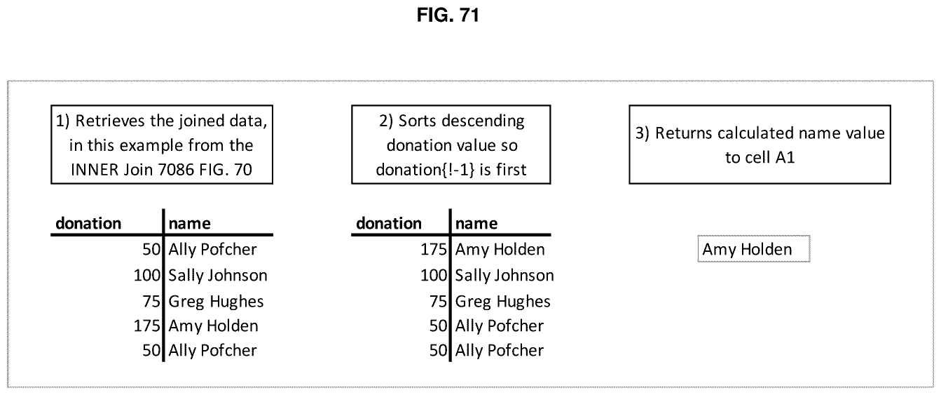

FIG. 68A through FIG. 71 examples an embodiment with no join type default and no alternative join key default. The user selects both the type of join and the join key pair. Like in the two previous examples, the user wants to know the name of the donor giving the largest donation. The user has started creating the formula by typing or specifying from a hint ‘=name { }’ 6812 at which point they get the selection list (e.g., hint) 6845 and when they don't see a field with the donation values in the ‘CONSTRAINT’ options 6835 they click the ‘ADD’ row 6825 where they see they will be able to add fields from ‘table_aa’ 6827. Note, in this embodiment the ‘ADD’ row 6825 shows up because the field ‘name’ has qualified joinable fields in this example in ‘table_aa’ 6827. The ‘ADD’ row 6825 selection then opens a new popup selection list 6865 in FIG. 68B with the four ‘ADDS’ fields 6864 where the user sees the field they want ‘donation’ and clicks it or its row 6874. In this embodiment that populates the field ‘donation { }’ into the formula 6882 in FIG. 68C and opens a new selection list 6884 which presents the user with the four different join types 6894 to select from in joining the data. As discussed previously these join predefined functions or constraints (they could operate either as a prebuilt function or a type of constraint/filter) use ‘JOIN’ in their name but could have used LINK, CONNECT, or some other term. It could present a different set of data joins. For example, some embodiments of our technology could allow the user to overcome the “many’ to “many” blocking restriction with a “CROSS_JOIN” which purposely gives a full Cartesian Product of every row with every row or overcome a blocking of partial Cartesian Products delivered by other joins for “many’ to “many” paired keys. Additional embodiments include a JOIN_SELF supporting self joins. In this example the user selected an inner join ‘JOIN_INNER’ 6893 which populates “JOIN_INNER( )’ into the formula 6912 and presents the user with a new selection list 6924 in FIG. 69A with the two different join key pairs 6934 for joining the data. The user then selects the second join key pair 6933 which then populates the join key pair ‘s_id_num,s_id’ as arguments in our ‘JOIN_INNER’ prebuilt function in the cell formula 6942 in FIG. 69B. The user then finishes the formula 6942 by clicking the ‘!-1 Always highest donation value’ 6964 in the selection list 6955 then hitting ENTER/RETURN to get the donor name ‘Amy Holden’ 6972 in cell ‘A1’ for the donor giving the largest donation from the formula 6973 in FIG. 69C. This calculation is illustratively exampled in in three steps in FIG. 71. The INNER join data (7086 in FIG. 70) referenced in step ‘1)’ eliminates the rows with no matching ‘s_id’ to ‘s_id_num’ value (7076 in FIG. 70) and then appends a ‘name’ to each of the remaining donation values. Step ‘2)’ then sorts those values from highest to lowest ‘donation’ value. Since the user asked for the largest ‘donation’ value the ‘name’ value ‘Amy Holden’ corresponding to it is returned in step ‘3)’ to the cell ‘A1’ 6972 in FIG. 69C.

FIG. 69D examples another embodiment of our technology where the join is visible in the cell formula but not as a formulaic data constraint but as prebuilt function ‘ADD_INNER’ within which resides ‘donation’ in the first of two argument groups separated by a vertical bar ‘I’ as shown in the formula 6983. In the first argument group the field desired from the join and the second argument group the join key pair ‘s_id_num,s_id’. That embodiment gives the same result ‘Amy Holden’ in cell ‘A1’ 6992 doing the same illustrative steps outlined in FIG. 71 using the data joined in FIG. 70. As we will example later there are many additional types of argument constructs that our technology supports to define the join type, join keys and if needed tables where the keys reside.

### Alternative Joins—Manual Override of Default Join

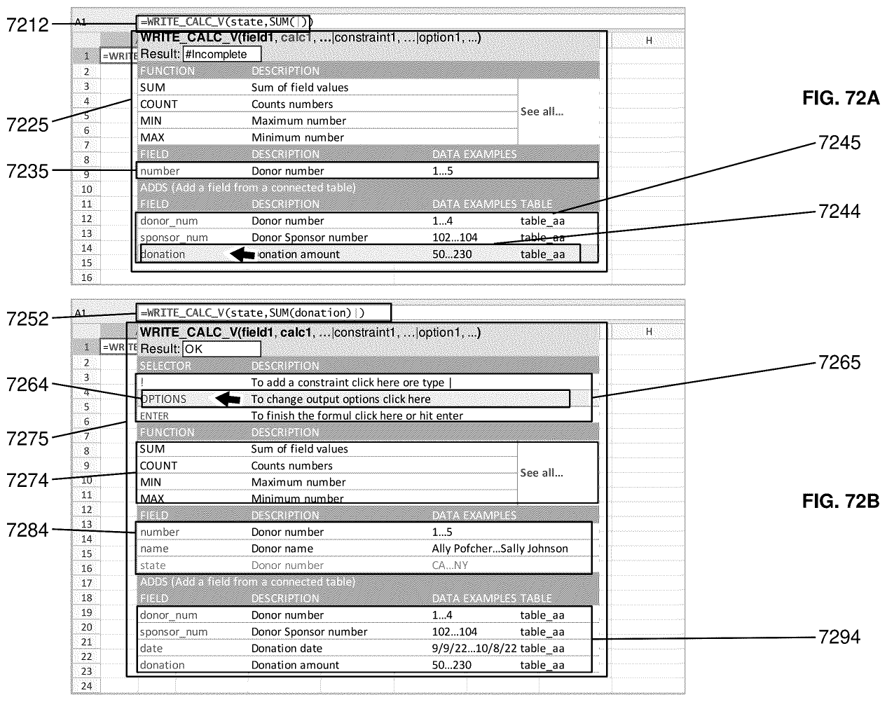

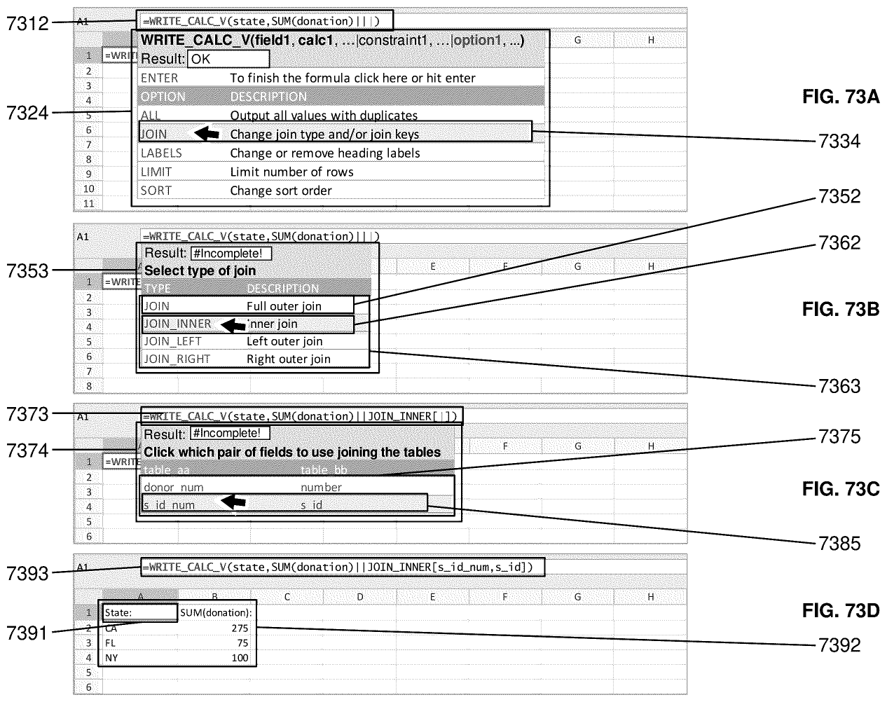

Embodiments of our technology also support the manual override of default specified data set join keys as exampled in FIG. 72A through FIG. 74. Our technology supports changing the type of join (e.g., inner, full outer or left outer join) and in situations where there is more than one alternative join key pair, changing which join key pair is used. FIG. 72A examples an embodiment where the fields being joined are visible in a selection list 7225 which in this embodiment displays the list in what we called a one-step selection list (i.e., list of original table 7235 and any joined table fields 7245 visible in the same selection list 7225). As we have previously discussed the joined data could have been displayed in a two-step or some other UI progression. And could have been shown in a very different UI. Our technology also supports embodiments with no selection list for the joined data fields where the user types the formula, as we will example later. In this example the user is employing one of our ‘WRITE’ functions (‘WRITE_CALC_V’) which both writes data and calculates values in an organized output as described in our U.S. application Ser. No. 17/374,901, titled “Method and System for Improved Ordering of Output from Spreadsheet Analytical Functions,”. The charity user wants to determine the total donations by state where the ‘state’ values are in ‘table_bb’ 7038 in FIG. 70 and the ‘donation’ values are in a different table ‘table_aa’ 7033 in FIG. 70. Because the cursor is in the ‘SUM( )’ argument in the formula 7212 the selection list 7225 displays only numeric fields from the joined data sets, ‘number’ 7235 from the same data set as ‘state’ (in table_bb), and the three fields 7245 from the joined ‘table_aa’. It is in the joined data that they user sees the field ‘donation’ that they want and clicks (selects) it 7244 to then get it populated in the formula 7252 as shown in FIG. 72B. At that point, in this embodiment, they get another selection list 7275 giving them fields 7284/7294, functions 7274, and other selectors 7265. Because the user knows they want to alter the data joining in this embodiment they then select (click) ‘OPTIONS’ 7264 to not change the formula 7312 but get a new selection list 7324 in FIG. 73A. There they see the ‘JOIN’ option that allows them to ‘JOIN Change join type and/or join keys’ and click (select) it 7334. In this embodiment that opens the join type selection list 7353 in FIG. 73B where the user sees the four different join types 7363 available in this embodiment. Note, other embodiments support different sets of join types (e.g., including cross and self). In this example the default join is called ‘JOIN’ being a ‘Full outer join’ 7352 however, the user wants an inner join, so they click ‘JOIN_INNER Inner join’ 7362. That populates the ‘JOIN_INNER [ ]’ argument into the formula 7373 in FIG. 73C and gives the user a selection list 7374 to potentially change the default join key-pair 7375. The user sees that they want the ‘s_id_num s_id’ join key-pair and selects (clicks) it 7385. At that point they also hit ENTER/RETURN to get the cell ‘A1’ 7391 formula 7393 and output in cells ‘A1’ through ‘B4’ 7392. Our technology has executed in the cell formula an inner join of the data in data sets ‘table_bb’ 7038 and ‘table_aa’ 7033 in FIG. 70 as illustratively exampled in 7086 in FIG. 70 then executing the four illustrated formula calculation steps in FIG. 74.

This gave the charity user the ability to select the type of join and join key-pairs (in situation where there is more than one) overriding the default setting. Then our in-cell formula join technology executes that overridden join and then uses its data in both the ‘WRITE’ function and the ‘SUM’ function within the ‘WRITE’ function. In these formulas the different joins can appear as a function or an argument within the cell formulas. They can reside in WRITE ‘OPTIONS’ argument group, ‘CONSTRAINTS’ argument group, or incorporated in the first argument group. They can be a visible or invisible arguments within those formulas and different types of our selection lists as described in our U.S. Provisional Application No. 63/337,576, titled “Methods and Systems for Spreadsheet Function and Flex Copy-Paste Control of Formatting and Use of Selection List Panels,”.

Rather than exampling more types of alternative joins in different types of formulas, using different functions, more algebraic operators, and more combinations of those, we will move onto a very different situation involving multiple join key pairs between two data sets but in this situation to effect multiple joins that can be done in one of our spreadsheet cell formulas.

### Multiple Joins Between Two Data Sets

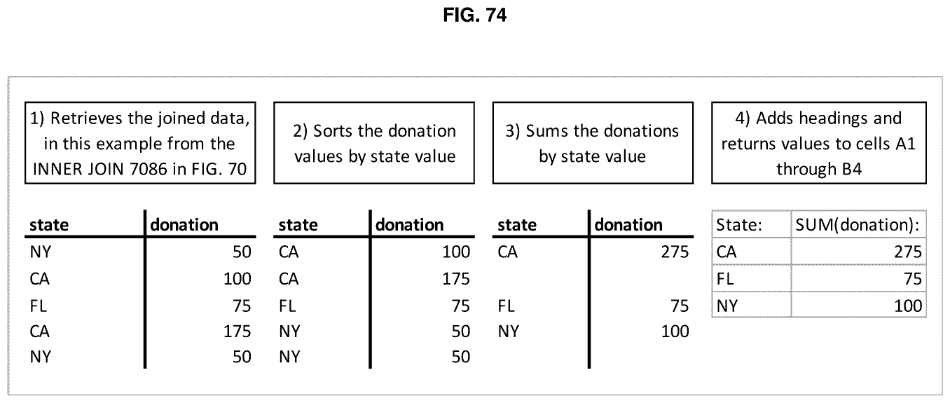

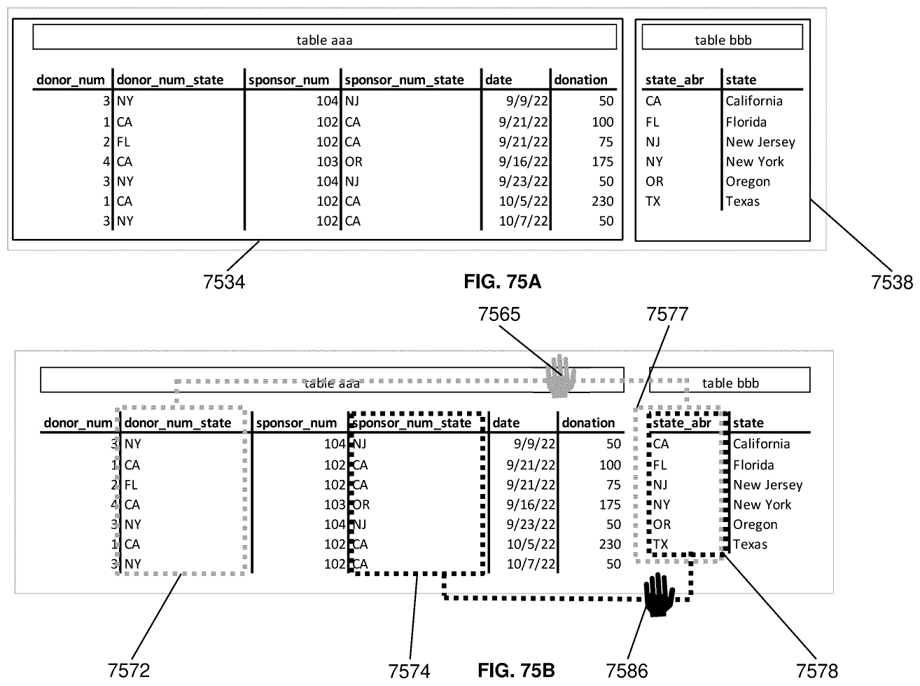

FIG. 75A through FIG. 83 example spreadsheet formulas using our technology in a spreadsheet cell to double join two data sets as part of the formula. While the two examples use employ variants of our multi-cell populating functions, the double joins could be used in other multi-cell populating functions (e.g., FILTER) formulas, in spreadsheet regular range function (e.g., SUM, COUNT or STDEV) formulas, in non-range function (e.g., COS or SQRT) formulas in formulaic data formulas, in algebraic combinations of any of the appropriate functions and formulaic data terms.

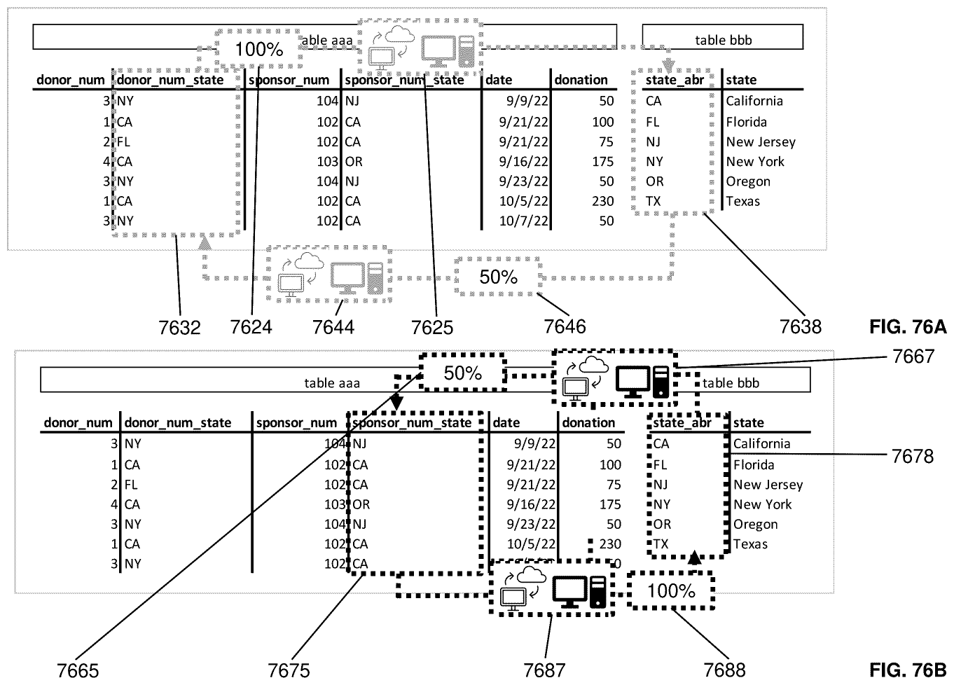

FIG. 75A examples the charity user using two data sets, ‘table aaa’ 7534 and ‘table bbb’ 7538. Data sets ‘table aaa’ 7534 and ‘table bbb’ 7538 have two potential pairs of join key pairs 7572/7577 and 7574/7578 which are manually specified by the user 7565/7586 as exampled in FIG. 75B. It is worth noting that 7577 and 7778 are actually the same join key simply used for two different joins which are color coded and therefore separately labelled. That manual specification could then be verified by our technology in different embodiments along the lines previously discussed (e.g., FIG. 4). FIG. 76A and FIG. 76B illustratively example those same two joins 7632/7638 and 7675/7678 being automatically generated and validated 7624/7646 and 7665/7688 (as exampled by match percentages) on the user's computer, in the cloud or some combination of the two 7625/7644 and 7667/7687. The data types are the same for each join key pair, one of each join key pair is unique, and the values matches are all ‘50%’ or higher (as shown in 7624/7646/7665/7688), thus passing the one-way and two-way match requirements set for this embodiment (e.g., >=50%). Those setup and validation actions could be done using any of the previously exampled appropriate UIs. However, unlike the previous alternative joins between two data sets these are double (multiple) joins (i.e., x joins where x is double, triple or a higher number) that coexist and can be simultaneously used.

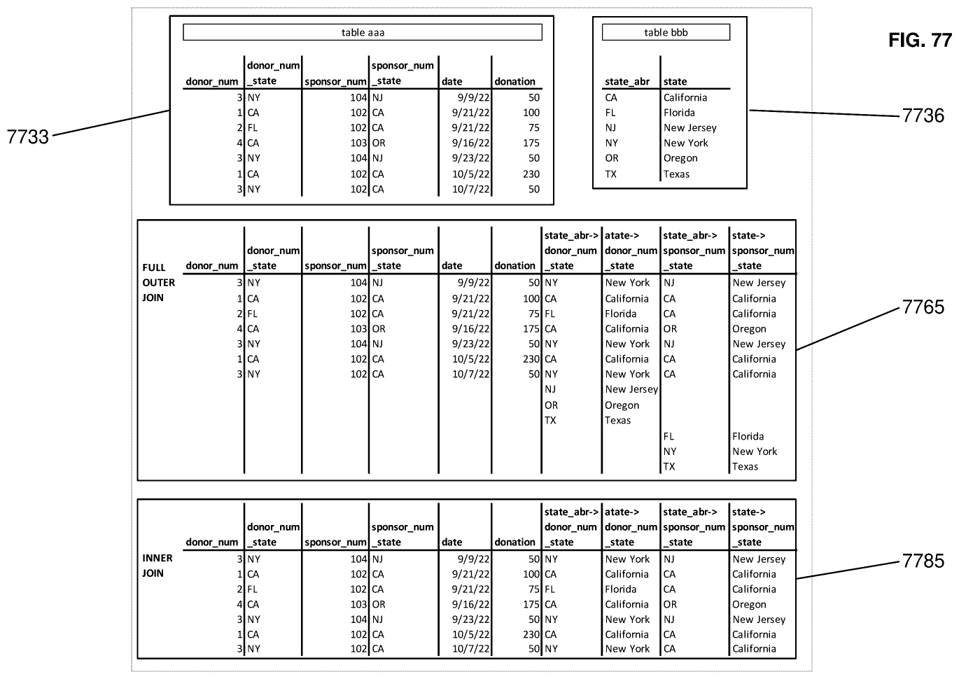

FIG. 77 examples the coexistence of the two joins illustratively exampled in FIG. 75B through FIG. 76B in a ‘FULL OUTER JOIN’ 7765 of all the columns/fields of two data sets, ‘table aaa’ 7733 and ‘table bbb’ 7736. While 7785 examples a ‘INNER JOIN’ of all the columns/fields of two tables, ‘table aaa’ 7733 and ‘table bbb’ 7736. Recognizing that in most of our spreadsheet cell formulas our technology is not joining all of the columns/fields but more typically only those fields/columns used in the formula employing the join key pairs.

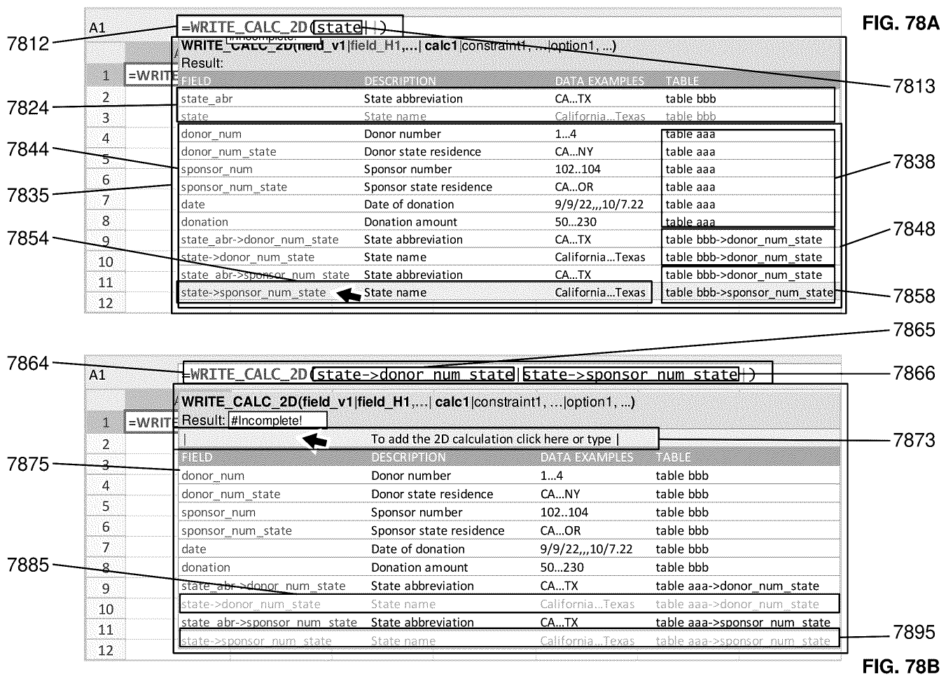

FIG. 78A through FIG. 80B example the charity user writing an in-cell formula to calculate and display donations by the state of the donor and the state of the donor's sponsor. Because they want this done by the non-abbreviated name of the state this requires two joins between ‘table aaa’ which has the donations and the abbreviations for the donors and sponsors states of residence to ‘table bbb’ to join the fully written out name of the state to both sets of abbreviations/donations etc. as was done in the joins exampled in FIG. 77.

FIG. 78A examples the user having started the formula 7812 using a ‘WRITE_CALC_2D’ function selecting or typing in the field/column ‘state’ and then selecting or typing in the bar ‘I’ to put the cursor in the second argument group, ‘field_H1’ which is for specifying the horizontal headings. At this at point the user gets the selection list 7835 which is what we have labelled a one-step selection list which displays the fields 7824 in the table with ‘state’ and all the joined fields 7844. Those joined fields are from ‘table aaa’ 7838, the join of ‘table aaa’ via the keys of ‘donor_num_state’ 7848 (‘table aaa->donor_num_state’) and the join of ‘table aaa’ via the keys of ‘sponsor_num_state’ 7858 (‘table aaa->sponsor_num_state’). In this embodiment the double (or x times) joined fields have a syntax of the field name then a ‘->’ symbol and the join key in the table where the different join key fields/columns reside, in this example the ‘table aaa’ join key. So, the selected field ‘state->sponsor_num_state’ 7854 is the field ‘state’ from the join of table aaa’ through its join key ‘sponsor_num_state’ 7574 to ‘table bbb’ through its join key ‘state_abr’ 7578 as exampled in FIG. 75B. That ‘table aaa’ join key ‘sponsor_num_state’ is used, in this embodiment, for the ‘TABLE’ naming after the table ‘table bbb’ and the ‘->’ symbol as shown by ‘table bbb->sponsor_num_state’ 7858. We are using the join key in the table that has the multiple different join keys between the two tables as the identifier of the join which is then used to identify the fields and to identify the tables. To fully example this point the two different joins in this example in FIG. 75B are:
table aaa join key ‘donor_num_state’ 7474 and table bbb join key ‘state_abr’ 7578
table aaa join key ‘sponsor_num_state’ 7472 and table bbb join key ‘state_abr’ 7577
   Where you can see the differentiating join keys are ‘donor_num_state’ in the first join and ‘sponsor_num_state’ in the second join because ‘state_abr’ is the same in both joins. In this embodiment those differentiated join keys are used in the automatic naming done by our application. In related other embodiments our application would give the user the opportunity to name the joins themselves, therefore replacing these automatically generated names.

Note, recognizing in this example because the fields in the data sets have unique names, we do not need to include the data set (table) name in the multiple joined field names. If that were not the case we would need to include those or some other mode of ensuring the field names were unique. With an understanding of the naming used in this embodiment for the double (or x times) joined fields, we will now return to the example. The user wants to have the sponsor non-abbreviated state names as the horizontal headings, so they select ‘state->sponsor_num_state’ 7854 which populates it 7866 into the formula 7864 in FIG. 78B. However, in this embodiment it also automatically triggers the replacement of ‘state’ 7813 in FIG. 78A in the first argument group with ‘state->donor_num_state’ 7865 in FIG. 78B. That occurs because in this situation once the two tables (‘table aaa’ and ‘table bbb’) have been confirmed joined by the population of ‘state->sponsor_num_state’ 7866 then ‘state’ 7813 in FIG. 78A must be converted to a joined version of ‘state’. And since there are only two options ‘state->sponsor_num_state’ and ‘state->donor_num_state’ and ‘state->sponsor_num_state’ 7866 is already taken (and fields/columns can only be used once in this function's headings) then ‘state’ 7813 in FIG. 78A must turn into the unused one ‘state->donor_num_state’ 7865, which our app automatically docs. Had there been three or more “x joins” between the two tables (‘table aaa’ and ‘table bbb’) then our application could not have made the automatic conversion and instead would have asked the user to specify which of the remaining ‘state’ join fields/columns the user wanted (as will be exampled later).

Note, that selection list 7875 in FIG. 78B also automatically disabled (grayed out) the two ‘state’ joined fields 7885 and 7895 as both had now been used as headings and removed the original ‘table aaa’ fields 7824 which were displayed in FIG. 78A because once a join is made those un-joined fields are no longer available in this formula or part of a formula.

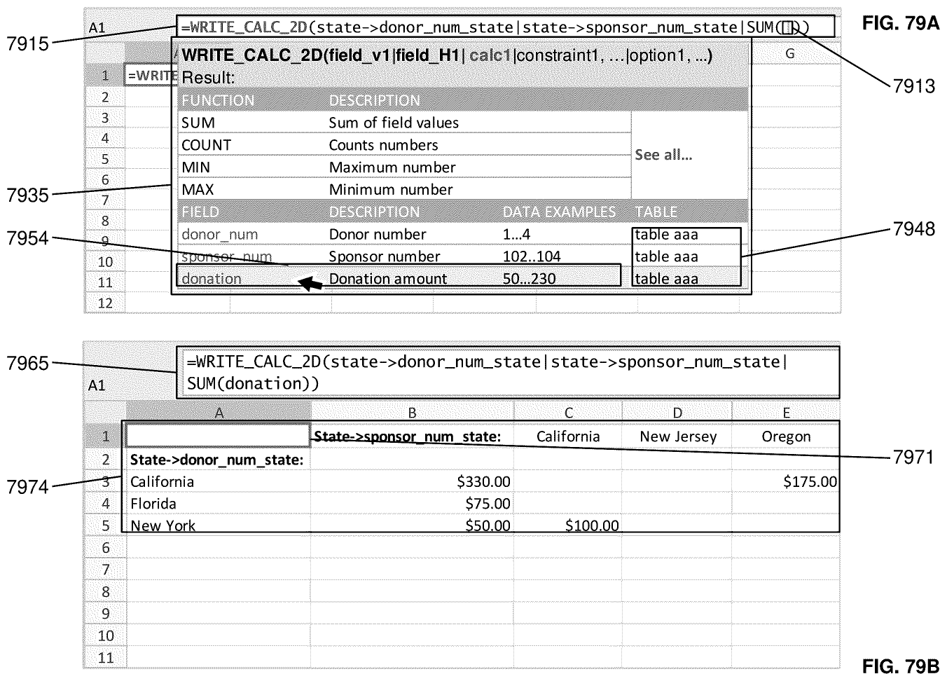

With the heading selections complete the user clicks the ‘I’ line 7873 in the selection list 7875 to begin to populate the ‘SUM’ calculation. The user then selects or types the ‘SUM’ function and with the cursor 7913 (shown as a gray bar) in between the ‘SUM’ parentheses the user gets the selection list 7935 in FIG. 79A which gives them the option to add further functions or what they want to do which is populate the ‘donation’ field 7948 in the formula. Since this embodiment is using the one-step selection list and we are within the ‘SUM’ function, the selection list is displaying all of the numeric fields in the joined ‘table aaa’ and table bbb’ lists which is this example is only fields in ‘table aaa’ 7948 because there are no numeric fields in ‘table bbb’ (7736 in FIG. 77). So, the user selects ‘donation’ field 7954 and hits ENTER/RETURN to deliver the output in cells ‘A1’ through ‘E5’ 7974 with the formula 7965 for cell ‘A1’ 7971 in FIG. 79B. The formula having executed the joins as illustratively exampled in FIG. 77B 7785 and then the steps ‘1.’ through ‘4.’ of the cell formula calculations as illustratively exampled in FIG. 80A and FIG. 80B.

### Multiple Joins Triggering Field Selection

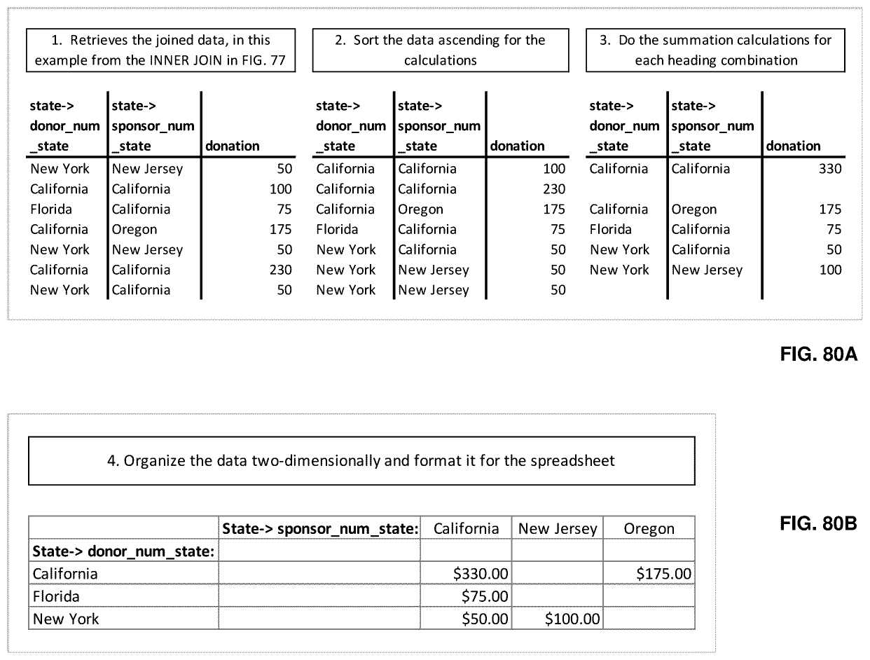

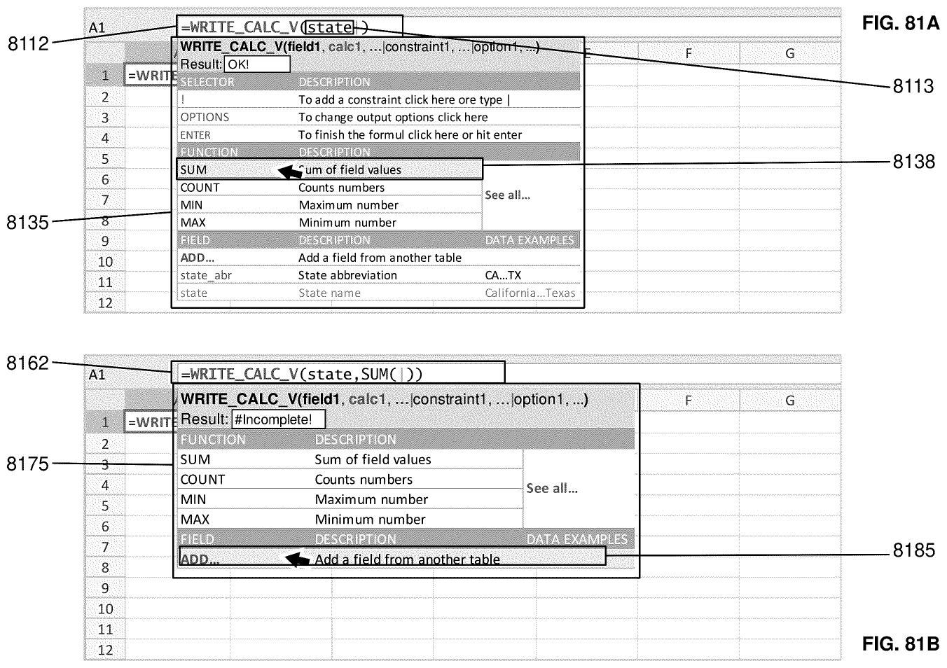

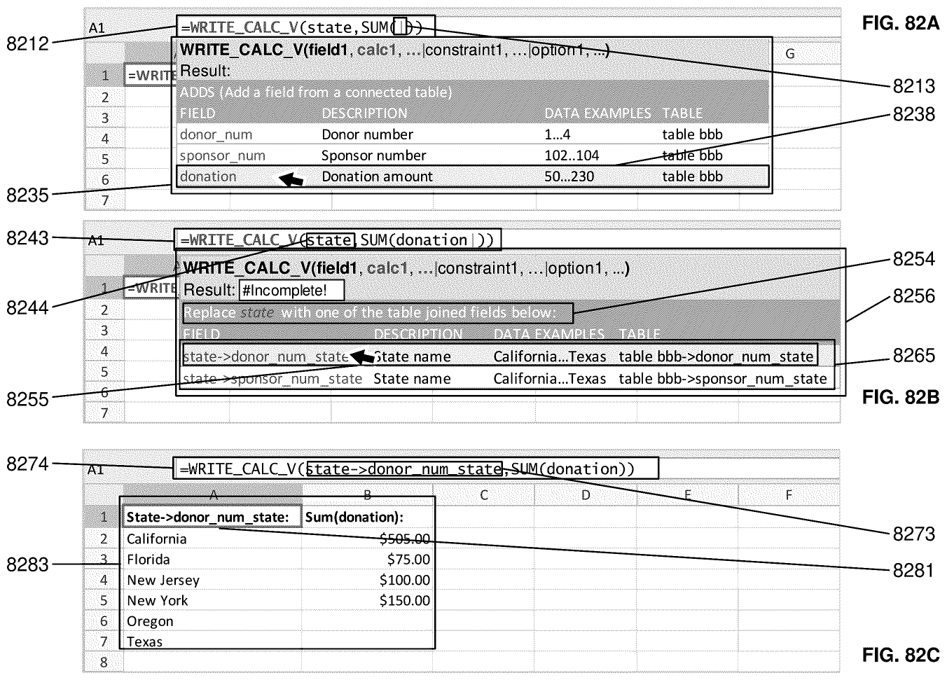

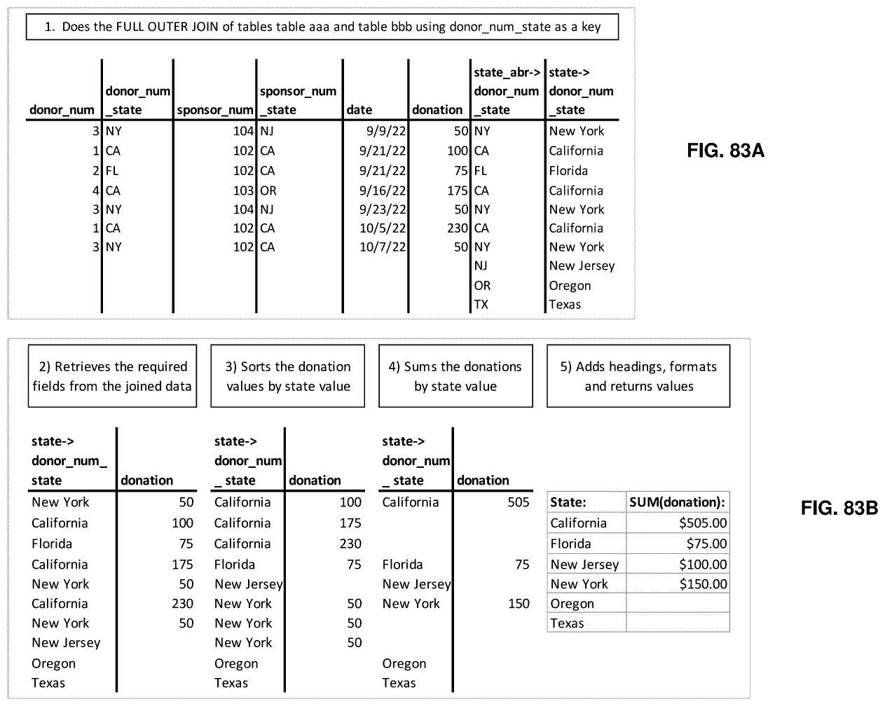

As previously mentioned, there are multiple join situations between two data sets where a formula selection in our technology requires the user to select the replacement of a previously populated field/column in the formula. FIG. 81A through FIG. 83B examples one such situation where our charity user wants to see the total donations by state of donor residence. To do so requires using data from both ‘table aaa’ 7534 and ‘table bbb’ 7538 in FIG. 75A. The user has typed or selected the formula 8112 in FIG. 81A having specified ‘state’ 8113 and now about to specify the sums of ‘donation’ so they select ‘SUM’ 8138 from the selection list 8135 to populate it in the formula 8162 in FIG. 81B. However, they then see that there are no numeric fields in the table with ‘state’ and therefore their only option is to ‘ADD’ a field from a joined table. They therefore select ‘ADD . . . ’ 8185 from the selection list 8175 in FIG. 81B. This automatically opens the selection list 8235 in FIG. 82A where the user sees the ‘donation’ field that they want. With the cursor 8213 still in the ‘SUM( )’ within the ‘WRITE_CALC_V’ in the formula 8212, they select ‘donation’ 8238 which populates ‘donation’ into the formula 8243 in FIG. 82B and in doing so the user has triggered a join which means that field/column ‘state’ 8244 shown in FIG. 82B must be replaced by a joined version which would be automatic if there were only one option except in a situation like this one where there are multiple joined versions of ‘state’ and our technology does not know which one the user wants. So, our technology will not proceed with the formula until the user specifies which replacement ‘state’ field they want, in this embodiment displayed in the selection list 8256 (which in this embodiment has the instruction 8254 to guide the user). The user wants the donor state name, so they click ‘state->donor_num_state’ 8255 and then hit ENTER/RETURN to populate the cells ‘A1’ through ‘B7’ 8283 in FIG. 82C. Those cells are populated by the formula 8274 in cell ‘A1’ 8281 after our application automatically executes the five steps illustrated in FIG. 83A and FIG. 83B.

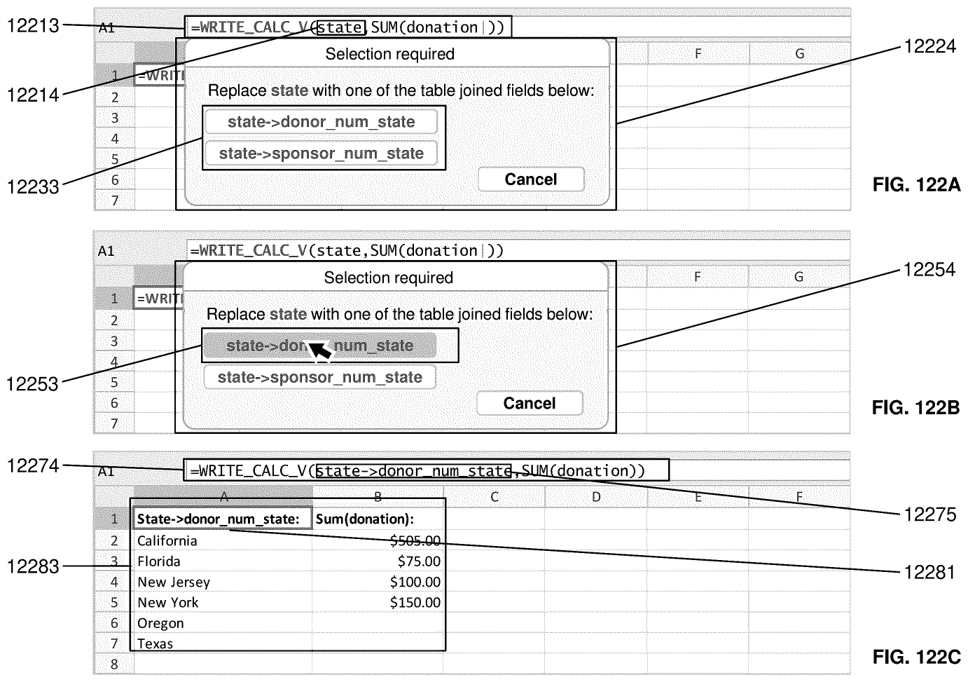

In a slightly different embodiment picking up with the ‘donation’ specification 8235 in FIG. 82A the user gets the popup 12224 in FIG. 122A with the joined table alternatives 12233 to replace the field ‘state’ 12214 in the formula 12213. As previously described once a join is invoked with the addition of the field ‘donation’ to the formula, ‘state’ must be replaced by one of its two joined fields. In this situation our application has no way of knowing which is desired by the user so the popup 12224 requires them to make a selection before proceeding with the formula (or at least before they submit the formula for evaluation). In this example, the user selects ‘state->donor_num_state’ 12253 in the popup 12254 (which is a repeat of 12224 in FIG. 122A) and then hits ENTER/RETURN to populate the cells ‘A1’ through ‘B7’ 12283 in FIG. 122C. Those cells are populated by the formula 12274 in cell ‘A1’ 12281 after our application automatically executes the five steps illustrated in FIG. 83A and FIG. 83B and are simply an alternative UI to deliver the same outcome in FIG. 82C. The field ‘state’ 12244 has been replaced by the joined field ‘state->donor_num_state’ 12275. This exampled a different form of user selection, one not reliant on a complete set of hints but one that can work with a full set of selection lists (e.g., hints) or one that can work in situations without selection lists yet still accomplish the requirement of requiring a user to make a selection to proceed with finishing the formula.

Our technology, exampled here for double joins between two data sets, similarly works for triple and more joins between the same two data sets. We have created a simple field and joined data set naming conventions using the differentiated join key field/column names after an arrow like set of characters ‘->’, however our technology supports other naming conventions and allows user to provide their own names. This is done to simplify the usage for the non-SQL join knowledgeable users so that they do not have to understand the mechanics of what the joins are doing but simply be able to decide which joined data they want. These multiple joins between two data sets work in all the different types of formulas and functions cited herein, so rather than exampling more combinations we are going to move onto how our technology handles joins between three or more data sets.

### Three Unique Data Set Joins

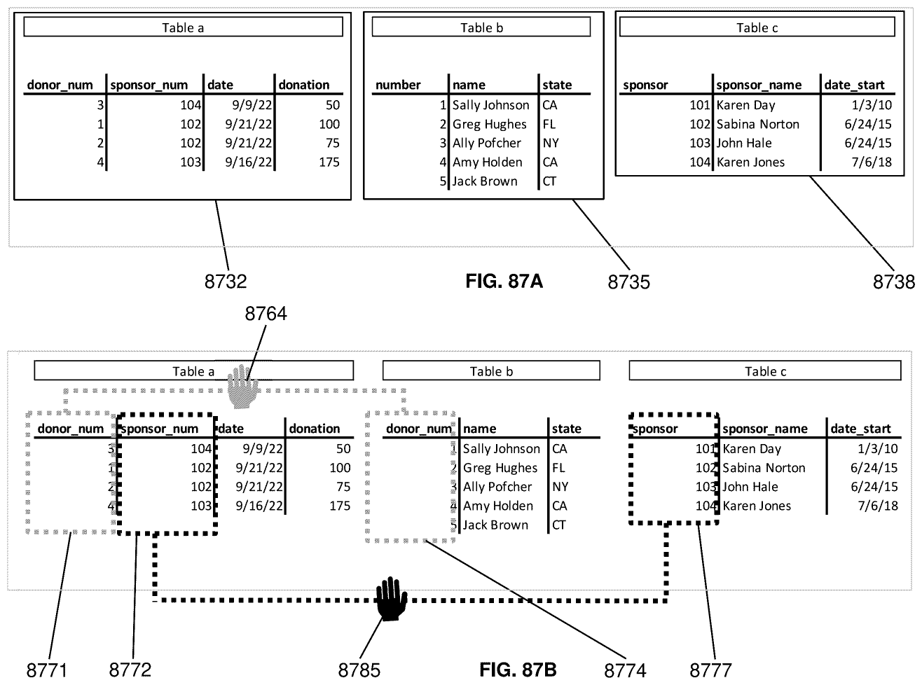

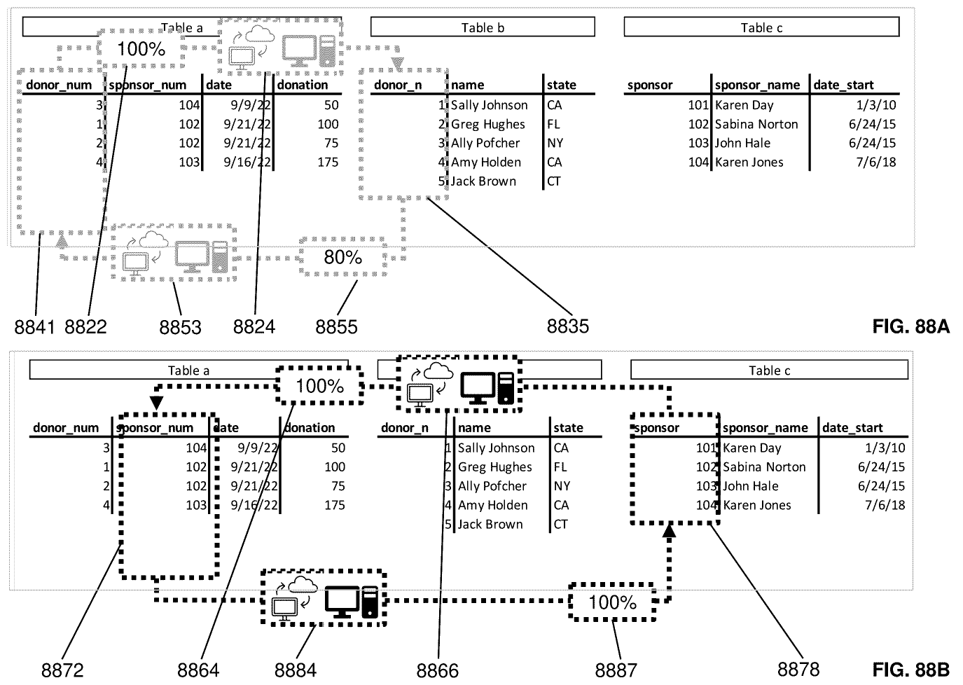

FIGS. 87A through 95B examples our technology chain/sequence joining three data sets within a cell formula for use in the formula calculations. FIG. 87A examples three data sets ‘Table a’ 8732, ‘Table b’ 8735, and ‘Table c’ 8738. There could be more data sets, but we example these three because they are joinable. Data sets ‘Table a’ 8732 and ‘Table b’ 8735 have potential join keys 8771/8774 and ‘Table a’ 8732 and ‘Table c’ 8738 have potential join keys 8772/8777 which are manually specified by the user 8764/8785 as exampled in FIG. 87B. That manual specification could then be qualification verified by our technology in one or more different embodiments along the lines previously discussed and exampled in FIG. 4. FIG. 88A and FIG. 88B illustratively examples those same two potential joins 8841/8835 and 8872/8878 being automatically generated and qualification validated 8822/8855 and 8864/8887 on the user's computer, in the cloud, or some combination of the two 8824/8853 and 8884/8866. The data types are the same for each join key pair, all the join key pairs are data modelling cardinality unique to non-unique, and the values matches are all ‘80%’ or higher (as shown in 8822/8855/8864/8887), thus passing the one-way and two-way match requirements set for this embodiment (e.g., 75%). Those setup and qualification validation actions could be done using any of the previously exampled appropriate UIs or alternatives with any of the different validation requirements.

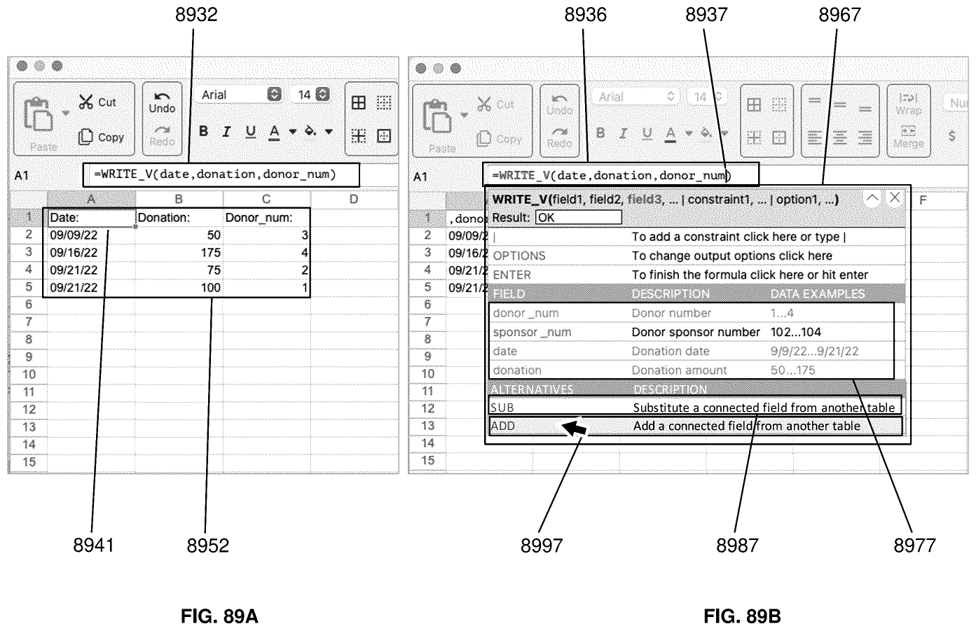

We will again return to our charity user doing a formula similar to one done previously except this time we will work through an example using data joined across three tables. FIG. 89A examples one of our ‘WRITE’ function formulas in cell ‘A1’ 8941 that populates the values in cells ‘A1’ through “C5’ 8952 from the formula 8932. The illustrative steps on what that ‘WRITE’ formula 8932 would parallel those exampled in FIG. 30A and FIG. 30B except with a smaller data set.

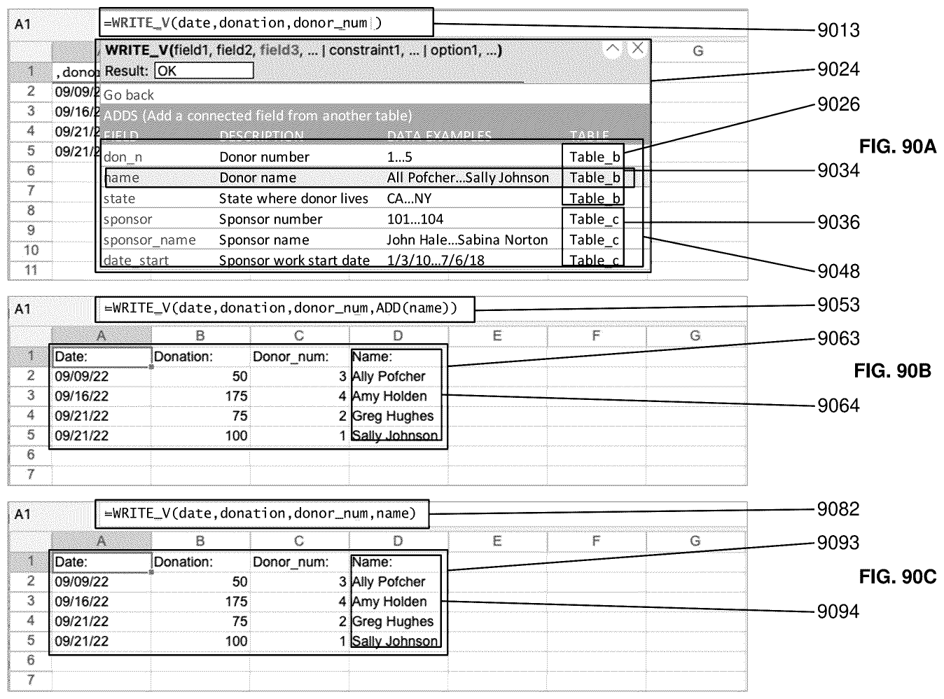

In FIG. 89B when the charity user reopens the formula putting the cursor 8937 inside the formula 8936 just before the closing parenthesis so they get the selection list (hint) 8967 which gives the user the selection list 8977 of additional fields in the table of the preceding fields (note with only one active field ‘sponsor_num’ which they have not already used) and via our new technology two additional ‘ALTERNATIVES’ to ‘SUB’ ‘Substitute a connected (joinable) field from another table’ 8987 or to ‘ADD’ ‘Add a connected field from another table’ 8997. In this example the charity user decides they would like to ‘ADD’ 8997 and clicks on that alternative which opens the selectable list 9024 in FIG. 90A. The formula 9013 has not changed but this new hint 9024 gives the user the option to add one of six different fields 9048 to the formula, where three of those fields are from ‘Table b’ 9026 and three of those fields are from ‘Table c’ 9036. The user sees the ‘Donor name’ field ‘name’ that they want and selects (e.g., clicks) it 9034 and then hits ENTER/RETURN to get either of the outcomes in FIG. 90B or FIG. 90C, depending on embodiment.

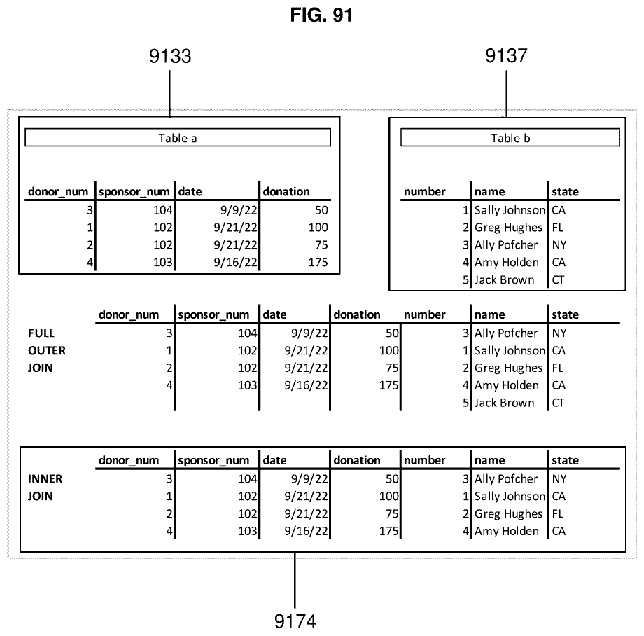

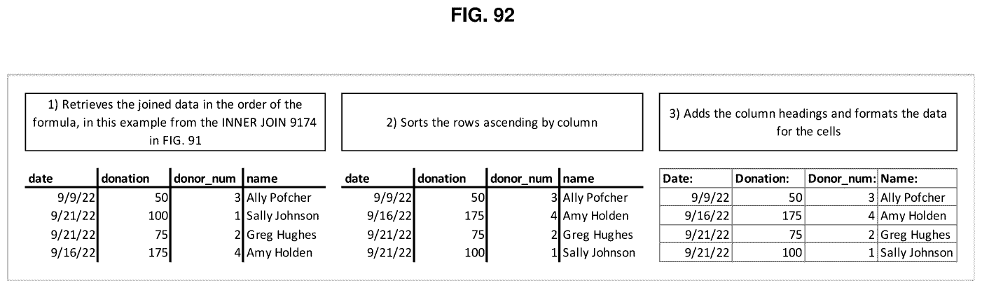

FIG. 90B examples an embodiment where the added join field ‘name’ 9034 is done via a function, in this example ‘ADD’, in the formula 9053 to populate the values in cells ‘D1’ through ‘D5’ 9064 as part of the ‘WRITE_V’ output 9063. FIG. 90C. examples another embodiment where the added joined field ‘name’ 9034 (clicked in FIG. 90A) goes into the formula 9082 to populate the values in cells ‘D1’ through ‘D5’ 9094 as part of the ‘WRITE_V’ output 9093. In both FIG. 90B and FIG. 90C the formula executes in our application illustrative steps along the lines shown in FIG. 91 9174 (using the data sets 9133 and 9137) and FIG. 92. Those illustrative steps start in step ‘1)’ with the retrieval of the required data from the inner join of the two data tables illustrated in FIG. 91 9174. Step ‘2)’ in FIG. 92 ascending value row sorts the data in the order of the fields/columns occurrence in the arguments of the ‘WRITE’ formula. Step ‘3’ adds the headings, as previously described, and sends the values and the formula to cells ‘A1’ through ‘D5’ in either FIG. 90B or FIG. 90C. Note, the ‘WRITE_V’ function embodiment in this example eliminates the ADD from the heading in FIG. 90B to display only the field name initial capitalized and followed by a colon. Although our technology could have also left the ‘ADD( )’ in the heading.

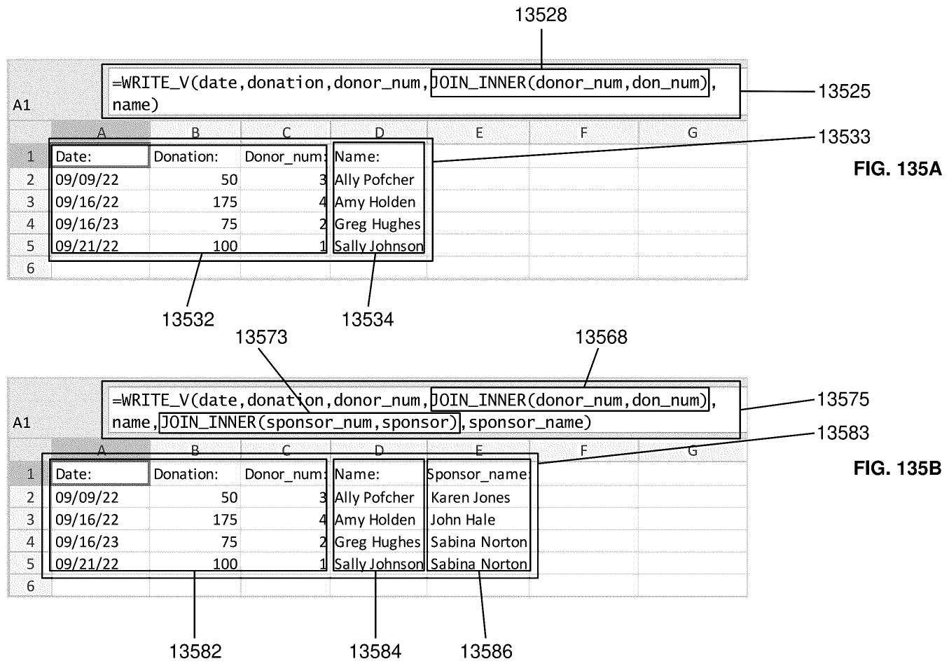

A more information rich variant of FIG. 90B is exampled in FIG. 135A where the auto-populated function ‘JOIN_INNER’ 13528 in the formula 13525 tells the user the type of join employed (e.g., inner join) and the join key pair fields ‘donor_num, don_num’ as the two arguments within the parentheses. This gives a more expert user all the information needed to know how the output 13534 of the ‘name’ field was joined to the outputs 13532 from the other data set to create the total output 13533 from the ‘WRITE_V’ formula 13525.

Thus far the formula in either FIG. 90B or FIG. 90C has only required a single join but we will now example an addition to the formula that results in two chained/sequenced joins.

### Third Data Set Joined

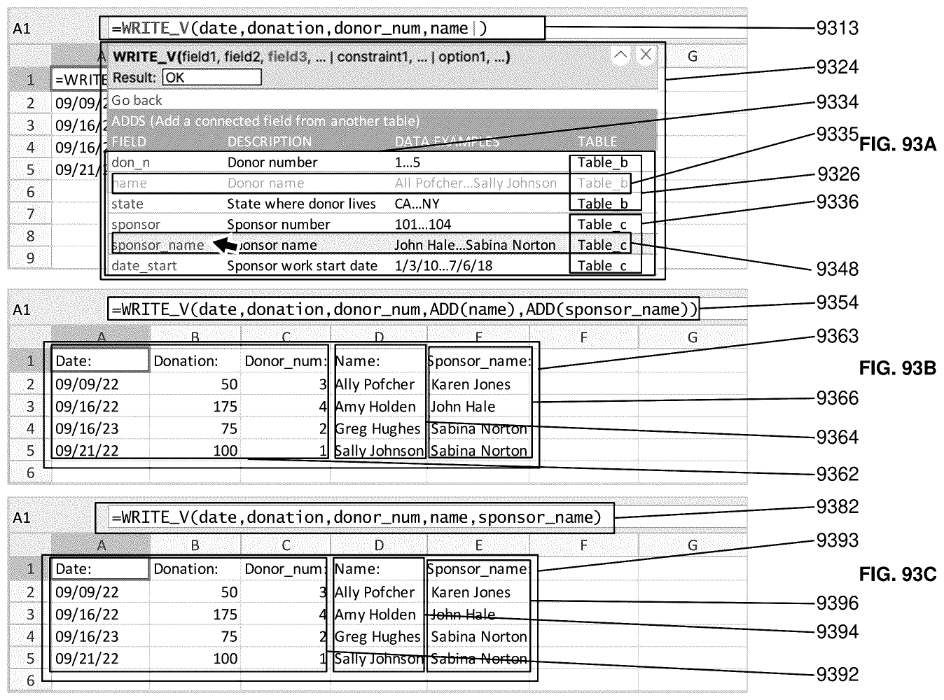

FIG. 93A through FIG. 93C examples the user adding an additional field from the third data set to the ‘WRITE’ formula. The user reopened the formula 9082 in FIG. 90C and clicked the ‘ADD’ line (like in 8997 in FIG. 89B) to open the selection list 9324 in FIG. 93A. The formula 9313 has not changed from the formula 9082 in FIG. 90C but this new hint 9324 gives the user the option to add one of five different fields 9334 to the formula with the sixth field ‘name’ 9335 disabled (grayed out) because it has already been used. So other than the one disabled field the ‘ADD’ selection list gives three fields from ‘Table b’ 9326 and three fields from ‘Table c’ 9336 as it did in 9024 in FIG. 90A. The user sees the ‘Sponsor name’ field that they want and selects (e.g., clicks) it 9348 and then hits ENTER/RETURN to get either of the outcomes in FIG. 93B or FIG. 93C, depending on embodiment. Note the formula in FIG. 93A 9313 is consistent with the formula 9382 in FIG. 93C however had the field ‘name’ in FIG. 93A 9313 been instead ‘ADD (name)’ then it would have been consistent with the formula 9354 in FIG. 93B. Note, FIG. 93A was not replicated like this for brevity's sake. Also note there are many variants of the function which embodiments of our technology populate, this ‘ADD’ version simply letting the user know a join or even a sequenced/chained join has taken place. Conversely the function could have been any of the variants discussed herein, e.g., one that specifies the type of join and the join keys in any number of ways exampled or discussed.

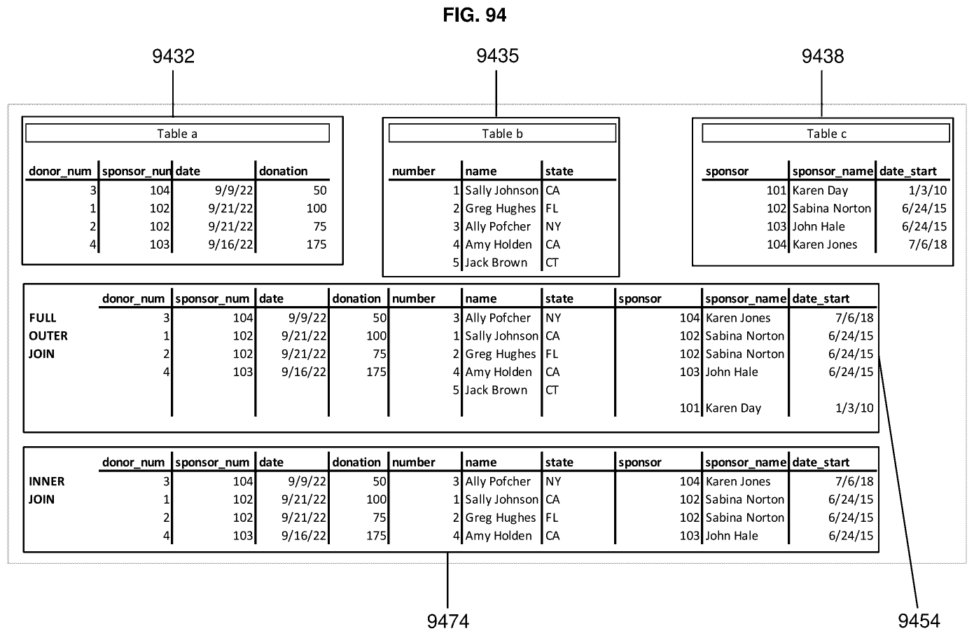

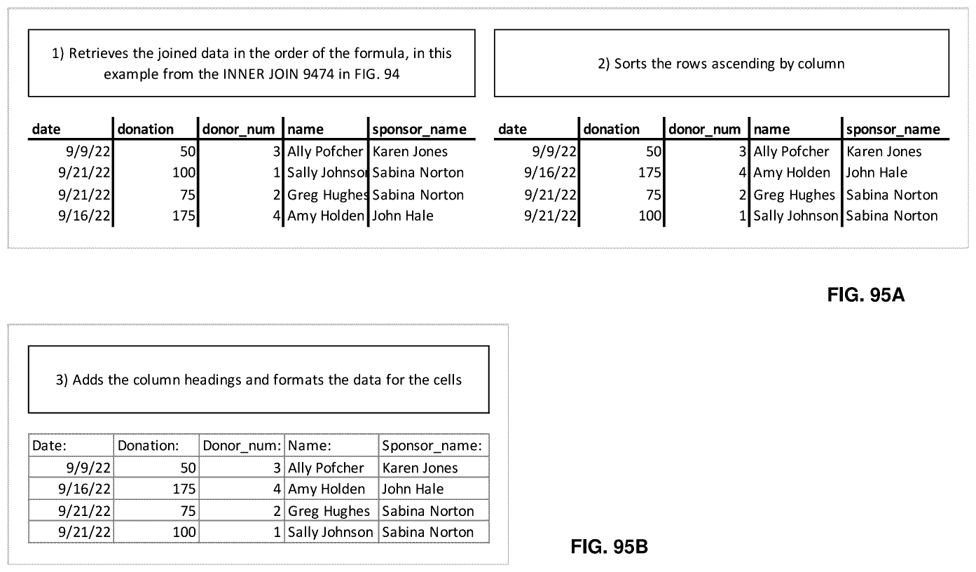

The end result is both FIG. 93B and FIG. 93C example one of our ‘WRITE’ function cell formulas joining data across three data sets (which could be from in-cell data, external data, or a combination of the two) as illustratively exampled in FIG. 94 through FIG. 95B. With the cells ‘A1’ through ‘C5’ 9362/9392 from ‘Table a’ 9432 in FIG. 94, with the cells ‘D1’ through ‘D5’ 9364/9394 from ‘Table b’ 9435 in FIG. 94, and with the cells ‘E1’ through ‘E5’ 9366/9396 from ‘Table c’ 9438 in FIG. 94. Those illustrative steps start with inner join of the three data sets illustrated in FIG. 94 9474 and then with the FIG. 95A step ‘1)’ retrieval of the required data. Step ‘2)’ in FIG. 95A ascending value row sorts the data in the order of the columns matching the argument order in the ‘WRITE’ formula. Step ‘3’ adds the headings, as previously described, and sends the values and the formula to cells ‘A1’ through ‘E5’ in either FIG. 93B 9363 or FIG. 93C 9393. Note, the ‘ADD’ function embodiment in this example eliminates the ADD from the ‘WRITE’ heading in FIG. 93B to display only the field name initial capitalized and followed by a colon. Although our technology could have also left the ‘ADD( )’ in the heading.

A more information rich variant of FIG. 93B is exampled in FIG. 135B where the auto-populated functions ‘JOIN_INNER’ (13568 and 13573) in the formula 13575 tells the user the types of joins employed (e.g., inner join) and the join key pair fields ‘donor_num, don_num’ and ‘sponsor_num, sponsor’ as the two arguments within the parentheses of each function. This gives a more expert user all the information needed to know how the output 13586 of the ‘sponsor_name’ and the output 13584 of the ‘name’ field was sequence/chain joined to the outputs 13582 from the third data set to give the complete ‘WRITE_V’ formula output 13583.

This example was selected because it is very visual and easy to understand what data went where via the functional formula joins. However, our technology for multiple (meaning more than two data set chained/sequenced joins) is applicable to any of the appropriate functional and formulaic data formulas mentioned herein. It is also applicable to joining four or more data sets and all the different applicable (e.g., ignoring self joins) join types discussed herein. It is applicable to many different types of joins, as exampled in FIG. 94 9454 which exampled the chained/sequenced join using a ‘FULL OUTER JOIN’ rather than the ‘INNER JOIN’ 9474 used in the examples in FIG. 89A and FIG. 95B. Rather than exampling more of these situations with this set of unique data joins, we will move onto multiple data set joins involving unique and non-unique join keys.

### Three or More Data Set Joins Involving Non-Unique Join Keys

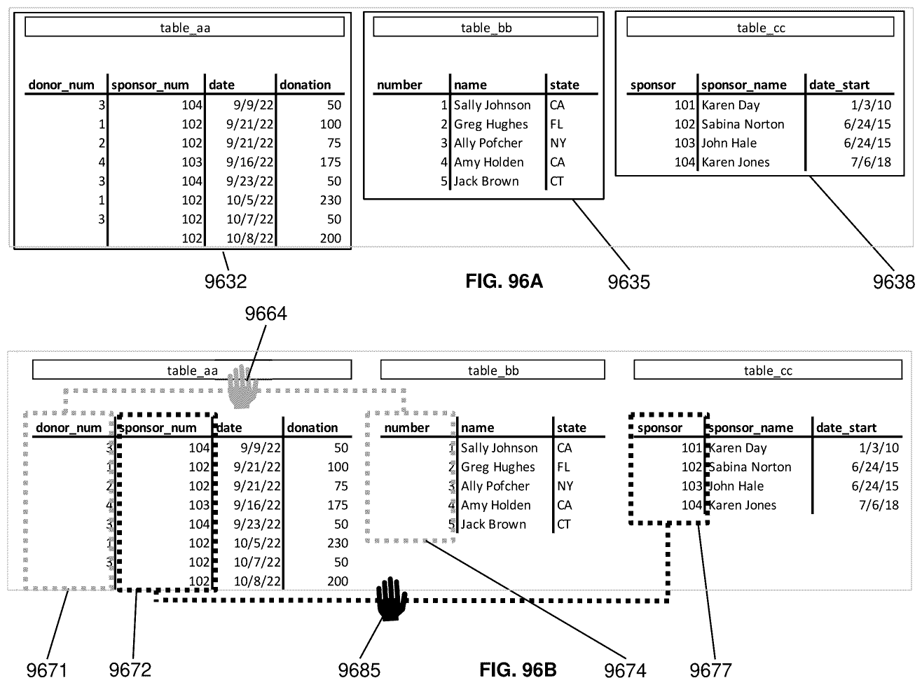

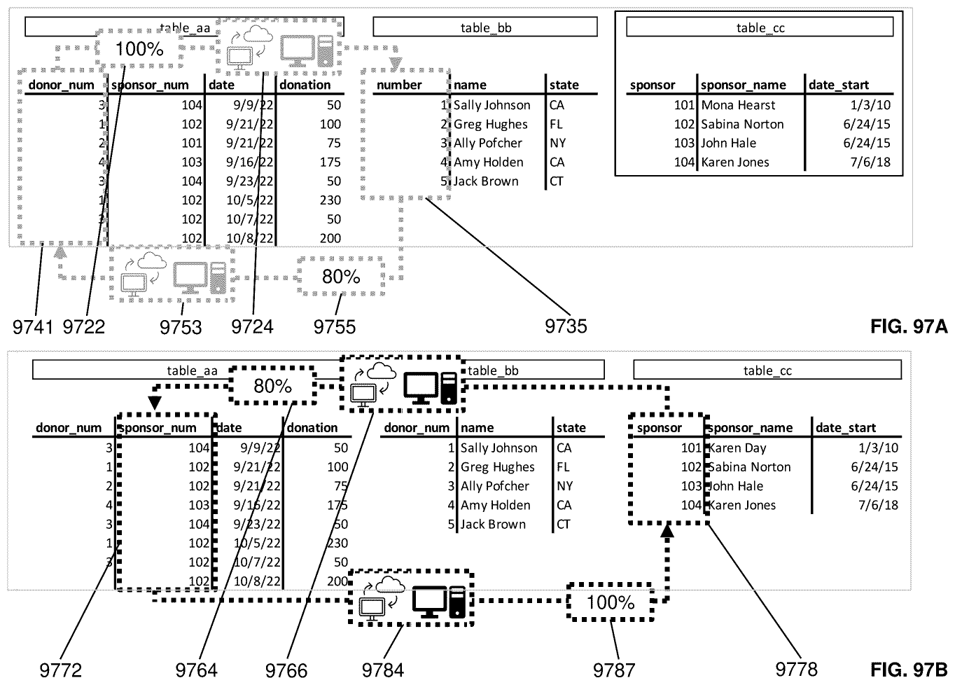

FIG. 96A examples three data sets ‘table_aa’ 9632, ‘table_bb’ 9635, and ‘table_cc’ 9638. There could be more data sets available to the user, but we example these three because they are joinable. In FIG. 96B tables ‘table_aa’ 9632 and ‘table_bb’ 9635 have potential join keys 9671/9674 where join key ‘donor_num’ 9671 is non-unique and ‘number’ 9674 is unique. ‘table_aa’ 9632 and ‘table_cc’ 9638 have potential join keys 9672/9677 where join key ‘sponsor_num’ 9672 is non-unique and ‘sponsor’ 9677 is unique. In FIG. 96B these join key pairs are manually specified by the user 9664/9685. That manual specification could then be verified by our technology in one or more different embodiments along the lines previously discussed and exampled in FIG. 4. FIG. 97A and FIG. 97B illustratively examples those same two potential joins 9741/9735 and 9772/9778 being automatically generated and qualification validated (9722/9755 and 9764/9787) on the user's computer, in the cloud or some combination of the two 9724/9753 and 9784/9766. The data types are the same for each join key pair, all the join key pairs are data modelling cardinality unique to non-unique, and the values matches are all ‘80%’ or higher (as shown in 9722/9755/9764/9787), thus passing the one-way and two-way match requirements set for this embodiment (e.g., 75%). Those setup and validation actions could be done using any of the previously exampled appropriate UIs or alternatives and could be fully automatic or semi-automatic with a last qualification by a user or our automated validation.

The user now has a data set with the potential for multiple unique to non-unique data set chained/sequences joins and, as we will example next, can do that in a formula with only two fields in our technology. The user would like to know the first alphabetically sorted donor name assigned to the sponsor Sabina Norton. They are going to do this using a FULL OUTER JOIN so that no data is eliminated in the process of the joins, which is easily done in our technology as we support all the join types.

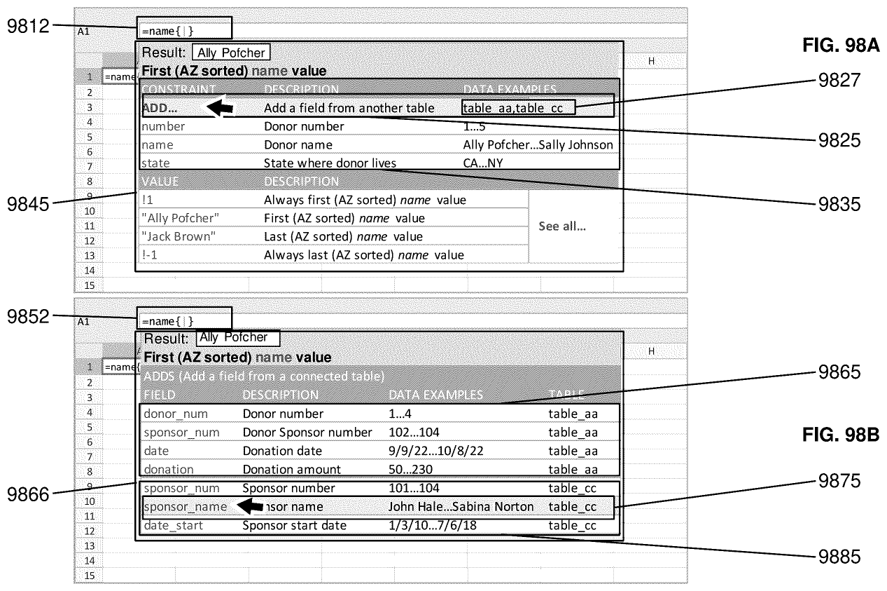

In FIG. 98A the charity user has typed or selected the formulaic data field/column ‘=name { }’ into the formula 9812 for cell ‘A1’. That opened the selection list 9845 in which the user does not see the field/column for sponsor name that they want in the list 9835 for the table which ‘name’ resides in, however they do see they have access to joinable data via ‘ADD . . . ’. They therefore click the ‘ADD . . . ’ row 9825 to gain access to the joinable fields in ‘table aa, table cc’ 9827 where they hope to find the field/column they desire. In this embodiment that does not change the formula 9852 but changes the selection list 9866 as shown in FIG. 98B. Here the user sees four fields/columns from ‘table aa’ 9865 and three fields/columns from ‘table_cc’ 9885. Within those they see the ‘sponsor_name’ field that they desire and click (select) it 9875. This populates ‘sponsor_name’ into the formula 9912 as shown in FIG. 99A and opens the ‘sponsor_name’ constraint (filter) selection list 9935. There the user sees the ‘Sabina Norton’ 9925 and selects it populating it into the formula 9942 shown in FIG. 99B. Because our formulaic data formulas default to the first value, which for a text field is alphabetically sorted, the user has the answer they want. With this hint 9965 it is visible in two places even before the user hits ENTER/RETURN. First it is visible in the ‘RESULT:—’ 9952 which tells the user the result for the formula thus far. Note in this embodiment nulls or blanks alphabetically sort first. It is also apparent to a user that if the ‘(blanks)’ line 9974 displays that a blank is the first value. So, when the user hits ENTER/RETURN it is not a surprise that the value returned by the formula 9982 in cell ‘A1’ 9992 in FIG. 99C is ‘-’ (blank). Note as well in this embodiment blanks/nulls are populated as ‘-’.

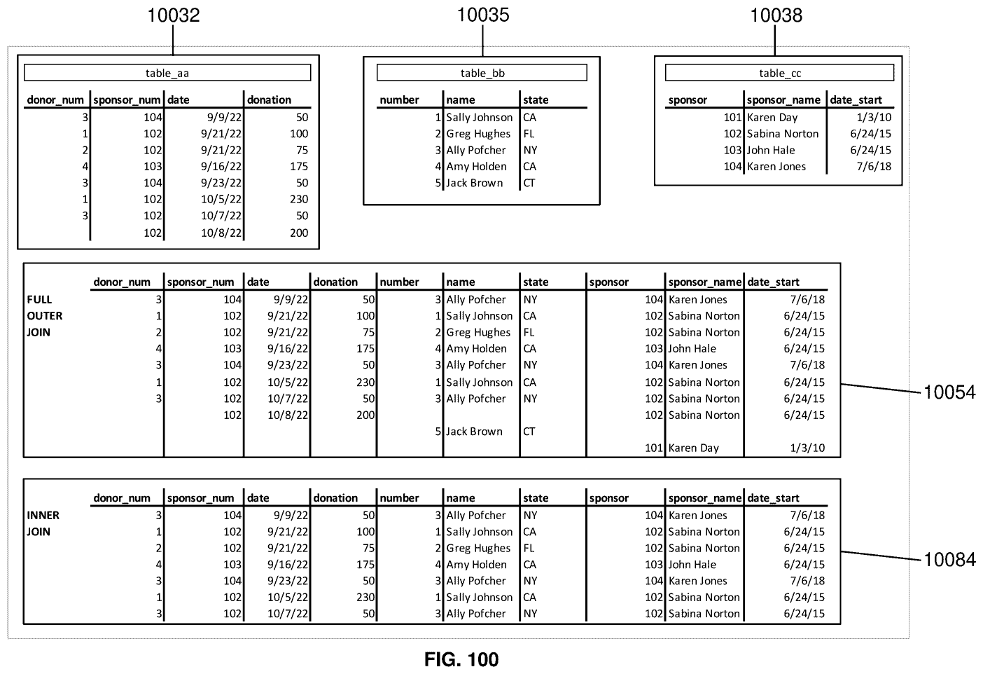

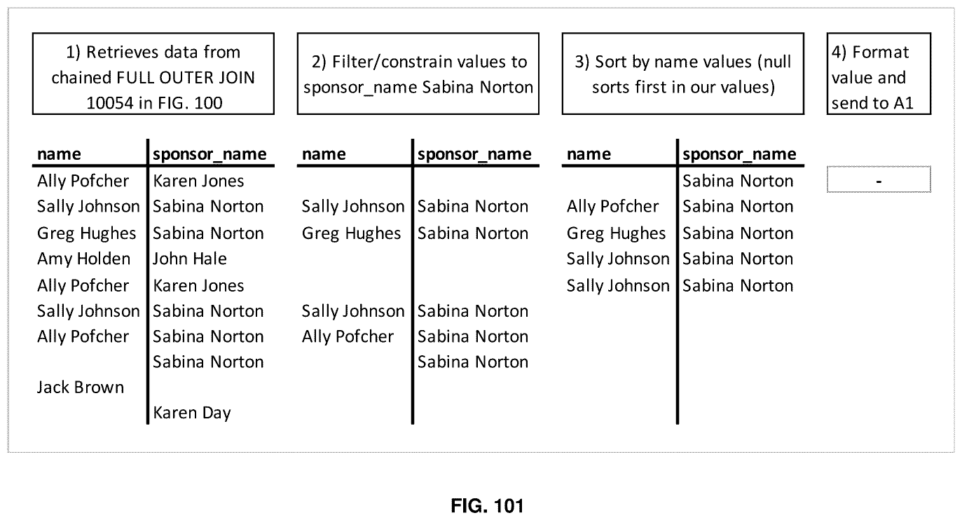

The intriguing part of this outcome is that a two-field cell formula triggered a three data set chained/sequenced join as illustratively exampled in FIG. 100 and used in FIG. 101. That is a capability supported in our technology where the fields joined are not in two data sets sharing a join key pair, but instead are in two tables (‘table_bb’ 10035 and) ‘table_cc’ 10038) chain/sequence joined through a third table, in this example ‘table_aa’ 10032. Thus, the join triggered by the formula 9982 in cell ‘A1’ 9992 in FIG. 99C does the three data set chained/sequenced ‘FULL OUTER JOIN’ 10054 in FIG. 100 from which step 1) in FIG. 101 retrieves the data for the formula, step 2) constrains (filters) the data to only ‘sponsor_name’ values of ‘Sabina Norton’, before step 3) sorts the values in ascending ‘name’ order before step 4) formats and sends the result to cell ‘A1’ 9992 in FIG. 99C. Our technology allowed a user to write a very simple formula that joined across (chained/sequenced) three data sets before doing other manipulation to arrive at the cell result. And as we discussed this could have been done in a formula with one or more range or non-range analytical prebuilt functions and in combinations of them with multiple algebraic operators.

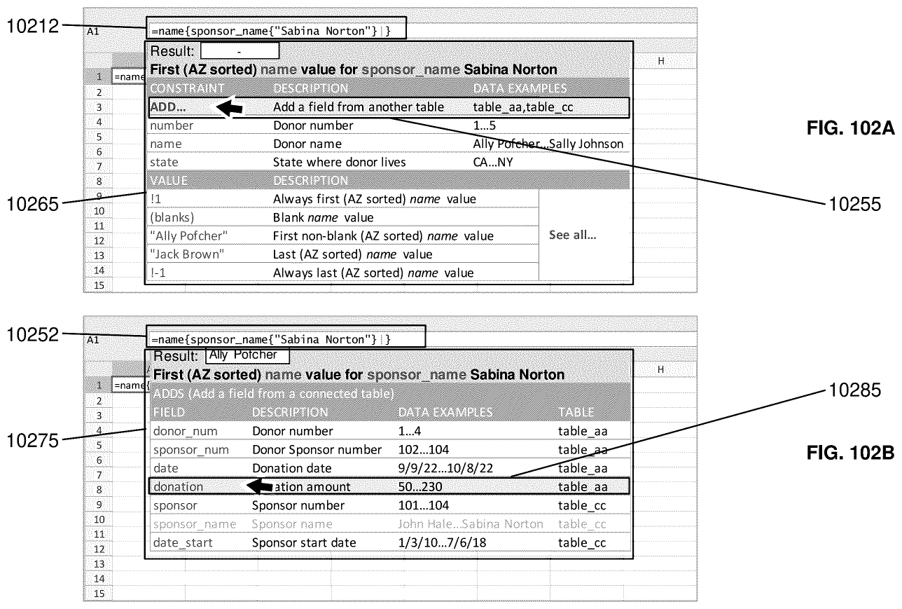

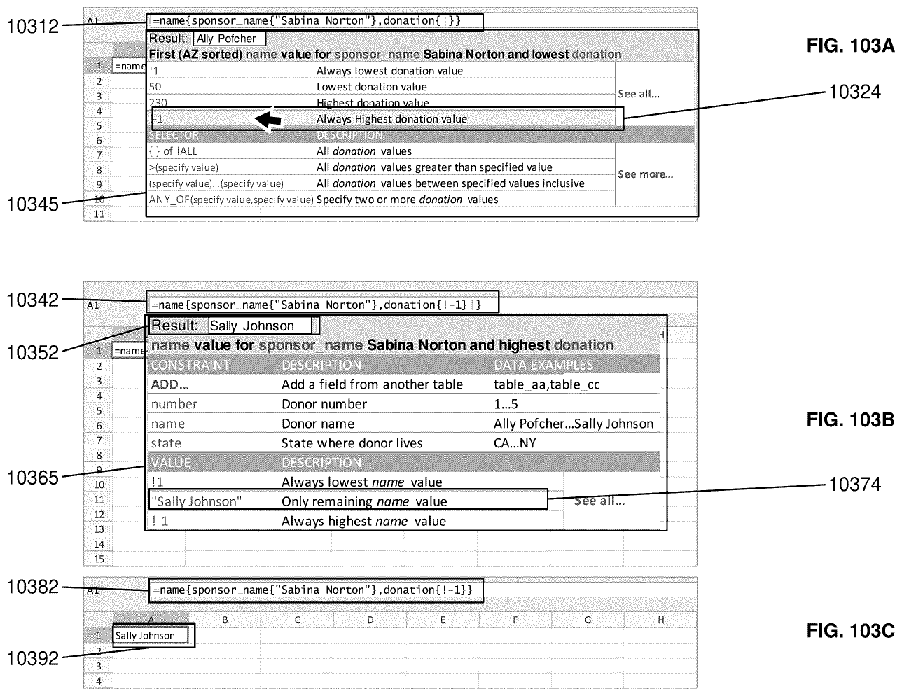

Our technology easily allows the user to go beyond that two field three table join to include fields from the third table as exampled in FIG. 102A through FIG. 104B. The charity user reopens the formula created in ‘A1’ 9992 in FIG. 99C in the formula 10212 in FIG. 102A opening in this embodiment the selection list 10265. The user wants to get the name of the donor who gave the largest donation for the ‘sponsor_name’ ‘Sabina Norton’. When they look at the selection list they do not see a donation amount field, so they select the ‘ADD . . . ’ line 10255 to see their joined field options in the next selection list 10275 in FIG. 102B. There they see the field that they want ‘donation’ and select (click) it 10285 to populate it into the formula 10312 in FIG. 103A. This gives them the selection list 10345 where they select”!-1’ 10324 to get the ‘!-1 Always Highest donation value’. That populates into the formula 10342 in FIG. 103B opening, in this embodiment, the selection list 10365 where the user can see the ‘RESULT: Sally Johnson’ 10352 which tells the user the result for the formula thus far. They can also see ‘“Sally Johnson” Only remaining name value’ 10374 so they know they have what they want. They therefore hit ENTER/RETURN to get outcome in FIG. 103C of ‘Sally Johnson’ in cell ‘A1’ 10392 from the formula 10382. FIG. 100, FIG. 104A and FIG. 104B example the illustrative steps automatically executed by our application to join the data sets (see FIG. 100) and then use those chain joined values produce the result (see the calculations in FIG. 104A and FIG. 104B). Our technology, even in this a relatively simple formula, chain/sequence joined three data sets and did multiple data manipulations to arrive at the cell result.

### Three or More Data Set Joins in Multiple Function Formulas

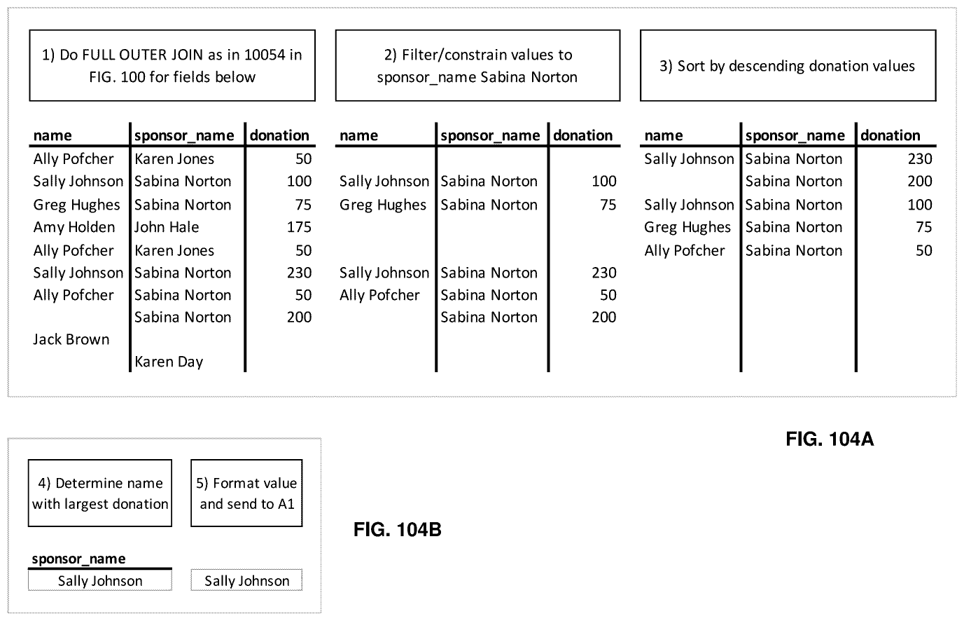

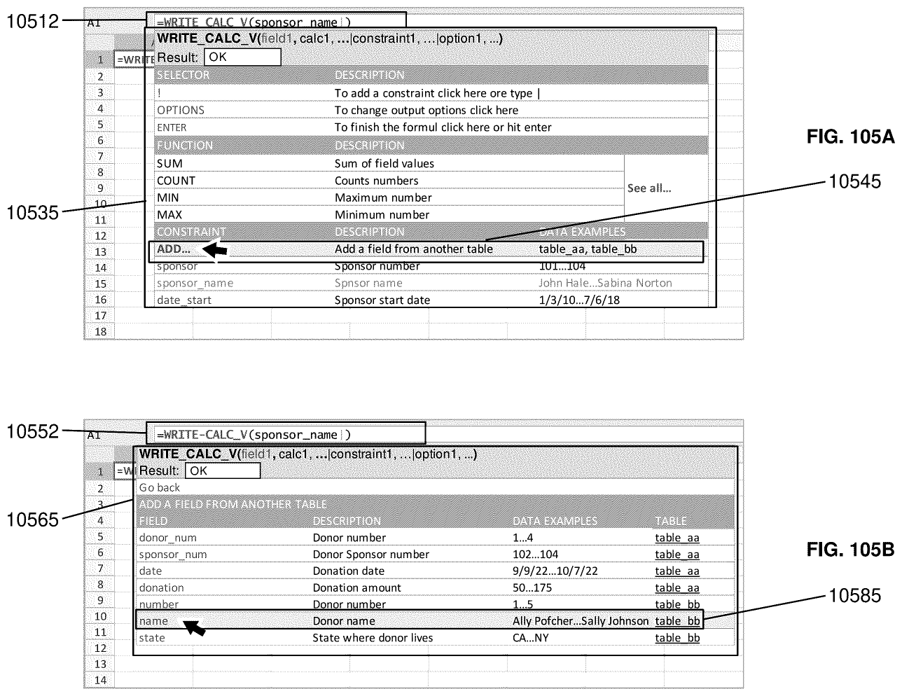

FIG. 105A through FIG. 108 examples multiple function use of our three or more data set chain/sequence join technology employing a combination of a ‘WRITE_CALC_V’ and ‘SUM’ function. As previously mentioned, this is a simple example of our technologies ability to handle formulas with multiple functions, different types of functions (e.g., range, non-range, multi-cell populating, and multi-value selecting single functions), and where appropriate connected by algebraic operators.

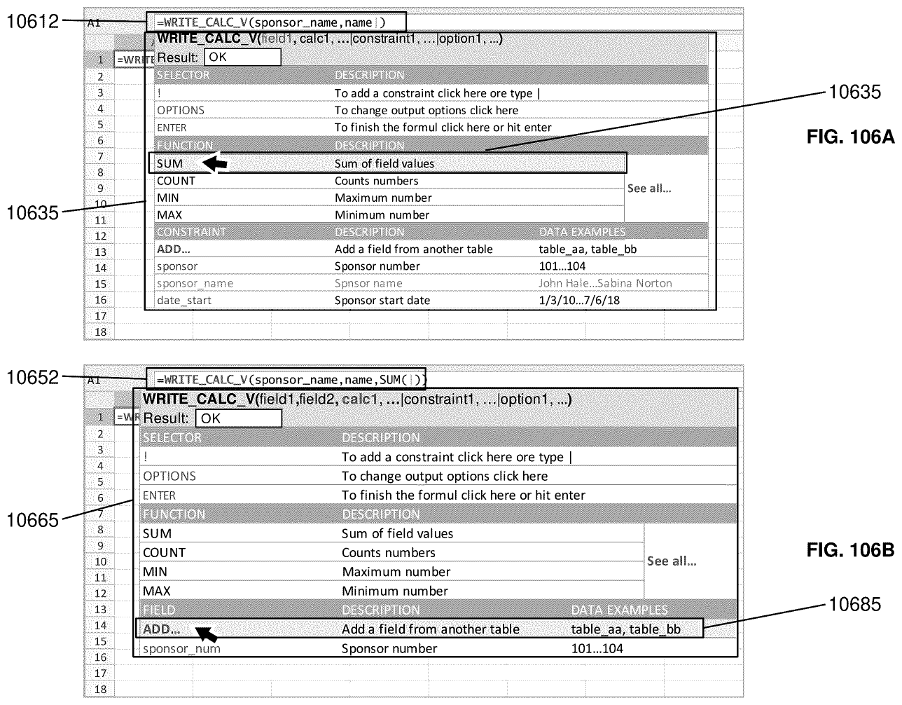

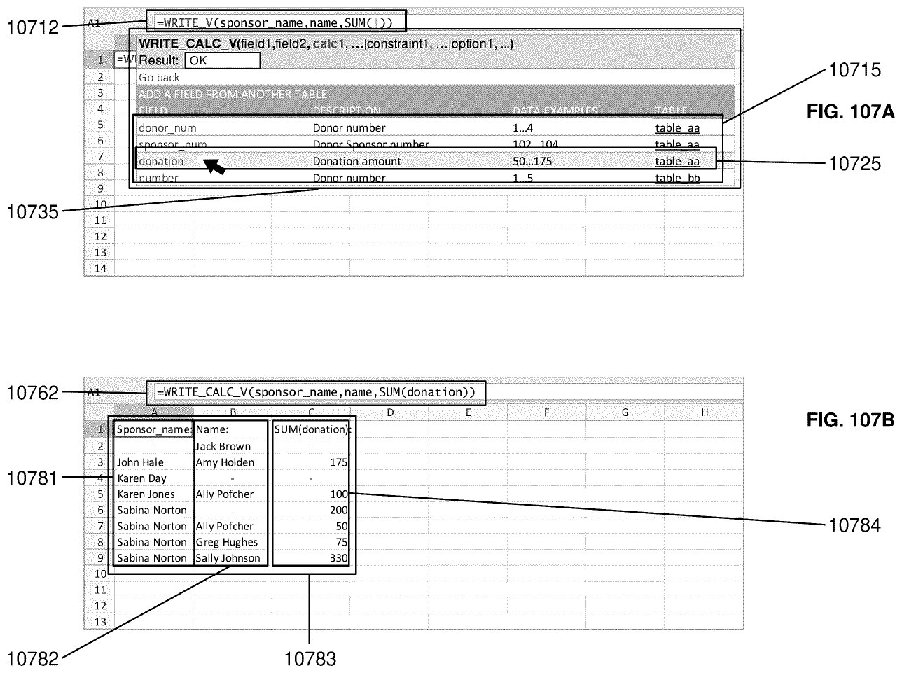

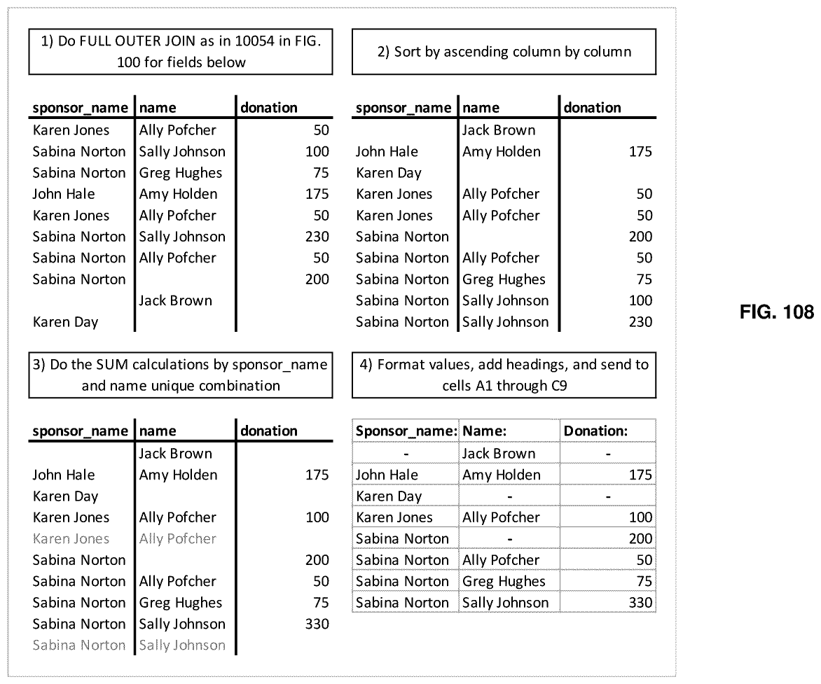

Our charity user wants to calculate the total donations for each donor (by their name) and each donor's sponsor (by their name). To do so they start in FIG. 105A with a ‘WRITE_CALC_V’ function then populating the field ‘sponsor_name’ in the formula 10512. In this embodiment this exposes the selection list 10535 where the user does not see the field they want to populate next, a field that holds the name of each donor. They therefore click the ‘ADD . . . ’ line 10545 which is visible there because there are joinable fields/columns in other tables. That selection does not change the formula 10552 but accesses/opens a new selection list 10565 in FIG. 105B where the user sees a field ‘name’ that holds the Donor name’. The user therefore selects that field ‘name’ 10585 which is then populated in the formula 10612 in FIG. 106A. This opens the selection list 10635 where the user selects ‘SUM’ 10635. This populates ‘SUM’ into the formula 10652 in FIG. 106B where the user does not see the value they want to sum in the selection list 10665. So, they select the ‘ADD . . . ’ line 10685 which lets the user know they can access and select fields from ‘table_aa, table_bb’. This opens the selection list 10735 in FIG. 107A for the unchanged formula 10712 where the user sees all numeric fields 10715 in data tables ‘table_aa’ and ‘table_bb’. There the user sees the field ‘donation’ which holds the ‘Donation Amount’ for each donation, so they select it 10725 and then hit ENTER/RETURN to deliver the formula 10762 in FIG. 107B which populates the cells ‘A1’ through ‘C9’ 10783. That output has values in cells ‘A1’ through ‘A9’ 10781 from ‘table_cc’, values in cells ‘B1’ through ‘B9’ 10782 from ‘table_bb’ and calculated values in cells ‘C1’ through ‘C9’ 10784 from “table_aa’ using the groupings created by the unique value combinations from cells ‘A1’ through ‘B9’ sourced from both tables ‘table_cc’ and ‘table_bb’ as illustrated in the sequenced/chained joins in FIG. 100 10054 and calculations in FIG. 108. Our technology not only does the triple table sequenced/chained join but then makes the data available for cell calculations use sorting in step 2 in FIG. 108), summing for the unique combinations across two tables using values from a third in step 3) in FIG. 108, and then formatting and sending to a cell or in this example multiple cells in step 4) in FIG. 108.

Our triple and beyond data set chained/sequenced joins technology can support all the types of SQL joins or block certain situations (e.g., with formula ERROR messages) as previously described for other join situations. Additionally, we can support certain sequenced/chained join situations with our selection lists while allowing a broader or complete set of SQL sequenced/chained join situations in our cell formulas (with this broader set of joins not supported by selection lists or very complete selection lists). We have already exampled this limitation of selection lists to exclude non-unique to non-unique join key pair joins and will now example a specialized situation of that rule that occurs in three or more data set chained/sequenced joins.

### Three or More Data Set Joins Situational Selection List Potential Joins

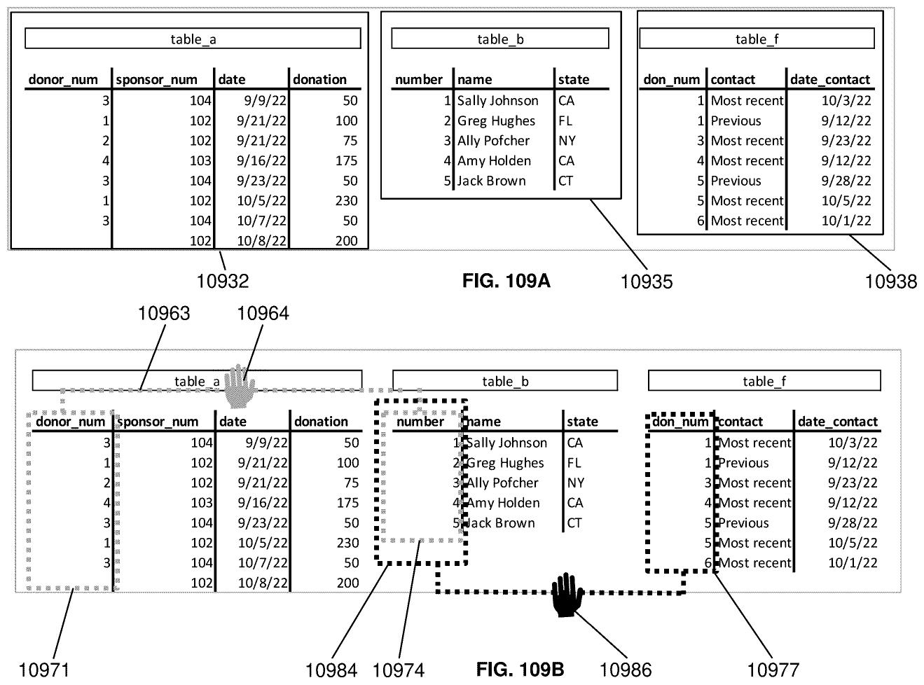

FIG. 109A through FIG. 116B examples a situation that does not occur in two data set joins but does occur in three or more data set chained/sequenced joins, where the combination turns unique to non-unique join key pair joins into effectively non-unique to non-unique chained/sequenced join key pair joins. Therefore, an embodiment of our selection lists can initially offer two potential table joins for a data set but once one of the fields from one of the joins is populated in the formula the option to join the other data set goes away. Embodiments supported by our technology then can differ in what they do, for example one embodiment can generate an error if the user goes ahead and populates a field from the third data set and another embodiment can allow the user to complete the chained/sequenced join and populate the field in the formula for a successful chained/sequenced join use.

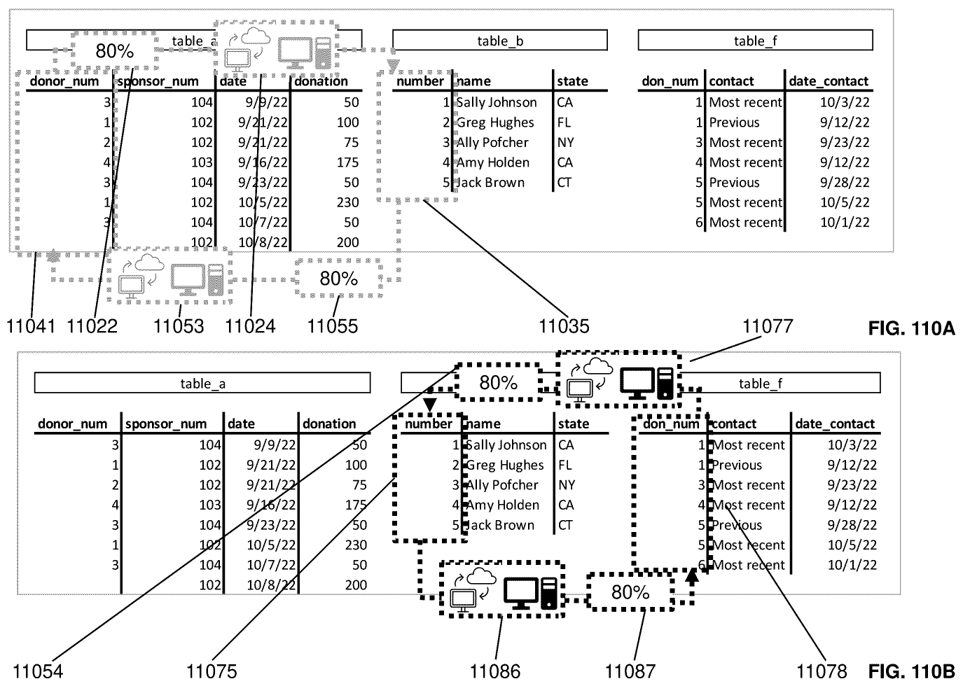

FIG. 109A examples three data sets ‘table_a’ 10932, ‘table_b’ 10935, and ‘table_f” 10938. There could be more data sets available to the user, but we example these three because they are joinable to each other. Data sets ‘table_a’ 10932 and ‘table_b’ 10935 in FIG. 109B have potential join keys 10971/10974 where join key ‘donor_num’ 10971 is non-unique and ‘number’ 10974 is unique. Then ‘table_b’ 10935 and ‘table_f’ 10938 have potential join keys 10984/10977 exampled in FIG. 109B where join key ‘don_num’ 10977 is non-unique and ‘number’ 10984 is unique. In FIG. 109B these join key pairs are manually specified by the user 10964/10986. That manual specification could then be verified by our technology in one or more different embodiments along the lines previously discussed and exampled in FIG. 4. FIG. 110A and FIG. 110B illustratively examples those same two potential joins 11041/11035 and 11075/11078 being automatically generated and qualification validated (11022/11055 and 11054/11087) on the user's computer, in the cloud or some combination of the two 11024/11053 and 11077/11086. The data types are the same for each join key pair, all the join key pairs are unique, and the values matches are all ‘80%’ (as shown in 11022/11055/11054/11087), thus passing the one-way and two-way match requirements set for this embodiment (e.g., 75%). Those setup and qualification validation actions could be done using any of the previously exampled appropriate UIs or alternatives in our spreadsheet application or a separate data intake tool. They could be done fully automatic or semi-automatic with a user making the final determination on the joins.

The user now has data sets with the potential for multiple unique to non-unique data set joins but as we will example in this embodiment the selection lists do not support joins across all three data sets when those sequenced/chained joins are non-unique to non-unique (many to many). The rationale being that when you sequence/chain join all three data sets the join becomes a non-unique to a non-unique which in this embodiment is not supported in the selection lists as we are about to example. In different variants of that embodiment the non-unique to non-unique join is also not supported in the formula (results in an error) or is supported (exposing users to what we have called partial Cartesian Product duplication of some data rows) as we will example.

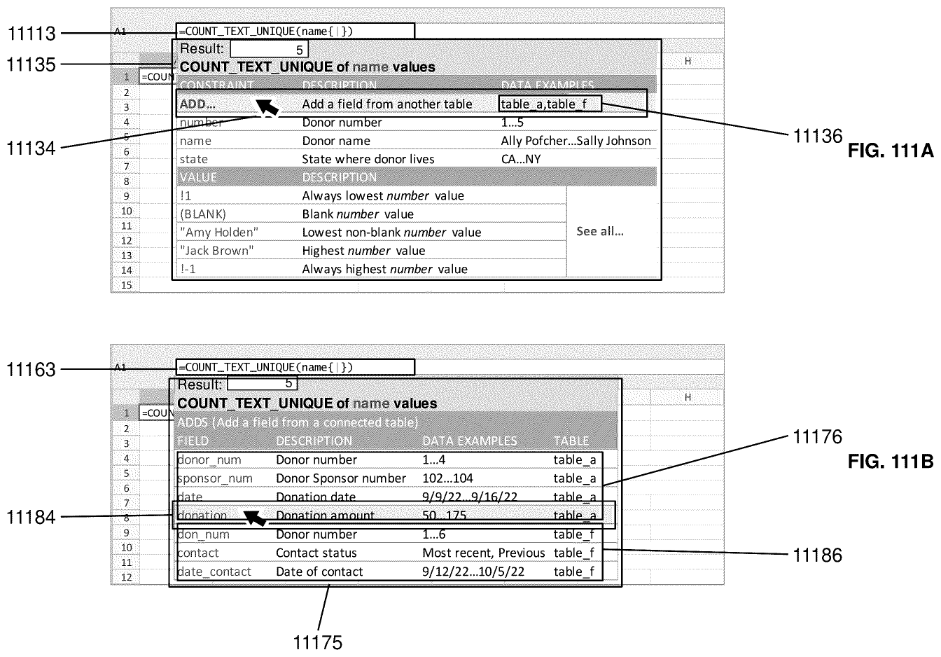

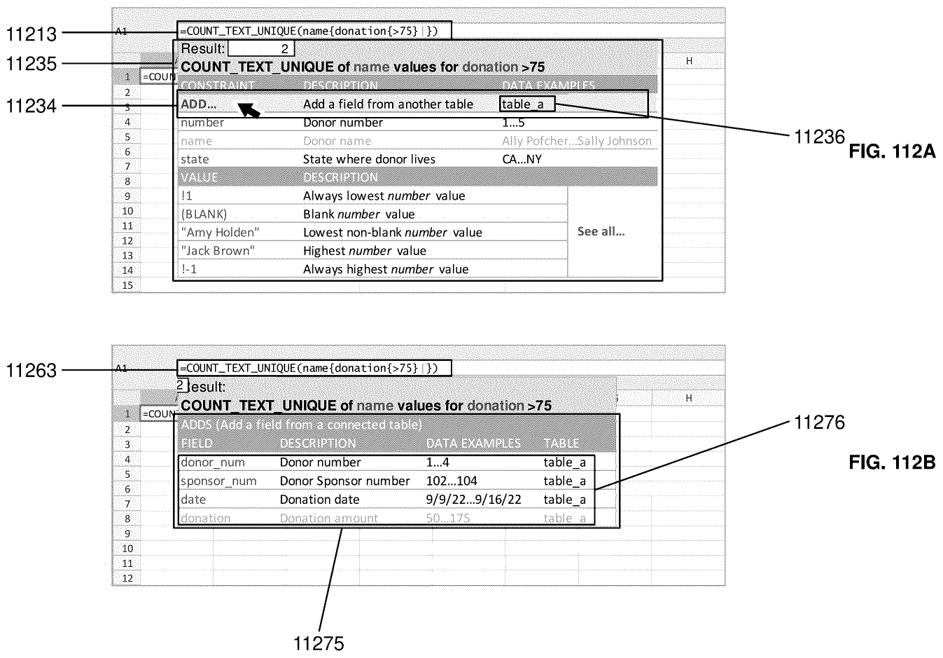

The user would like to know the count of the unique donors, by their donor name, who gave over $75 and were contacted by a charity worker (sponsor) before ‘Oct. 1, 2022’. To do so, they start a cell formula ‘-COUNT_TEXT_UNIQUE (name { })’ 11113 in FIG. 111A opening, in this embodiment, the selection list 11135 for the ‘table_b’ which ‘name’ resides in and with ‘ADD . . . ’ access to the joinable tables. Because they want to next add the constraint of donations greater than $75 and they do not see donations in the selection list 11135, they click the ‘ADD . . . ’ row 11134 to gain access to the joinable fields in ‘table_a, table_f’ 11136 where they hope to find the field/column. In this embodiment that does not change the formula 11163 but changes the selection list 11175 as shown in FIG. 111B. Here the user sees four fields/columns from ‘table_a’ 11176 and three fields/columns from ‘table_f’ 11186. Within those they see the ‘donation’ field that they desire and click (select) it 11184. This populates ‘donation’ into the formula 11213 where they have additionally populated the constraint/filter of ‘>75’ as shown in FIG. 112A. This then opens the selection list 11235. Where it is different that the ‘ADD . . . ’ line 11234 only lists ‘table_a’ 11236 and no longer lists ‘table_f’ as it did in the selector list 11135 ‘DATA EXAMPLES’ ‘table_a, table_f 11136 shown in FIG. 111A. This is because once the ‘table_a’ and table_b’ join has taken place (which is a non-unique to unique join), adding the ‘table_f’ join would create a non-unique to non-unique chained/sequenced join which this embodiment of selection lists does not support (i.e., does not present). Therefore, when the user clicks (selects) ‘ADD . . . ’ 11234 they get the selection list 11275 in FIG. 112B which only has fields/columns from ‘table_a’ 11276. They are not presented the fields/columns from ‘table_f″ 11186 as they were in FIG. 111B. This embodiment of our technology automatically stops presenting a selection list option once its selection would result in a many to many (non-unique to non-unique) data modelling cardinality sequenced/chained join.

Other embodiments of our technology support presenting every available SQL legitimate join option in selection lists, not limited by any singular limitation including, non-unique to non-unique, one-way match percentages, two-way match percentages, or combinations of those limitations.

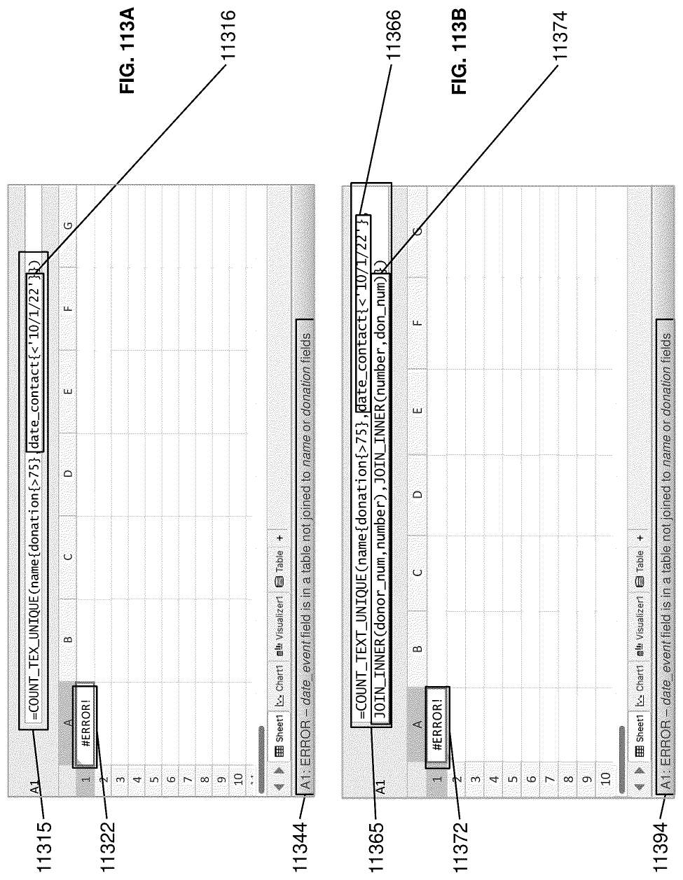

In this embodiment, with selection lists blocking non-unique to non-unique joins, one embodiment variant generates an error if the user goes ahead and types the formula as if the join exists and works. FIG. 113A and FIG. 113B example two different ways of the user typing the formula with the same outcome of an ERROR. In FIG. 113A the user types the formulaic data constraint argument ‘date_contact {<‘Oct. 1, 2022’}’ 11316 into the formula 11315 which attempts to join the third data set resulting in the non-unique to non-unique join. But this embodiment blocks that in the formula resulting in the ‘#ERROR!’ 11322 error result. In this embodiment it also registers an error message 11344 in the status bar at the bottom of the application. FIG. 113B examples the user not only typing the formulaic data constraint argument ‘date_contact {<‘Oct. 1, 2022’}’ 11366 but also typing two arguments specifying the two different joins (e.g., where ‘JOIN’ is a FULL OUTER JOIN) with their join key pair fields 11374 into the formula 11365. However, this greater definition of the two joins which result in the three-data set chained/sequenced join is still blocked by this embodiment because it results in a non-unique to non-unique join. When the user hits ENTER/RETURN to evaluate the formula the result is the ‘#ERROR!’ 11372 error and it also registers an error message 11394 in the status bar at the bottom of the application. So, in this embodiment variant the user is totally blocked from non-unique to non-unique joins. And as described previously this total blocking could be extended to other qualification validation types, such as those exampled in FIG. 4.

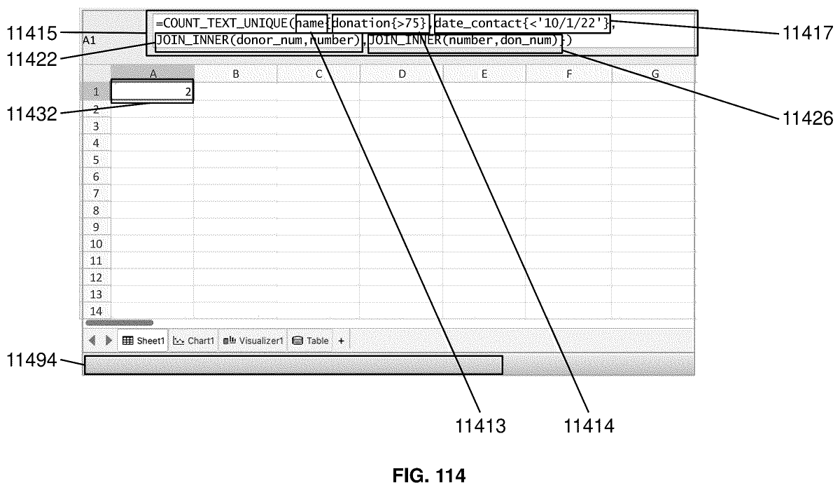

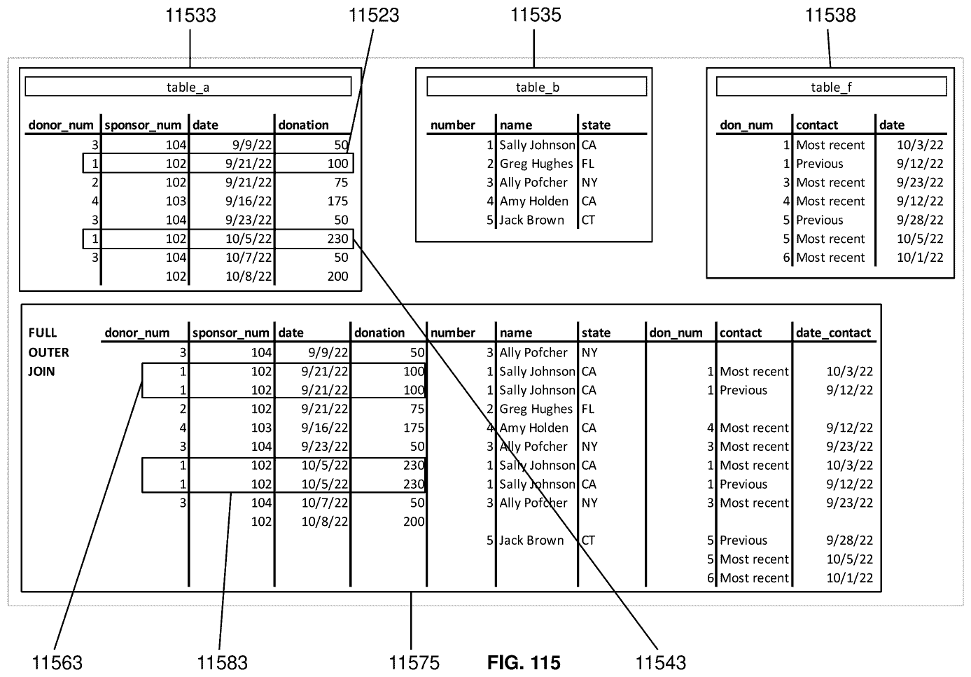

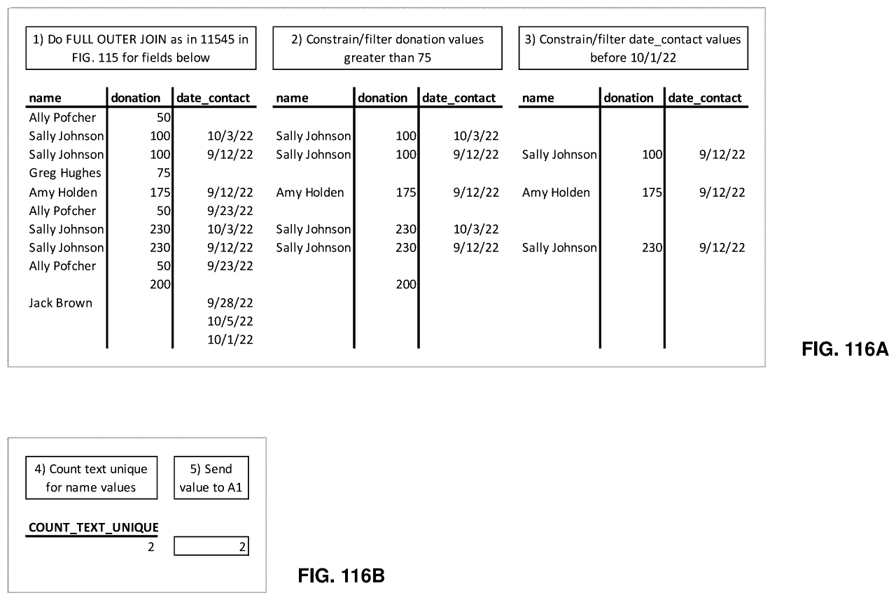

However, in another variant of the embodiment where the selection list does not present join options that would result in non-unique to non-unique join, our technology allows formulas typed or otherwise inputted without a selection list as exampled in FIG. 114. In this example the selection lists worked as exampled in FIG. 111A through FIG. 112B for the first two data set arguments ‘name’ 11413 and ‘donation {>75}’ 11414. However, when the user then manually typed the remaining three arguments, 11417 (the third data set field), 11422 (the first join), and 11426 (the second join) and hits ENTER/RETURN the formula successfully evaluates as exampled by the output ‘2’ in cell ‘A1’ 11432. As also exampled in this embodiment by the lack of an error message in the status bar 11494 at the bottom of the application. The formula does the three data set chained/sequenced join and evaluates as illustratively exampled in FIG. 115 (exampling the chained/sequenced joins) and FIG. 116A/FIG. 116B (exampling the function calculations using the chain/sequenced joined data). As we have previously described, this allows a more sophisticated user who understands what occurs in non-unique to non-unique joins to do those in our technology while protecting less sophisticated users, who rely on the selection lists, from creating joins they likely do not understand. Where for example the more sophisticated user in this example would understand or figure out that what we have called the partial Cartesian Product duplication of some rows in the chained/sequenced join does not affect this formula's outcome. Although in other situations, which we will example later, the user would need to consider other actions (e.g., adding constraints) to remove the impact of those duplications (e.g., removing the duplication of ‘donation’ values which would otherwise overstate the actual donations) to get a correct answer.

The end result is our technology has the flexibility to support in our selection lists the full range from every type of SQL supported join to no joins at all, has the flexibility in our formulas to support the full range from every type of SQL supported join to no joins at all, and has flexibility to support any of the combinations of those capabilities where the formula support is equal to or broader than selection list support. Before exampling our spreadsheet formula data joining technology working with little or no selection lists, we will example our technology supporting two different sets of selection lists that can then work together.

Data Joining Setup and Joinable Data Use Selection Lists—from Formula Start

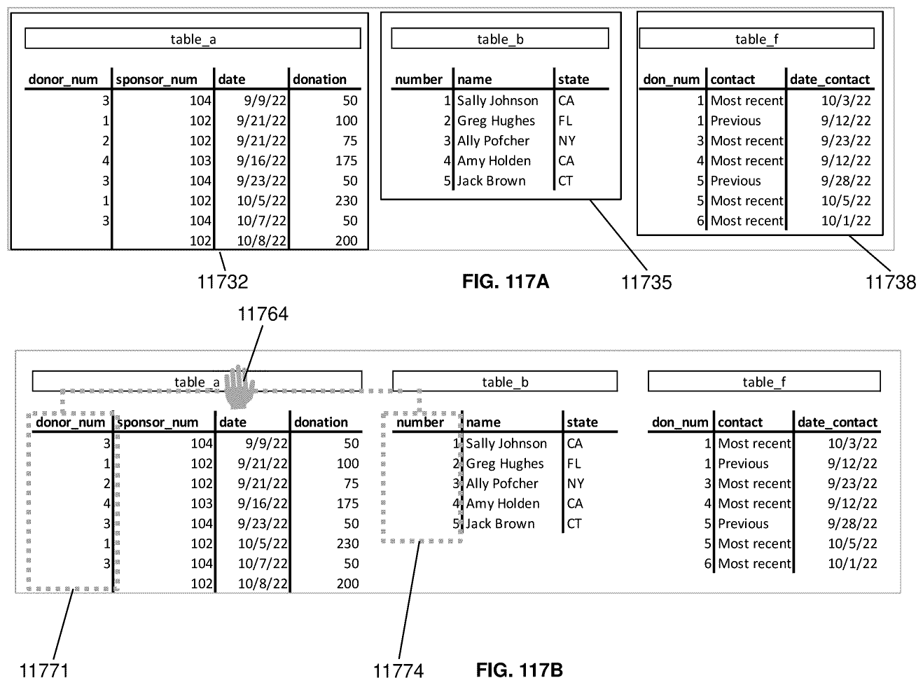

FIG. 117A through FIG. 121C example our spreadsheet cell formula data joining technology working for two different sets of data joining selections lists from the beginning of the formula, one set for setting up joins and one set for using the joinable fields/columns. We return to our charity user who has the three data sets in FIG. 117A. As we previously exampled in FIG. 115, joining all three of these data sets (11533, 11535 and 11538) results 11575 in what we called a partial Cartesian Product duplication of some of the rows (e.g., 11523 duplicated in 11563 and 11543 duplicated in 11583) that can distort values such as the total amount of donations. For that reason, the person setting up the readily visible joined fields only sets up the data set join between ‘table_a’ 11732 (FIG. 117A) and ‘table_b’ 11735 (FIG. 117A) as exampled in FIG. 117B 11771/11764/11774. They want the data joins between ‘table_a’ 11732 (FIG. 117A) and ‘table_b’ 11735 (FIG. 117A) to be readily visible to all the users. However, in this embodiment there is a secondary (double) selection list that helps more sophisticated users create their own joins and then in that formula make the joined fields visible in the readily available selection list. We will return to the charity worker wanting to know the number of donors, by name, who gave donations of greater than ‘$75’ and have been contacted by their sponsor before ‘Oct. 1, 2022’.

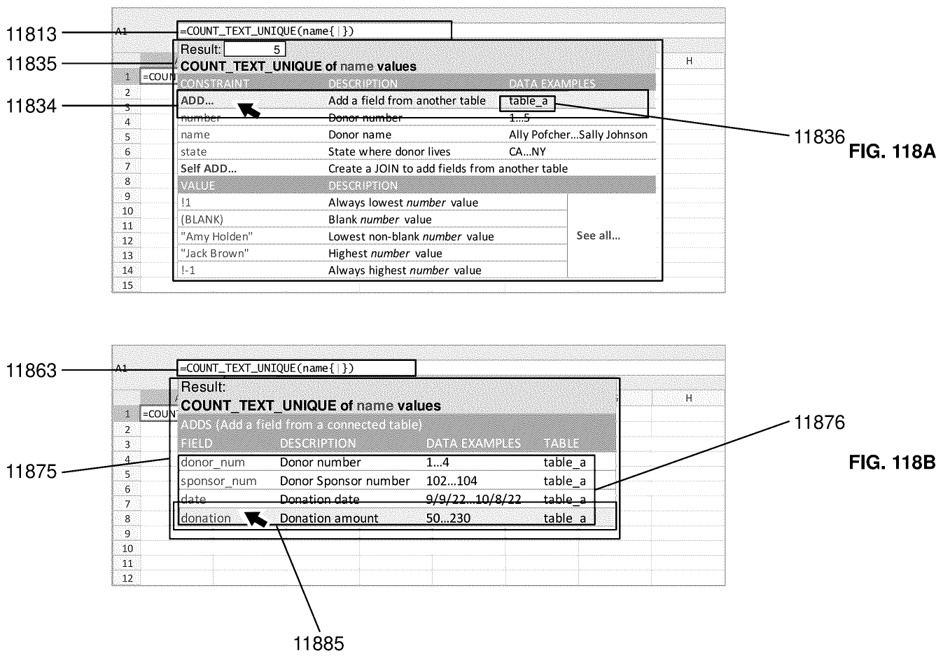

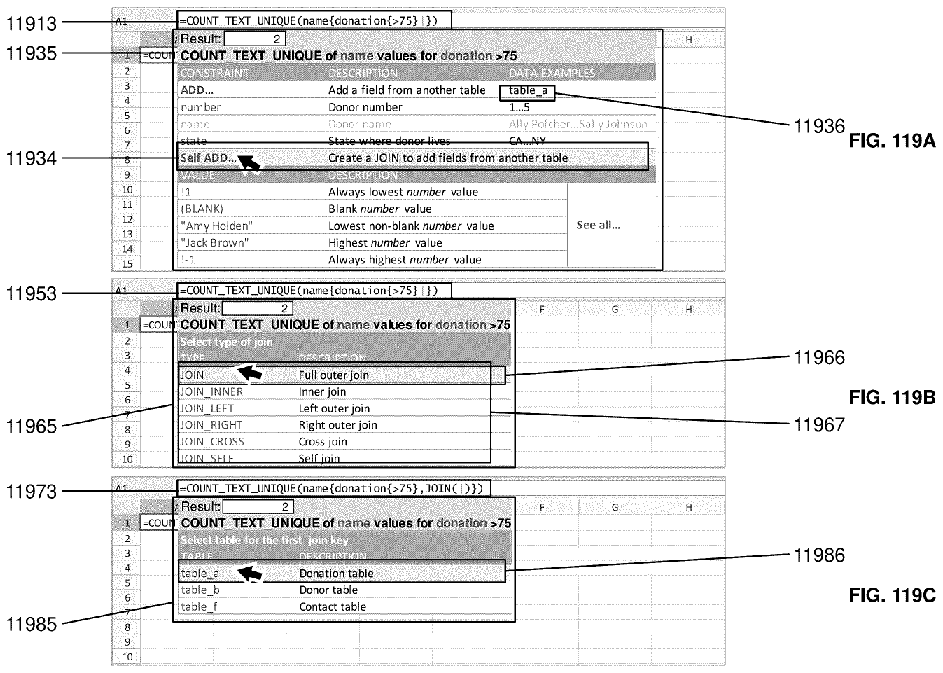

To do so, they start a cell formula ‘=COUNT_TEXT_UNIQUE (name { })’ 11813 in FIG. 118A opening in this embodiment the selection list 11835 for the ‘table_b’ which ‘name’ resides in. Because they want to next add the constraint of donations greater than $75 and they do not see donations in the selection list 11835, they click the ‘ADD . . . ’ row 11834 to gain access to the joinable fields in ‘table_a’ 11836 where they hope to find the field/column they desire. In this embodiment that does not change the formula 11863 but changes the selection list 11875 as shown in FIG. 118B. Here the user sees four fields/columns from ‘table_a’ 11876. Within those they see the ‘donation’ field that they desire and click (select) it 11885. This populates ‘donation’ into the formula 11913 where they have additionally populated the constraint/filter of ‘>75’ as shown in FIG. 119A. This then opens the selection list 11935 but this time the user wants to add a constraint (filter) of the donor having been contact (by their sponsor from the charity) before ‘Oct. 1, 2022’. Because they have not seen that field but knows it is available in their data, they know they need to join it themselves. In this embodiment they click (select) the ‘Self ADD . . . ’ line 11934 to begin that process. Note that line could have been called ‘JOIN’ or something else but in this embodiment was call ‘Self ADD

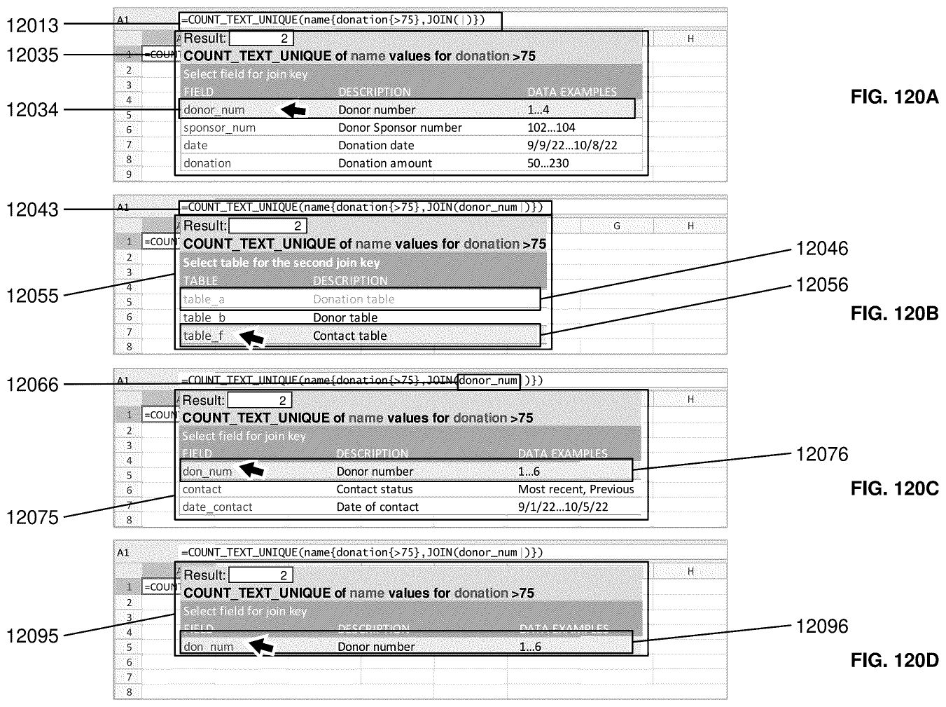

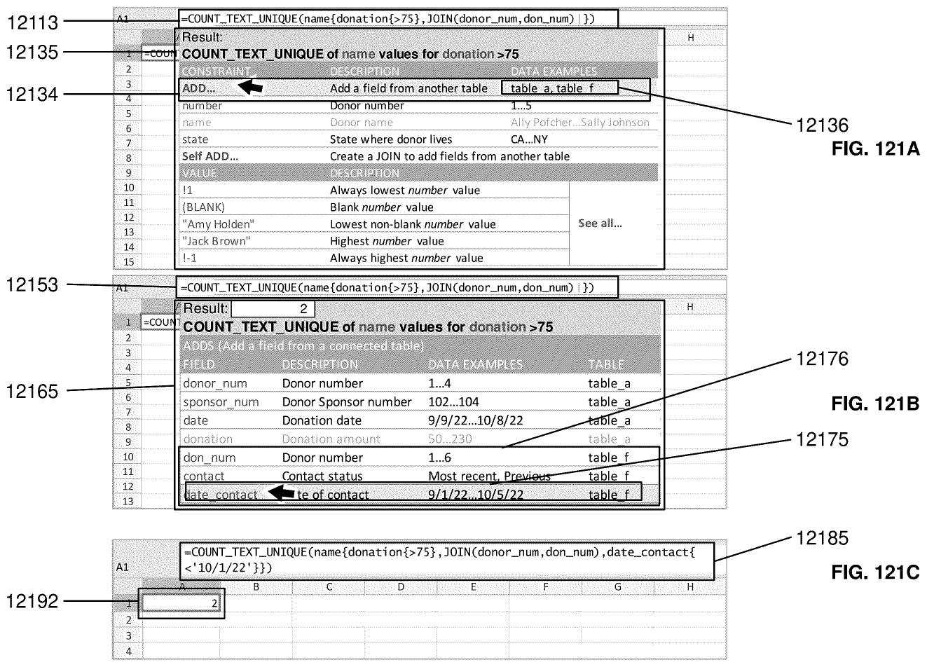

This opens the selection list 11965 in FIG. 119B which begins the data joining selection lists supporting a spreadsheet user adding their own data set joins in the spreadsheet formula (e.g., 11953). Where the data being joined could reside in spreadsheet cells (e.g., FIG. 11A and FIG. 11B), in data external to the spreadsheet cells (e.g., FIG. 10A and FIG. 10B), or in some combination of both. This selection list 11965 examples the list of different join types available to the user in this embodiment. The user decides they would like to use a ‘Full outer join’, so they select (click) ‘JOIN’ 11966 to populate ‘JOIN( )’ in the formula 11973 and opens the selection list 11985 in FIG. 119C. This selection list 11985 gives the user the list of data sets available to them (which is kept short for example purposes but could be a long list of data sets). The user sees the data set they want to start the join from and selects (clicks) ‘table_a’ 11986 to open the selection list 12034 in FIG. 120A. In this embodiment nothing has yet been populated in the formula 12013 because this has opened up a selection list of potential fields to populate as the first join key pair (because each field is unique there is no need to populate the table in the formula, but our technology could support that or other join formula syntaxes). The user then sees the field that want for the join key, ‘donor_num’, which they select (click) 12034 to populate ‘donor_num’ in the formula 12043 and open (automatically) the selection list 12055 in FIG. 120B. This gives them data set selector for the second join key where they see the data set they want and select ‘table_f 12056 to open the selection list 12075 in FIG. 120C. Note in FIG. 120B the selection list had ‘table_a’ disabled 12046 (e.g., grayed out) because the user had not selected a self-join and therefore needs to select a different table. The selection list 12075 in FIG. 120C gives the user the field they desire for the second join key, so they select ‘don_num’ 12076 to populate ‘don_num’ in the formula 12113 and open the selection list 12135 in FIG. 121A. This has not only availed the user to the joined fields from ‘table_f but in this embodiment has added them to the readily available joined data accessible through the ‘ADD . . . ’ line as exampled by ‘table_f’ now being listed with ‘table_a’ 12136. This was not the case before the join as was exampled in 11936 in FIG. 119A which only listed ‘table_a’. Through the join adding supported selection list capability feeding the joinable data selection lists the user was able to create a join through selection list selections and add those joinable fields to the readily usable joined field selections as we will example next.

In FIG. 120C the embodiment delivered a join key selection list that had no qualification validation, thereby having fields that were of different data types with no value matches with the first join key field, ‘donor_num’ 12066. In a different embodiment exampled in FIG. 120D with data type qualification validation the user would get only the only fields that are a comparable integer data type in the selection list 12095, which in this example is only the field ‘don_num’ 12096. Different embodiments of our technology support all the different qualification validation pathways exampled in FIG. 4, with FIG. 120C exampling pathway ‘A’ while FIG. 120D examples pathway ‘B’. Additionally, our technology supports selection lists displaying more (e.g., match percentages, join relationship types) or less information (e.g., just the fields) as we example herein. It is useful to note that in this embodiment the data modelling cardinality qualification validation is different for the pre-cell formula qualified joins and the in-cell qualified joins. The pre-cell qualified joins rejected the data modelling cardinality of many to many which is why ‘table_f’ fields did not show up in original ‘ADD’ line 11834 data examples listing 11836 in the selection list 11835 in FIG. 118A. However, because in this embodiment the data modelling cardinality restriction on in-cell joins accepts all cardinalities the user was able to add the many to many data set join between ‘table_a’ and ‘table_f’ as exampled in FIG. 119A through FIG. 121A. Exampling how our technology supports different data modelling cardinality qualification validation restrictions as well as differences in restrictions for different locations of qualification.

Returning to the example in FIG. 121A, this time when the user clicks the ‘ADD . . . ’ row 12134 to gain access to the joinable fields and they know they will see the joinable field they want in ‘table_f 12136. Like before in this embodiment that selection does not change the formula 12153 (versus 12113) but changes the selection list 12165 as shown in FIG. 121B. Here the user sees three fields/columns from ‘table_f 12176 which were not there prior to the user adding the join, as exampled in comparable selection list 11875 in FIG. 118B. At this point the user sees the ‘date_contact’ field that they want and selects (clicks) it 12175 then selecting/filling in ‘<‘Oct. 1, 2022’ and hitting ENTER/RETURN to get the value ‘2’ in cell ‘A1’ 12192 from the formula 12185 in FIG. 121C. The data joining and calculations parallel those done in FIG. 115, FIG. 116A and FIG. 116B although in this situation employing one pre-formula setup join of two data sets and one in-formula setup join of two data sets combining in the three data set chained/sequenced join. As we have discussed, our technology supports different ways described herein to setup the data set joins used in our spreadsheet formula and as exampled herein different sets of selection lists to support those data set joins.

Having exampled our spreadsheet cell formula data joining technology with extensive single and double selection lists and a spectrum of joins setup at the data intake, we will now example the other end of the spectrum before discussing the breadth of the mix and match combinations of selection lists and join types and situations supported.

### Manual Joins Minimal Selection Lists

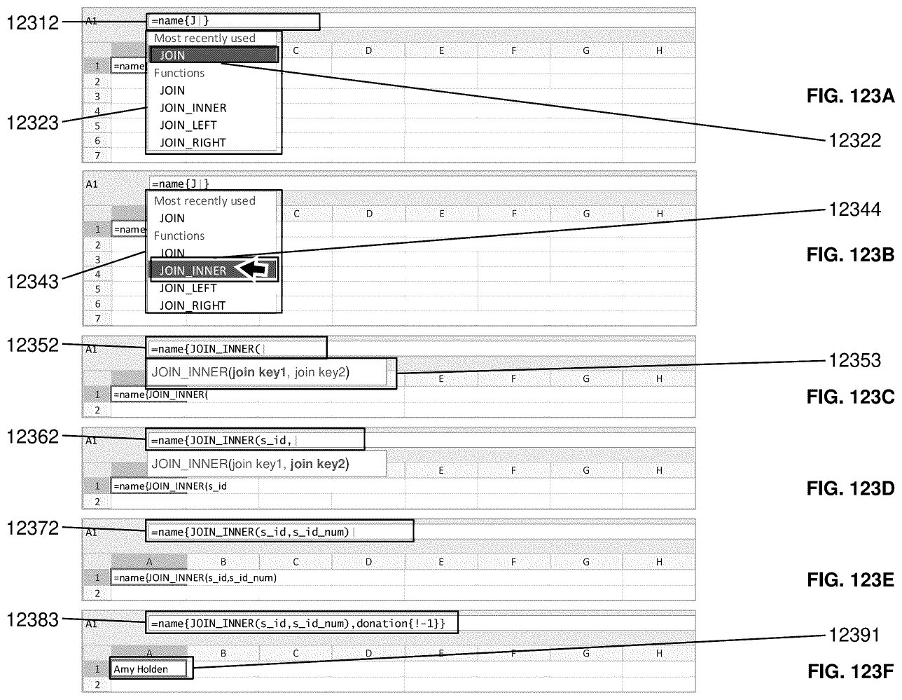

FIG. 123A through FIG. 123F examples our technology supporting manual joins with only function selection lists. The user is employing the data in FIG. 70 to manually setup a join between two data sets, ‘table_aa’ 7033 and ‘table_bb’ 7038. There are no pre-set joins when the spreadsheet was opened. The charity user is setting up the join in the spreadsheet cell formula in this embodiment with only the help of function selection lists. The charity user wants to know the name of the donor who gave the largest donation, requiring data from both data sets. They have typed ‘=name {J’ 12312 in cell ‘A1’ and because of the ‘J’ get a selection list 12323 of all the functions beginning with ‘J’ in FIG. 123A. Like some of the current spreadsheets that list includes the ‘Most recently used’ function which in this example is ‘JOIN’ 12322. As it also turns out, there are no other functions beginning with ‘J’ other than our new join family of functions which here includes four functions but could have included more.

The wants an inner join so they select (click) ‘JOIN_INNER’ 12344 in the selection list 12343 in FIG. 123B. In this embodiment that populates ‘JOIN_INNER (’ in the formula 12352 and opens up a syntax guide 12353 as exampled in FIG. 123C. The user then types in ‘s_id,’ as the ‘join key1’ as shown the formula 12362 in FIG. 123D. In FIG. 123E the user then types in ‘s_id_num)’ as the ‘join key2’ as shown the formula 12372 closing the parentheses of the ‘JOIN_INNER (s_id,s_id_num)’ argument in the formula. They then add the argument ‘donation {!-1}’ to get the largest donation from the joined data sets and finish the formula adding the closing curly bracket ‘}’ and hitting ENTER/RETURN to get the result of ‘Amy Holden’ shown in cell ‘A1’ 12391 from the formula 12383 shown in FIG. 123F. The formula executes the two-data set data join as illustratively exampled in 7086 in FIG. 70 and the three steps in in FIG. 71 to get the result of ‘Amy Holden’. In this embodiment the user executed an in-cell formula delivering a data join with no pre-set joins and no selection lists beyond those found in a conventional spreadsheet (function selection lists).

Note, in this embodiment our joining technology utilizes a join function with a structured argument structure of the two join keys. It, like all the current spreadsheet functions, has a structured argument structure which can be supported by a syntax guide like 12353 in FIG. 123C. This is very different than the typical programming language queries which do not have a defined structure. Note that function syntax could be a different structure such as one including the table (data set) names in situations where the field/column names are not unique.

### Manual Joins Minimal Selection Lists

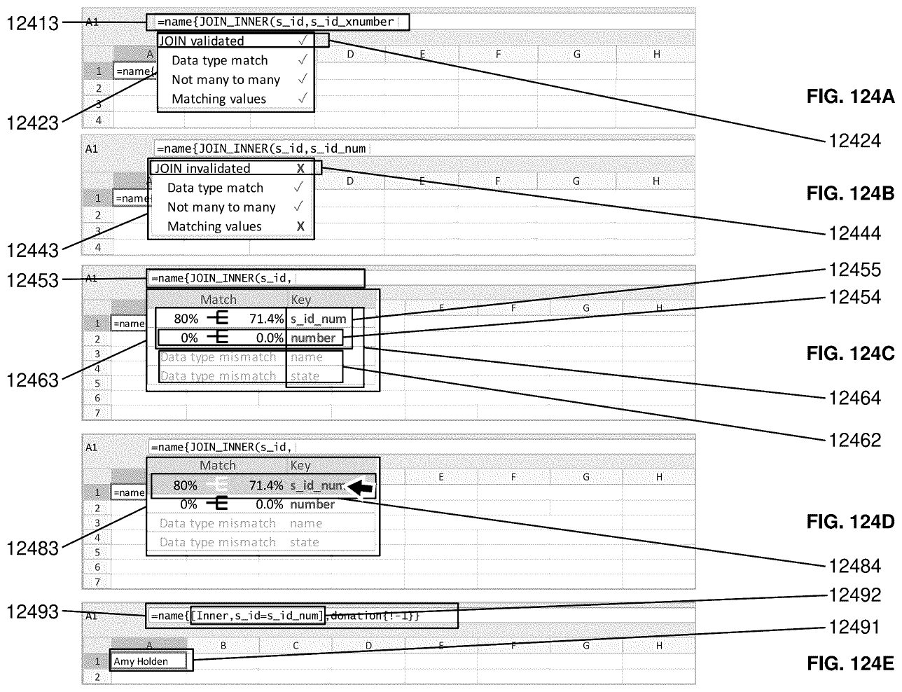

FIG. 124A through FIG. 124D examples our technology supporting manual joins with more informative join key selection lists. FIG. 124C examples the user receiving a selection list 12463 of all the potential second join keys 12464 after they inputted the first join key ‘s_id,’ into the formula 12453. This selection list presents the user with information so they can do their own qualification validation of the field they are going to select. In this embodiment it tells the user the percentage of rows of the first key field that are found in the potential second key values and the percentage of rows of the potential second key field that are found in the first key values provided the data type matches. It also tells the user the cardinality of the join, unique to unique, unique to non-unique, or non-unique to non-unique using the diagrams between the two “Match” percentages (shown for the two rows 12455 and 12454). Different embodiments with automatic validation would alter the selection list for example so the ‘Data type mismatch’ rows 12462 are disabled or removed. A further embodiment would also disable the ‘0%’ match both way lines (e.g., 12454) because with no overlapping values they will have no joined rows (certainly in inner, left outer and right outer joins). FIG. 124D then examples the user selecting a join 12484 in the selection list 12483 to populate it into the formula.

FIG. 124A and FIG. 124B example an automated qualification validation checking capability once a user has written the fields sufficiently for a test to occur. In FIG. 124A the user has entered both join keys into the formula 12413 to the point that our technology tests and informs the user that it has passed all the validation checks in this embodiment with the check mark for ‘JOIN validated’ 12424 in the list 12423. It also gives the user a breakdown of the validation checks or failures as shown by the three different checks 12423 in FIG. 124A which for this example are all green check marks indicating validation success. However, in FIG. 124B the two checks and one red ‘X’ 12443 result in the ‘JOIN invalidated’ 12444 as exampled in FIG. 124B list 12443. While we could example many different ways to show the validation results for the different pathways in FIG. 4 in informative popups like in FIG. 124A and FIG. 124B or in selection lists like in FIG. 124C and FIG. 124D, instead we will move on to exampling the manual end of the spectrum of our spreadsheet cell formula join technology in a functional formula.

### Manual Joins in Functional Formula

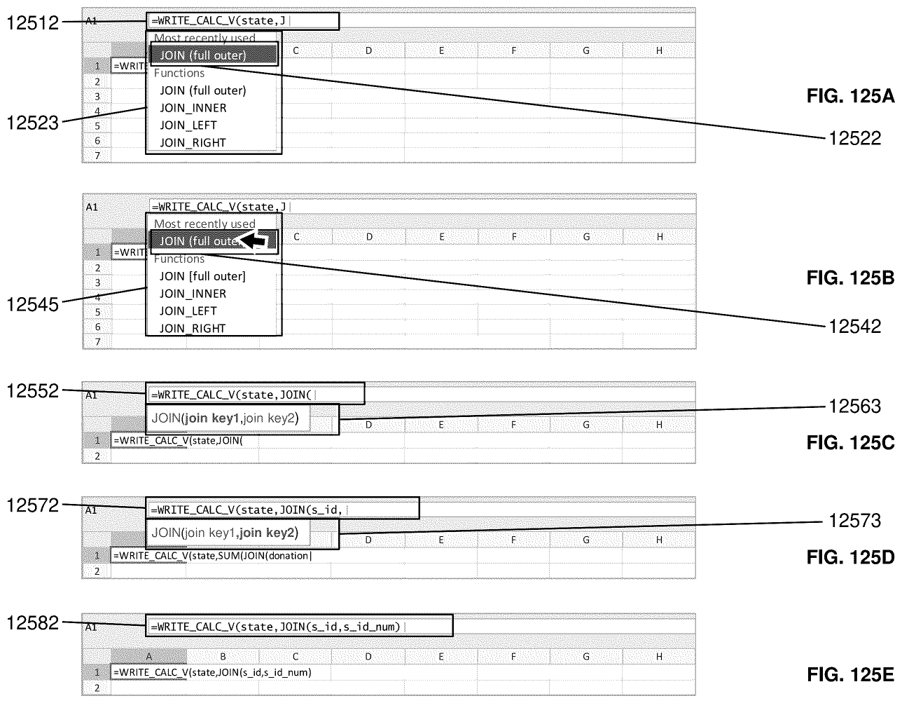

FIG. 125A through FIG. 127B examples our technology supporting manual creation of the join formula in a function (SUM) within a function (WRITE_CALC_V) formula. The user again is employing the data in FIG. 70 to manually setup a join between two data sets, ‘table_aa’ 7033 and ‘table_bb’ 7038. In this usage there are no pre-set joins when the data is set up in Intake or when the spreadsheet was opened. The charity user is setting up the join in the spreadsheet cell formula in this embodiment with only the help of function selection lists. The charity user wants to write out the donations totaled by state, which requires getting the ‘donation’ values from ‘table_aa’ and the ‘state’ values from ‘table_bb’. Thus, the need for the data set join. To start the formula in FIG. 125A they have typed the formula ‘=WRITE_CALC_V (J’ 12512 in cell ‘A1’ and because of the ‘J’ get a function selection list 12523 for all the functions beginning with ‘J’. Like some of the current spreadsheets that list includes the ‘Most recently used’ function which in this example is ‘JOIN’ 12522. As it also turns out, there are no other functions beginning with ‘J’ other than our new join family of functions which here includes four functions but could have included more.

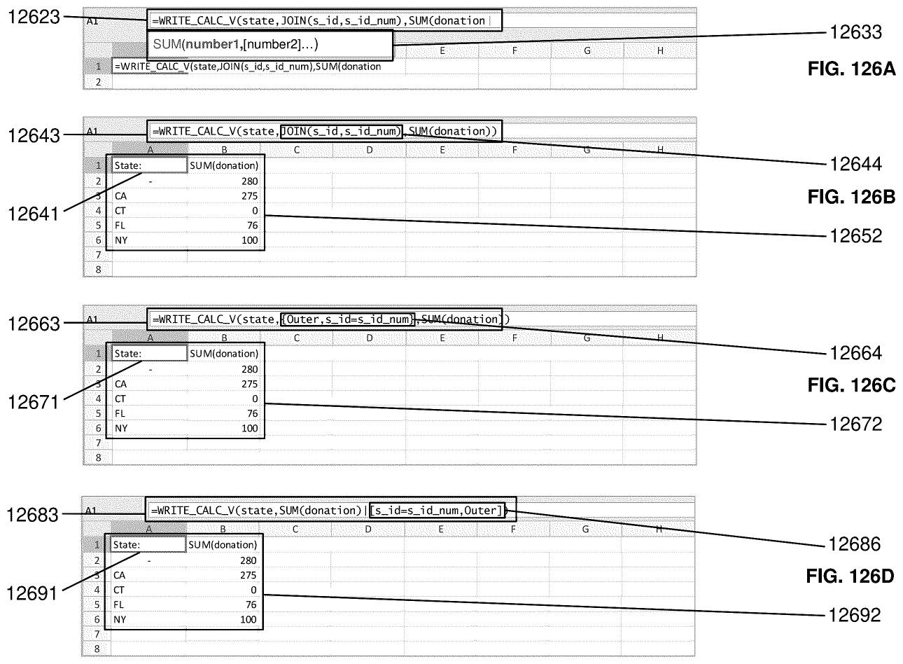

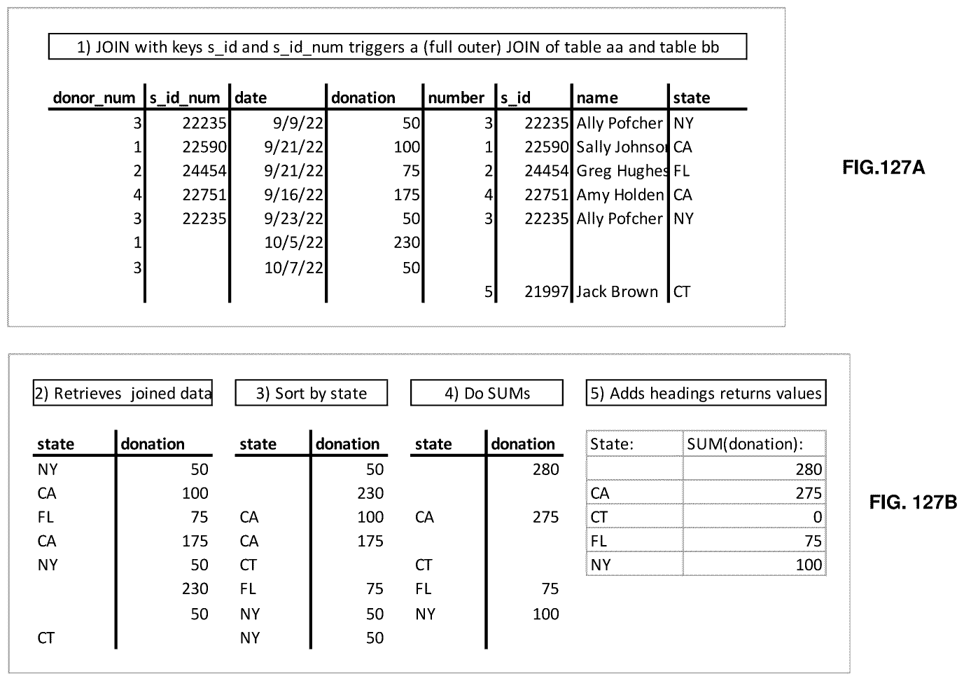

The wants a full outer join so they select (click) ‘JOIN’ 12542 in the selection list 12545 in FIG. 125B. In this embodiment that populates ‘JOIN (’ in the formula 12552 and opens up a syntax guide 12563 as exampled in FIG. 125C. The user then types in ‘s_id,’ as the ‘join key1’ as shown the formula 12572 in FIG. 125D. In FIG. 125E the user then types in ‘s_id_num)’ as the ‘join key2’ as shown the formula 12582 closing the parentheses of the ‘JOIN_INNER (s_id,s_id_num)’ argument in the formula. They then add the argument ‘SUM (donation’ to sum the donations for each state for the formula 12623 as exampled in FIG. 126A. They then add the two closing parentheses as shown in the formula 12643 in cell ‘A1’ 12641 in FIG. 126B and hit ENTER/RETURN to get the results shown in cells ‘A1’ through ‘B6’ 12652. The formula executes the two-data set data join as illustratively exampled in FIG. 127A and the five steps illustratively exampled in FIG. 127B to get the results sent to cells ‘A1’ through ‘B6’ 12652 in FIG. 126B. In FIG. 126B examples where the join is populated via a join function 12644 where JOIN is a full outer join function, and its two arguments ‘s_id,s_id_num’ specify the join keys (not needing data set identifiers because the field names are unique and therefore identify the data set). FIG. 126C and FIG. 126D example two different syntaxes for populating the same join within a formula. In FIG. 126C the join 12664 is populated like another argument in the first argument group within the ‘WRITE_CALC_V’ functional formula 12663 in cell ‘A1’ 12671 which populates the cells ‘A1’ through ‘B6’ 12672. The join syntax is different than the syntax used in FIG. 126B. The join syntax put the join arguments within curly brackets with the join type argument (e.g., ‘Outer’) followed by the two join keys. FIG. 126D examples yet another syntax where the join argument is within square brackets and has a syntax where with the two join key arguments first and second then followed by the join type argument (e.g., ‘Outer’). In these different embodiments the user executed an in-cell formula delivering a data join with no pre-set joins and no selection lists beyond those found in a conventional spreadsheet (function selection lists) for a two-function cell formula. While the different join syntaxes could be used in other situations by our technology and could employ different syntaxes for brevity's sake we will not example other options. While we could example other more complicated formulas employing our manually created in-cell join technology without the use of pre-set joins and without the use of our extensive and situationally variable content selection lists, we will instead example a range of situations where our joins can be set up and the range of support setting them up from our selection lists.

### Example Spectrum of Setup and Selection List

Thus far we have exampled different ways our technology can support determining the joins (in FIG. 8), exampled different ways our technology can support qualification validating those joins (in FIG. 4), exampled different ways our selection lists can support use of the joins (from function only to extensive double sets of selection lists for setting up joins and using the joinable data) but have not fully exampled the spectrum of where the joins can be set up or reset. FIG. 128 examples some of the endpoints of the spectrums of join setup and resetting supported by our in-cell formula data joining technology as well as some midpoints. We example five different locations where a user, using one of the UIs exampled herein, can setup a two or more data set join.

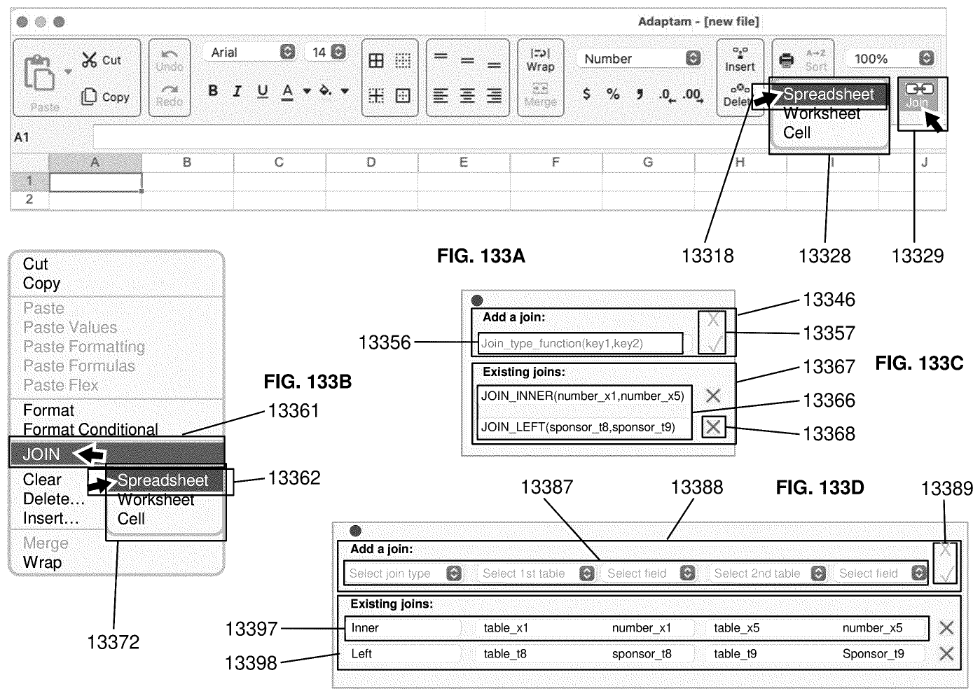

The first location exampled is the ‘INTAKE-external to spreadsheet’ 12835 in FIG. 128 which has the advantage of setting up joins for any user using that external data and thus setting up joins for many users at one time. It can use many different types of UIs including the ones exampled in FIG. 12, FIG. 13, FIG. 54, FIG. 55, FIG. 56, and FIG. 151. The next location exampled is the ‘INTAKE—in spreadsheet’ 12845 which works similarly to the external intake but is within a single spreadsheet frequently used to setup data from in-cells as described in our U.S. application Ser. No. 17/752,814 titled “Method And System for Spreadsheet Error Identification and Avoidance,”. It allows a user to do a one-time setup for all the worksheets within a spreadsheet using many different types of UIs including the ones exampled in FIG. 12, FIG. 13, FIG. 54, FIG. 55, FIG. 56, and FIG. 151. Embodiments could then alter qualifications done by the previous location 12835 for either selection lists and/or formulas. The next location example is the ‘Spreadsheet capability’ 12855 which can be as simple as our technology allowing any join setup in any cell of any worksheet to apply to all cells of every worksheet. It could also be a UI, like the ones exampled in FIG. 133C and FIG. 133D, where a user can specify joins (e.g., join type and join keys) for all worksheets within the spreadsheet. The UI could also use elements of FIG. 12, FIG. 13, FIG. 54, FIG. 55, FIG. 56, and FIG. 151 to give users more information and different levels of automation. Embodiments could then alter qualifications done by the previous locations for either selection lists and/or formulas.

Note, FIG. 133A through FIG. 133D example two of many different modes of accessing join setup and setting up joins for a spreadsheet, a worksheet, and a spreadsheet cell. FIG. 133A examples accessing join setup through a spreadsheet ribbon button 13329 which when clicked in this embodiment opens a selection popup 13328 where the user can specify the applicability location of the join or joins. In this example the user has selected ‘Spreadsheet’ 13318 but they could have easily specified ‘Worksheet’ or ‘Cell’. Once the selection is made our technology opens a UI to specify the join like either FIG. 133C or FIG. 133D. FIG. 133B examples another way to accesses the join setup through a spreadsheet menu with the ‘Join’ option 13361 which when clicked in this embodiment opens a selection popup 13372 where the user can specify the applicability location of the join or joins. In this example the user has selected ‘Spreadsheet’ 13362 but they could have easily specified ‘Worksheet’ or ‘Cell’. Once the selection is made our technology opens a UI to specify the join like either FIG. 133C or FIG. 133D. The menu could have been a right click menu in a cell, one from the application overall menu, or another spreadsheet menu. FIG. 133C examples a fairly manual UI setup approach where the user effectively constructs a join type function formula with arguments of a key1 comma key2 like they might in a regular formula following the input syntax in the entry box 13356. Once they have made an input the disabled ‘check; and ‘X’ 13357 become live for the user to ‘Add a join:’ 13346 to the ‘Existing joins:’ 13367. In this example to add to the two joins 13366 already there. If the user wants to get rid of one of those existing joins they simply click its corresponding ‘X’ (e.g., 13368). These joins could have any path of qualification validation testing exampled in FIG. 4. FIG. 133D examples a somewhat less manual join UI with dropdown selection lists to help in the ‘Add a join:’ 13388 setup. Each input 13387 tells the user what to select and the screening of the values in the second table ‘Select field’ could have any qualification validation testing exampled in FIG. 4. Once the user has completed an input the disabled ‘check; and ‘X’ 13389 become live for the user to ‘Add a join:’ 13388 to the ‘Existing joins:’ 13398. If the user wants to get rid of one of the existing joins 13397 they simply click its corresponding ‘X’. For brevity purposes we did not example the spectrum of qualification validation test results for these UIs recognizing they can display capabilities across the spectrum including more informative information such as that displayed in FIG. 151.

The next location example is the ‘Worksheet capability’ 12865 which can be as simple as our technology allowing any join setup in any cell of that worksheet to apply to all cells of that worksheet. It could also be a UI and access, like the ones exampled in FIG. 133A through FIG. 133D, where a user can specify joins (e.g., join type and join keys) for all worksheets within the spreadsheet, like the ones exampled in FIG. 133A through FIG. 133D. The UI could also use elements of FIG. 12, FIG. 13, FIG. 54, FIG. 55, FIG. 56, and FIG. 151 to give users more information and different levels of automation. Embodiments could then alter qualifications done by the previous locations for either selection lists and/or formulas. The next location example is the ‘In cell-all content’ 12875 which is as simple as our technology allowing any join setup in any argument within the cell to apply to all the arguments within the cell (i.e., the entire formula). Embodiments could then support the transformation of any in cell join to the primary selections lists as exampled in FIG. 117A through FIG. 121B and specifically exampled in 12136 FIG. 121A and 12176 FIG. 121B where a formula specific join now shows up in the primary selection lists. Variants of the ‘In cell’ join setup UIs could also use elements of FIG. 12, FIG. 13, FIG. 54, FIG. 55, FIG. 56, and FIG. 151 to give users more information and different levels of automation. Embodiments could then alter qualifications done by the previous locations for either selection lists and/or formulas. The next location example is the ‘In cell-function or formulaic data field’ join 12885 which is the most limited of the options as to breadth of applicability of the join. In this option the join applies only to the formulaic data field in which it is done or in some situations the function that it is done in (e.g., a WRITE function). Some embodiments then support the transformation of the cell formula joins to the primary join selections lists (if they exist) as exampled in FIG. 117A through FIG. 121B and specifically exampled in 12136 FIG. 121A and 12176 FIG. 121B where a formula specific join now shows up in the primary selection lists. Other embodiments are like the ones exampled in like the ones exampled in FIG. 133A through FIG. 133D, where users can access and specify joins usable with a cell. Variants of this ‘In cell’ join setup UIs could also use elements of FIG. 12, FIG. 13, FIG. 54, FIG. 55, FIG. 56, and FIG. 151 to give users more information and different levels of automation. Embodiments could then alter qualifications done by the previous locations for either selection lists and/or formulas.

The previously described join locations are exampled as singular locations of joins in the pathways ‘A’ through ‘F’ and ‘I’ through ‘M’ in FIG. 128 12887. There are advantages and disadvantages to any one of those locations, so our technology also allows resetting of joins at most locations as exampled in the pathways' ‘G’ and ‘N’. Those two pathways example the extreme situation with our technology supporting resetting of the joins at each of the subsequent locations. Our join technology supports any of the applicable mix and match combinations of locations as exampled in ‘H’ and ‘O’. Pathways ‘H’ and ‘O’ example two such pathways where a previously set join is revised in-cell in the function or formulaic data field specific parts of the formula. For brevity we did not diagram out all the different combinations of the locations and we also did not diagram out joining data across external and in-cell data sets (which is supported as has been described herein). Instead, we will recap the breadth of join location, type of setup and join validation combinations before exampling the technologies used for its operation.

FIG. 128, FIG. 8, and FIG. 4 example different join set up locations, set up types, and join qualification validation types supported by our technology, respectively. Our technology supports the mix and match combinations of each of the different pathways. For example, mixing and matching the different sources of data 12816 and 12818 in what ultimately is joined in the cell formulas 12897. Our technology also supports the spectrum of join creating and joinable field use selection lists from the minimum of function only selection lists to multiple separate types of selection lists (e.g., join creating and joinable field use) that can work together, as exampled in FIG. 117A through FIG. 121C.

### Data Joining Setup Delivering Joinable Data Use Selection Lists

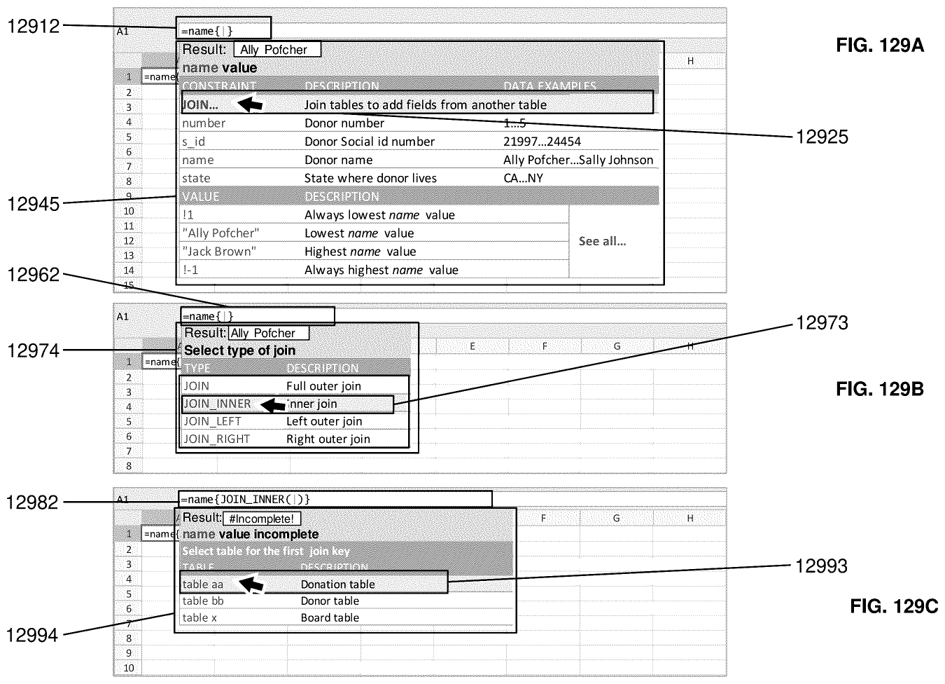

FIG. 129A through FIG. 132B example our spreadsheet cell formula data joining technology working first for data joining selections lists that then instantiate selection lists for using the joinable data. We return to our charity user who wants to know the name of the donor with the largest donation. The user is employing the data in FIG. 70 and must manually setup a join between two data sets, ‘table_aa’ 7033 and ‘table_bb’ 7038 to generate the desired answer. In this embodiment the user sets up all the joins, so there are no pre-qualified joins. The charity user is setting up the join in the spreadsheet cell formula in this embodiment with only the help of function, table, and data field joining selection lists. Once they set up the join the fields joined will be available in joined selection lists.

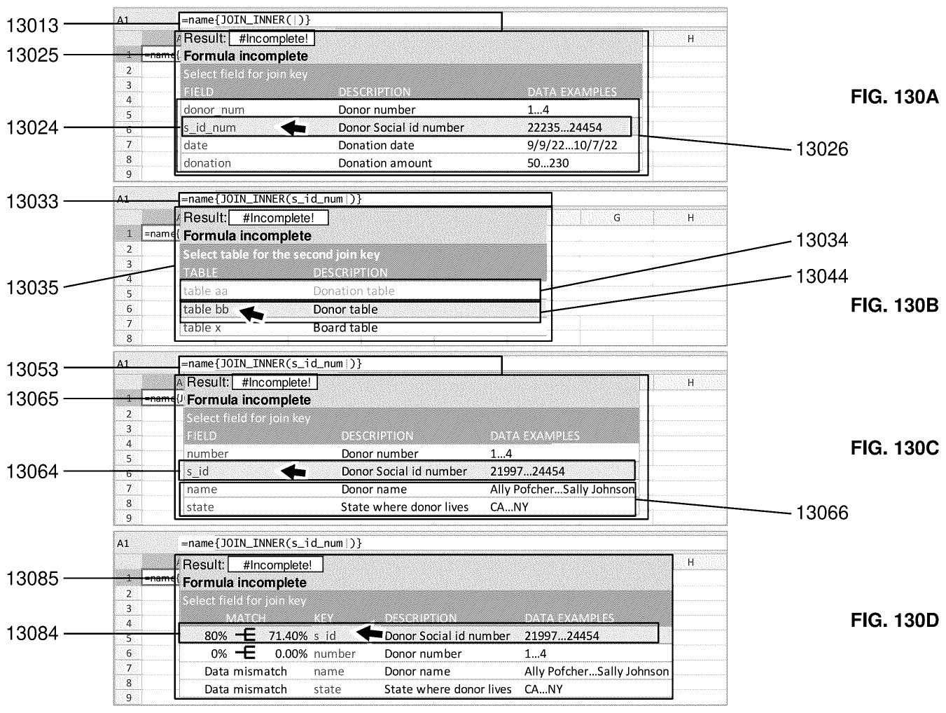

The starts by typing ‘=’ and then tying or selecting ‘name { }’ in cell ‘A1’ as shown in the formula bar 12912 in FIG. 129A. In this embodiment it opens a selection list 12945 displaying the constraint and value options and a ‘JOIN . . . ’ line with the ‘DESCRIPTION’ ‘Join tables to add fields from another table’. This is what the user wants to do so they click ‘JOIN . . . ’ 12925 to open the new selection list 12974 in FIG. 129B without changing the formula 12962. The new selection list provides them with four different types of joins to select from (note, it could have been a longer list) and they see the inner join they want and click ‘JOIN_INNER’ 12973 to populate it into the formula 12982 in FIG. 129C. This opens a new selection list 12994 containing all the data sets available to the user, in this example three tables. The user sees the first table they want to include in the join, ‘table_aa’ 12993 and clicks it. This does not populate anything into the formula, because in this embodiment field names are unique and do not require a table designation. However, had that not been true then this action could have populated the table into the formula. In this embodiment the action does automatically open a new selection list 13025 in FIG. 130A displaying all the fields 13026 in ‘table_aa’. The user sees the field that they want as the join key, ‘s_id_num’, and clicks it 13024 to populate it into the formula 13033 in FIG. 130B and automatically open the selection list 13035. That selection list displays the tables for the second join key. Because this embodiment does not have the self-join function ‘table_aa’ 13034 is disabled but this list would be different if a self-join function had been available and selected. The user sees ‘table_bb’ 13044, which they want, and clicks it. As before this does not populate anything into the formula 13053 in FIG. 130C but opens the next selection list 13065. In this embodiment that selection list 13065 displays all the fields in ‘table_bb’. However, as we will now describe our technology supports many different embodiment variants for this selection list.

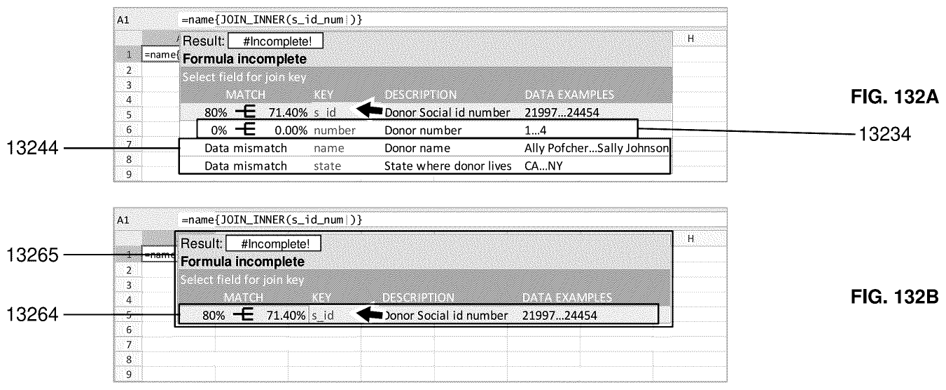

Selection list 13065 in FIG. 130C displays fields that clearly will not work in the join key pair, as the already specified join key, ‘s_id_num’, is a numeric field and two of the fields 13066 in the selection list 13065 are text and therefore would generate no key matches. So, a one more step intelligent embodiment is displayed in FIG. 130D where the selection list 13085 display qualification validation information showing the user one-way and two-way match percentages, data modelling cardinality, data type mismatches and any other applicable information (e.g., ‘DESCRIPTION’ and ‘DATA EXAMPLES’) to make the selection decision easier for the user. That way the user can more knowledgeably click their selection ‘s_id’ 13084. An even more automated embodiment exampled in FIG. 132B where our technology automatically executes qualification validation screening of the second join key relative to the first join key. That validation could be any of the FIG. 4 paths ‘B’ through ‘G’ as exampled here removing the data mismatches (e.g., 13244 in FIG. 132A) and removing the value matches having zero matching values (e.g., 13234 in FIG. 132A). In this example making it very easy to select the only remaining join key field 13264 from the selection list 13265 in FIG. 132B. Imagine how helpful this is in a data set with fifty or more fields to only see the fields that pass all the qualification validation tests. Note of course the user could select the desired field/column from 13224 in FIG. 132A or 13064 in FIG. 130C.

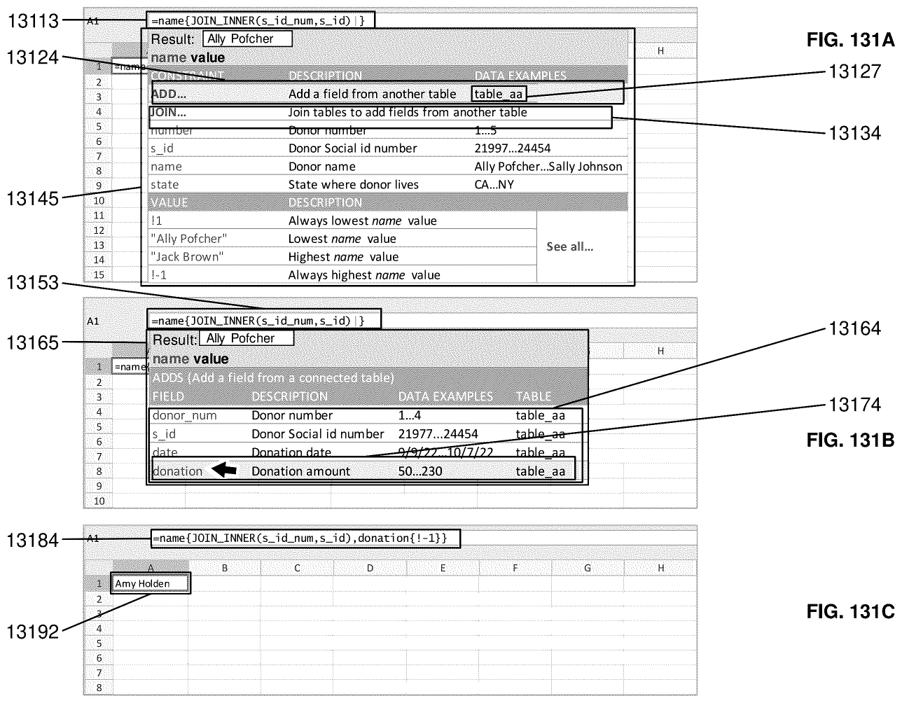

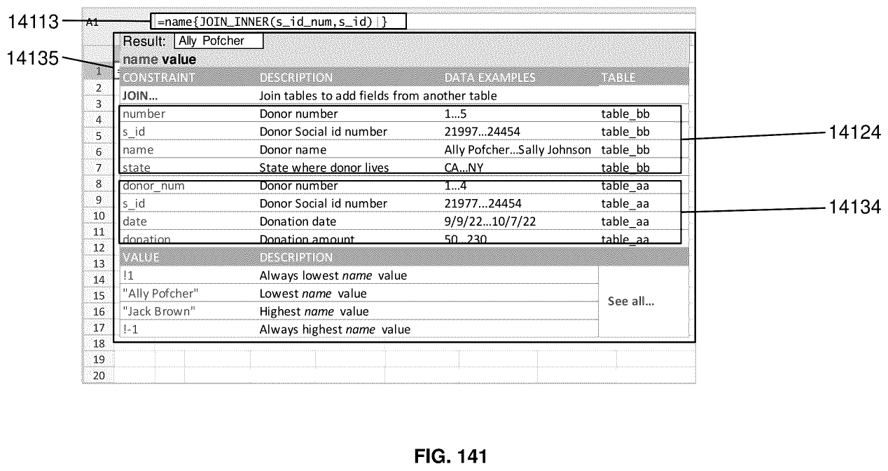

Returning back to our user example with the selection of the second join key populating the formula 13113 in FIG. 131A and opening the selection list 13145 to continue on with the formula. This embodiment then automatically made the joinable fields accessible in the selection list, in this embodiment via two steps. Note, the same situation is exampled in FIG. 141 for a one step selection list 14135 where the fields from both joined tables (14124 and 14134) are automatically displayed together from the same formula 14113. Returning to FIG. 131A, since the user wanted a field in the joined table they click the ‘ADD . . . ’ 13124 which they can see will take them to fields joinable from ‘table_aa’ 13127. That opens the selection list 13165 in FIG. 131B with four fields/columns 13164 here the user sees the ‘table_aa’ field ‘donation’ that they desire and click it 13174. After which they add ‘!-1’ to get the largest donation and hit ENTER/RETURN to get the result of ‘Amy Holden’ shown in cell ‘A1’ 13192 from the formula 13184 shown in FIG. 131C. The formula executes the two-data set data join as illustratively exampled in 7086 in FIG. 70 and the three steps in in FIG. 71 to get the result of ‘Amy Holden’. In this embodiment the user executed an in-cell formula delivering a data join with no pre-set joins but after they set up the join had the joinable data automatically available in selection lists for their use. The technology would work for adding additional joins and additional joins that chain/sequence as exampled in ‘JOIN . . . ’ 13134 remaining available in FIG. 131A for further join setup.

Note, in this embodiment our joining technology utilizes a join function with a structured argument structure of the two join keys. It, like all the current spreadsheet functions, has a structured argument structure which can be supported by a syntax guide like 12353 in FIG. 123C. This is very different than the typical programming language data joining queries which do not have a defined structure. We also exampled join functions that are specific to the type of join being utilized, as we will example next that instead can be a general join function in our technology with an argument that specifies the type of join.

Data Joining Setup Delivering Joinable Data Use Selection Lists with General Join Function

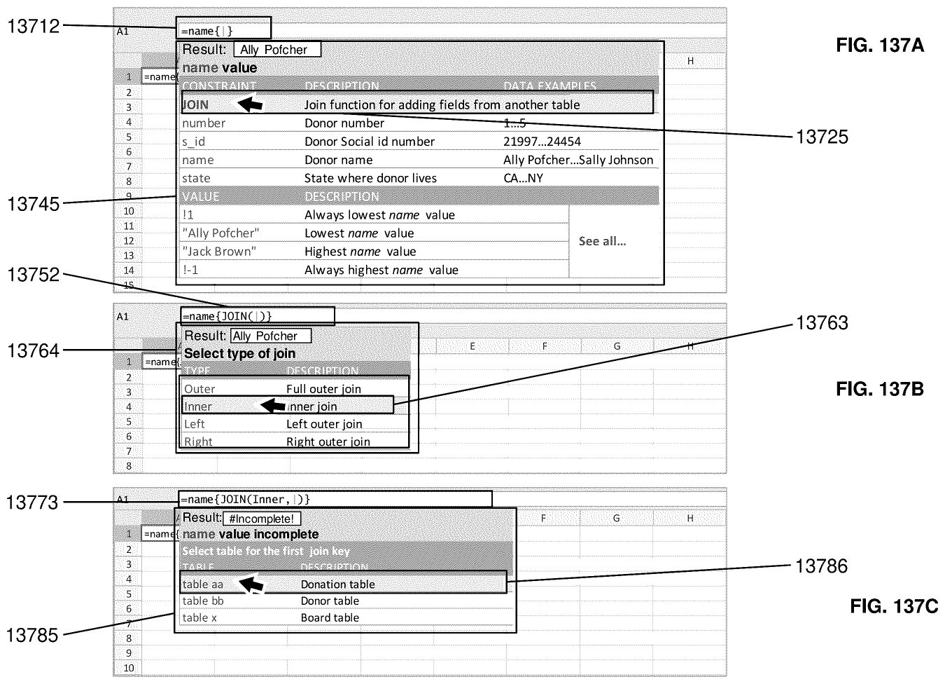

FIG. 137A through FIG. 139C example our spreadsheet cell formula data joining technology working first for data joining selections lists that then instantiate selection lists for using the joinable data employing a general join function with an argument specifying the join type. This parallels the example in FIG. 129A through FIG. 132B with different a different join function (i.e., general join function) with an added join type argument. We return to our charity user who wants to know the name of the donor with the largest donation. The user is employing the data in FIG. 70 and must manually setup a join between two data sets, ‘table_aa’ 7033 and ‘table_bb’ 7038 to generate the desired answer. In this embodiment the user sets up all the joins, so there are no pre-qualified joins. The charity user is setting up the join in the spreadsheet cell formula in this embodiment with only the help of function, table, and data field joining selection lists. Once they set up the join the fields joined will be available in joined selection lists.

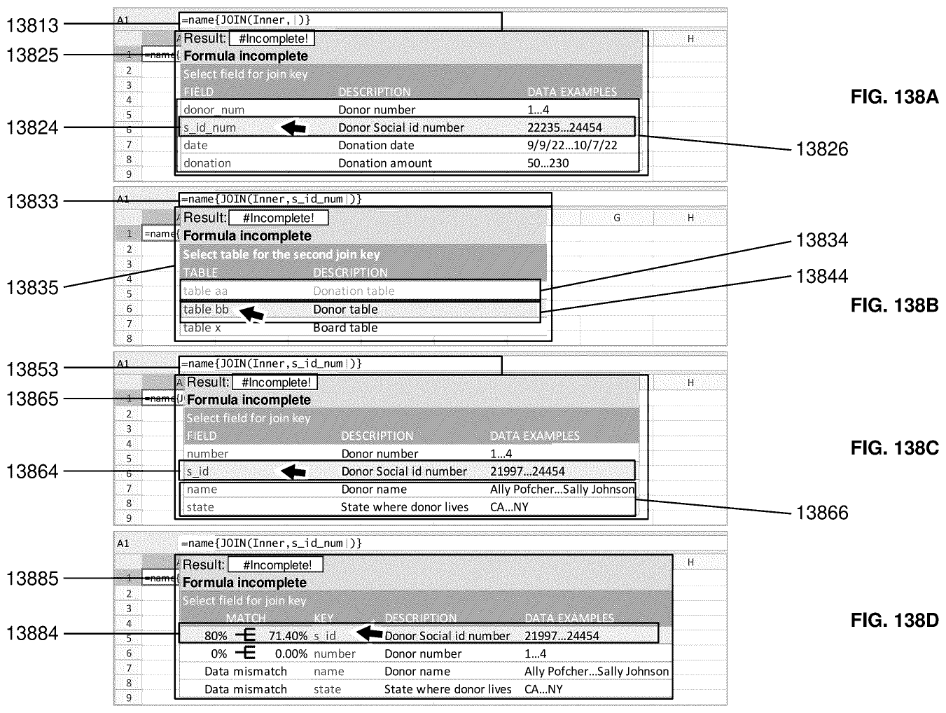

The starts by typing ‘=’ and then tying or selecting ‘name { }’ in cell ‘A1’ as shown in the formula bar 13712 in FIG. 137A. In this embodiment it opens a selection list 13745 displaying the constraint and value options and a ‘JOIN’ function line with the ‘DESCRIPTION’ ‘Join function for adding fields from another table’. This is what the user wants to do so they click ‘JOIN’ 13725 to add the ‘JOIN’ function to the formula 13752 in FIG. 137B and open the new selection list 13764. The new selection list provides them with four different types of joins to select from (note, it could have been a longer list) and they see the inner join they want and click ‘Inner’ 13763 to populate it as the first argument in the “JOIN’ function in the formula 13773 in FIG. 137C. This opens a new selection list 13785 containing all the data sets available to the user, in this example three tables. The user sees the table they want to include first in the join, ‘table_aa’ 13786 and clicks it. This does not populate anything into the formula 13813 in FIG. 138A, because in this embodiment field names are unique and do not require a table designation. However, had that not been true then this action could have populated the table into the formula. In this embodiment the action does automatically open a new selection list 13825 in FIG. 138A displaying all the fields 13826 in ‘table_aa’. The user sees the field that they want as the join key, ‘s_id_num’, and clicks it 13824 to populate it into the second argument of the ‘JOIN’ function in the formula 13833 in FIG. 138B and automatically open the selection list 13835. That selection list displays the tables for the join. Because this embodiment does not have the self-join function and that function was then not selected ‘table_aa’ 13834 is disabled but this list would be different if a self-join function had been available and selected. The user sees ‘table_bb’ 13844, which they want, and clicks it. As before this does not populate anything into the formula 13853 in FIG. 138C but automatically opens the next selection list 13865. In this embodiment that selection list 13865 displays all the fields in ‘table_bb’. However, as we will now describe our technology supports many different embodiment variants for this selection list.

Selection list 13865 in FIG. 138C displays fields that clearly will not work in the join key pair, as the already specified join key, ‘s_id_num’, is a numeric field and two of the fields 13866 in the selection list 13865 are text and therefore would generate no key matches and no results for an inner join. So, a one more step intelligent embodiment is displayed in FIG. 138D where the selection list 13885 displays qualification validation information showing the user one-way and two-way match percentages, data modelling cardinality, data type mismatches and any other applicable information (e.g., field/column ‘DESCRIPTION’ and “DATA EXAMPLES’) to make the selection decision easier for the user. That way the user can more knowledgeably click their selection ‘s_id’ 13884. An even more automated embodiment exampled in FIG. 132B (with a different JOIN function) where our technology automatically executes qualification validation screening of the second join key relative to the first join key. That validation could be any of the FIG. 4 paths ‘B’ through ‘G’ as exampled here removing the data mismatches (e.g., 13244 in FIG. 132A) and removing the value matches having zero matching values (e.g., 13234 in FIG. 132A). In this example making it very easy to select the only remaining join key field 13264 from the selection list 13265 in FIG. 132B. Imagine how helpful this is in data set with fifty or more fields to only see the fields that pass all the qualification validation tests.

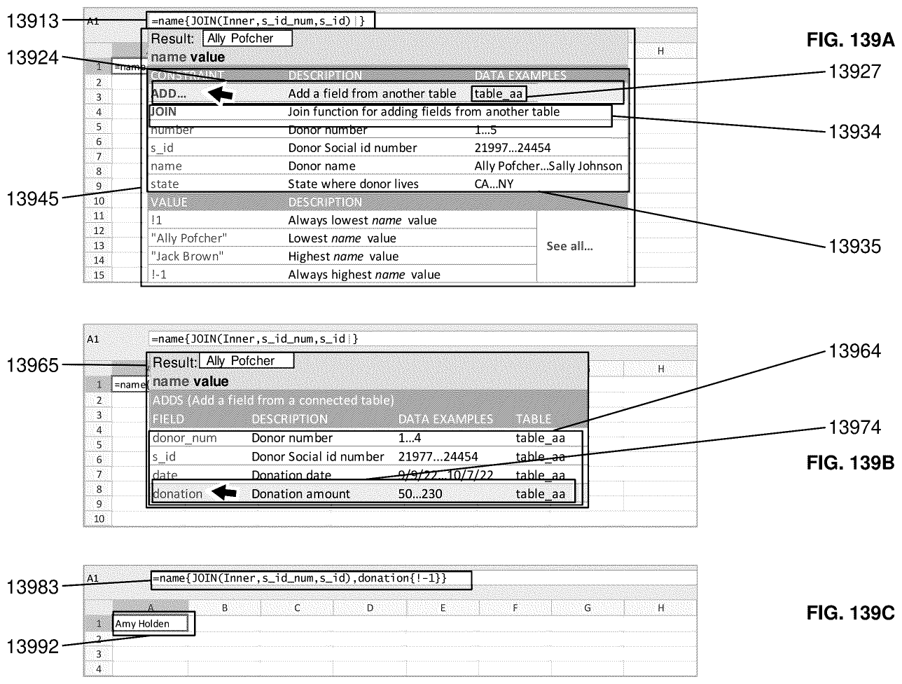

Returning back to our user example with the selection of the second join key (whether from 13864 in FIG. 138C or 13884 in FIG. 138D) populating the formula 13913 in FIG. 139A and opening the selection list 13945 to continue on with the formula. This embodiment then automatically made the joinable fields accessible in the selection list, in this embodiment via two steps. Since the user wanted a field in the joined table they click the ‘ADD . . . ’ 13924 which they can see will take them to fields joinable from ‘table_aa’ 13927. That opens the selection list 13965 in FIG. 139B where the user sees all the fields/columns 13964 the ‘table_aa’ and selects the field ‘donation’ 13974 that they desire. After which they add ‘!-1’ to get the largest donation and hit ENTER/RETURN to get the result of ‘Amy Holden’ shown in cell ‘A1’ 13992 from the formula 13983 shown in FIG. 139C. The formula executes the two-data set data join as illustratively exampled in 7086 in FIG. 70 and the three steps in in FIG. 71 to get the result of ‘Amy Holden’. In this embodiment the user executed an in-cell formula delivering a data join with no pre-set joins, but after they set up the join had the joinable data automatically available in selection lists for their use.

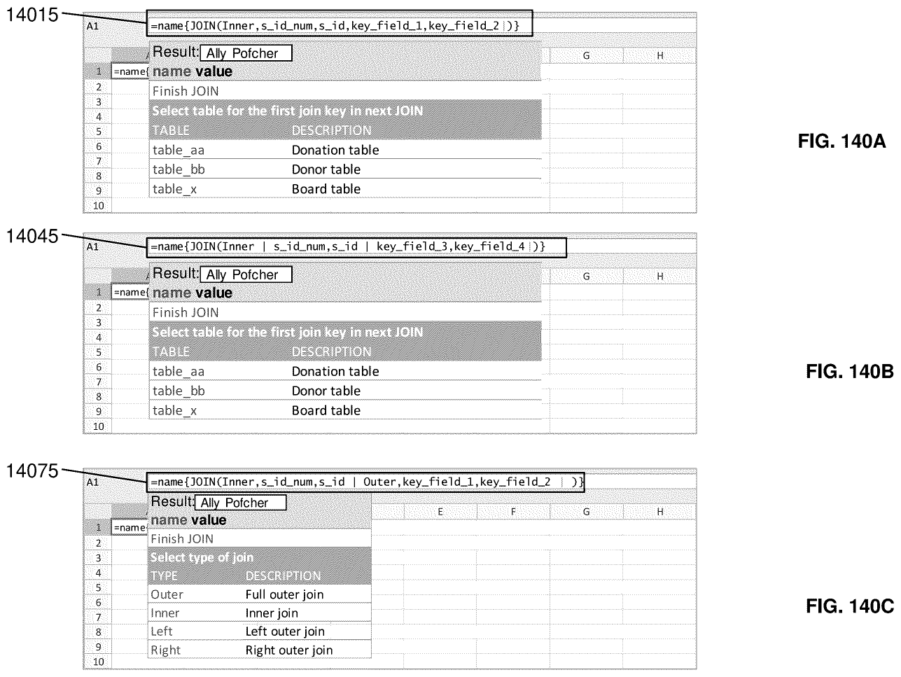

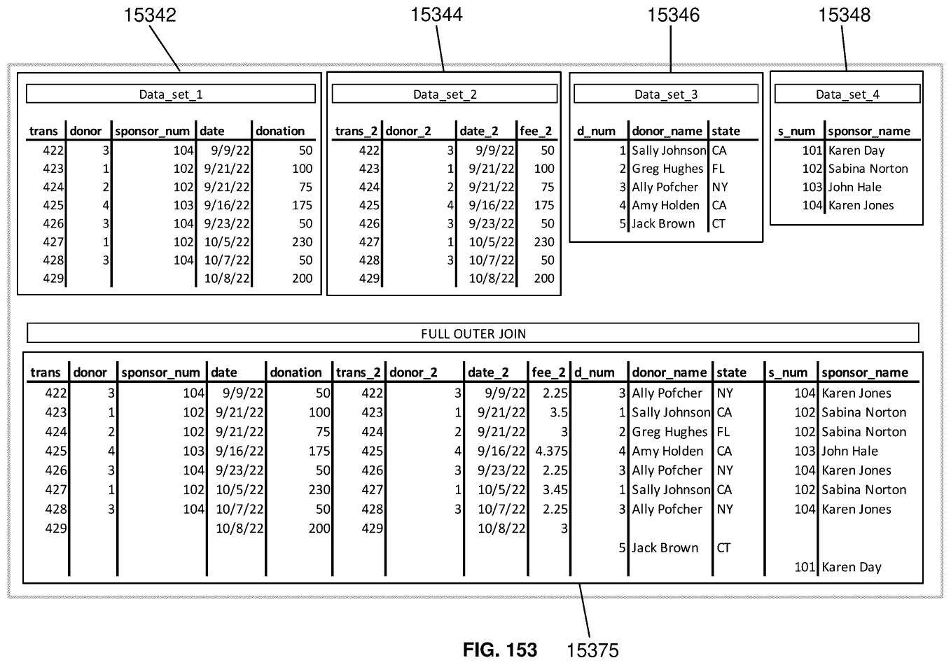

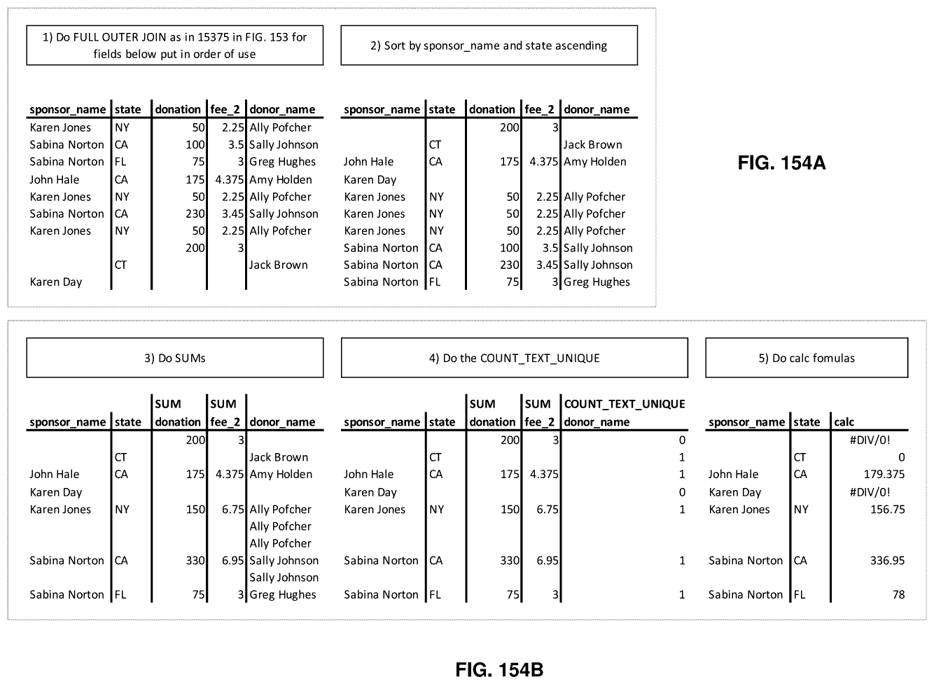

The technology would work for adding additional joins and additional joins that chain/sequence as exampled in ‘JOIN’ 13934 remaining available in FIG. 139A for further join setup. FIG. 140A through FIG. 140C examples three different argument constructs for multiple joins in our general ‘JOIN’ function. All three argument constructs have repeating structured arguments that can be supported by prebuilt function syntax guides like those found in typical spreadsheet functions and deliver chained/sequenced joins like those exampled in FIG. 153C 15032. FIG. 140A examples a function argument syntax which has the first argument specifying the join type (e.g., ‘Inner’) followed by repeating pairs of join keys (e.g., ‘s_id_num,s_id’ followed by a second pair ‘key_field_1,key_field_2’) all separated by commas as exampled in formula 14015. FIG. 140B examples a function argument syntax which has the first argument specifying the join type (e.g., ‘Inner’) in an argument group, followed by repeating pairs of join keys (e.g., ‘s_id_num,s_id’ followed by a second pair ‘key_field_1,key_field_2’) in separate argument groups, where the argument groups are separated by vertical bars ‘|’ and any arguments within the argument groups separated by commas as exampled in in formula 14045. FIG. 140C examples a function argument syntax which has repeating argument groups each with a first argument specifying the join type (e.g., ‘Inner’) followed two arguments specifying the join keys (e.g., ‘s_id_num,s_id’) all separated by commas with where applicable repeating argument groups separated by vertical bars ‘|’ as exampled in in formula 14075. These are three examples of a much broader potential set of structured arguments (e.g., including data set names) and other structured constructs (e.g., argument groups) that our spreadsheet cell joining technology supports.

### Data Joining Setup Delivering Joinable Data Use Selection Lists for Chained Joins

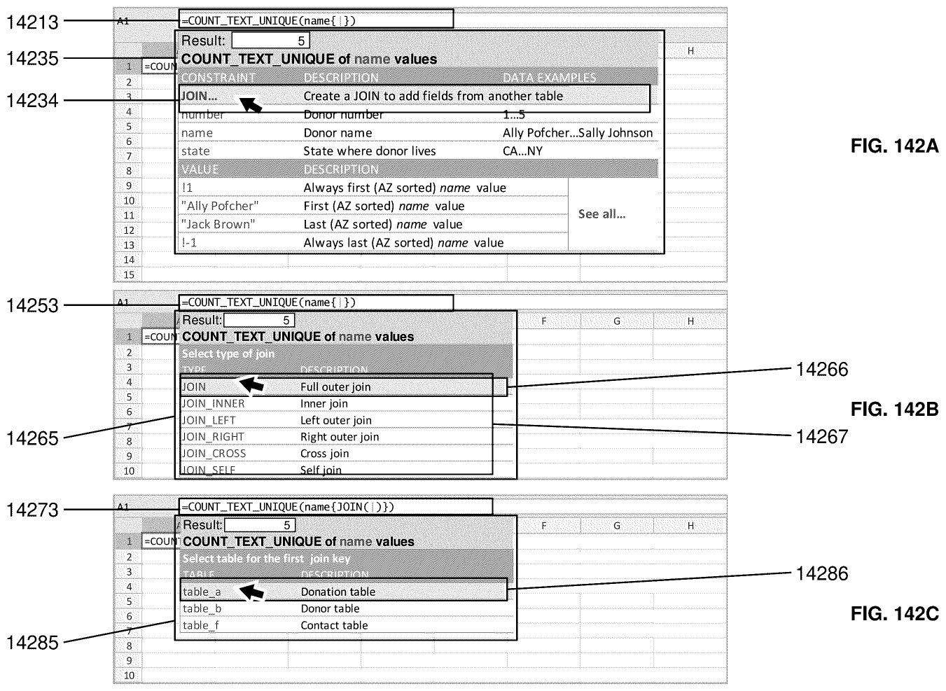

FIG. 142A through FIG. 147C example our spreadsheet cell formula data joining technology working first for data joining selections lists that then instantiate selection lists for using the joinable data for chained/sequenced joins. We return to our charity user who has the three data sets in FIG. 117A. They want to know the number of donors, by name, who gave donations of greater than ‘$75’ and have been contacted by their sponsor before ‘Oct. 1, 2022’. To do so will require chain/sequence joining all three data sets. The user is in an embodiment with no joins qualified before the formula so they will need to populate the joins within the formula at which point the joinable fields will become automatically available in the field selection lists.

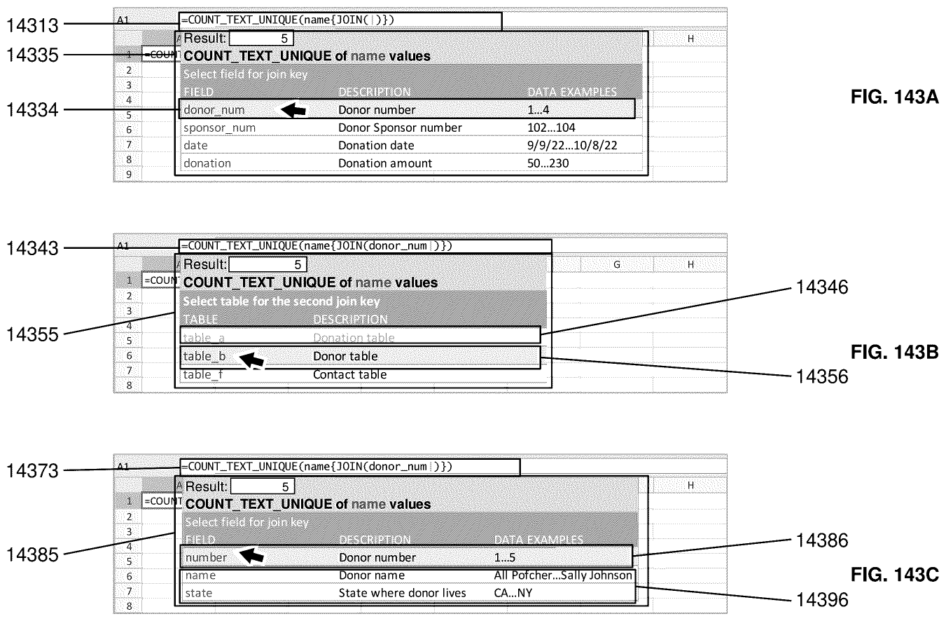

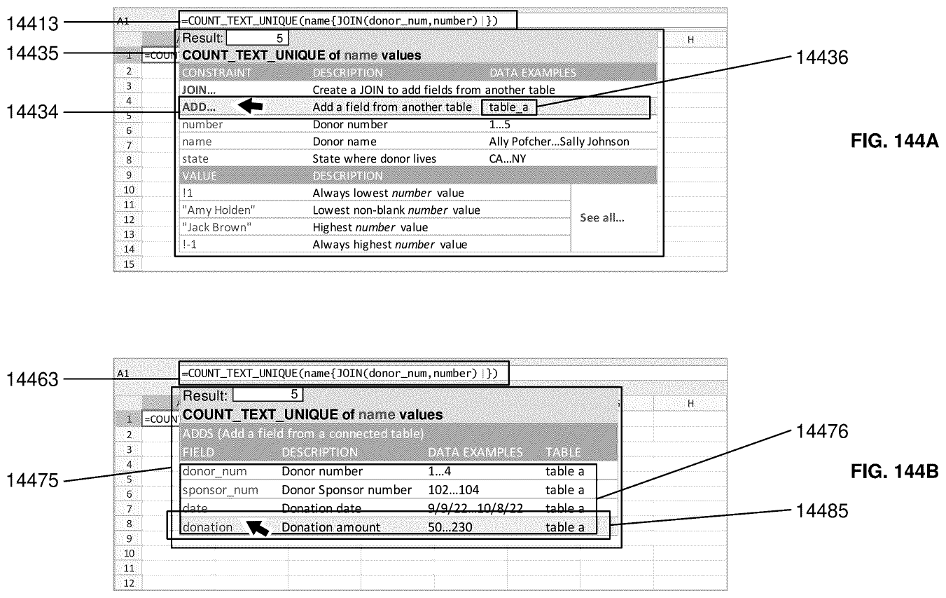

They start a cell formula ‘=COUNT_TEXT_UNIQUE (name { })’ 14213 in FIG. 142A opening in this embodiment the selection list 14235 for the ‘table_b’ which ‘name’ resides in. The selection list also has a ‘JOIN . . . ’ function (purple with a . . . in this embodiment because it accesses options rather than populates into the formula) accessing line that the user clicks 14234 to select a function to join the data sets. That opens the selection list 14265 in FIG. 142B which displays the six different join type functions 14267 in this embodiment without changing the formula 14253. The user wants to do a full outer join so in this embodiment they select (click) ‘JOIN’ 14266 to populate it into the formula 14273 as shown in FIG. 142C. That opens the selection list 14285 displaying the three data sets available to the user. Those data sets could reside in spreadsheet cells (e.g., FIG. 11A and FIG. 11B), in data external to the spreadsheet cells (e.g., FIG. 10A and FIG. 10B), or in some combination of both. The user sees the data set they want to start the join from and selects (clicks) ‘table_a’ 14286 to open the selection list 14335 in FIG. 143A. In this embodiment nothing has yet been populated in the formula 14313 because this has opened up a selection list of potential fields to populate as the first join key pair (because each field is unique there is no need to populate the table in the formula, but our technology could support that or other join formula syntaxes). The user then sees the field that want for the join key, ‘donor_num’, which they select (click) 14334 to populate ‘donor_num’ in the formula 14343 and open (automatically) the selection list 14355 in FIG. 143B. This displays the data set selector for the second join key where they see the data set (‘TABLE’) they want and therefore select ‘table_b’ 14356 to open the selection list 14385 in FIG. 143C. Note in FIG. 120B the selection list had ‘table_a’ disabled 14346 (e.g., grayed out) because the user had not selected a self-join and therefore needs to select a different table. The selection list 14385 in FIG. 143C gives the user the field they desire for the second join key, so they select ‘number’ 14386 to populate ‘number’ in the formula 14413 and open the selection list 14435 in FIG. 144A.

Note, the selection list 14385 in FIG. 143C displays fields that clearly will not work in the join key pair, as the already specified join key, ‘donor_num’, is a numeric field and two of the fields 14396 in the selection list 14385 are text and therefore would generate no key matches. So, as previously exampled, our technology supports more intelligent embodiments such as in FIG. 130D where the selection list 13085 displays qualification validation information showing the user one-way and two-way match percentages, data modelling cardinality, data type mismatches and any other applicable information to make the selection decision easier for the user. That way the user can more knowledgeably click their selection. An even more automated embodiment is exampled in FIG. 132B where our technology automatically executes qualification validation screening of the second join key relative to the first join key. That validation could be any of the FIG. 4 paths ‘B’ through ‘G’ as exampled here removing the data mismatches (e.g., 13244 in FIG. 132A) and removing the value matches having zero matching values (e.g., 13234 in FIG. 132A). Making it very easy to select the only remaining join key field 13264 from the selection list 13265 in FIG. 132B. Imagine how helpful this is in table with fifty or more fields to only see the fields that pass all the qualification validation tests.

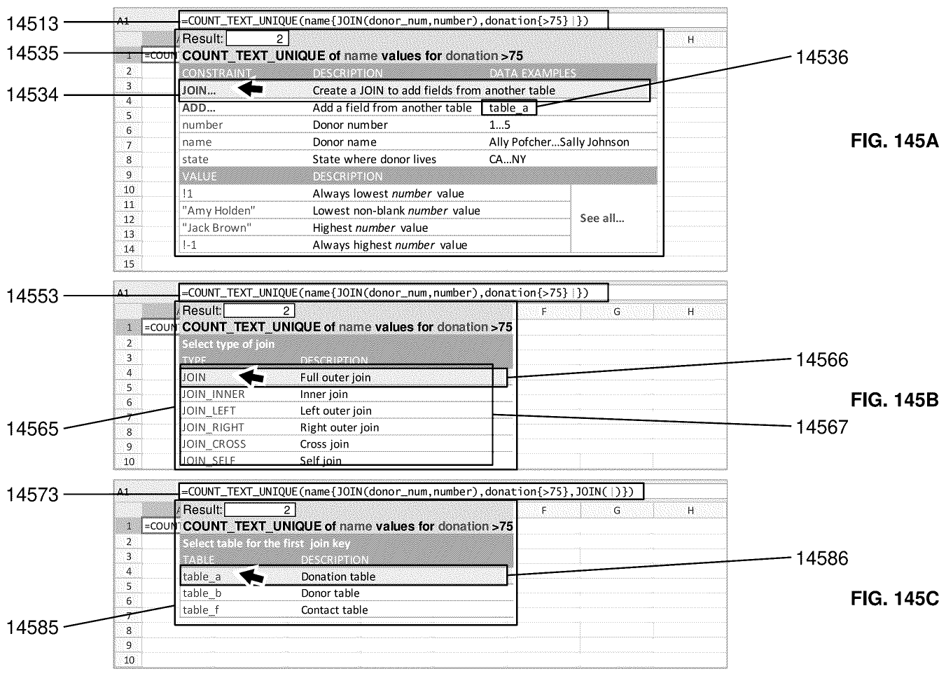

Returning to the example in FIG. 144A, the join has not only availed the user to the joined fields from ‘table_a’ but in this embodiment has made the joined data readily accessible in the selection list through the ‘ADD . . . ’ line 14434 as exampled by ‘table_a’ now listed 14436. And in a different embodiment the joinable data could have been available in a single step selection list like the one exampled in FIG. 141. In this embodiment the ‘ADD . . . ’ line for ‘table_a’ was not displayed before the join was added (e.g., selection list 14235 in FIG. 142A). The user clicks the ‘ADD . . . ’ row 14436 to gain access to the joinable fields as they know they will see the joinable field they want in ‘table_a’ 14436. That selection does not change the formula 14463 (versus 14413) but changes the selection list 14475 as shown in FIG. 144B. Here the user sees four fields/columns from ‘table_a’ 14476 containing the field ‘donation’ that they select 14485. This populates ‘donation’ into the formula 14513 where the user immediately adds ‘>75’ into the formula 14513 to get the selection list 14535 as shown in FIG. 145A.

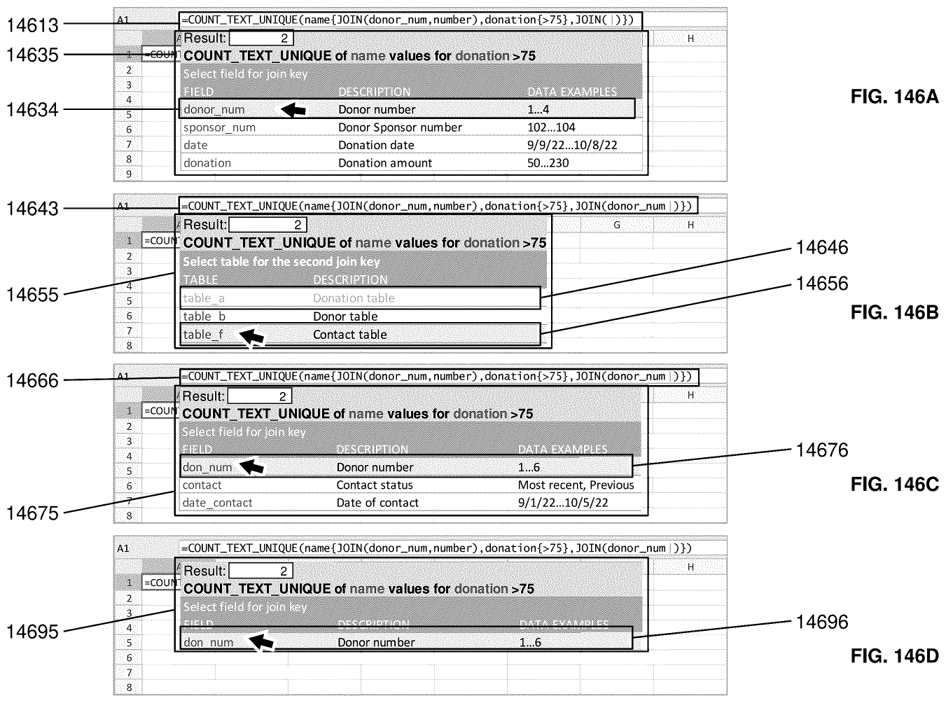

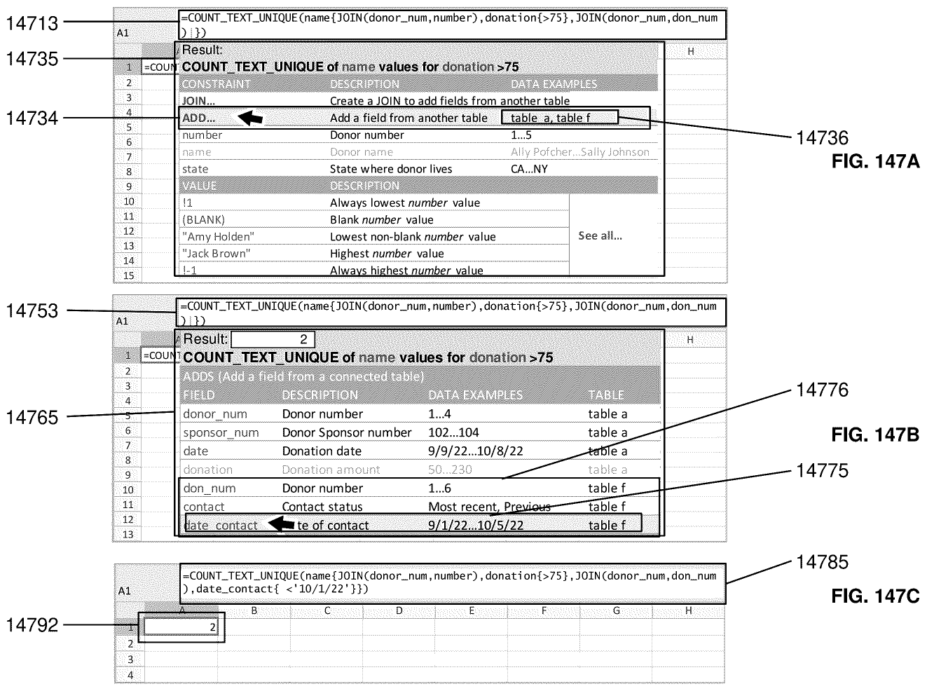

At this point the user knows they need to add a second join that will then sequence/chain to allow join the fields of ‘table_b’ to the fields of ‘field_f’ which is required for the desired formula. So, they again click ‘JOIN . . . ’ 14534 to select a function to join the data sets. That opens the selection list 14565 in FIG. 145B which again displays six different join type functions 14567 in this embodiment without changing the formula 14553. The user wants to do a full outer join so in this embodiment they select (click) ‘JOIN’ 14566 to populate it into the formula 14573 as shown in FIG. 145C. That opens the selection list 14585 displaying the three data sets available to the user. The user sees the data set they want to start the join from and selects (clicks) ‘table_a’ 14586 to open the selection list 14635 in FIG. 146A. In this embodiment nothing has yet been populated in the formula 14613 because this has opened up a selection list of potential fields to populate as the first join key pair (because each field is unique there is no need to populate the table in the formula, but our technology could support that or other join formula syntaxes). The user then sees the field that want for the join key, ‘donor_num’, which they select (click) 14634 to populate ‘donor_num’ in the formula 14643 and open (automatically) the selection list 14655 in FIG. 146B. This displays the data set selector for the second join key where they see the data set they want and therefore select ‘table_f 14656 to open the selection list 14675 in FIG. 146C. The selection list 14675 in FIG. 146C gives the user the field they desire for the second join key, so they select ‘don_num’ 14676 to populate ‘don_num’ in the formula 14713 and open the selection list 14735 in FIG. 147A.

This has not only availed the user to the joined fields from ‘table_f’ but in this embodiment has added them to the readily available joined data accessible through the ‘ADD . . . ’ line 14734 as exampled by ‘table_f 14736 now being listed with ‘table_a’ 14736. This was not the case before the join as was exampled in 14536 in FIG. 145A which only listed ‘table_a’. The second join, through the chained/sequenced joins, added the ‘table_f joinable fields to the selection lists as we will example after returning to FIG. 146C.

As before the selection list in FIG. 146C delivered a join key selection list 14675 that had no qualification validation, thereby having fields that were of different data types with no value matches with the first join key field, ‘donor_num’. As before a different embodiment exampled in FIG. 146D with data type qualification validation would give the user in the selection list 14695 only fields that are a comparable integer data type, which in this example is only the field ‘don_num’ 14696. And as described before and not repeated again different embodiments bring forth different levels of information for the user and qualification validation tests to make it easier for the user to select well performing join keys.

Returning to the example in FIG. 147A, this time when the user clicks the ‘ADD . . . ’ row 14734 to gain access to the joinable fields where they know they will see the joinable field they want in ‘table_f 14736. Like before in this embodiment that selection does not change the formula 14753 (versus 14713) but changes the selection list 14765 as shown in FIG. 147B. Here the user sees three fields/columns 14776 from ‘table_f’ which were not there prior to the user adding the second join (JOIN (donor_num,don_num), as exampled in comparable selection list 14475 in FIG. 144B lacking the ‘table_f fields/columns 14776. At this point the user sees the ‘date_contact’ field that they want and selects (clicks) it 14775 then selecting/filling in “<‘Oct. 1, 2022’ and hitting ENTER/RETURN to get the value ‘2’ in cell ‘A1’ 14792 from the formula 14785 in FIG. 147C. The data joining and calculations parallel those done in FIG. 115, FIG. 116A and FIG. 116B although in this situation employing two in-formula setup joins of two data sets combining the three data set via a chained/sequenced join. As we have discussed, our technology supports different ways described herein to setup the data set joins used in our spreadsheet formula and as exampled herein different sets of selection lists to support those data set joins.

### Data Joining Setup Delivering Joinable Data Use Selection Lists for Chained Joins Employing a General Join Function

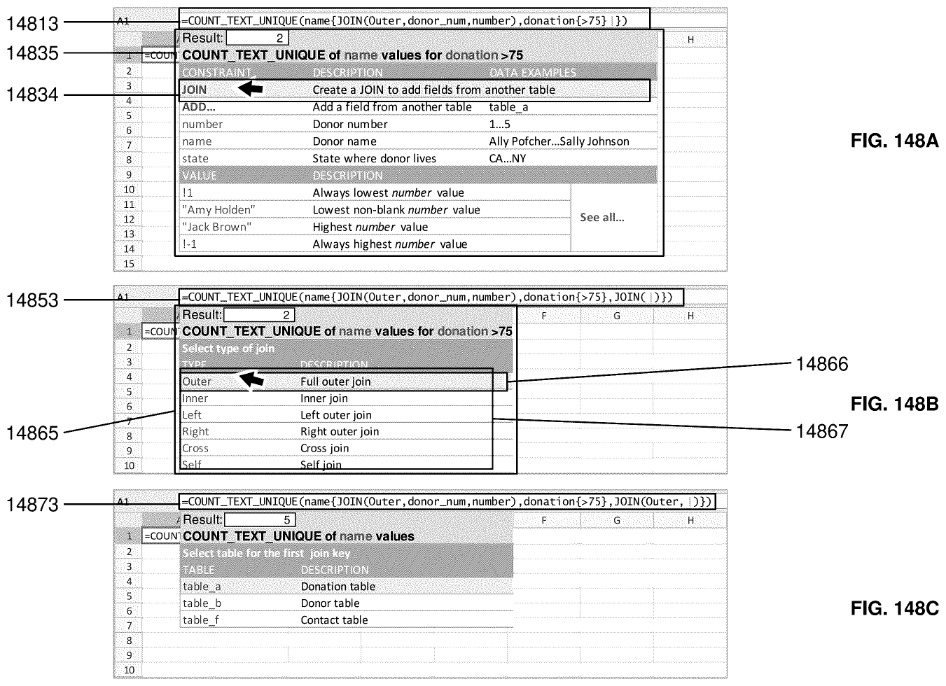

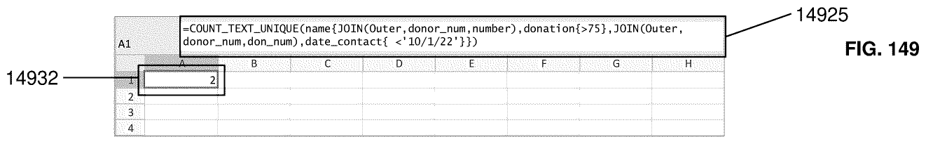

FIG. 148A through FIG. 149 examples some vignettes similar to FIG. 142A through FIG. 147C in-formula joins and chained/sequenced joins automatically enabling the joinable field selection lists employing a general ‘JOIN’ function rather than the join type specific functions. The difference is this embodiment is the selection list 14835 in FIG. 148A displays a ‘JOIN’ function 14834 instead of the ‘JOIN . . . ’ link 14234 in FIG. 142A. Therefore, when the ‘JOIN’ function 14834 is clicked it populates the function in the formula 14853 in FIG. 148B and the selection list 14865 displays argument selections 14867 (not functions as selection list 14265 in FIG. 142B) that then populate as an argument when selected 14866, as exampled in formula 14873 in FIG. 148C. But other than the general function and the join type arguments the formula works similarly to FIG. 142A through FIG. 147C as exampled by the same result of ‘2’ in cell ‘A1’ 14932 in FIG. 149 from a formula 14925 that only differs in the ‘JOIN’ function (which is a general join function not a type specific one) and its join type argument.

Our technology supports even more minimalistic embodiments going all the way to embodiments which have no selection list support other than the function lists you find in existing Microsoft Excel spreadsheets.

Data Joining with Minimal Selection Lists

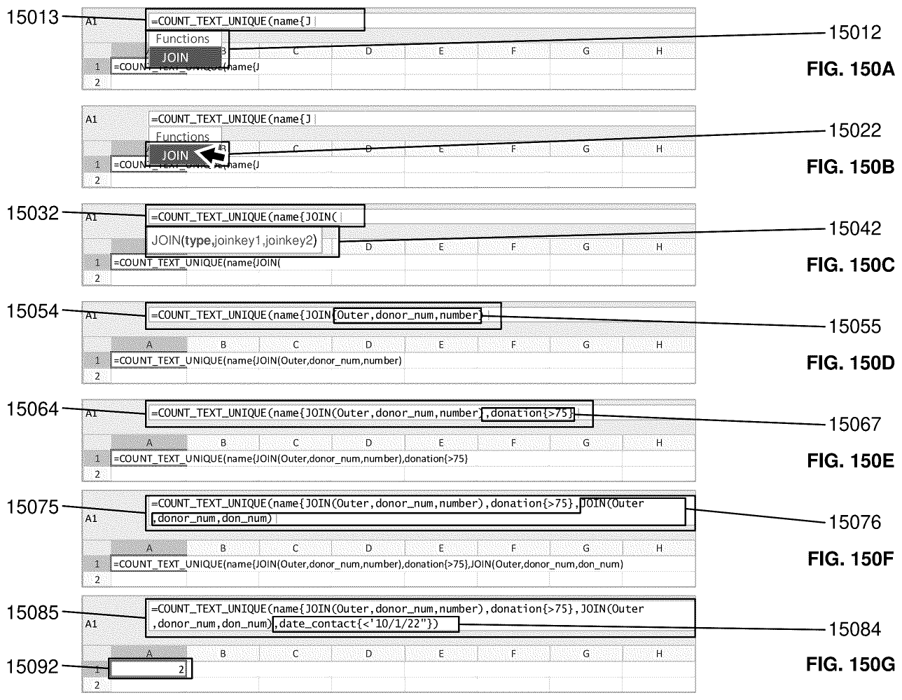

FIG. 150A through FIG. 150G examples the setup of a functioning formula with multiple chained/sequenced joins supported only by a function selection list and the function guiding syntax help. The user is replicating the formula in FIG. 149 by predominately typing the formula arguments. In FIG. 150A the user types ‘=COUNT_TEXT_UNIQUE (name {J’ 15013 at which point they get the function selector for ‘J’ which only has one function ‘JOIN’ 15012. They click ‘JOIN’ 15022 in FIG. 150B which populates the ‘JOIN’ function in the formula 15032 in FIG. 150C and opens the syntax guide 15042 at which point the user knows what they need to input into the ‘JOIN’ function. They type in ‘Outer, donor_num, number)’ 15055 as the ‘type,joinkey1,joinkey2’ in the formula 15054 in FIG. 150D. They then type ‘, donation {>75} 15067 into the formula 15064 in FIG. 150E after which they type ‘JOIN (Outer, donor_num,don_num) 15076 in FIG. 150F to add the second join which then chain/sequence connects the three data sets ‘table_a’, 11732, ‘table_b’, 11735, and ‘table_f’, 11738 in FIG. 117. They then finish the formula adding ‘, date_contact {<‘Oct. 1, 2022’}))’ 15084 and hit ENTER/RETURN to get the value ‘2’ in cell ‘A1’ 15092 from the formula 15085 in FIG. 150G. The data joining and calculations parallel those done in FIG. 115, FIG. 116A and FIG. 116B although in this situation employing two in-formula setup joins of two data sets combining the three data set via a chained/sequenced join.

In our technology the user can specify more of the qualifications that determine the join outcomes, e.g., for of the join qualification tests in FIG. 4. In different embodiments that can be done in different locations (e.g., see FIG. 128), different ways and using different UIs. In this formula driven embodiment, it can be done as exampled in FIG. 156A through FIG. 156C. Where the user specifies arguments that specify the cardinality and value matches as specified in the syntax 15624 for the formula 15622 in FIG. 156A. This immediately lets the user, in a limited selection supported embodiment, know whether their specified join passes the qualification arguments. In the examples in FIG. 156B and FIG. 156C the formulas (15634 and 15655) contain a cardinality argument value of ‘3’ 15636 which stands for accepting unique to unique and non-unique to unique cardinalities but rejecting joins that are non-unique to non-unique (many to many). The ‘50,50’ inputs 15637 in the ‘match1’ and ‘match2’ arguments in the formulas (15634 and 15655) accept joins where the match of the first key values found in the second key is greater than fifty percent and match of the second key values found in the first key is greater than fifty percent. That same cardinality requirement can be automatically applied by our technology to the sequenced joins as was exampled in FIG. 110A through FIG. 113B.

Rather than describing more different variants of setting up the joins and specifying the in-cell formulas using them in our technology, we will example a more complicated formula employing more than two joins.

### More Complicated Formula and More Joins

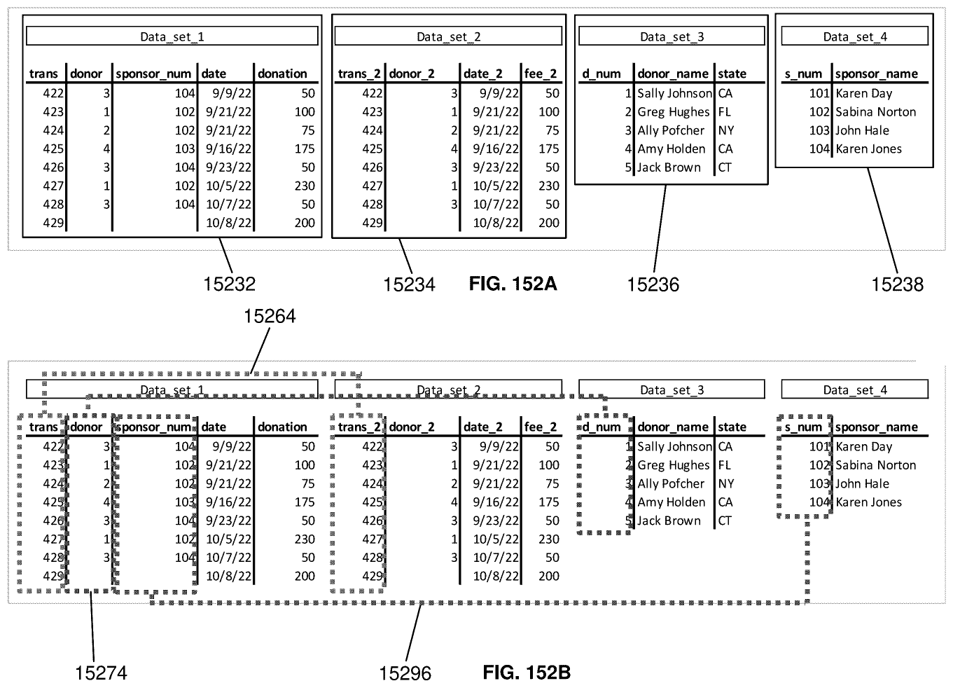

FIG. 136A, FIG. 136B and FIG. 152A through FIG. 155B examples a more complicated formula with multiple functions and algebraic operators employing joins of four different data sets in our technology. The in-cell formula could have been specified using any of the approaches described herein with any of the applicable formats. FIG. 136A examples a formula 13635 with invisible join arguments joining the four data sets (15232, 15234, 15236, and 15238) in FIG. 152A employing the color-coded join key pairs (green—15264, red—15274, and blue—15296) illustratively exampled in in FIG. 152B. The horizontal headings 13646 are from a field/column in ‘Data_set_3’ while the vertical headings 13651 are from a field/column in ‘Data_set_4’ while the related calculation in cells ‘C3’ to ‘G7’ 13656 use fields from ‘Data_set_1’, ‘Data_set_2’, and ‘Data_set_3’ thus using all four data sets in the cell formula 13635 for cell ‘A1’ 13641. FIG. 136B examples a formula 13685 with visible join arguments 13695, in this example using a general join function, that produces the same result in cells ‘A1’ through ‘G7’ 13655 in FIG. 136A. In FIG. 136B the visible ‘JOIN’ arguments 13695 were placed in the fourth argument group which contains the constraints/filters, where a join is then a type of constraint/filter-one that reverses the filtration or broadens the constraint to contain the joined fields. However, our technology supports putting them elsewhere in the formula in the same way that you put functions (e.g., in this case JOIN) in the arguments of other functions or in the arguments of our formulaic data. We could example many different variants of our formulas delivering the same outcome but for brevity's sake will leave it as these two.

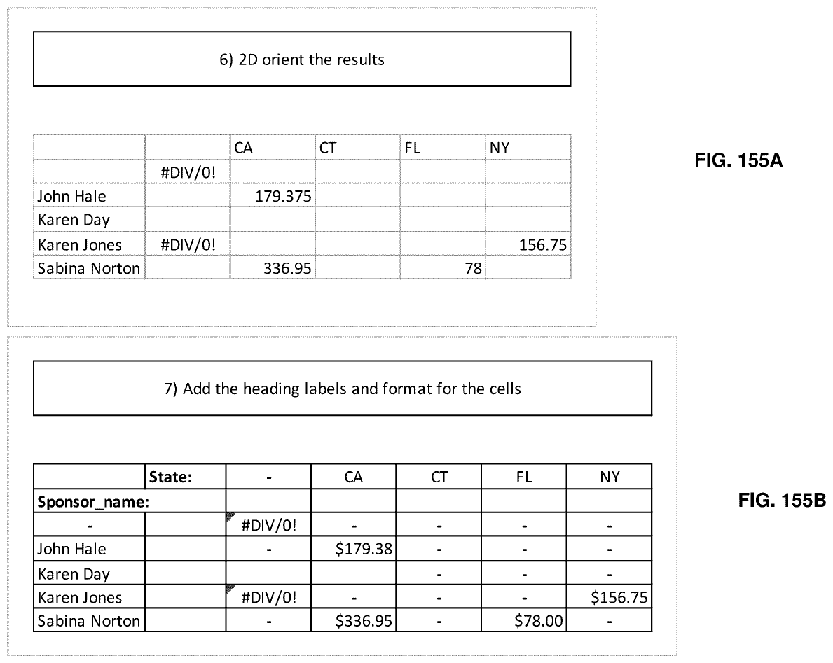

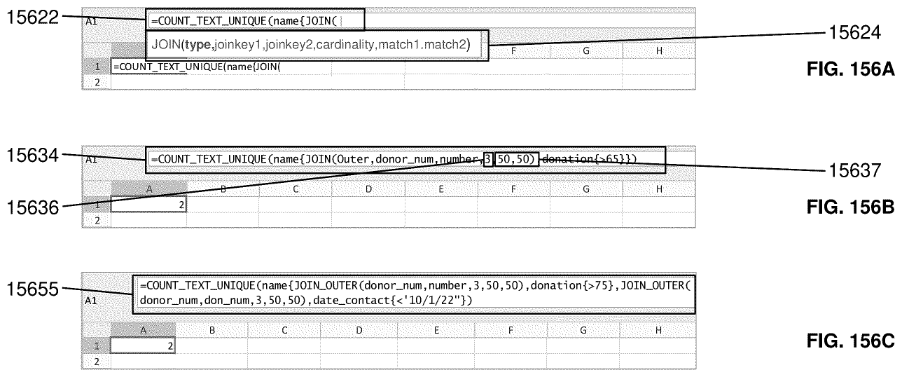

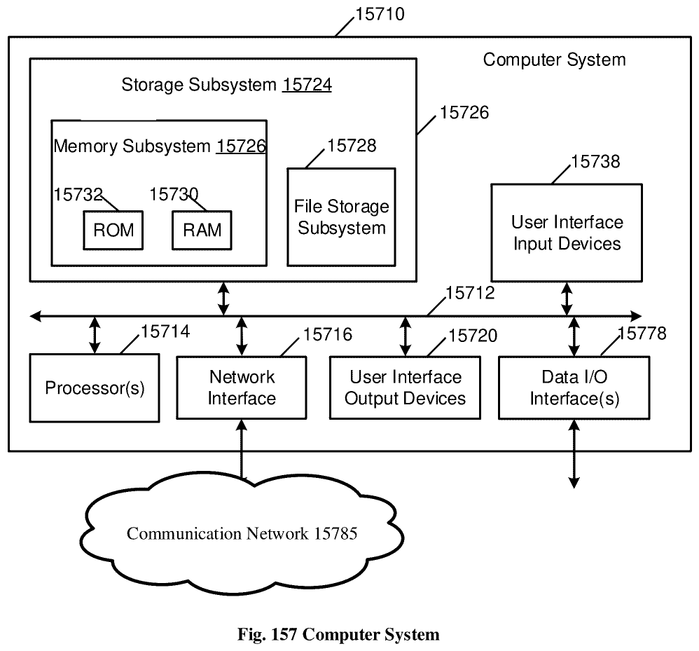

The operations delivering the results 13655 in FIG. 136A are illustratively exampled in FIG. 153 through FIG. 155B. FIG. 153 examples the chained/sequenced full outer join 15375 of the four data sets (15342, 15344, 15346, and 15348) in our technology. Step ‘1)’ in FIG. 154A executes the chained/sequenced full outer join and organizes the required data in an order easy to see the further steps. Step ‘2)’ in FIG. 154A sorts the data by ascending values of ‘sponsor_name’ and then ‘state’ creating the loops of the ‘WRITE_CALC_2D’ function. Step ‘3)’ in FIG. 154B then does the SUMs of the ‘donation’ and ‘fee_2’ values for each loop. Step ‘4)’ in FIG. 154B then does the ‘COUNT_TEXT_UNIQUE’ function evaluation of ‘donor_name’ in preparation for step ‘5)’ in FIG. 154B to then use those loop function evaluations to do the calc for each loop. Step ‘6)’ in FIG. 155A then two-dimensionally orients the results of step ‘4)’ in preparation for ‘step ‘7’ to add the heading labels and format the results for the cells ‘A1’ to ‘G7’ 13655 in FIG. 136A. Our technology supports even more joins and even more complex formulas using the broad spectrum of prebuilt spreadsheet analytical functions. But for brevity's sake we will move on to discussing the other types of implementations before discussing example computer systems employed by our spreadsheet technology.

### Other Types of Implementation Embodiments

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In the interest of conciseness, the combinations of features disclosed (e.g., locations of joins, types of joining, validation of joins, join selection lists and joinable data selection lists) in this application have not repeated with each of the other features and in all the possible combinations. The reader will understand how features identified in this section can readily be combined with sets of other features. We will therefore move on to describing one of many example computer systems that can be used for our technology.

### Computer System

FIG. 157 is a block diagram of an example computer system, according to one implementation. Computer system 15710 typically includes at least one processor 15714 which communicates with a number of peripheral devices via bus subsystem 15712. These peripheral devices may include a storage subsystem 15724 (including, for example, memory devices 15726/15732/15730 and a file storage subsystem 15728), user interface input devices 15738, user interface output devices 15720, Data I/O interface(s) 15778, and a network interface subsystem 15716. The input and output devices allow user interaction with computer system 15710. Network interface subsystem 15716 provides an interface to outside networks, including an interface to communication network 15785, and is coupled via communication network 15785 to corresponding interface devices in other computer systems or in the cloud and usable for cloud applications.

User interface input devices 15738 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 15710 or onto communication network 15785.

User interface output devices 15720 may include a display subsystem, a printer, a fax machine, or non-visual displays such as audio output devices. The display subsystem may include a touch screen, a flat-panel device such as a liquid crystal display (LCD), a projection device, a cathode ray tube (CRT), or some other mechanism for creating a visible image. The display subsystem may also provide a non-visual display such as via audio output devices. In general, use of the term “output device” is intended to include all possible types of devices and ways to output information from computer system 15710 to the user or to another machine or computer system.

Storage subsystem 15724 stores programming and data constructs that provide the functionality of some or all of the modules and methods described herein. These software modules are generally executed by processor 15714 alone or in combination with other processors.

Memory 15726 used in the storage subsystem can include a number of memories including a main random-access memory (RAM) 15730 for storage of instructions and data during program execution and a read only memory (ROM) 15732 in which fixed instructions are stored. A file storage subsystem 15728 can provide persistent storage for program and data files, and may include a hard disk drive, SSD, a tape drive, an optical drive, or removable media cartridges. The modules implementing the functionality of certain implementations may be stored by file storage subsystem 15728 in the storage subsystem 15724, or in other machines accessible by the processor.

Bus subsystem 15712 provides a mechanism for letting the various components and subsystems of computer system 15710 communicate with each other as intended. Although bus subsystem 15712 is shown schematically as a single bus, alternative implementations of the bus subsystem may use multiple busses.

Computer system 15710 can be of varying types including a workstation, server, computing cluster, blade server, server farm, or any other data processing system or computing device. Due to the ever-changing nature of computers and networks, the description of computer system 15710 depicted in FIG. 157 is intended only as one example. Many other configurations of computer system 15710 are possible having more or fewer components than the computer system depicted in FIG. 157.

### Some Particular Implementations

Some particular implementations and features are described in the following discussion. Implementations of our spreadsheet cell formula data joining technology support a broad spectrum of situations from two data set joins, multiple joins between two data sets, multi-data set joins to data sets combining all of these. Our implementations support prequalifying joins (before the in-cell formula), so the typical spreadsheet user does not have to deal with the mechanics of determining the join keys and/or the join type. So that the prequalified joinable fields are simply available to users in selection lists for use in cell formulas. For the more sophisticated user implementations our technology supports altering (requalifying) those join keys or join types as well as having implementations with no prequalification where all the join setting is done in the cell formula. Implementations of our technology support the full spectrum of cardinality (data modelling) or relationships between data sets as well as having implementations that limit cardinality types and even limit prequalification cardinality (e.g., to exclude many to many) while having a different limitation or no limitation on requalification (e.g., in joins specified in the cell formula). All our implementations support data sets from different types of sources, data external to the spreadsheet and in-cell data, and support combinations of those sources. We will start with a two-data set implementation employing prequalified joins used for selection lists before moving on to implementations further broadening the range of situations supported.

### Two Data Set Qualified Selection List Join

Our data set joining technology supports a spreadsheet cell formula joining data from two data sets using any of the SQL supported join types (e.g., full outer, inner, and left outer). This implementation starts by qualifying the joinability of the two data sets based on the field/column in each data set specified for the join keys. That qualification flag setting can be done in many different ways, as exampled in FIG. 8, with the validation of the join qualification being tested (validated) in different ways, as exampled in FIG. 4, and taking place in many different locations, as exampled in FIG. 128. FIG. 151 examples one UI used in the qualification flag setting via a data intake tool (e.g., external or within the spreadsheet) exampling the setting of the join qualification flag for join keys 15141 and 15166. It also examples many of the qualification validation test results (Data type match—15187, Cardinality—15177/15154, Data values match—15167, and Data values match percent 15153/15155) as docs FIG. 57.

What follows next is one example starting with the join qualification flags set through to completing the in-cell formula executing the join. This example is then followed by a much longer list of examples. When a user begins a spreadsheet formula cell formula populating a field from one of those two data sets our technology displays a way for the user to see and select the fields in the joinable data set (the other data set in this example) in a selection list as exampled in FIG. 16A, and FIG. 16B. Once the user has selected at least one field from each of the two joinable data sets and executed the spreadsheet cell formula our technology joins the data, as exampled in FIG. 15, and uses it to determine the outcome of the spreadsheet cell formula as exampled in FIG. 16C via supporting illustrative in-cell formula calculations, as exampled in FIG. 18A or FIG. 18B.

More examples follow of when a user begins a spreadsheet formula cell formula populating a field from one of those two data sets and our technology displays a way for the user to see and select the fields in the joinable data set (the other data set in this example) in a selection list. Those examples are in FIG. 17A, FIG. 20B, FIG. 21A/B, FIG. 23A/B, FIG. 25A, FIG. 27A, FIG. 29B/31A, FIG. 33B/34A, FIG. 36A, FIG. 38A, FIG. 43B, FIG. 45A/B, FIG. 47A/B, FIG. 49A, FIG. 51A, and FIG. 62A/B. Once the user has selected at least one field from each of the two joinable data sets and executed the spreadsheet cell formula our technology joins the data, as exampled in FIG. 15, FIG. 28A, FIG. 32A, FIG. 35A, FIG. 37A, FIG. 39A, FIG. 41/42 and FIG. 50A, and uses it to determine the outcome of the spreadsheet cell formula as exampled in FIG. 17B, FIG. 17C, FIG. 20C, FIG. 20D, FIG. 21C, FIG. 21D, FIG. 23C, FIG. 23D, FIG. 25B, FIG. 25C, FIG. 27B, FIG. 27C, FIG. 31B, FIG. 31C, FIG. 34B, FIG. 34C, FIG. 36B, FIG. 36C, FIG. 38B, FIG. 38C, FIG. 43C, FIG. 43D, FIG. 45C, FIG. 45D, FIG. 47C, FIG. 47D, FIG. 49B, FIG. 49C, FIG. 51B, FIG. 51C, FIG. 63B, FIG. 64C, and FIG. 67B, supporting illustrative in-cell formula calculations, as exampled in FIG. 18A, FIG. 18B, FIG. 22, FIG. 24, FIG. 26A, FIG. 26B, FIG. 28B/C, FIG. 32B/C, FIG. 35B/C, FIG. 37B, FIG. 39B/C, FIG. 44A, FIG. 44B, FIG. 46, FIG. 48, FIG. 50B, FIG. 52A/B, and FIG. 65A/B.

### Two Data Set Qualified Selection List Join-Qualification Before Cell Formula

Our technology supports many different ways to qualify the join flag. In one implementation the join qualifying is done in a data intake tool where the data is prepared most typically by a single user for use by all the spreadsheet users employing that combination of data sets. That way the typical spreadsheet user (not the user qualifying the joins) does not have to deal with the mechanics of determining the join keys and/or the join type when they are creating a spreadsheet cell formula. So that the qualified joinable fields are simply available to them in selection lists for use in cell formulas. In this implementation the data set join keys are determined, and qualification flag validated before the cell formula as exampled in the UIs in FIG. 12, FIG. 13, and FIG. 151. It is also exampled in FIG. 128 for the boxes corresponding to ‘INTAKE-External to spreadsheet’ qualification 12835, recognizing that for reasons of conciseness FIG. 128 does not example all the possible combinations supported by our technology including those with combined external and in-cell data sets.

However, our technology supports many other qualification locations before in-cell as exampled by ‘INTAKE—in spreadsheet’ 12845 in FIG. 128 where the spreadsheet user qualifies, with or with automated qualification validation, join keys as exampled in paths ‘B’ and ‘|’ in FIG. 128. That can employ a UI similar to those in FIG. 12, FIG. 13, and FIG. 151 or other UIs mentioned herein. Our technology also supports ‘Spreadsheet capability’ 12855 and ‘Worksheet capability’ 12865 level join keys qualification where the difference is the extensiveness of the qualification. The whole spreadsheet for the ‘Spreadsheet capability’ 12855 and just the worksheet for the ‘Worksheet capability’ 12865. With setting done in a UI like that exampled in FIG. 133C and FIG. 133D or other UIs mentioned herein.

Our technology also supports qualification first set in one location and then reset to something else in another location as exampled in the extreme situations in paths ‘G’ and ‘N’ FIG. 128. All the mix and match combinations were not illustrated for brevity's sake. The ‘In cell-all content’ 12875 is also applicable provided the cell the join was created in was done prior to the cell now using the join.

### Two Data Set Qualified Selection List Join—Qualified Join Fields Before Cell Formula Invisible Join Argument

A further implementation employing the before cell formula qualified joinable data sets requires no visible join argument in the cell formulas as exampled in FIG. 16C, FIG. 17B, FIG. 20D, FIG. 21C, FIG. 23C, FIG. 25B, FIG. 27B, FIG. 31C, FIG. 34C, FIG. 36C, FIG. 38B, FIG. 43D, FIG. 45D, FIG. 47C, FIG. 49C, FIG. 51B, and FIG. 67B. Therefore, the typical user does not need to deal with the complexity of seeing the join keys and join type but simply sees the fields/columns they desire in the formula. In all these examples the fields/columns have unique names not requiring the inclusion of a data set in the field/column identifier (naming), but our technology supports a data identifiers composed of data set names and field/column names.

### Two Data Set Qualified Selection List Join—Qualified Join Fields Before Cell Formula Visible Join Argument or Function

Another implementation variant employing the qualified joinable data sets populates a visible join argument or function (with its own arguments) in the cell formulas as exampled in FIG. 17C, FIG. 20C, FIG. 21D, FIG. 23D, FIG. 25C, FIG. 27C, FIG. 31B, FIG. 34B, FIG. 36B, FIG. 38C, FIG. 43C, FIG. 45C, FIG. 47D, FIG. 49B, FIG. 51C, and FIG. 63B. That argument or function, with its own arguments, may tell the user the join type (e.g., JOIN, JOIN_INNER, JOIN_LEFT), the join key fields/columns, both of those or simply tell the user that a join took place and/or the situation it was used in (e.g., substitution). FIG. 135A examples the auto populated function (13528) telling the user the type of join employed (e.g., inner join) and the join key pair fields as the two arguments within the parentheses. FIG. 121C also examples a join dedicated function identifying the join keys. FIG. 126C and FIG. 126D example cell arguments identifying the join type and join keys.

### Two Data Set Qualified Selection List Join—Qualified Joins Changed in Formula

Implementations of our technology also support the overriding of a qualified join in a cell formula by inclusion of a join argument and/or a join prebuilt function changing the join type as exampled in FIG. 66A through FIG. 67B, where the user has a ‘JOIN . . . ’ 6634 selection giving the user the user the opportunity to change the default join. They could then change the default join type (e.g., left outer, right outer, and inner) used for joining in table_aa, 6627 FIG. 66A, employing a UI like 6884 in FIG. 68C. The spreadsheet cell user can change the join keys using a selection list UI like the one in 6924 in FIG. 69A or the selection list UIs in FIG. 119C through FIG. 120D. In those examples the join type is defined by the name of the join function (e.g., JOIN is full outer, JOIN_INNER is an inner join, and JOIN_SELF is a self-join). Alternatively, our technology supports a general join function with a join type argument (e.g., FIG. 140A through FIG. 140C) or the join type as an argument added to the regular formula or regular functions (e.g., FIG. 126C through FIG. 126D).

### Two Data Set Qualified Selection List Join—In Formula Join Qualification and Selecting

In another implementation the join can be added to the cell formula by the user via specifying a formula argument or a prebuilt function that specifies the join to be done in the formula, provides the joined data to be used in the formula calculation and qualifies the joined data sets for the field selection lists as exampled in FIG. 129A through FIG. 132B and FIG. 70 and FIG. 71. The addition of the completed join function ‘JOIN_INNER {s_id,s_id_num)’ in the formula 13113 in FIG. 131A automatically qualifies the joined fields for the selection lists as exampled by the ‘ADD’ line 13124 for ‘table_aa’ 13127 in FIG. 131A now being visible when it was not previously visible in the selection list 12945 in FIG. 129A (before the addition of the join function to the formula). FIG. 70 examples the ‘JOIN_INNER {s_id,s_id_num)’ in the formula 13184 in executing the data set join and FIG. 71 examples the joined data used to deliver the value in cell ‘A1’ 13192. The formula argument version of the implementation could use an argument like 12664 in FIG. 126C but otherwise operate the same way qualifying the joinable data for selections lists, executing the join, and providing the joined fields for use in the formula.

FIG. 117A through FIG. 121C examples a hybrid situation where one join is qualified before the cell formula (in this example having an invisible argument) and a second join is added and qualified in the cell formula, so that both specifies the joins to be done in the formula, provides the joined data to be used in the formula calculation and qualifies the joined data sets for the field selection lists.

### Two Data Set Qualified Selection List Join—In Formula Join Selection List Support

In another implementation the user creation of a join formula argument or join function has extensive selection list support to help them users create the join as exampled by the selection lists in FIG. 129A through FIG. 130D and FIG. 132A and FIG. 132B. These selection lists give the user situationally specific listings of available data sets (e.g., 12985 in FIG. 129C and 13055 in FIG. 130B) and more situationally specific help such as the qualification validation information in FIG. 132A or a step further in FIG. 132B where our automated qualification validation has removed join keys (13234 and 13244 in FIG. 132A) to only leave the keys that have passed the qualification validation flag steps. Exampling one path in FIG. 4 passing only join key pairs that have data matches and greater than ‘0%’ matching values.

### Two Data Set Qualified Selection List Join—Qualification Ways

As previously described our technology supports many different ways to validate the qualification flag of a data set to data set join as exampled in FIG. 8. In one implementation the qualification validation is done by a human as laid out in FIG. 8 pathway ‘a/b/h’ and exampled in a UI in FIG. 12. In another implementation the human starts the process by specifying a join after which that join is goes through a further qualification step employing one or more validation test as exampled in FIG. 4. That join qualification pathway, exampled in FIG. 8 pathway ‘a/c/d/h’, can employ any one of the automated validation tests in FIG. 4 during step ‘d’. FIG. 54 and FIG. 55 example what a UI might look like if that join is rejected.

In another implementation the joins are automatically identified and qualified without human actions other than specifying the data sets. FIG. 8 pathway ‘a/g/h’ lays this out and it can be set up in our technology, so its automated validation testing uses any of the paths in FIG. 1 other than path A. A related implementation starts with the automated identification of the join key pairs but adds human qualification step allowing ideally a data savvy user to eliminate any auto validated join key pairs that while technically correct do not make sense as laid out in FIG. 8 pathway ‘a/e/f/h’. Such a pathway could be executed in a UI like 5645 in FIG. 56 where the user could then click ‘ADD’ 5648 to add the join to the ‘Existing joins’ 5668. FIG. 56 also examples how our technology can support more than one implementation together such as the ability to have FIG. 8 pathway ‘a/b/h’ coexist with pathway ‘a/e/f/h’ to make it easy for the user to add back pathways they may have previously rejected. There are combinations of the pathways such as the UI exampled in FIG. 151 where the user specified the two data sets and a join key in the first data set and our technology validated all the possible fields in the second data set leaving it for the user to decide between the multiple fields that passed all the validation tests (15147 selected and 15157 not selected).

### Two Data Set Qualified Selection List Join—Qualification Location

As previously described our technology supports many different locations to validate the qualification of a data set to data set join as exampled in FIG. 128. In one implementation the qualification is done external to the spreadsheet in the data intake tool 12835 in FIG. 128. A more detailed example of that could employ a UI as exampled in FIG. 12, FIG. 13, FIG. 54, FIG. 55, FIG. 56, and FIG. 151. In another implementation, which can co-exist with the previous implementation, the qualification is done within the spreadsheet in a data intake tool 12845 in FIG. 128. This data intake tool can intake data both internal to the spreadsheet (i.e., data sets in cells) and external to the spreadsheet. A more detailed example of that could employ a UI as exampled in FIG. 12, FIG. 13, FIG. 54, FIG. 55, FIG. 56, and FIG. 151. In another implementation the join qualification is done in a spreadsheet wide (e.g., 12855 in FIG. 128) or worksheet specific (e.g., 12865 in FIG. 128) capability with a UIs exampled in FIG. 133A and FIG. 133D. As stated previously any of these forementioned qualification locations can coexist with any or all of the others. And any of them other than the first data intake location can requalify (change) a previously qualified data set to data set join qualification.

### Two Data Set Qualified Selection List Join—Alternative Joins

Our technology supports the creation and usage of alternative qualified data set joins employing all different join keys. Those joins have two different sets of join key pairs which contain no duplicate dataset/field combination. In one implementation when the two alternative joins have been qualified one of the joins (join key pairs) is selected as the default join (the join used unless a user manually switches to the other) with the second an alternative which has selection list support for selection as specifically exampled in FIG. 62C and FIG. 64A and exampled with the data sets through calculations in FIG. 59A through FIG. 65B.This occurs when in the qualification process the user sets up two potential joins between the same two data sets where all the join key fields are different, setting up two different ways to join the same two data sets. The default join can be automatically selected by our implementation employing matching rules and a potential tiebreaker or it can be left for the user to decide as is exampled in radio buttons 13467 setting the default in FIG. 134. In a related implementation exampled in FIG. 68A through FIG. 71 the alternative joins are prequalified but the selection between them is left for the in-cell formula supported by selection lists for selecting the join type (FIG. 68C) and the join key pairs (FIG. 69A).

### Two Data Set Qualified Selection List Join—Join Qualification Validation Tests

Our technology supports the automatic application of many different types of qualification validation tests and combinations of those tests as exampled in FIG. 4. One implementation rejects a join where the join key fields in the two different data sets are not the same data type (e.g., numeric or finer cut to integer and floating point, text, and date) as exampled in step ‘2’ in FIG. 4, 12462 in FIG. 124C and FIG. 132B versus 13244 in FIG. 132A. Alternatively said, the implementation only accepts the join if both join keys are the same data type.

Another implementation rejects a join if join key pair field values have no overlaps, i.e., none of the same values shared in the two fields which therefore would append no data in the join or yield no rows of data in an inner join. Alternatively said, the implementation only accepts the join if at least one shared value is found in both of the two join keys as exampled in step ‘3’ in FIG. 4 or FIG. 124B and FIG. 132B (versus FIG. 132A 13234). That same implementation can reject the join if a minimum percentage of shared values is not found in one or both of the two join keys as exampled in step ‘3a’ in FIG. 4, 15167 in FIG. 151, or 13265 in FIG. 132B (versus 13234 in FIG. 132A). Alternatively said, the implementation only accepts the join if minimum percentage of shared values is found in one or both of the two join keys.

Another set of implementations rejects or does not reject joins based on the data modelling cardinality of the two join keys as exampled in step ‘4’ in FIG. 4. Step ‘4’ rejects based non-unique to non-unique (many to many) joins, said differently accepts only unique to unique and unique to non-unique cardinality joins, as exampled in the data intake UI in FIG. 55 resulting from the action in FIG. 54. Or exampled in FIG. 151 15177. FIG. 57 step ‘3’ 5745 examples the removal of the many to many join key pairs 5735 during an automated qualification validation and FIG. 113A and FIG. 113B examples the resulting formula error generation when a user types a formula failing this data modelling cardinality qualification validation rule. Alternatively, FIG. 114 accepts non-unique to non-unique (many to many) joins and executes the formula as contrasted with FIG. 113B where exact same formula generates an error.

There are many additional variants of the data modelling cardinality implementations including a more rigorous rule rejecting joins that are not one to one (i.e., one join key value/record in a data set is associated with one and only one join key value/record in another data set). An additional implementation varies the modelling cardinality rule, applying one data modelling cardinality rule (e.g., reject many to many) at one qualification location and a different one (e.g., accept everything) at a different location. FIG. 117A through FIG. 121C with the cell formula join and calculations in FIG. 115 through FIG. 116B examples that where the data modelling cardinality rule is to reject many to many joins in pre-in-cell formula qualifications with a different data modelling cardinality rule of accept all cardinalities applied to in-cell qualified joins.

### Two Data Set Qualified Selection List Join—Joinable Fields Selection List Types

Our technology supports many different visual representations of the joinable fields. One implementation once a joinable field is inputted into the formula displays all the joinable fields when appropriate in a single selection list as exampled in FIG. 17A, FIG. 20B, FIG. 27A, FIG. 36A, FIG. 38A, FIG. 43B, FIG. 49A, and FIG. 51A. However, in some instances where there are large numbers of fields in each data set and/or many data sets joined, presenting all the joinable fields in a single selection list can be overpowering and instead the joinable data is accessible in the first selection list and fully displayed in subsequent selection lists. FIG. 16A/B, FIG. 21A/B, FIG. 23A/B, FIG. 29B/31A, FIG. 45A/B, FIG. 47A/B, FIG. 62A/B, and FIG. 66A/B example a first selection list where the joinable fields are accessible via a selection that takes the user to a second selection list displaying the joinable fields. In situations we will discuss later where there are more than two joinable data sets the accessing mode may differ adding a table (data set) selection step. As also exampled the accessing display may have more than one type of option (e.g., ‘ADD’ and ‘SUB) as exampled in FIG. 29B, and FIG. 33B.

### Two Data Set Qualified Selection List Join—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. An application default join type can then be overridden by a user selection. All types of SQL joins are supported by our implementations but can also be more limited in their selection list as exampled in FIG. 73B, FIG. 119B, FIG. 125B, and FIG. 129B.

### Two Data Set Qualified Selection List Join—Joinable Field Replacement

Implementations of our technology not only support adding joinable fields to spreadsheet cell formula but also replacing (substituting) a field from one joinable data set by a field from one of the other joinable data sets as exampled in FIG. 33B through FIG. 34C, FIG. 38A through FIG. 38C, and FIG. 51A through FIG. 51C. This works the same way in our technology when there are more than one joinable data set.

### Two Data Set Qualified Selection List Join—Joinable Field Formula Usage

Implementations of our technology support usage in the broad spectrum of spreadsheet cell formula including any formulaic data field formula as exampled in FIG. 16A through FIG. 18B, FIG. 20A through FIG. 52B, FIG. 58C through FIG. 73D, and FIG. 129A through FIG. 132B. Implementations support usage in a broad range of prebuilt spreadsheet functions (e.g., SQRT, COS, SUM, COUNT, WRITE_CALC_2D) as exampled in FIG. 21A through FIG. 39C, FIG. 45A through FIG. 52B, and FIG. 72A through FIG. 74.

Implementations support use in prebuilt spreadsheet functions (e.g., FILTER, WRITE_V and WRITE_CALC_2D) that populate values into more than one spreadsheet cell as exampled in FIG. 29A through FIG. 39C, FIG. 49A through FIG. 52B, and FIG. 72A through FIG. 74. Our implementations also support usage of joined data fields in formulas containing many different combinations of functions within functions, combinations of functions and algebraic operators, many formulaic data fields and/or combinations of those combinations as exampled in FIG. 136A, FIG. 136B, and FIG. 152A through FIG. 155B (recognizing that example is for a multiple join but a formula of that complexity and more could easily be for a single join).

### Two Data Set Qualified Selection List Join—Data Set Source

Implementations of our technology support data sets external to the spreadsheet (e.g., FIG. 10A, and FIG. 10B), data tables or data ranges within the cells of the spreadsheet (e.g., FIG. 11A, and FIG. 11B), and a combination of the two.

### Two Data Set Qualified Selection List Join—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

Implementations of our technology support more limited locations of qualifying joins as well as sequencing/chaining joins to join more than two data sets. Before moving to the implementations that sequence/chain joins we will outline the preferred embodiments where all aspects of creating the join are done within the arguments of the spreadsheet cell formula.

### In Cell Formula Two Data Set Join

We are now moving on to a two-data set implementation not employing prequalified joins used for selection lists but instead employing only joins that are populated in the cell formula. Creating those joins in the cell formula may or may not be supported by selection lists going beyond the typical function selection list found in other spreadsheets (e.g., Microsoft Excel or Google Sheets). And those joins may or may not create automatic joinable data selection lists for then using the joinable data in the cell formula. The full range of these implementations start from the core implementation described next.

Implementations of our data set joining technology support formulas within a spreadsheet cell joining data from two data sets via a formula element that then executes the join so that the joined data can be used to execute the formula. This join element comes in many different forms, for example a predefined join dedicated spreadsheet function (e.g., join type dedicated functions FIG. 129B or a general join function with a join type argument FIG. 139C), a join argument within a non-join dedicated prebuilt function (e.g., FIG. 126C and FIG. 126D), a join argument within a formulaic data field (e.g., FIG. 124E 12492), or some other formula argument. This formula element joins a first and second data set employing a first (join key) field/column in the first data set and a second (join key) field/column in the second data set. Once the user populates at least one field/column from each of the two data sets the join can be done by the cell formula and the joined data used to execute the formula as exampled in FIG. 129A, through FIG. 131C with the join exampled in FIG. 70, and formula use of the joined data exampled in FIG. 71. Other examples from beginning the formula through completing it are shown in FIG. 123A, through FIG. 127B and FIG. 138A, through FIG. 139A.

### In Cell Formula Two Data Set Join—Specified Function Formula Elements

Our technology supports many different formula element implementations specifying the join within the cell formula. In one such implementation the join is specified by a join specific (e.g., JOIN_INNER, JOIN_LEFT and JOIN_RIGHT) spreadsheet predefined function. Those functions, like typical spreadsheet functions, have structured arguments to specify the first data set and it's join key field/column and the second data set and it's join key field/column as exampled in ‘JOIN_INNER (s_id,s_id_num)’ in the formula 13184 in FIG. 131C. In this example the structured arguments are the join key (‘s_id’) in the first data set and then the join key (‘s_id_num’) in the second data set separated by a comma (‘,’). This is a streamlined argument structure which works when the field/column names are unique and therefore identify their dataset. Had that not been the situation then additional arguments would be needed to identify the data sets. However, in either situation the arguments can be structured so that they can be displayed in a typical spreadsheet function syntax guide like exampled in 12563 in FIG. 125C. In this implementation the arguments are structured, not an unstructured query.

### In Cell Formula Two Data Set Join—Single Join Function Formula Element

Another implementation generalizes the join function to a single join function that contains an argument where the user specifies what join type (e.g., using abbreviation of the types like Outer, Inner, and Self) they want to employ before or after specifying the datasets/join key fields as exampled in ‘JOIN (Inner,s_id,s_id_num)’ in the formula 13913 in FIG. 139A and formula 14813 in FIG. 148A. In this example the structured arguments start with the join type (‘Inner’) then the join key (‘s_id’) in the first data set and then the join key (‘s_id_num’) in the second data set all separated by a commas (‘,’). This is a streamlined argument structure which works when the field/column names are unique and therefore identify their dataset. Had that not been the situation then additional arguments would be needed to identify the data sets. However, in either situation the arguments can be structured so that they can be displayed in a typical spreadsheet function syntax guide like exampled in 12563 in FIG. 125C (noting that FIG. 125C would then have a join type in the syntax). In this implementation the arguments are structured, not an unstructured query.

### In Cell Formula Two Data Set Join—Flexible Formula Element

Another implementation makes the join function flexible to accommodate more than one join while still working for a single join as exampled in the formula 13983 in FIG. 139C only containing the first join 13983. This implementation employs a function with structured groups of arguments, e.g., 13983, that have structured arguments within the argument group and then have as many argument groups as the user likes as exampled in FIG. 140B and FIG. 140C for two joins.

### In Cell Formula Two Data Set Join—Function Argument Element

In another implementation the join element is a newly defined argument added to existing predefined (prebuilt) spreadsheet functions as exampled in 12674 in FIG. 126C and 12686 in FIG. 126D. These examples are in a ‘WRITE_CALC_V’ function but could as easily been in any other function supporting data inputs (e.g., SQRT, COS, SUM, IF, and COUNT).

### In Cell Formula Two Data Set Join—Formulaic Data Argument Element

In another implementation the join element is a newly defined argument added to formulaic data fields/columns as exampled in 12492 the spreadsheet cell formula 12493 for the cell ‘A1’ 12491 in FIG. 124E. These new arguments could come in many different forms and configurations used to differentiate them from the existing arguments.

### In Cell Formula Two Data Set Join—Selection List Support

Our technology has implementations with selection list support extending well beyond the typical function selector found in existing spreadsheets. An implementation of our technology has data set and data field/column selection support for setting the join key fields/columns as exampled in FIG. 129C through FIG. 130D and FIG. 137C through FIG. 138D. Further implementations go beyond presenting the join key options to supplying validation analytical results (e.g., data type matches, data value matches, and data modelling cardinality) about those options as exampled in FIG. 130D, FIG. 132A, FIG. 124C and FIG. 124D. An additional implementation goes farther and screens the options based on join qualification (like those in FIG. 4) as exampled in FIG. 132B, FIG. 124A and FIG. 124B.

### In Cell Formula Two Data Set Join—Selection List Automated Qualification

Our technology supports the automatic application of many different types of qualification validation tests and combinations of those tests as exampled in FIG. 4. One implementation rejects a join where the join key fields in the two different data sets are not the same data type (e.g., numeric or finer cut to integer and floating point, text, and date) as exampled in step ‘2’ in FIG. 4, 12462 in FIG. 124C and FIG. 132B versus 13244 in FIG. 132A. Alternatively saying the implementation only accepts a join that has data keys of the same data type. Another implementation rejects a join if join key pair field values have no overlaps, i.e., none of the same values shared in the two fields which therefore would append no data in the join or yield no rows of data in an inner join). Alternatively saying the implementation only accepts a join if there is at least one value match between the values of the two join keys. As exampled in step ‘3’ in FIG. 4 or FIG. 124B and FIG. 132B (versus FIG. 132A 13234). That same implementation can reject the join if a minimum percentage of shared values is not found in one or both of the two join keys as exampled in step ‘3a’ in FIG. 4, 15167 in FIG. 151, or 13265 in FIG. 132B (versus 13234 in FIG. 132A). Alternatively saying the implementation only accepts a join if there is at least a specified percentage match (e.g., weighted by rows or weighted by distinct values) of the values between the values of the two join keys.

Another set of implementations rejects or does not reject joins based on the data modelling cardinality of the two join keys as exampled in step ‘4’ in FIG. 4. Step ‘4’ accepts unique to unique and unique to non-unique joins and rejects non-unique to non-unique (many to many) joins as exampled in the data intake UI in FIG. 55 resulting from the action in FIG. 54. FIG. 151 15177 examples the rejection of the many to many joins and through the passing of the others the acceptance of the unique to unique and unique to non-unique joins. FIG. 57 step ‘3’ 5745 examples the removal of the many to many join key pairs 5735 during an automated qualification validation and FIG. 113A and FIG. 113B examples the resulting formula error generation when a user types a formula failing this data modelling cardinality qualification validation flag rule. Alternatively, FIG. 114 accepts all data modelling cardinality types therefore including the non-unique to non-unique (many to many) joins and executes the formula as contrasted with FIG. 113B where exactly same formula generates an error. There are many additional variants of the data modelling cardinality implementations including a more rigorous rule rejecting joins that are not one to one (i.e., one join key value/record in a data set is associated with one and only one join key value/record in another data set).

### In Cell Formula Two Data Set Join—Selection List Automated Qualification

In another implementation once the join element is added to the cell formula by the user via specifying a formula argument or a join prebuilt function, this automatically qualifies the joined data sets for the joinable field selection lists as exampled in FIG. 131A and FIG. 131B or FIG. 141. Implementations of those selection lists display the joinable field in a single selection list, as exampled in FIG. 141, or a selection list that makes them all accessible, as exampled in FIG. 131A, that then provides an additional selection list, as exampled in FIG. 131B, or sequence of selection lists, e.g., a joinable data set selector list followed by a joinable field/column selector list for the selected data set, to see the joinable fields/columns.

### In Cell Formula Two Data Set Join—Join Type

Implementations of our technology support the qualified joinable data sets being joinable by any of the SQL join types. For example, a left outer join often used to append data, an inner join to limit outcomes to overlapping values, or a full outer join to ensure no data loss. All types of SQL joins are supported by our implementations but can also be more limited in their selection list as exampled in FIG. 73B, FIG. 119B, FIG. 125B, and FIG. 129B.

### In Cell Formula Two Data Set Join—Joinable Field Formula Usage

Implementations of our technology support usage in the broad spectrum of spreadsheet cell formula including any formulaic data field formula as exampled in FIG. 129A through FIG. 132B. Implementations support usage in a broad range of prebuilt spreadsheet functions (e.g., SQRT, COS, SUM, COUNT, WRITE_CALC_2D) as exampled in FIG. 125A through FIG. 127B and many other examples herein. Implementations support use in prebuilt spreadsheet functions (e.g., FILTER, WRITE_V and WRITE_CALC_2D) that populate values into more than one spreadsheet cell as exampled in FIG. 125A through FIG. 127B. Our implementations also support usage of joined data fields in formulas containing many different combinations of functions within functions, combinations of functions and algebraic operators, many formulaic data fields and/or combinations of those combinations as exampled in FIG. 136A, FIG. 136B, and FIG. 152A through FIG. 155B (recognizing that example is for a multiple join but a formula of that complexity and more could easily be for a single join).

### In Cell Formula Two Data Set Join—Data Set Source

Implementations of our technology support data sets external to the spreadsheet (e.g., FIG. 10A, and FIG. 10B), data tables or data ranges within the cells of the spreadsheet (e.g., FIG. 11A, and FIG. 11B), and a combination of the two (e.g., FIG. 9B 965/993, and FIG. 40B 4065/4093).

### In Cell Formula Two Data Set Join—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

### Chained Qualified Selection List Joins

As previously discussed, our data set joining technology supports joining more than two data sets. When there is no overlap between the joined data sets then that is just multiple instances of the two data set join implementations just discussed. However, when the pairs of data sets include a common data set then those joined data set can chain together in our technology to join all three of the data sets (e.g., two pairs of two data sets with one shared). In our technology that chaining is not limited to three data sets but can continue on until there are no additional chain possibilities, subject to data modelling cardinality limitations (if specified) which may invalidate some of the chain joins. There is one specialized additional situation worth discussion which is multiple joins between two data sets which chain together to effectively create more than two data sets. For example, two data sets employing two pairs of join keys between the two data sets sharing one common join key effectively creates two joins and the equivalent of three data sets as we will example later. Our technology also supports chaining of the multiple joins between two data sets and joins to other data sets. All these situations are supported for any of the applicable SQL join types (e.g., full outer, inner, and left outer).

### Chained Qualified Selection List Joins—One or More Chained Join

There are many different variants of the chained/sequenced join technology so we will first describe the core implementation for one or more chained/sequenced joins and then more specific variations. The implementation starts by individually qualifying the joinability of the multiple data sets based on the fields/columns in each data set pair specified join keys. That qualification flag setting can be done in many different ways, as exampled in FIG. 8, with the validation of the join qualification being tested (validated) in different ways, as exampled in FIG. 4, and taking place in many different locations, as exampled in FIG. 128. FIG. 151 examples one UI used in the qualification flag setting via a data intake tool (e.g., external or within the spreadsheet) exampling the setting of the join qualification flag for join keys 15141 and 15166. It also examples many of the qualification validation test results (15187, 15177, 15167, 15153, 15154, and 15155) as docs FIG. 57.

Then our technology determines the joinable data set pairs that can also be sequence/chain joined. In most, but not all, situations if the qualified joinable data sets pairs contain a common data set they can be chained. The exception would be if there is a data modelling cardinality constraint that the chained join fails but both of the pairs pass, as we example in FIG. 109A through 113B. In those situations, the joined combination of the data sets is not sequence/chained joinable and only the pairs of data sets will be joinable. Our technology does not require the pairs of data set joins to share any common join keys to sequence/chain joins as exampled in FIG. 87A through FIG. 95B and FIG. 96A through FIG. 108.

With the individual joins and sequenced/chained joins setting a qualification flag, once the user populates one of the fields from those joinable data sets our technology displays a way for the user to access and select the fields in the other joinable data sets in a selection list as exampled in FIG. 98A/B, FIG. 105A/B, FIG. 78A, and FIG. 81A for a user entering their first field and as exampled in FIG. 89A/90A, FIG. 93A, FIG. 102B, FIG. 106B/107A, and FIG. 121A/B for a user entering or altering a field later in the formula. Once the user has selected at least one field from the two joinable data sets requiring a sequenced/chained join and executed the spreadsheet cell formula our technology sequence/chain joins the data, as exampled in FIG. 94, FIG. 100, and FIG. 77, and uses it to determine the outcome of the spreadsheet cell formula as exampled in FIG. 93B, FIG. 93C, FIG. 99C, FIG. 103C, FIG. 107B, FIG. 121C, FIG. 135B, and FIG. 79B via the supporting illustrative in-cell formula calculations, as exampled in FIG. 95A/B, FIG. 101, FIG. 104A/B, FIG. 108, and FIG. 80A/B.

### Chained Qualified Selection List Joins—One Chained Join

We will now describe an implementation for a one chained/sequenced join, using the example in FIG. 96A through FIG. 108, so that we can get very specific on the fields and the joins. We are going to call ‘table_aa’ 9632 in FIG. 96B data set one as it has qualification flag joins to both of the other tables, ‘table_bb’ 9635 (data set two) and ‘table_cc’ 9638 (data set three), as exampled in FIG. 96B, and FIG. 97A/B.

The qualification flag setting for the individual joins can be done in many different ways, as exampled in FIG. 8, with the validation of the join qualification being tested (validated) in different ways, as exampled in FIG. 4, and taking place in many different locations, as exampled in FIG. 128. FIG. 151 examples one UI used in the qualification flag setting via a data intake tool (e.g., external or within the spreadsheet) exampling the setting of the join qualification flag for join keys 15141 and 15166. It also examples many of the qualification validation test results (15187, 15177, 15167, 15153, 15154, and 15155) as does FIG. 57.

The qualification join flag setting for the chained join could be set manually by a user but most frequently is automatically executed once the individual joins are determined applying an accepted data modelling cardinality or set of cardinalities. As previously exampled the acceptable data modelling cardinality can vary by the location of where it was set. It can be the same as for the individual join validation flag or could be specified separately. FIG. 96A through FIG. 108 examples a situation where the chained/sequenced cardinality rule is the same as for the individual joins and automatically accepts the chained join between data sets two and three. FIG. 109A through FIG. 113B examples a situation where the chained/sequenced cardinality rule is the same as for the individual joins but automatically rejects the chained join between its data sets two and three.

When the user inputs a field (‘name’ in the formula 9812 in FIG. 98A) from table two the user automatically sees a selection list displaying access to the fields in data set two, data set one and data set three in the selections within 9835 in FIG. 98A. There are many different ways those fields are displayed such as in a two-selection list sequence via a selection, in this example ‘ADD’ 9825 which then automatically opens the selection list for data sets one (‘table_aa’ 9865) and three (‘table_cc’ 9885). As described herein those selection lists could be a one-step or more than two-step and can be presented in different UIs. In some situations, like this example the selection list displays all the data set one, two and three fields but in other situations those may be partial lists when for example functions (e.g., SUM) limit the fields to a certain data type. When the user then completes the formula and hits ENTER/RETURN our technology automatically executes the chained join for all the fields in the formula, e.g., FIG. 100, then using the joined fields to execute the formula e.g., FIG. 101.

### Chained Qualified Selection List Joins—Qualification Before Cell Formula

Our technology supports many different ways to qualify the join flag. In one implementation the join qualifying is done in a data intake tool where the data is prepared most typically by a single user for use by all the spreadsheet users employing that combination of data sets. That way the typical spreadsheet user (not the user qualifying the joins) does not have to deal with the mechanics of determining the join keys and/or the join type when they are creating a spreadsheet cell formula. So that the qualified joinable fields are simply available to them in selection lists for use in cell formulas. In this implementation the data set join keys are determined, and qualification flag validated before the cell formula as exampled in the UIs in FIG. 12, FIG. 13, and FIG. 151. It is also exampled FIG. 128 for the boxes corresponding to ‘INTAKE-External to spreadsheet’ qualification 12835, recognizing that for reasons of conciseness FIG. 128 does not example all the possible combinations supported by our technology including those with combined external and in-cell data sets.

However, our technology supports many other qualification locations before in-cell as exampled by ‘INTAKE—in spreadsheet’ 12845 in FIG. 128 where the spreadsheet user qualifies, with or with automated qualification validation, join keys as exampled in paths ‘B’ and ‘I’ in FIG. 128. That can employ a UI similar to those in FIG. 12, FIG. 13, and FIG. 151 or others discussed or exampled herein. Our technology also supports ‘Spreadsheet capability’ 12855 and ‘Worksheet capability’ 12865 level join keys qualification where the difference is the extensiveness of the qualification. The whole spreadsheet for the ‘Spreadsheet capability’ 12855 and just the worksheet for the ‘Worksheet capability’ 12865. With setting done in a UI like that exampled in FIG. 133C and FIG. 133D or others discussed or exampled herein.

Our technology also supports qualification first set in one location and then reset to something else in another location as exampled in the extreme situations in paths ‘G’ and ‘N’ FIG. 128. All the mix and match combinations were not illustrated for brevity's sake. The ‘In cell-all content’ 12875 is also applicable provided the cell the join was created in was done prior to the cell now using the join.

Our technology supports chained/sequenced joins automatically following the data modelling cardinality used for the individual joins as well as letting the user specify something different through a rule set or individual chained/sequenced join validation flag setting.

### Chained Qualified Selection List Joins—Qualified Join Fields Before Cell Formula Invisible Join Argument

A further implementation employing the before cell formula qualified joinable data sets requires no visible join argument in the cell formulas as exampled in FIG. 93C, FIG. 99C, FIG. 103C, and FIG. 107B. Therefore, the typical user does not need to deal with the complexity of seeing the join keys and join type but simply sees the fields/columns they desire in the formula. In all these examples the fields/columns have unique names not requiring the inclusion of a data set in the field/column identifier (naming), but our technology supports a data identifiers composed of data set names and field/column names.

### Chained Qualified Selection List Joins—Qualified Join Fields Before Cell Formula Visible Join Argument or Function

Another implementation variant employing the qualified joinable data sets populates a visible join argument or function with its own arguments in the cell formulas as exampled in FIG. 93B, FIG. 135B, and FIG. 114. That argument or function with its own arguments may tell the user the join type (e.g., JOIN, JOIN_INNER, JOIN_LEFT), the join key fields/columns, both of those or simply tell the user that a join took place and/or the situation it was used in (e.g., substitution). In FIG. 135B the auto populated functions (13568 and 13573) tell the user the type of join they employ (e.g., inner join) and the join key pair fields as the two arguments within the parentheses. The two joins (13568 and 13573) in combination then sequence/chain for multiple data set joins.

### Chained Qualified Selection List Joins—Qualified Joins Changed in Formula

Implementations of our technology also support the overriding of a qualified join or multiple joins in a cell formula by inclusion of a join argument and/or a join prebuilt function changing the join type as exampled in FIG. 117A through FIG. 121C, specifically shown in FIG. 119B. And in a variant of the embodiment exampled in the access line for the join in FIG. 67A 6735 and then in use in FIG. 68C 6894 and FIG. 73B 7363, switching from the default specified previous qualified join type to a user selected join type (e.g., left outer, right outer, and inner). In those examples the join type is defined by the name of the join function (e.g., JOIN is full outer, JOIN_INNER is an inner join, and JOIN_SELF is a self-join) as shown in FIG. 119B 11967, FIG. 68C 6894 and FIG. 73B 7363. In situations of more than one join chained/sequenced together our technology supports changing one or more of the joins join types which are then altered in the chained/sequenced joins. Alternatively, our technology supports the join type as an argument added to the regular formula or regular functions.

Implementations of our technology also support the overriding of a previously qualified join in a cell formula by inclusion of a join argument and/or a join prebuilt function with its own arguments changing the first data set join key field/column and/or changing the second data set join key field/column as exampled in FIG. 117A through FIG. 121C, specifically shown in FIG. 119B through FIG. 120D. And in a variant of the embodiment exampled in FIG. 67A 6735/FIG. 69A 6934 and FIG. 73C 7375, switching from the default specified previously qualified default join keys to the previously qualified but not default specified join keys. In situations of more than one join chained/sequenced together our technology supports changing one or more of the joins join key field/column pairs which are then altered in the chained/sequenced joins.

### Chained Qualified Selection List Joins—Same Data Sets Multiple Joins

In an implementation of our technology two or more joins are supported between the same two data sets provided those joins share the same first join key field in the first data set but have different join key fields in the second data set as exampled in FIG. 77 through FIG. 83B. Both of those joins can be qualified in our technology and be accessible in the same selection lists although with an additional change to differentiate their field/column names, so the two different joins are distinguishable. Our technology automatically implements the field/column joinable data name changes to the fields/columns in the first data sets so that they are differentiated when used in the joins. Those names could be anything that differentiates the fields/columns from their original fields/columns and that then differentiates the multiple join variants from each other. In one implementation our technology appends the respective two different second data set join key field/column names to each of the two sets of first data set field/column names. In another implementation it appends those two different second data set join key field/column names to each of the first data set field names prefaced (prefixed) with an ‘->’ (e.g., ‘field/column name dataset one->second data set join key field/column name’ as in the example ‘state->sponsor_num_state’ where ‘state’ is a field/column in data set one and ‘sponsor_num_state’ is one of the two data set two join keys) so that it displays as exampled in FIG. 78A 7854, FIG. 78B 7865/7866, FIG. 82B 8265, and FIG. 82C 8273. Note, as we mentioned previously the use of the data set join keys as the differentiator of the two versions of data set one could be replaced by two user specified unique character sets that would then be automatically added to each of the fields/columns in the two different versions of data set one.

### Chained Qualified Selection List Joins—In Formula Join Qualification and Selection

In another implementation the join can be added to the cell formula by the user via specifying a formula argument or a prebuilt function that specifies the join to be done in the formula, provides the joined data to be used in the formula calculation, and qualifies the joined data sets for the field selection lists as exampled in FIG. 129A through FIG. 132B and FIG. 70 and FIG. 71. More than one join may be added to the formula to create a sequence/chain of joins across three or more data sets. The addition of the completed join argument or function, e.g., ‘JOIN_INNER {s_id,s_id_num)’ in the formula 13113 in FIG. 131A, automatically qualifies the joined fields for the selection lists as exampled by the ‘ADD’ line 13124 for ‘table_aa’ 13127 in FIG. 131A now being visible when it was not previously visible in the selection list 12945 in FIG. 129A (before the addition of the join function to the formula). This visibility in selection lists not only extends for addition of additional join functions or formula arguments with other data set joins but extends to any sequencing/chaining of those joins. FIG. 70 examples the ‘JOIN_INNER {s_id,s_id_num)’ in the formula 13184 in executing the data set join and FIG. 71 examples the joined data used to deliver the value in cell ‘A1’ 13192. The formula argument version of the implementation could use an argument like 12492 in FIG. 124E. but otherwise operate the same way qualifying the joinable data for selections lists, executing the join, and providing the joined fields for use in the formula. FIG. 126C 12664 and FIG. 126D 12686 example different formula arguments within a function but as mentioned here operate the same way qualifying the joinable data for selections lists, executing the join, and providing the joined fields for use in the formula. The chaining/sequencing of joins works in the formula as previously exampled in FIG. 94 and supports the calculations of the cell formula as exampled in FIG. 95A, and FIG. 95B.

### Chained Qualified Selection List Joins—In Formula Join Selection List Support

In another implementation the user creation of a join formula argument or join function has extensive selection list support to help them users create the join as exampled by the selection lists in FIG. 129A through FIG. 130D and FIG. 132A and FIG. 132B. These selection lists go beyond the typical spreadsheet function selection list to give the user situationally specific listings of available data sets (e.g., 12985 in FIG. 129C and 13055 in FIG. 130B) and more situationally specific help such as the qualification validation information in FIG. 132A or a step further in FIG. 132B where our automated qualification validation has removed join keys (13234 and 13244 in FIG. 132A) to only leave the keys that have passed the qualification validation steps. Exampling one path in FIG. 4 passing only join key pairs that do not have data mismatches and join key pairs with ‘0%’ matching values. These selection lists could go as far as displaying automatically selected join key pair fields asking the user to select between ties.

### Chained Qualified Selection List Joins—Qualification Ways

As previously described our technology supports many different ways to validate the qualification of a data set to data set join as exampled in FIG. 8. In one implementation the qualification validation is done by a human as laid out in FIG. 8 pathway ‘a/b/h’ and exampled in a UI in FIG. 12. In another implementation the human starts the process by specifying a join after which that join is goes through a further qualification step employing one or more validation test as exampled in FIG. 4. That join qualification pathway, exampled in FIG. 8 pathway ‘a/c/d/h’, can employ any one of the automated validation tests in FIG. 4 during step ‘d’. FIG. 54 and FIG. 55 example what a UI might look like if that join is rejected.

In another implementation the joins are automatically identified and qualified without human actions other than specifying the data sets. FIG. 8 pathway ‘a/g/h’ lays this out and it can be set up in our technology, so its automated validation testing uses any of the paths in FIG. 1 other than path A. A related implementation starts with the automated identification of the join key pairs but adds human qualification step allowing ideally a data savvy user to eliminate any auto validated join key pairs that while technically correct do not make sense as laid out in FIG. 8 pathway ‘a/e/f/h’. Such a pathway could be executed in a UI like 5645 in FIG. 56 where the user could then click ‘ADD’ 5648 to add the join to the ‘Existing joins’ 5668. FIG. 56 also examples how our technology can support more than one implementation together such as the ability to have FIG. 8 pathway ‘a/b/h’ coexist with pathway ‘a/e/f/h’ to make it easy for the user to add back pathways they may have previously rejected. Doing multiple joins and multiple joins that sequence/chain does not change the qualification ways.

### Chained Qualified Selection List Joins—Qualification Location

As previously described our technology supports many different locations to validate the qualification of a data set to data set join as exampled in FIG. 128. Rather than describing again the different location implementations we will point out that the initial qualification can take place all in the same location for multiple joins (including those that sequence/chain). And lie previously discussed, any of locations other than the first data intake location can requalify (change) a previously qualified data set to data set join qualification.

### Chained Qualified Selection List Joins—Alternative Joins

Our technology supports the creation and usage of alternative qualified data set joins employing all different join keys. Those joins have different two sets of join key pairs which contain no duplicate dataset/field combination. In one implementation when the two alternative joins have been qualified one of the joins (join key pairs) is selected as the default join (the join used unless a user manually switches to the other) with the second an alternative which has selection list support for selection as exampled in FIG. 62C, FIG. 64A, and FIG. 69A. This occurs when in the qualification process the user sets up two potential joins between the same two data sets where all the join key fields are different, setting up two different ways to join the same two data sets. The default join can be automatically selected by our implementation employing matching rules and a potential tiebreaker or it can be left for the user to decide as is exampled in radio buttons 13467 setting the default in FIG. 134. In situation where the user makes a change in the default our technology will automatically make any sequenced/chained join changes reflecting the change.

### Chained Qualified Selection List Joins—Join Qualification Validation Tests

Our technology supports the automatic application of many different types of qualification validation tests and combinations of those tests as exampled in FIG. 4. Many of those validation tests are resolved when the before the sequencing/chaining of joins but there are some implementations where the chaining/sequencing results in the failure of a join between two datasets that previously passed. We will therefore more briefly walk through the qualification tests that are completed before the sequencing/chaining.

One implementation rejects a join where the join key fields in the two different data sets are not the same data type (e.g., numeric or finer cut to integer and floating point, text, and date) as exampled in step ‘2’ in FIG. 4, 12462 in FIG. 124C and FIG. 132B versus 13244 in FIG. 132A. Another implementation rejects a join if join key pair field values have no overlaps, i.e., none of the same values shared in the two fields which therefore would append no data in the join or yield no rows of data in an inner join). As exampled in step ‘3’ in FIG. 4 or FIG. 124B and FIG. 132B (versus FIG. 132A 13234). That same implementation can reject the join if a minimum percentage of shared values is not found in one or both of the two join keys as exampled in step ‘3a’ in FIG. 4, 15167 in FIG. 151, or 13265 in FIG. 132B (versus 13234 in FIG. 132A).

Another set of implementations rejects or does not reject joins based on the data modelling cardinality of the two join keys as exampled in step ‘4’ in FIG. 4. Step ‘4’ rejects based non-unique to non-unique (many to many) joins as exampled in the data intake UI in FIG. 55 resulting from the action in FIG. 54. FIG. 57 step ‘3’ 5745 examples the removal of the many to many join key pairs 5735 during an automated qualification validation and FIG. 113A and FIG. 113B examples the resulting formula error generation when a user types a formula failing this data modelling cardinality qualification validation rule. Alternatively, FIG. 114 accepts non-unique to non-unique (many to many) joins and executes the formula as contrasted with FIG. 113B where exact same formula generates an error.

There are many additional variants of the data modelling cardinality implementations including a more rigorous rule rejecting joins that are not one to one (i.e., one join key value/record in a data set is associated one and only one join key value/record in another data set). An additional implementation varies the modelling cardinality rule, applying one data modelling cardinality rule (e.g., reject many to many) at one qualification location and a different one (e.g., accept everything) at a different location. FIG. 117A through FIG. 121C and FIG. 116A and FIG. 116B examples that where the data modelling cardinality rule is to reject many to many joins in pre-in-cell formula qualifications with a different data modelling cardinality rule of accept all cardinalities applied to in-cell qualified joins.

When joins are sequenced/chained our implementations can determine whether a data set to data set join with a previously acceptable data modelling cardinality changes to a rejected one as exampled in FIG. 110A through FIG. 113B. This can occur with a non-unique to non-unique (many to many) failure rule where the two joins prior to being chained/sequenced passed, but when sequenced become non-unique to non-unique (many to many) failing. Thus, our technology with that rule blocks the selection list displaying the added data set and generates an error if a user types the formula attempting to sequence/chain the join.

### Chained Qualified Selection List Joins—Joinable Fields Selection List Types

Our technology supports many different visual representations of the joinable fields. One implementation once a joinable field is inputted into the formula displays all the joinable fields when appropriate in a single selection list as exampled in FIG. 78A and the previous examples for single joins. However, in some instances where there are large numbers of fields in each data set and/or many data sets joined, presenting all the joinable fields in a single selection list can be overpowering and instead the joinable data is accessible in the first selection list and fully displayed in subsequent selection lists. FIG. 89B/90A, FIG. 98A/B, FIG. 102A/B, FIG. 105A/B, FIG. 106B/107A, and FIG. 121A/B example a first selection list where the joinable fields are accessible via a selection that takes the use to a second selection list displaying the joinable fields. In situations with more than two joinable data sets the accessing mode may differ in there is a data sets selection list before getting to the joinable fields' selection list. As also exampled the accessing display may have more than one type of option (e.g., ‘ADD’ and ‘SUB) as exampled in FIG. 89B.

### Chained Qualified Selection List Joins—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. The application default join type can then be overridden by a user selection. All types of SQL joins are supported by our implementations but can also be more limited in their selection list as exampled in FIG. 73B, FIG. 119B, FIG. 125B, and FIG. 129B.

### Chained Qualified Selection List Joins—Joinable Field Replacement

Implementations of our technology not only support adding joinable fields to spreadsheet cell formula but also replacing (substituting) a field from one joinable data set by a field from the other joinable data set as exampled in FIG. 33B through FIG. 34C, FIG. 38A through FIG. 38C, and FIG. 51A through FIG. 51C.

### Chained Qualified Selection List Joins—Joinable Field Formula Usage

Implementations of our technology support usage in the broad spectrum of spreadsheet cell formula including any formula evaluating a formulaic data field as exampled in FIG. 97A through FIG. 104B. Implementations support joined data usage in a broad range of prebuilt spreadsheet functions (e.g., SQRT, COS, SUM, COUNT, WRITE_CALC_2D) as exampled in FIG. 89A through FIG. 95B, FIG. 105A through FIG. 198, and FIG. 117A through FIG. 121C. Prebuilt (predefined) functions in the spreadsheet application that have a structured argument structure or have a structured set of arguments groups containing argument. Implementations of our joining technology work in functions that evaluate a single input and functions that handle range or array inputs. Implementations support use in prebuilt spreadsheet functions (e.g., FILTER, WRITE_V and WRITE_CALC_2D) that populate values into more than one spreadsheet cell as exampled in FIG. 89A through FIG. 85B, and FIG. 105A through FIG. 108. Our implementations also support usage of joined data fields in formulas containing many different combinations of functions within functions, combinations of functions and algebraic operators, many formulaic data fields and/or combinations of those combinations.

### Chained Qualified Selection List Joins—Data Set Source

Implementations of our technology support data sets external (e.g., data sets) to the spreadsheet (e.g., FIG. 10A, and FIG. 10B), data tables or data ranges within the cells of the spreadsheet (e.g., FIG. 11A, and FIG. 11B), and a combination of the two (e.g., FIG. 9B 965/993, and FIG. 40B 4065/4093).

### Chained Qualified Selection List Joins—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

Our technology supports other implementations of the chained/sequenced joins as we will not layout.

### In Cell Formula Chained Join

Implementations of our data sets joining technology support joining more than two data sets, multiple joins between two data sets and combinations therein without any joins qualified before the start of the cell formula. These implementations starting a formula, such as done in FIG. 150A or FIG. 142A and then within that formula the user specifying the data set to data set joins as exampled by the two formula elements exampled in the formula 15075 in FIG. 150F:
‘JOIN (Outer,donor_num, number)’
‘JOIN (Outer,donor_num,don_num)’
   or as exampled by the two formula elements exampled in the formula 14713 in FIG. 147A:
‘JOIN (donor_num, number)’
‘JOIN (donor_num,don_num)’
   Those data set joins are then qualified for joining in some manner ranging from the user doing so by creating the join element or elements of the cell formula (e.g., FIG. 150F) to further qualification ways, as exampled in FIG. 8, with the validation of the join qualification being tested in different ways, as exampled in FIG. 4. In most, but not all, situations the join qualification of the pairs of data sets qualifies the join for chaining. Our technology does not require the pairs of data set joins to share common join keys to sequence/chain joins as exampled in FIG. 96A through FIG. 108. However, if there is a data modelling cardinality rule qualification, there are situations where the two pairs of joins each pass the qualification validation test but the chained combination of the two does not. In those situations, the joined combination of the data sets is not sequence/chained joinable and only the pairs of data sets will be joinable as exampled in FIG. 109A through FIG. 113B. In any of those situations our technology automatically determines the joinability of the chained/sequenced joins. However, as exampled in FIG. 114 with a different cardinality rule the formula in FIG. 113B automatically works. As do the chained/sequenced joins in FIG. 93B, FIG. 93C, FIG. 99C, and FIG. 103C

With the individual joins and sequenced/chained joins qualified, once the user populates the spreadsheet cell formula with at least two fields requiring the chaining of the joins our technology is ready to execute the chained/sequenced join for all the specified fields and supply it to the formula for execution of any additional manipulations or calculations done by the formula as exampled in the join in FIG. 115 and the use of the formula specified join data fields in FIG. 116A and FIG. 116B to deliver the result in cell ‘A1’ 15092 in FIG. 150G or cell ‘A1’ 14792 in FIG. 147C. This implementation of our technology covers a spectrum of selection list support as exampled by the more minimal selection list support in FIG. 150A through FIG. 150G versus the more extensive selection list support for the same formula exampled in FIG. 142A through FIG. 147C. The implementation supports a broad spectrum of spreadsheet formulas as has been described herein.

### In Cell Formula Chained Join—Specified Function Formula Elements

Our technology supports many different formula element implementations specifying the join within the cell formula. In one such implementation the join is specified by a join specific (e.g., JOIN_INNER, JOIN_LEFT and JOIN_RIGHT) spreadsheet predefined function. Those functions, like typical spreadsheet functions, have structured arguments to specify the first data set and it's join key field/column and the second data set and it's join key field/column as exampled in ‘JOIN (donor_num,number)’ and ‘JOIN (donor_num,don_num)’ in the formula 14713 in FIG. 147A (where JOIN is a full outer join as shown in FIG. 145B 14566). In this example the structured arguments are the join key (e.g., ‘donor_num’) in the first data set and then the join key (e.g., ‘number’) in the second data set separated by a comma (‘,’). This is a streamlined argument structure which works when the field/column names are unique and therefore identify their dataset. Had that not been the situation then additional arguments would be needed to identify the data sets such as:
‘JOIN (donor_num,number)’
   becoming
‘JOIN (table_a,donor_num,table_b,number)’.
   Another variant is where the chained/sequenced joins are using the same join type, and the structured arguments employ argument groups for each of the joins as exampled here:
‘JOIN (donor_num,number|donor_num,don_num)’
   or
JOIN (table_a,donor_num, table_b,number|table_a,donor_num, table_f,don_num)’

In this implementation while there are many variants of arguments with or without argument groups, they are structured arguments (not an unstructured query) with the ability to support a syntax guide as exampled in FIG. 123C 12353.

### In Cell Formula Chained Join—Single Join Function Formula Element

Another implementation generalizes the join function to a single join function that contains an argument where the user specifies what join type (e.g., using abbreviation of the types like Outer, Inner, and Self) they want to employ before or after specifying the datasets/join key fields as exampled in the formula 14925 in FIG. 149:
‘JOIN (Outer,donor_num,number)’ and ‘JOIN (Outer,donor_num, don_num)’.
   In this example the structured arguments start with the join type (‘Outer’) then the join key (e.g., ‘donor_num’) in the first data set and then the join key (e.g., ‘number’) in the second data set all separated by a commas (‘,’). This is a streamlined argument structure which works when the field/column names are unique and therefore identify their dataset. Had that not been the situation then additional arguments would be needed to identify the data sets as exampled previously. However, in either situation the arguments can be structured so that they can be displayed in a typical spreadsheet function syntax guide like exampled in 15032 in FIG. 150C. In this implementation the arguments with or without argument groups are structured, not an unstructured query.

### In Cell Formula Chained Join—Flexible Formula Element

Another implementation makes the join function flexible to accommodate more than one join while still working for a single join as exampled in the formula 14015 in FIG. 140A. This implementation variation employs a function with repetitive structured sets of arguments, e.g., join type, followed by one or more join key pairs all separated by commas. FIG. 140B examples an implementation with the join type followed by repetitive argument groups separated by bars ‘|’ for the join key pairs in the formula 14045. FIG. 140C examples an implementation with repetitive argument groups of the join type and the two keys separated by commas and then separated by bars ‘|’ from any number of additional joins in formula 14075. This implementation employs different repetitive structures, e.g., argument sets or argument groups to specify the join type and tables/field keys. While these examples used fields that identified the table, had the fields not been unique then the table names or their proxy could have been utilized as previously exampled.

### In Cell Formula Chained Join—Function Argument Element

In another implementation the join element is a newly defined argument added to existing predefined (prebuilt) spreadsheet functions as exampled in 12674 in FIG. 126C and 12686 in FIG. 126D. These examples are in a ‘WRITE_CALC_V’ function but could as easily been in any other function supporting data inputs (e.g., SQRT, COS, SUM, IF, and COUNT).

### In Cell Formula Chained Join—Formulaic Data Argument Element

In another implementation the join element is a newly defined argument added to formulaic data fields/columns as exampled in 12492 in FIG. 124E. These new arguments could come in many different forms and configurations used to identify them from the existing arguments.

### In Cell Formula Chained Join—Selection List Support

Our technology has selection list support extending well beyond the typical function selector found in existing spreadsheets. An implementation of our technology has data set and data field/column selection support for setting the join key fields/columns as exampled in FIG. 142A through FIG. 147C. Further implementations go beyond presenting the join key options to supplying validation analytical results (e.g., data type matches, data value matches, and data modelling cardinality) about those options and previously exampled in FIG. 130D, FIG. 132A, FIG. 124C and FIG. 124D. An additional implementation goes farther and screens the options based on join qualification (like those in FIG. 4) as exampled in FIG. 146D (versus FIG. 146C) and previously exampled in FIG. 132B, FIG. 124A and FIG. 124B.

### In Cell Formula Chained Join—Selection List Automated Qualification

Our technology supports the automatic application of many different types of qualification validation tests and combinations of those tests as exampled in FIG. 4. One implementation rejects a join where the join key fields in the two different data sets are not the same data type (e.g., numeric or finer cut to integer and floating point, text, and date) as exampled in step ‘2’ in FIG. 4, 15187 in FIG. 151, and FIG. 146D (versus FIG. 146C) and previously exampled 12462 in FIG. 124C and FIG. 132B versus 13244 in FIG. 132A. Another implementation rejects a join if join key pair field values have no overlaps, i.e., none of the same values shared in the two fields which therefore would append no data in the join or yield no rows of data in an inner join) as exampled in. As exampled in step ‘3’ in FIG. 4, 15167 in FIG. 151, or FIG. 124B and FIG. 132B (versus FIG. 132A 13234). That same implementation can reject the join if a minimum percentage of shared values is not found in one or both of the two join keys as exampled in step ‘3a’ in FIG. 4, 15167 in FIG. 151, or 13265 in FIG. 132B (versus 13234 in FIG. 132A).

Another set of implementations rejects or does not reject joins based on the data modelling cardinality of the two join keys as exampled in 15177 in FIG. 151 and step ‘4’ in FIG. 4. Step ‘4’ rejects based non-unique to non-unique (many to many) joins as exampled in the data intake UI in FIG. 55 resulting from the action in FIG. 54. FIG. 57 step ‘3’ 5745 examples the removal of the many to many join key pairs 5735 during an automated qualification validation and FIG. 113A and FIG. 113B examples the resulting formula error generation when a user types a formula failing this data modelling cardinality qualification validation rule. Alternatively, FIG. 114 accepts non-unique to non-unique (many to many) joins and executes the formula as contrasted with FIG. 113B where exactly same formula generates an error. There are many additional variants of the data modelling cardinality implementations including a more rigorous rule rejecting joins that are not one to one (i.e., one join key value/record in a data set is associated one and only one join key value/record in another data set).

### In Cell Formula Chained Join—Selection List Automated Qualification

In another implementation once the join element is added to the cell formula by the user via specifying a formula argument or a prebuilt function, this automatically qualifies the joined data sets for the joinable field selection lists as exampled in FIG. 147A and FIG. 147B or FIG. 148A 14843. Implementations of those selection lists display the joinable field in a single selection list, as previously exampled in FIG. 141, or a selection list that makes them all accessible, as exampled in FIG. 147A, that then provides an additional selection list, as exampled in FIG. 147B, or a further sequence of selection lists, e.g., a joinable table selector list followed by a joinable field/column selector list for the selected table, to see the joinable fields/columns.

### In Cell Formula Chained Join—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. The application default join type can then be overridden by a user selection. All types of SQL joins are supported by our implementations but can also be more limited in their selection list as exampled in FIG. 145B and previously ex FIG. 73B, FIG. 119B, FIG. 125B, and FIG. 129B.

### In Cell Formula Chained Join—Joinable Field Formula Usage

Implementations of our technology support usage in the broad spectrum of spreadsheet cell formula including any formulaic data field formula as exampled in FIG. 129A through FIG. 132B. Implementations support usage in a broad range of prebuilt spreadsheet function (e.g., SQRT, COS, SUM, COUNT, WRITE_CALC_2D) as exampled in FIG. 125A through FIG. 127B and many examples herein. Implementations support use in prebuilt spreadsheet functions (e.g., FILTER, WRITE_V and WRITE_CALC_2D) that populate values into more than one spreadsheet cell as exampled in FIG. 125A through FIG. 127B. Our implementations also support usage of joined data fields in formulas containing many different combinations of functions within functions, combinations of functions and algebraic operators, many formulaic data fields and/or combinations of those combinations.

### In Cell Formula Chained Join—Data Set Source

Implementations of our technology support data sets external (e.g., data sets) to the spreadsheet (e.g., FIG. 10A, and FIG. 10B), data tables or data ranges within the cells of the spreadsheet (e.g., FIG. 11A, and FIG. 11B), and a combination of the two (e.g., FIG. 9B 965/993, and FIG. 40B 4065/4093).

### In Cell Formula Chained Join—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

### Double Joins

Implementations of our technology make the execution of spreadsheet cell formulas using fields employing one or both of the double joins very easy for the user. Joins between two data sets where the two join keys for one of the data sets is the same field while the corresponding join keys in the other data set differ. Thus, creating two possible joins between the two data sets where one or more of each of the double joined data sets can be used in generating a spreadsheet cell formula outcome as exampled in FIG. 75A through FIG. 80B.

Implementations of our technology further makes double join usage easy by automatically changing the double joined data set field names for the data set which has the same join keys. Those name changes then identify which of the two different joins in the other data set has been used as exampled in FIG. 78A and FIG. 78B. One implementation uses the two different join key field names as the automatically altered names as exampled by ‘donor_num_state’ and ‘sponsor_num_state’ automatically appended to the data set field names (in the double joined data set with the same field as the two join keys) in FIG. 78A and FIG. 78B. Implementations also include character(s) automatically appended to differentiate the appended characters from the original data set field names such as the dash and right pointing greater than characters ‘->’ exampled in FIG. 78A and FIG. 78B before the other table join key field names. For example, ‘field/column name dataset two->join key field/column name data set one’ as in the example ‘state->sponsor_num_state’ FIG. 78A 7854 where ‘state’ is a field/column in data set two and ‘sponsor_num_state’ is one of the two different data set one join keys. Additional implementations replace the automatically generated additions to differentiate the double joined data set field names with a user specified set of characters for each of the double joins.

### Double Joins—Involving Double Join Conversion

Situations occur in the spreadsheet cell formula inputs where users have already populated a spreadsheet cell formula input with a double joinable field and then make an additional input that requires that already populated field to need to be converted to one of the two double joins. In some of those situations the spreadsheet cell formula input limitations make it knowable by our technology as to which of the double joins that field should be converted to. In that situation an implementation of our technology automatically converts the field to the joined field as exampled in FIG. 78A and FIG. 78B. In other situations where it is impossible to know which of the two joins the field should be converted to, our applicable automatically presents the user with both options for their selection as exampled in FIG. 81A through FIG. 83B. And as also exampled in FIG. 122A through FIG. 122C. Once the user makes a selection our technology automatically alters the field in the spreadsheet cell formula input.

### Double Joins—Join Types

Implementations of our double joins technology support all types of SQL joins including inner, full outer, left outer, right outer, self, and cross joins as exampled in FIG. 37 3748. Implementations support the types of join used being application specified or user specified. Implementation support any of the different type of joins used as the application default join, with the full outer join being an attractive option that drops no data.

### Double Joins—Data Sources

All of our double joins involving both doubles implementations support using data sets from non-spreadsheet cell external to the spreadsheet cells data as exampled in FIG. 10A and FIG. 10B. Those implementations also support using data sets that are ranges of data or tables within cells of the spreadsheet as exampled in FIG. 11A and FIG. 11B and those implementations support use of combinations of external data sets and in-cell data sets.

### Double Joins—Selection Lists

Our double join implementations support automatically displaying the double joined data fields in cell formula selection lists as exampled in FIG. 78A and FIG. 78B. That displaying of the double joined fields can be triggered by setting or resetting the joins in any of the locations exampled in FIG. 128. The specified joins can be invisible as exampled in FIG. 79B and FIG. 82C or visibly included in the cell formula as exampled many times herein (e.g., FIG. 126A through FIG. 126D). The double joins can be displayed in a single selection list, as exampled in FIG. 78A and FIG. 78B, or in a series of selection list as exampled time herein (e.g., FIG. 16A and FIG. 16B).

### Double Joins—Other Implementations

Other implementations of our double joins technology may include a non-transitory computer readable storage medium storing instructions executable by a processor to perform any of the methods described above. Yet another implementation may include a system including memory and one or more processors operable to execute instructions, stored in the memory, to perform any of the methods described above. Implementations also support triple, quadruple, and so on multiple joins working in the same manner where all the join keys in one data set are the same key and each of the join keys in the other data set are different fields.

While the technology disclosed is disclosed by reference to the embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following clauses and claims.

### CLAUSES

### Two Data Set Qualified Selection List Join

1. A method of qualifying a join to be performed within a spreadsheet cell formula, displaying those qualified joinable fields in formula populating selection lists, and in the spreadsheet cell formula joining and using the fields to execute the cell formula, including:
   setting a join qualification flag for joinability of a first data set with a second data set via a first key field in the first data set and a second key field in the second data set;
   receiving from a user input setting at least one argument of a spreadsheet formula in a cell, wherein the argument is a specified field in the first data set;
   responsive to the one or more specified field in the first data set and the join qualification flag, automatically displaying a list including at least some of the fields of the second data set, accepting a user selected field from the second data set from the list, and populating an argument of the spreadsheet cell formula with the selected field from the second data set;
   joining the specified field from the first set and the selected field from the second data set employing an application default or user specified join type employing the first key field in the first data set and the second key field in the second data set; and
   using the joined data to execute the spreadsheet cell formula.
2. The method of clause 1, wherein the join qualification flag is set before user input of the cell formula.
3. The method of clause 2, wherein the join of the first and second data sets requires no visible joining argument or joining function in the cell formula.
4. The method of clause 2, wherein the join of the first and second data sets includes a visible joining argument or joining function in the cell formula.
5. The method of clause 4, wherein the joining argument or function specifies the join type.
6. The method of clause 4, wherein the joining argument or function specifies the join keys.
7. The method of clause 2, wherein a type of joining can be changed via inclusion in the cell formula of a join prebuilt function and/or a join type argument.
8. The method of clause 7, wherein a function name of the join prebuilt function specifies a to join type, among at least inner, full outer, outer right and outer left joins.
9. The method of clause 2, wherein the qualified data set join can be changed by the inclusion in the cell formula of a join prebuilt function and/or a join formula argument changing the first key field in the first data set and/or second key field in the second data set.
10. The method of clause 1, wherein a join can be added via a formula argument or prebuilt function specified by the spreadsheet user in the spreadsheet formula within a cell.
11. The method of clause 10, wherein after the input into the formula of the completed join argument or join prebuilt function the joined fields are qualified for selection list support.
12. The method of clause 1, wherein the qualification of the join employs a join key pair selection list including join validation information and results for the qualification of the join.
13. The method of clause 12, wherein that selection list support includes automated data type and data value match validation of the qualification of the join.
14. The method of clause 1, wherein the qualified join is human qualified to set the flag.
15. A method of clause 14, wherein a human qualified join is further automatically qualified for at least data type and data match.
16. The method of clause 1, wherein a join is automatically identified and qualified to set the flag.
17. The method of clause 16, wherein the automatically qualified joins are further human qualified to set the flag.
18. The method of clause 2, wherein the join qualification flag setting is done before the spreadsheet in a data intake tool.
19. The method of clause 2, wherein the join qualification flag setting is done within the spreadsheet by a data intake tool used before the cell formula.
20. The method of clause 2, wherein the join qualification flag setting is done within a spreadsheet specific or worksheet specific capability before the cell formula.
21. The method of clause 2, wherein two joins are qualified for flags between the same two data sets with no common fields in the two sets of first data set key fields and second data set key fields.
22. The method of clause 21, wherein only one of the two alternative joins gets the qualification flag and the other can be selected as a replacement in a formula argument or formula prebuilt function argument.
23. The method of clause 1, wherein automated flag qualification accepts the first data set first key and the second data set second key only when they are of the same data type.
24. The method of clause 1, wherein the automated flag qualification accepts the first data set first key and the second data set second key only if they have at least one matching value.
25. The method of clause 1, wherein the automated flag qualification accepts joins the first data set first key and the second data set second key provided they have specified data modeling cardinalities.
26. The method of clause 25, wherein the accepted data modeling cardinality differs by location of qualification.
27. The method of clause 25, wherein the accepted data modeling cardinality is unique to unique, unique to non-unique, or non-unique to unique.
28. The method of clause 26, wherein the prior cell formula flag qualification join accepts data modeling cardinality unique to unique, unique to non-unique, or non-unique to unique and the in-cell formula accepts all modeling cardinalities.
29. The method of clause 1, wherein the fields in joinable data sets are displayed in a single selection list.
30. The method of clause 1, wherein the fields in joinable sets are accessible from a single selection list.
31. The method of clause 30, wherein accessing the fields in the joinable data set involves one or more sequential selection list selections.
32. The method of clause 2, wherein the flag qualified joins have an application or a user specified SQL join type.
33. The method of clause 32, wherein the join type is a full outer join.
34. The method of clause 32, wherein all SQL join types are supported.
35. The method of clause 1, wherein a user selected joined field replaces a field in the other joined data set.
36. The method of clause 1, wherein the joined fields are used in formulaic data field formulas.
37. The method of clause 1, wherein the joined fields are used in prebuilt spreadsheet function formulas which have structured arguments or structured groups of arguments.
38. The method of clause 37, wherein the prebuilt spreadsheet function populates more than one cell.
39. The method of clause 1, wherein the joined fields are used in multi-function and multi-algebraic operator formulas.
40. The method of clause 1, wherein the data sets are data tables external to the spreadsheet.
41. The method of clause 1, wherein the data sets are ranges of data or tables within cells of the spreadsheet.
42. The method of clause 1, wherein the data sets are a combination of data tables external to the spreadsheet and ranges of data or tables within cells of the spreadsheet.
43. The method of clause 1, wherein the join qualification flag is set after automatically determining that the first field and second field are of the same data type, have overlapping values and have data modeling cardinalities of unique to unique or unique to non-unique.
44. A non-transitory computer readable memory, the memory impressed with computer instructions that, when executed on hardware, cause the hardware to carry out the method of any of clauses 1 through 43.
45. A system including processing hardware coupled to memory, the memory impressed with computer instructions that, when executed, cause the hardware to carry out the method of any of clauses 1 through 43.

### In Cell Formula Two Data Set Join

46. A method for joining and using the joined fields from two different data sets within a spreadsheet cell formula, including:
   beginning a spreadsheet formula in a cell;
   adding a formula element that joins a first and a second data set via a first field join key in the first data set and a second field join key in the second data set;
   where the join formula element is an argument within a function or formulaic data field within the spreadsheet formula or an argument within an argument within a function or formulaic data field and/or the join element is a join function;
   where a formulaic data field is a named formulaic variable that accesses a column of data from an in-spreadsheet cells data set or a non-spreadsheet cell external data set;
   responsive to the user populating at least one field from each data set into that spreadsheet cell formula joining the specified fields from the first and second data sets, based on the parameters of the spreadsheet formula; and
   using the joined data to execute the spreadsheet cell formula.
47. The method of clause 46, wherein the formula element that specifies the join is a join type specific prebuilt spreadsheet function with structured arguments that specify the first data set first join key field and second data set second join key field used as keys in the join.
48. The method of clause 46, wherein the formula element that specifies the join is a prebuilt spreadsheet function with arguments used to specify the join type, the first data set first join key field and the second data set second join key field.
49. The method of clause 46, wherein the formula element that specifies the join is a prebuilt function with argument groups containing arguments used to specify the join type, the first data set first join key field and the second data set second join key field.
50. The method of clause 46, wherein the formula element that specifies the join are added arguments to non-join dedicated regular prebuilt functions used to specify the join type and the first data set first join key field and the second data set second join key field.
51. The method of clause 46, wherein the formula element that specifies the join are added arguments to formulaic data fields used to specify the join type and the first data set first join key field and the second data set second join key field.
52. The method of clause 46, wherein adding a formula element that joins a first and a second data set via a first join key field in the first data set and a second join key field in the second data set has selection list support.
53. The method of clause 52, wherein that selection list support includes data set and data field selections within the data set.
54. The method of clause 52, wherein that selection list support includes validation analytical results for the qualification of the join.
55. The method of clause 52, wherein that selection list support includes automated validation of the qualification of the join.
56. The method of any of clause 55, wherein the qualification accepts join key field one and join key field two only when they are of the same data type.
57. The method of any of clause 55, wherein the automated qualification accepts join key field one and join key field two only if they have at least one matching value.
58. The method of clause 55, wherein the automated qualification accepts joins that have specified data modeling cardinalities.
59. The method of clause 58, wherein the accepted data modeling cardinalities are unique to unique, unique to non-unique, and non-unique to unique.
60. The method of clause 52, wherein manual specification of the join between the first and second data sets causes the fields in the first and second datasets to become automatically visible in selection lists for subsequent selection into the spreadsheet formula.
61. The method of clause 60, wherein the fields in joinable data sets are displayed in a single selection list.
62. The method of clause 60, wherein the fields in joinable data sets are accessible from multiple selection lists.
63. The method of clause 62, wherein selecting the fields in the joinable data sets involves two or more sequential selection list selections.

64 The method of clause 46, wherein all SQL join types are supported.
65. The method of clause 46, wherein the joined fields can be used in formulaic data field formulas.
66. The method of clause 46, wherein the joined fields can be used in prebuilt spreadsheet function formulas which have structured arguments or structured groups of arguments.
67. The method of clause 46, wherein the joined fields can be used multi-function and multi-algebraic operator formulas.
68. The method of clause 46, wherein the data sets are a combination of in-spreadsheet cells data set and non-spreadsheet cell external data set.
69. A non-transitory computer readable memory, the memory impressed with computer instructions that, when executed on hardware, cause the hardware to carry out the method of any of clauses 46 through 70.
70. A system including processing hardware coupled to memory, the memory impressed with computer instructions that, when executed, cause the hardware to carry out the method of any of clauses 46 through 70.

### In Cell Formula Three and More Data Sets Prequalified Selection List Join

71. A method of qualifying multiple joins to be performed within a spreadsheet cell formula, displaying those qualified joinable fields in formula populating selection list, and in the spreadsheet cell formula joining together more than one set of those joins and using some of those joined fields to execute the spreadsheet formula, including:
   setting a join qualification flag for the joinability of:
      a first and second data set via a first join key field in the first data set and a second join key field in the second data set and
      a first and a third data set via a third join key field in the first data set and a fourth join key field in the third data set;
   setting a chained join qualification flag for the chained joinability of the second and the third data sets;
   receiving input from a user into a spreadsheet formula in a cell a field belonging to the second data set;
   responsive to the specified field and the chained join qualification flag, automatically displaying at least some of the fields of the second, first, and the third data sets, accepting a user selection of a field in the third data set, and populating the spreadsheet cell formula with the selected field from the from the third data set; and
   chain joining the fields from each data set shown in the spreadsheet formula; and using the joined data to execute the spreadsheet cell formula.
72. The method of clause 71, wherein the join qualification flags are set before user input of the cell formula.
73. The method of clause 72, wherein the joins of the first, second, and third data sets, based on the parameters of the spreadsheet formula requires no visible joining argument or function in the cell formula.
74. The method of clause 72, wherein the qualified join requires a visible joining argument or function in the cell formula.
75. The method of clause 74, wherein the joining argument or function specifies the join type.
76. The method of clause 74, wherein the joining argument or function specifies the join keys.
77. The method of clause 72, wherein the join qualification flag can be changed via inclusion in the cell formula of a join prebuilt function and/or a join formula argument.
78. The method of clause 77, wherein join prebuilt function and/or a join formula argument respecifies at least one of the first, second, third and/or fourth field used as a key for the join.
79. The method of clause 77, wherein a join prebuilt function and/or a join formula argument changes at least one join type.
80. The method of clause 79, wherein the join prebuilt function specifies in its name a join type.
81. The method of clause 71, wherein two joins between the same two data sets where:
   both the join keys in the first data set, join key one and join key three employ the same field;
   the second and the third data set are the same data set;
   the second join key field is different than the fourth join key field and
   the join creates two versions of the first data set.
82. The method of clause 81, wherein the joinable field names for the two versions of the first data set are automatically changed so they differ from each other.
83. The method of clause 82, wherein the automatic change of the field names includes appending the second join key field name to each of the fields in one of the first data sets and appending the fourth join key field name to each of the fields in the other version of the first data set.
84. The method of clause 82, wherein the automatic change of the field names includes appending the second join key field name preceded by the characters -> to each of the fields in one of the first data sets and appending the fourth join key field name preceded by the characters -> to each of the fields in the other version of the first data set.
85. The method of clause 82, wherein the automatic change of the field names for the two different versions of data set one employ appending a user specified unique set of characters for each version.
86. The method of clause 71, wherein a new qualified join flag can be added via a formula argument or prebuilt function specified by the spreadsheet user.
87. The method of clause 86, wherein after the new qualified join flag is added the joinable fields are qualified for combined selection list support.
88. The method of clause 86, wherein a join formula addition has data set selection list support and join key field selection list support.
89. The method of clause 88, wherein that selection list support includes validation analytical results for the qualification of the join.
90. The method of clause 88, wherein that selection list support includes automated validation of the qualification of the join.
91. The method of clause 71, wherein the qualified joins are human validated.
92. A method of clause 91, wherein the human qualified joins are further algorithmically validated (qualified).
93. The method of clause 71, wherein the qualified joins are automatically validated (qualified) algorithmically.
94. The method of clause 93, wherein the automatically validated joins are further human validated (qualified).
95. The method of clause 72, wherein the join qualification is done before the spreadsheet in a data intake tool before the cell formula.
96. The method of any of clause 72, wherein the join qualification is done within the spreadsheet in a data intake tool before the cell formula.
97. The method of any of clause 72, wherein the join qualification is done within a spreadsheet specific or worksheet specific capability before the cell formula.
98. The method in clause 71, wherein multiple joins are qualified between the same two data sets with different first fields in the first data set and a different second fields in the second data set.
99. The method in clause 98, wherein one of the multiple alternative joins is set as the default for qualification use and the other can be selected as a replacement in a formula argument or formula prebuilt function argument.
100. The method in clause 71, wherein automated flag qualification accepts fields one and two only when they are of the same data type.
101. The method in clause 71, wherein the automated flag qualification accepts fields one and two only if they have at least some matching values.
102. The method of clause 71, wherein the automated qualification accepts joins that have specified data modeling cardinalities.
103. The method of clause 102, wherein the accepted data modeling cardinality differs by location of qualification.
104. The method of clause 102, wherein the accepted data modeling cardinality is unique to unique or unique to non-unique.
105. The method of clause 103, wherein the prior to cell formula flag qualification join accepts data modeling cardinality unique to unique or unique to non-unique and the in-cell formula accepts all modeling cardinalities.
106. The method of clause 71, wherein the fields in joinable data sets are displayed in a single selection list.
107. The method of clause 71, wherein the fields in joinable data sets are accessible from a single selection list.
108. The method of clause 107, wherein accessing the fields in the joinable data sets involves one or more sequential selection list selections.
109. The method of clause 72, wherein the qualified joins have an application specified join type.
110. The method of clause 72, wherein the qualified joins have a user specified join type.
111. The method of clause 109, wherein the join type is a full outer join.
112. The method of clause 71, wherein all SQL join types are supported.
113. The method of clause 71, wherein a user selected joined field replaces a field in the other joined data set.
114. The method of clause 71, wherein the joined fields are used in formulaic data field formulas.
115. The method of clause 71, wherein the joined fields are used in a formula evaluating a prebuilt spreadsheet function which has structured arguments or structured groups of arguments.
116. The method of clause 115, wherein the prebuilt spreadsheet function populates more than one cell.
117. The method of clause 71, wherein the joined fields is used in a formula evaluating multiple prebuilt functions with structured arguments and multi-algebraic operator formulas.
118. The method of clause 71, wherein the data sets are data tables external to the spreadsheet.
119. The method of clause 71, wherein the data sets are ranges of data or tables within cells of the spreadsheet.
120. The method of clause 71, wherein the data sets are a combination of data tables external to the spreadsheet and ranges of data or tables within cells of the spreadsheet.
121. A non-transitory computer readable memory, the memory impressed with computer instructions that, when executed on hardware, cause the hardware to carry out the method of any of clauses 71 through 120.
122. A system including processing hardware coupled to memory, the memory impressed with computer instructions that, when executed, cause the hardware to carry out the method of any of clauses 71 through 120.

### In Cell Formula Chained Join

123. A method for chain joining and using the joined fields from three or more different data sets within a spreadsheet cell formula, including:
   beginning a spreadsheet formula in a cell;
   receiving from user inputs formula elements that specify multiple joins of a first and a second data set via a first field/column join key in the first data set and a second field/column join key in the second data set;
   where the join formula element is an argument within a function or formulaic data field within the spreadsheet formula or an argument within an argument within a function or formulaic data field and/or the join element is a join function;
   automatically determining the different joinable data sets that can also be joined by a sequence/chain of joins;
   responsive to the user populating into the spreadsheet cell formula at least one selected field from two or more of the different data sets that can only be joined by a sequence/chain of joins, performing any required any required sequence/chain of joins; and
   using the joined data to execute the spreadsheet cell formula.
124. The method of clause 123, wherein the formula element that specifies the join is a join type specific prebuilt spreadsheet function with structured arguments that specify the first data set first join key field and second data set second join key field used as keys in the join.
125. The method of clause 123, wherein the formula element that specifies the join is a prebuilt spreadsheet function with arguments that specify the join type and specify the first data set first join key field and the second data set second join key field used as keys in the join.
126. The method of clause 123, wherein the formula element that specifies the join is a prebuilt function with argument groups containing arguments used to specify the join type, the first data set first join key field and the second data set second join key field.
127. The method of clause 123, wherein the formula element that specifies the join are added arguments to non-join dedicated regular prebuilt functions used to specify the join type and the first data set first join key field and the second data set second join key field.
128. The method of clause 123, wherein the formula element that specifies the join are added arguments to formulaic data fields used to specify the join type and the first data set first join key field and the second data set second join key field.
129. The method of clause 123, wherein adding a formula element that joins a first and a second data set via a first join key field in the first data set and a second join key field in the second data set has selection list support.
130. The method of clause 129, wherein that selection list support includes data set selection list support and join key field selection list support.
131. The method of clause 129, wherein that selection list support includes validation analytical results for the qualification of the join.
132. The method of clause 129, wherein that selection list support includes automated validation of the qualification of the join.
133. The method of any of clause 132, wherein the qualification accepts fields one and two only when they are of the same data type.
134. The method of any of clause 132, wherein the automated qualification accepts fields one and two only if they have at least some matching values.
135. The method of clause 132, wherein the automated qualification accepts fields one and two that have specified data modeling cardinalities.
136. The method of clause 135, wherein the accepted data modeling cardinality is unique to unique or unique to non-unique.
137. The method of clause 129, wherein manual specification of the join between the first and second data sets causes the fields in the first and second datasets to become automatically visible together in selection lists for subsequent use of the first and second datasets.
138. The method of clause 137, wherein the fields in joinable data sets are displayed in a single selection list.
139. The method of clause 137, wherein the fields in joinable data sets are accessible from a single selection list.
140. The method of clause 139, wherein accessing the fields in the joinable data sets involves one or two sequential selection list selections.
141. The method of clause 123, wherein all SQL join types are supported.
142. The method of clause 123, wherein a user selected joined field replaces a field in another joined data set.
143. The method of clause 123, wherein the joined fields are used in formulaic data field formulas.
144. The method of clause 123, wherein the joined fields are used in prebuilt spreadsheet function formulas which have structured arguments or structured groups of arguments.
145. The method of clause 123, wherein the joined fields can be used multi-function and multi-algebraic operator formulas.
146. The method of clause 123, wherein the data sets are data tables external to the spreadsheet.
147. The method of clause 123, wherein the data sets are ranges of data or tables within cells of the spreadsheet.
148. The method of clause 123, wherein the data sets are a combination of data tables external to the spreadsheet and ranges of data or tables within cells of the spreadsheet.
149. A non-transitory computer readable memory, the memory impressed with computer instructions that, when executed on hardware, cause the hardware to carry out the method of any of clauses 123 through 148.
150. A system including processing hardware coupled to memory, the memory impressed with computer instructions that, when executed, cause the hardware to carry out the method of any of clauses 123 through 148.

### Double Joins

151. A method of selecting between two potentially simultaneous joins between two data sets within a spreadsheet cell formula and using one or more of the two joins to produce the spreadsheet formula output, including:
   receiving a definition of two potentially simultaneous joins:
      join one a first and second data set via a first key field in the first data set and a second key field in the second data set and
      join two the same first and the second data sets via a third key field in the first data set that is different than the first key field and the second key field in the second data set that is the same second key as used with the first key in the first join;
   receiving input into the spreadsheet cell formula from a user that specifies:
      at least on field from the first data set; and
      at least one field from second data set employing join one;
not receiving any input from a user specifying a field from the second data set employing join two;
   joining the inputted fields from the first and the second datasets using join one; and
using the joined data to execute the spreadsheet cell formula.
152. The method of clause 151, further including:
   where the user specifies at least one field from the second data set employing the second join:
   chain joining the inputted fields from second datasets and any inputted fields from the first data set using join one and join two; and
   using the chain joined data to execute the spreadsheet cell formula.
153. The method of clause 151, wherein the joinable field names for the join one data set two and the join two data set two are automatically changed so they are differentiated from the other versions.
154. The method of clause 153, wherein the automatic change of the field names includes appending the first key field name to each of the fields in data set two to make the join one version of data set two field names and appending the third key field name to each of the fields in data set two to make the join two version of data set two fields names.
155. The method of clause 154, wherein the appended second and third key field names are preceded by the dash and right pointing characters (->).
156. The method of clause 151, wherein the joinable field names for the join one data set two and the join two data set two are changed by a user specified data field name addition so they are differentiated from the other versions.
157. The method of clause 151, wherein a previous population of a non-join one or non-join two data set two field into an input is automatically converted to a join one version of the same field once a user populates an input with a data set two join one field of the same field into spreadsheet cell formula inputs that do not allow multiple use of the same field.
158. The method of clause 151, wherein a previous population of a non-join one or non-join two data set two field into an input is automatically presented an option for a join one or join two version of the same field once a user populates an input with a data set one field, a data set two join one field, or a data set two join two field.
159. The method of clause 151, wherein inner, full outer, right outer, self, cross and left outer SQL join types are supported.
160. The method of clause 151, wherein the default join type is a full outer join.
161. The method of clause 151, wherein the data sets are data tables external to the spreadsheet.
162. The method of clause 151, wherein the data sets are ranges of data or tables within cells of the spreadsheet.
163. The method of clause 151, wherein the data sets are a combination of ranges of data or tables within cells of the spreadsheet and the data sets are data tables external to the spreadsheet.
164. The method of clause 151, wherein specification of join one and join two automatically make visible the joined fields in spreadsheet cell formula selection lists.
165. The method of clause 164, wherein specification of join one and join two is done prior to the spreadsheet cell formula.
166. The method of clause 164, wherein specification of join one and/or join two is done within the spreadsheet cell formula.
167. The method of clause 165, wherein specification of join one and join two is invisible in the spreadsheet cell formula.
168. The method of clause 164, wherein the fields in joinable data sets are displayed in a single selection list.
169. The method of clause 164, wherein the fields in joinable data sets are accessible from multiple selection lists.
170. A non-transitory computer readable memory, the memory impressed with computer instructions that, when executed on hardware, cause the hardware to carry out the method of any of clauses 151 through 169.
171. A system including processing hardware coupled to memory, the memory impressed with computer instructions that, when executed, cause the hardware to carry out the method of any of clauses 151 through 169.

We claim as follows:

1. A method of qualifying a join to be performed within a spreadsheet cell formula that accepts a list of values as input, displaying those qualified joinable fields in formula populating selection lists, and in the spreadsheet cell formula joining and using the fields to execute the cell formula, including:
receiving a user input setting at least one argument of a spreadsheet formula in a cell, wherein the argument is a specified field in a first data set;
accessing a join qualification flag for joinability of the first data set with at least a second data set via a first join key field in the first data set and a second join key field in the second data set;
responsive to the specified field in the first data set and the join qualification flag for joinability of the first data set and the second data set, automatically displaying a list including a plurality of fields of the second data set, receiving a user selection from the list of a field from the second data set, and populating an argument of the spreadsheet cell formula with the selected field from the second data set;
joining the specified field from the first set and the selected field from the second data set employing an application default or user specified join type employing the first join key field in the first data set and the second join key field in the second data set to produce a list of values; and
using the list of values in the joined data to execute the spreadsheet cell formula.

2. The method of claim 1, wherein the join qualification flag is set before user input of the cell formula.

3. The method of claim 2, wherein the join of the first and second data sets requires no visible joining argument or joining function in the spreadsheet cell formula.

4. The method of claim 1, wherein the join of the first and second data sets includes a visible joining argument or joining function in the spreadsheet cell formula.

5. The method of claim 4, wherein the joining argument or joining function included in the spreadsheet cell formula specifies the join type.

6. The method of claim 4, wherein the joining argument or joining function included in the spreadsheet cell formula specifies the join keys.

7. The method of claim 2, wherein a type of join and/or the join keys can be changed via inclusion in the cell formula of a joining argument or joining function specifying the type of join or the join keys used by the join.

8. The method of claim 2, wherein the join qualification flag for the first data set is stored with and accessed with first data set.

9. The method of claim 2, wherein the join qualification flag for the first data set is stored within the spreadsheet by a data intake tool used before receiving the cell formula.

10. The method of claim 2, wherein the join qualification flag for the first data set is stored for a specific worksheet with a scope accessible only to formulas entered in the specific worksheet.}

11. The method of claim 1, wherein fields in joinable data sets are displayed in a single list for selection.

12. The method of claim 1, wherein accessing the fields in the second data set involves sequential selection list selections.

13. The method of claim 1, wherein the join type for the joining is an SQL join type.

14. The method of claim 1, wherein the spreadsheet cell formula is a prebuilt spreadsheet functional formula.

15. The method of claim 1, wherein the spreadsheet cell formula includes multiple prebuilt spreadsheet functions combined by one or more algebraic operators.

16. The method of claim 1, wherein the data sets are data tables external to the spreadsheet.

17. The method of claim 1, wherein the data sets are ranges of data or tables within cells of the spreadsheet.

18. The method of claim 1, wherein the data sets are a combination of data tables external to the spreadsheet and ranges of data or tables within cells of the spreadsheet.

19. A non-transitory computer readable memory, the memory impressed with computer instructions that, when executed on hardware, cause the hardware to carry out the method of qualifying a join to be performed within a spreadsheet cell formula, displaying those qualified joinable fields in formula populating selection lists, and in the spreadsheet cell formula joining and using the fields to execute the cell formula, including:
receiving a user input setting at least one argument of a spreadsheet formula in a cell, wherein the argument is a specified field in a first data set;
accessing a join qualification flag for joinability of the first data set with at least a second data set via a first join key field in the first data set and a second join key field in the second data set;
responsive to the specified field in the first data set and the join qualification flag for joinability of the first data set and the second data set, automatically displaying a list including a plurality of fields of the second data set, receiving a user selection from the list of a field from the second data set, and populating an argument of the spreadsheet cell formula with the selected field from the second data set;
joining the specified field from the first set and the selected field from the second data set employing an application default or user specified join type employing the first join key field in the first data set and the second join key field in the second data set to produce a list of values; and
using the list of values in the joined data to execute the spreadsheet cell formula.

20. The non-transitory computer-readable medium of claim 19, wherein the join qualification flag is set before user input of the cell formula.

21. The non-transitory computer-readable medium of claim 20, wherein the join of the first and second data sets requires no visible joining argument or joining function in the spreadsheet cell formula.

22. The non-transitory computer-readable medium of claim 19, wherein the join of the first and second data sets includes a visible joining argument or joining function in the spreadsheet cell formula.

23. A system including processing hardware coupled to memory, the memory impressed with computer instructions that, when executed, cause the hardware to carry out the method of qualifying a join to be performed within a spreadsheet cell formula, displaying those qualified joinable fields in formula populating selection lists, and in the spreadsheet cell formula joining and using the fields to execute the cell formula, including:
receiving a user input setting at least one argument of a spreadsheet formula in a cell, wherein the argument is a specified field in a first data set;
accessing a join qualification flag for joinability of the first data set with at least a second data set via a first join key field in the first data set and a second join key field in the second data set;
responsive to the specified field in the first data set and the join qualification flag for joinability of the first data set and the second data set, automatically displaying a list including a plurality of fields of the second data set, receiving a user selection from the list of a field from the second data set, and populating an argument of the spreadsheet cell formula with the selected field from the second data set;
joining the specified field from the first set and the selected field from the second data set employing an application default or user specified join type employing the first join key field in the first data set and the second join key field in the second data set to produce a list of values; and
using the list of values in the joined data to execute the spreadsheet cell formula.

24. The system of claim 23, wherein fields in joinable data sets are displayed in a single list for selection.

25. The system of claim 23, wherein accessing the fields in the second data set involves sequential selection list selections.
